(19) United States
(12) Patent Application Publication
(10) Pub. No.: US 2024/0187908 A1
(43) Pub. Date: Jun. 6, 2024

(54) CSI CODEBOOK PARAMETERS AND CSI REPORTING FOR COHERENT JOINT TRANSMISSION

(71) Applicant: Samsung Electronics Co., Ltd., Suwon-si (KR)

(72) Inventors: Gilwon Lee, McKinney, TX (US); Md. Saifur Rahman, Plano, TX (US); Eko Onggosanusi, Coppell, TX (US)

(21) Appl. No.: 18/499,142

(22) Filed: Oct. 31, 2023

Related U.S. Application Data
(60) Provisional application No. 63/424,741, filed on Nov. 11, 2022.
(60) Provisional application No. 63/424,749, filed on Nov. 11, 2022.
(60) Provisional application No. 63/424,757, filed on Nov. 11, 2022.
(60) Provisional application No. 63/425,630, filed on Nov. 15, 2022.
(60) Provisional application No. 63/426,076, filed on Nov. 17, 2022.
(60) Provisional application No. 63/426,081, filed on Nov. 17, 2022.
(60) Provisional application No. 63/426,980, filed on Nov. 21, 2022.
(60) Provisional application No. 63/427,717, filed on Nov. 23, 2022.
(60) Provisional application No. 63/427,725, filed on Nov. 23, 2022.
(60) Provisional application No. 63/439,776, filed on Jan. 18, 2023.
(60) Provisional application No. 63/443,310, filed on Feb. 3, 2023.
(60) Provisional application No. 63/448,812, filed on Feb. 28, 2023.
(60) Provisional application No. 63/448,822, filed on Feb. 28, 2023.

(51) Int. Cl. H04W 24/10; H04L 5/00

(52) U.S. Cl. CPC H04W 24/10; H04L 5/0051

(57) ABSTRACT

Apparatuses and methods for channel state information (CSI) codebook parameters and CSI reporting for a coherent joint transmission. A method performed by a user equipment (UE) includes receiving information about (i) a channel state information (CSI) report associated with N_{TRP}≥1 CSI reference signal (CSI-RS) resources and (ii) N_{L}≥1 values of (L₁, . . . , L_{N}_{_{TRP}}). Each of the N_{L} values of (L₁, . . . , L_{N}_{_{TRP}}) belongs to a table including N_{TRP}, (L₁, . . . , L_{N}_{_{TRP}}), and an associated index and (L₁, . . . , L_{N}_{_{TRP}}) is a tuple of numbers of spatial-domain (SD) basis vectors Lᵣ associated with CSI-RS resource r=1, . . . , N_{TRP}. The method further includes determining the CSI report based on the information and transmitting the determined CSI report.

### CROSS-REFERENCE TO RELATED AND CLAIM OF PRIORITY

The present application claims priority under 35 U.S.C. § 119(e) to: U.S. Provisional Patent Application No. 63/424,741 filed on Nov. 11, 2022; U.S. Provisional Patent Application No. 63/424,749 filed on Nov. 11, 2022; U.S. Provisional Patent Application No. 63/424,757 filed on Nov. 11, 2022; U.S. Provisional Patent Application No. 63/425,630 filed on Nov. 15, 2022; U.S. Provisional Patent Application No. 63/426,076 filed on Nov. 17, 2022; U.S. Provisional Patent Application No. 63/426,081 filed on Nov. 17, 2022; U.S. Provisional Patent Application No. 63/426,980 filed on Nov. 21, 2022; U.S. Provisional Patent Application No. 63/427,717 filed on Nov. 23, 2022; U.S. Provisional Patent Application No. 63/427,725 filed on Nov. 23, 2022; U.S. Provisional Patent Application No. 63/439,776 filed on Jan. 18, 2023; U.S. Provisional Patent Application No. 63/443,310 filed on Feb. 3, 2023; U.S. Provisional Patent Application No. 63/448,812 filed on Feb. 28, 2023; and U.S. Provisional Patent Application No. 63/448,822 filed on Feb. 28, 2023, which is hereby incorporated by reference in their entirety.

### TECHNICAL FIELD

The present disclosure relates generally to wireless communication systems and, more specifically, the present disclosure is related to apparatuses and method for channel state information (CSI) codebook parameters and CSI reporting for coherent joint transmission.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to CSI codebook parameters and CSI reporting for coherent joint transmission.

In an embodiment, a user equipment (UE) is provided. The UE includes a transceiver configured to receive information about (i) a CSI report associated with N_{TRP}≥1 CSI reference signal (CSI-RS) resources and (ii) N_{L}≥1 values of (L₁, . . . , L_{N}_{_{TRP}}). Each of the N_{L} values of (L₁, . . . , L_{N}_{_{TRP}}) belongs to a table including N_{TRP}, (L₁, . . . , L_{N}_{_{TRP}}), and an associated index and (L₁, . . . , L_{N}_{_{TRP}} is a tuple of numbers of spatial-domain (SD) basis vectors Lᵣ associated with CSI-RS resource r=1, . . . , N_{TRP}. The UE further includes a processor operably coupled to the transceiver. The processor is configured to determine the CSI report based on the information. The transceiver is further configured to transmit the determined CSI report.

In another embodiment, a base station (BS) is provided. The BS includes a transceiver configured to transmit information (i) about a CSI report associated with N_{TRP}≥1 CSI-RS resources and (ii) about N_{L}1 values of (L₁, . . . , L_{N}_{_{TRP}}). Each of the N_{L} values of (L₁, . . . , L_{N}_{_{TRP}}) belongs to a table including N_{TRP}, (L₁, . . . , L_{N}_{_{TRP}}), and an associated index and (L₁, . . . , L_{N}_{_{TRP}} is a tuple of numbers of spatial-domain (SD) basis vectors Lᵣ associated with CSI-RS resource r=1, . . . , N_{TRP}. The transceiver is further configured to receive the CSI report that is based on the information.

In yet another embodiment, a method performed by a UE is provided. The method includes receiving information (i) about a CSI report associated with N_{TRP}≥1 CSI-RS resources and (ii) about N_{L}≥1 values of (L₁, . . . , L_{N}_{_{TRP}}). Each of the N_{L} values of (L₁, . . . , L_{N}_{_{TRP}}) belongs to a table including N_{TRP}, (L₁, . . . , L_{N}_{_{TRP}}), and an associated index and (L₁, . . . , L_{N}_{_{TRP}} is a tuple of numbers of spatial-domain (SD) basis vectors Lᵣ associated with CSI-RS resource r=1, . . . , N_{TRP}. The method further includes determining the CSI report based on the information and transmitting the determined CSI report.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a distributed multiple input multiple output (MIMO) according to embodiments of the present disclosure;

FIG. 7 illustrates an example of a distributed MIMO according to embodiments of the present disclosure;

FIG. 8 illustrates an example of an antenna port layout according to embodiments of the present disclosure;

FIG. 9 illustrates a diagram of an example 3D grid of direct fourier transform (DFT) beams according to embodiments of the present disclosure;

FIG. 10 illustrates an example of codebooks according to embodiments of the present disclosure; and

FIG. 11 illustrates an example method performed by a UE in a wireless communication system according to embodiments of the present disclosure.

### DETAILED DESCRIPTION

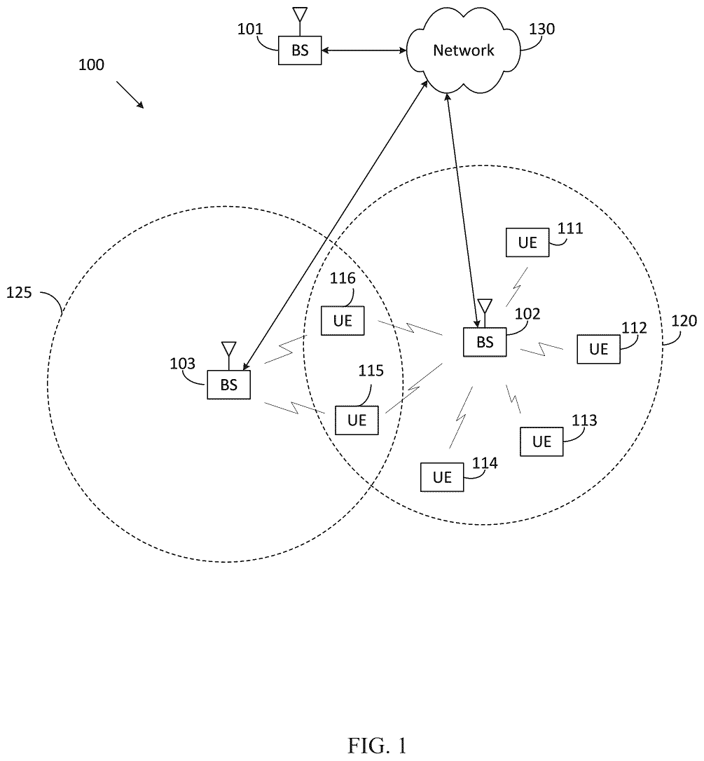

FIGS. 1-11, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 36.211 v17.2.0, “E-UTRA, Physical channels and modulation;” [2] 3GPP TS 36.212 v17.2.0, “E-UTRA, Multiplexing and Channel coding;” [3] 3GPP TS 36.213 v17.2.0, “E-UTRA, Physical Layer Procedures;” [4] 3GPP TS 36.321 v17.1.0, “E-UTRA, Medium Access Control (MAC) protocol specification;” [5] 3GPP TS 36.331 v17.1.0, “E-UTRA, Radio Resource Control (RRC) Protocol Specification;” [6] 3GPP TS 38.211 v17.2.0, “NR, Physical channels and modulation;” [7]3GPP TS 38.212 v17.2.0, “NR, Multiplexing and Channel coding;” [8] 3GPP TS 38.213 v17.2.0, “NR, Physical Layer Procedures for Control;” [9] 3GPP TS 38.214 v17.2.0, “NR, Physical Layer Procedures for Data;” [10]3GPP TS 38.215 v17.1.0, “NR, Physical Layer Measurements;” [11] 3GPP TS 38.321 v17.1.0, “NR, Medium Access Control (MAC) protocol specification;” and [12] 3GPP TS 38.331 v17.1.0, “NR, Radio Resource Control (RRC) Protocol Specification.”

FIGS. 1-11 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for utilizing and performing CSI codebook parameters and CSI reporting for coherent joint transmission. In certain embodiments, one or more of the BSs 101-103 include circuitry, programing, or a combination thereof to provide CSI codebook parameters and receive CSI reporting for coherent joint transmission.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

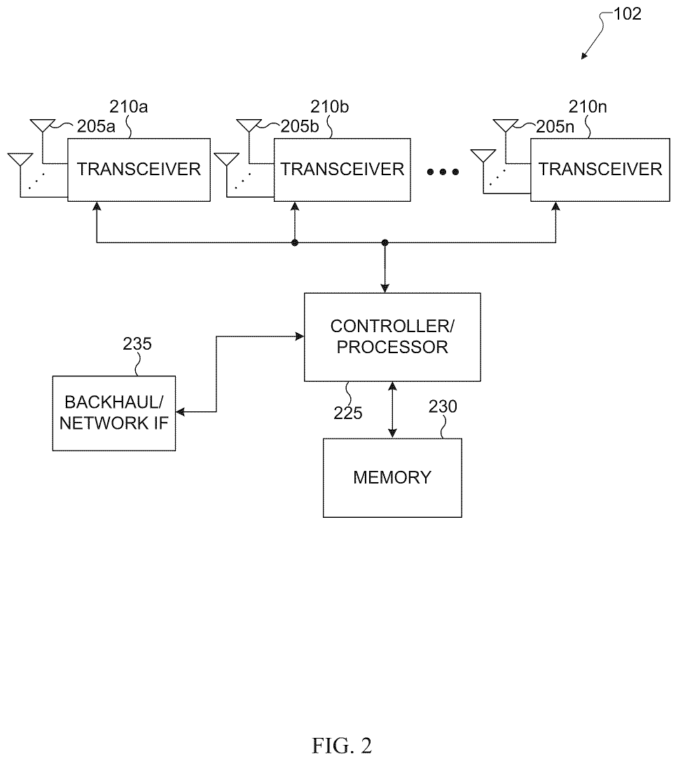

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for providing CSI codebook parameters and receiving CSI reporting for coherent joint transmission. Any of a wide variety of other functions could be supported in the gNB 102 by the controller/processor 225.

The controller/processor 225 is also capable of executing programs and other processes resident in the memory 230, such as processes to provide CSI codebook parameters and receive CSI reporting for coherent joint transmission. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

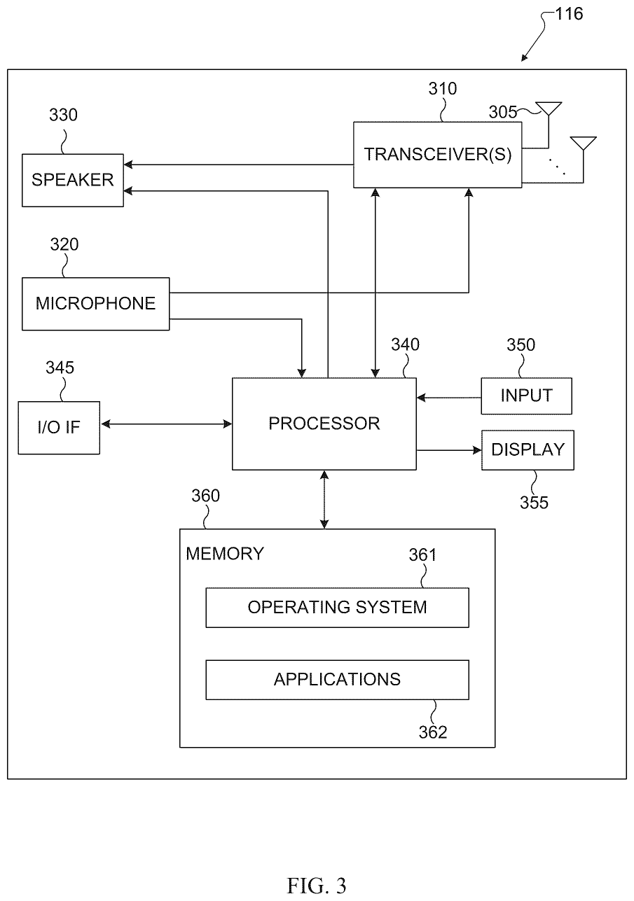

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for utilizing CSI codebook parameters and performing CSI reporting for coherent joint transmission as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

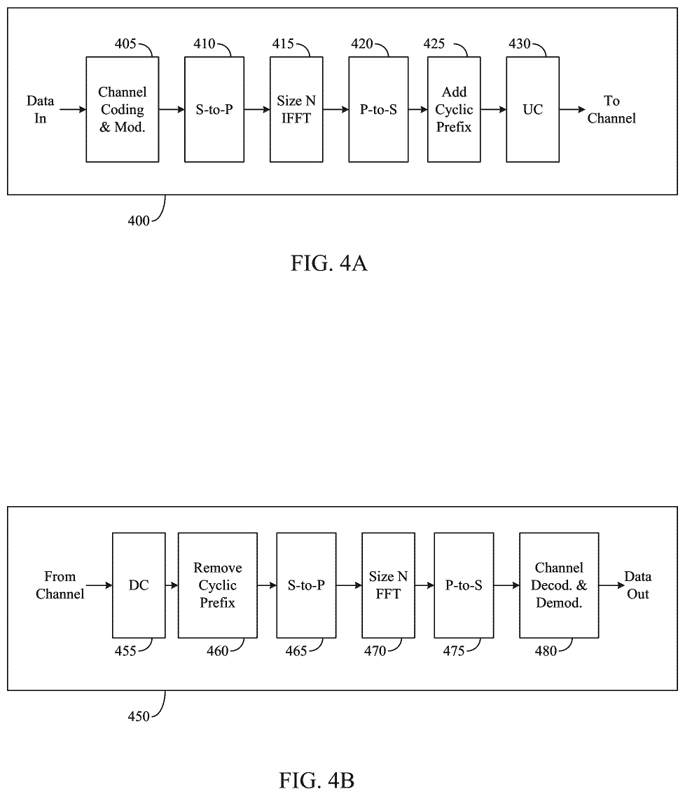

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the receive path 450 is configured to receive CSI codebook parameters for CSI reporting for coherent joint transmission as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

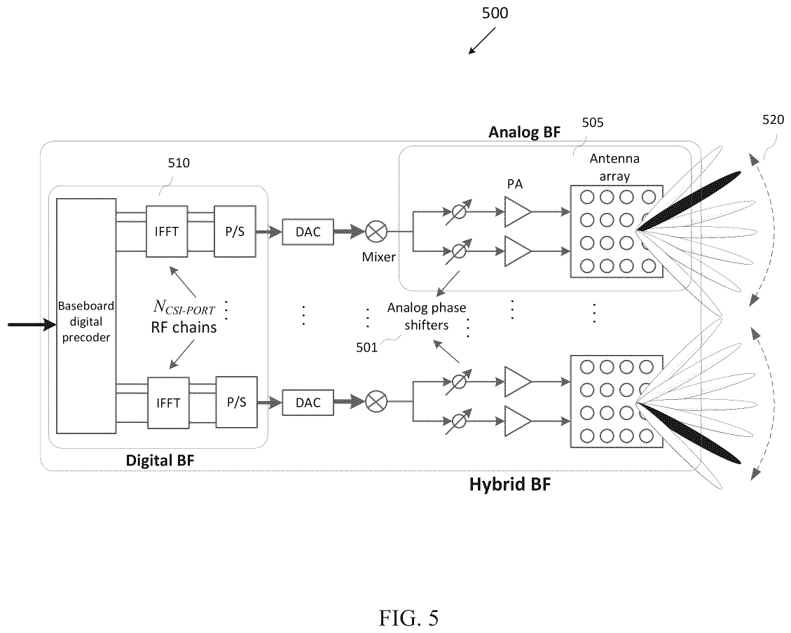

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are necessary to compensate for the additional path loss.

Embodiments of the present disclosure recognize for a cellular system operating in a sub-1 GHz frequency range (e.g., less than 1 GHz), supporting large number of CSI-RS antenna ports (e.g., 32) at a single location or remote radio head (RRH) or TRP is challenging due to that a larger antenna form factor size is necessary at these frequencies than a system operating at a higher frequency such as 2 GHz or 4 GHz. At such low frequencies, the maximum number of CSI-RS antenna ports that can be co-located at a single site (or TRP/RRH) can be limited, for example to 8. This limits the spectral efficiency of such systems. In particular, the multi user MIMO (MU-MIMO) spatial multiplexing gains offered due to large number of CSI-RS antenna ports (such as 32) can't be achieved.

One way to operate a sub-1 GHz system with large number of CSI-RS antenna ports is based on distributing antenna ports at multiple locations (or TRP/RRHs). The multiple sites or TRPs/RRHs can still be connected to a single (common) base unit, hence the signal transmitted/received via multiple distributed TRPs/RRHs can still be processed at a centralized location. This is called distributed MIMO or multi-TRP coherent joint transmission (C-JT).

The present disclosure evaluates the multi-TRP C-JT scenario and proposes method and apparatus for codebook parameters contemplating feedback overhead in the scenario.

Embodiments of the present disclosure relate to electronic devices and methods on codebook parameter configurations for MIMO operations, more particularly, to electronic devices and methods on codebook parameter configurations for distributed MIMO or multi-TRP operations in wireless networks.

CSI enhancement described in Rel-18 MIMO evaluates Rel-16/17 Type-II CSI codebook refinements to support mTRP coherent joint transmission (C-JT) operations by contemplating performance-and-overhead trade-off. The Rel-16/17 Type-II CSI codebook has three components W₁, W₂, and W_{f}. Among them, W₂ is the component that could induce large CSI feedback overhead especially in mTRP C-JT operations. In the present disclosure, we provide several embodiments on codebook parameter configuration to alleviate amount of CSI reporting overhead to have good performance-and-overhead trade-off for C-JT operations.

In the present disclosure, codebook parameter configurations (an extension of the tables of paraCombination-r16, paraCombination-r17) are proposed in order to provide good performance-and-overhead trade-off for mTRP C-JT operations.

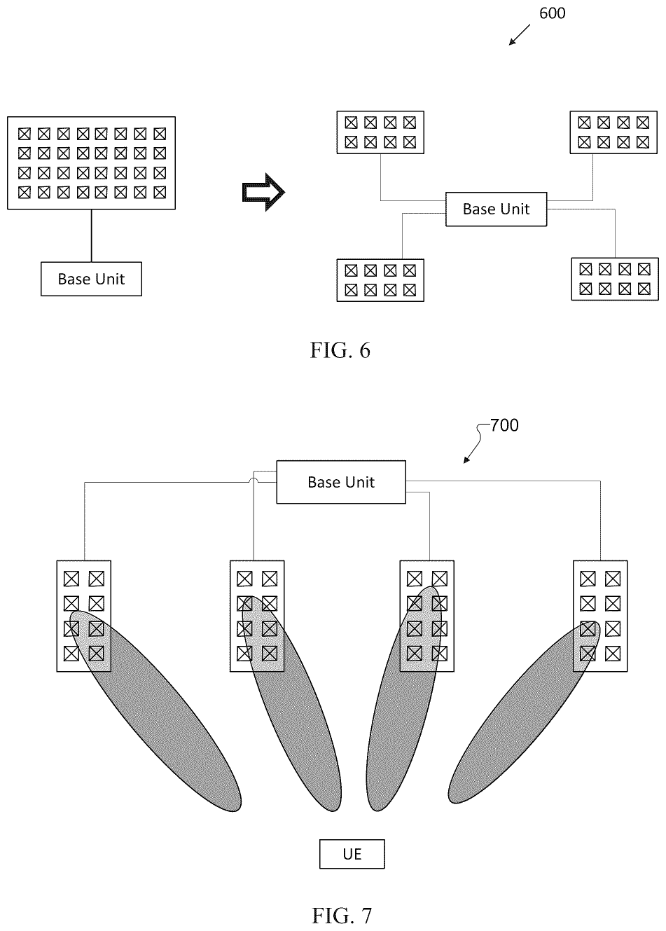

FIG. 6 illustrates an example of a distributed MIMO 600 according to various embodiments of the present disclosure. For example, the distributed MIMO 600 forms multiple antenna panels, such as antenna modules or RRHs, with a small number of antenna ports instead of integrating each of the antenna ports in a single panel or at a single site and distributing the multiple panels in multiple locations/sites or RRHs. For example, the distributed MIMO 600 may be implemented by one or more BSs such as BS 102. This example is for illustration only and other embodiments can be used without departing from the scope of the present disclosure.

At lower frequency bands such as <1 GHz, on the other hand, the number of antenna elements may not be large in a given form factor due to the large wavelength. As an example, for the case of the wavelength size (A) of the center frequency 600 MHz (which is 50 cm), it desires 4 m for uniform-linear-array (ULA) antenna panel of 16 antenna elements with the half-wavelength distance between two adjacent antenna elements. Regarding a plurality of antenna elements mapped to one digital port in practical cases, the desirable size for antenna panel(s) at gNB to support a large number of antenna ports such as 32 CSI-RS ports becomes very large in such low frequency bands, and it leads the difficulty of deploying 2-D antenna element arrays within the size of a common form factor. This results in a limited number of CSI-RS ports that can be supported at a single site and limits the spectral efficiency of such systems.

One possible approach to resolving the issue is to form multiple TRPs (multi-TRP) or RRHs with a small number of antenna ports instead of integrating each of the antenna ports in a single panel (or at a single site) and to distribute the multiple panels in multiple locations/sites (or TRPs, RRHs).

FIG. 7 illustrates another example of a distributed MIMO 700 according to various embodiments of the present disclosure. For example, the distributed MIMO 700 may be implemented by one or more BSs such as BS 102. This example is for illustration only and other embodiments can be used without departing from the scope of the present disclosure.

The multiple TRPs at multiple locations can still be connected to a single base unit, and thus the signal transmitted/received via multiple distributed TRPs can be processed in a centralized manner through the single base unit.

Note that although we have mentioned low frequency band systems (sub-1 GHz band) as a motivation for distributed MIMO (or mTRP), the distributed MIMO technology is frequency-band-agnostic and can be useful in mid- (sub-6 GHz) and high-band (above-6 GHz) systems in addition to low-band (sub-1 GHz) systems.

The terminology “distributed MIMO” is used as an illustrative purpose, it can be under other terminology such as multi-TRP, mTRP, cell-free network, and so on.

Each of the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, each of the following components and embodiments are applicable for UL transmission when the scheduling unit in time is either one subframe (which can include one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous physical resource blocks (PRBs) which represents the smallest frequency unit for CSI reporting. The number of PRBs in a subband can be fixed for a given value of DL system bandwidth, configured either semi-statically via higher-layer/RRC signaling, or dynamically via L1 DL control signaling or medium access control (MAC) control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include each of the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” or bandwidth part (BWP) can also be used.

In terms of UE configuration, a UE can be configured with at least one CSI reporting band. This configuration can be semi-static (via higher-layer signaling or RRC) or dynamic (via MAC CE or L1 DL control signaling). When configured with multiple (N) CSI reporting bands (e.g., via RRC signaling), a UE can report CSI associated with n≤N CSI reporting bands. For instance, >6 GHz, large system bandwidth may desire multiple CSI reporting bands. The value of n can either be configured semi-statically (via higher-layer signaling or RRC) or dynamically (via MAC CE or L1 DL control signaling). Alternatively, the UE 116 can report a recommended value of n via an UL channel.

Therefore, CSI parameter frequency granularity can be defined per CSI reporting band as follows. A CSI parameter is configured with “single” reporting for the CSI reporting band with Mₙ subbands when one CSI parameter for each of the Mₙ subbands within the CSI reporting band. A CSI parameter is configured with “subband” for the CSI reporting band with Mₙ subbands when one CSI parameter is reported for each of the Mₙ subbands within the CSI reporting band.

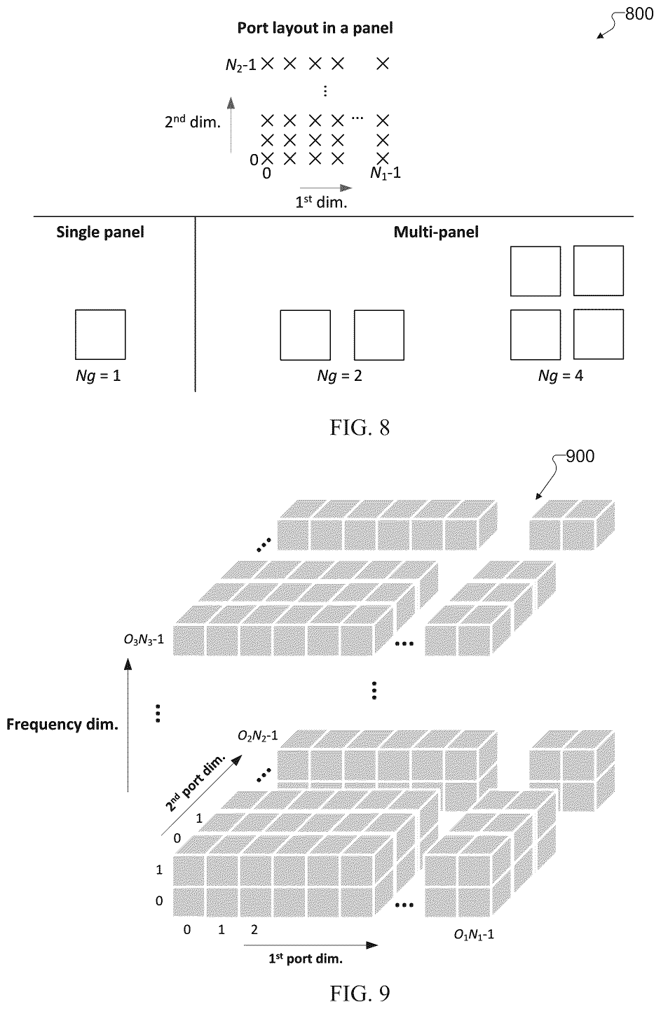

FIG. 8 illustrates an example of an antenna port layout 800 according to embodiments of the present disclosure. For example, antenna port layout 800 can be implemented by the BS 102 of FIG. 1. This example is for illustration only and other embodiments can be used without departing from the scope of the present disclosure.

Herein, we assume that N₁ and N₂ are the number of antenna ports with the same polarization in the first and second dimensions, respectively. For 2D antenna port layouts, we have N₁>1, N₂>1, and for 1D antenna port layouts N₁>1 and N₂=1. So, for a dual-polarized antenna port layout, the total number of antenna ports is 2N₁N₂ when each antenna maps to an antenna port. “X” represents two antenna polarizations. In the present disclosure, the term “polarization” refers to a group of antenna ports. For example, antenna ports

$$j = X + 0 , X + 1 , ... , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , ... , X + {P}_{CSIRS} - 1$$

comprise a second antenna polarization, where P_{CSIRS} is a number of CSI-RS antenna ports and X is a starting antenna port number (e.g., X=3000, then antenna ports are 3000, 3001, 3002, . . . ). Let N_{g} be a number of antenna panels at the gNB 102. When there are multiple antenna panels (N_{g}>1), we assume that each panel is dual-polarized antenna ports with N₁ and N₂ ports in two dimensions. Note that the antenna port layouts may or may not be the same in different antenna panels.

In one example, the antenna architecture of a distributed MIMO (D-MIMO) or CJT (coherent joint-transmission) system is structured. For example, the antenna structure at each RRH (or TRP) is dual-polarized (single or multi-panel as shown in FIG. 8). The antenna structure at each RRH/TRP can be the same. Or the antenna structure at an RRH/TRP can be different from another RRH/TRP. Likewise, the number of ports at each RRH/TRP can be the same. Or the number of ports at one RRH/TRP can be different from another RRH/TRP. In one example, N_{g}=N_{RRH}, a number of RRHs/TRPs in the D-MIMO transmission.

In another example, the antenna architecture of a D-MIMO or CJT system is unstructured. For example, the antenna structure at one RRH/TRP can be different from another RRH/TRP.

We assume a structured antenna architecture in the rest of the present disclosure. For simplicity, we assume each RRH/TRP is equivalent to a panel (cf. FIG. 8), although, an RRH/TRP can have multiple panels in practice. However, the present disclosure is not restrictive to a single panel assumption at each RRH/TRP and can easily be extended (covers) the case when an RRH/TRP has multiple antenna panels.

In one embodiment, an RRH constitutes (or corresponds to or is equivalent to or is associated with) at least one of the following.

In one example, an RRH corresponds to a TRP.

In one example, an RRH or TRP corresponds to a CSI-RS resource. A UE is configured with K=N_{RRH}=(N_{TRP})>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained earlier in the present disclosure.

In one example, an RRH or TRP corresponds to a CSI-RS resource group, where a group comprises one or multiple NZP CSI-RS resources. A UE is configured with K≥N_{RRH}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained herein in the present disclosure. In particular, the K CSI-RS resources can be partitioned into N_{RRH} resource groups. The information about the resource grouping can be provided together with the CSI-RS resource setting/configuration, with the CSI reporting setting/configuration, or with the CSI-RS resource configuration.

In one example, an RRH or TRP corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an RRH/TRP. The information about the subsets of ports or grouping of ports can be provided together with the CSI-RS resource setting/configuration, or with the CSI reporting setting/configuration, or with the CSI-RS resource configuration.

In one example, an RRH or TRP corresponds to one or more examples described herein depending on a configuration. For example, this configuration can be explicit via a parameter (e.g., an RRC parameter). Or it can be implicit.

In one example, when implicit, it could be based on the value of K. For example, when K>1 CSI-RS resources, an RRH corresponds to one or more examples described herein, and when K=1 CSI-RS resource, an RRH corresponds to one or more examples described herein.

In another example, the configuration could be based on the configured codebook. For example, an RRH corresponds to a CSI-RS resource or resource group when the codebook corresponds to a decoupled codebook (modular or separate codebook for each RRH), and an RRH corresponds to a subset (or a group) of CSI-RS ports when codebook corresponds to a coupled (joint or coherent) codebook (one joint codebook across TRPs/RRHs).

In one example, when RRH or TRP maps (or corresponds to) a CSI-RS resource or resource group, and a UE can select a subset of TRPs/RRHs (resources or resource groups) and report the CSI for the selected TRPs/RRHs (resources or resource groups), the selected TRPs/RRHs can be reported via an indicator. For example, the indicator can be a CRI or a PMI (component) or a new indicator.

In one example, when RRH or TRP maps (or corresponds to) a CSI-RS port group, and a UE can select a subset of TRPs/RRHs (port groups) and report the CSI for the selected TRPs/RRHs (port groups), the selected TRPs/RRHs can be reported via an indicator. For example, the indicator can be a CRI or a PMI (component) or a new indicator.

In one example, when multiple (K>1) CSI-RS resources are configured for N_{RRH} TRPs/RRHs, a decoupled (modular) codebook is used/configured, and when a single (K=1) CSI-RS resource for N_{RRH} TRPs/RRHs, a joint codebook is used/configured.

FIG. 9 illustrates a diagram of an example 3D grid of direct fourier transform (DFT) beams 900 according to embodiments of the present disclosure. For example, DFT beams 900 may be implemented by the BS 102 of FIG. 1. This example is for illustration only and other embodiments can be used without departing from the scope of the present disclosure.

As described in U.S. Pat. No. 10,659,118 issued May 19, 2020, and entitled “Method and Apparatus for Explicit CSI Reporting in Advanced Wireless Communication Systems,” which is incorporated herein by reference in its entirety, a UE is configured with high-resolution (e.g., Type II) CSI reporting in which the linear combination based Type II CSI reporting framework is extended to include frequency dimension in addition to the 1st and 2nd antenna port dimensions. With reference to FIG. 9, the 3D grid of the oversampled DFT beams (1st port dim., 2nd port dim., freq. dim.) shows 1st dimension is associated with the 1st port dimension, 2nd dimension is associated with the 2nd port dimension, and 3rd dimension is associated with the frequency dimension.

The basis sets for 1^{st} and 2^{nd} port domain representation are oversampled DFT codebooks of length-N₁ and length-N₂, respectively, and with oversampling factors O₁ and O₂, respectively. Likewise, the basis set for frequency domain representation (i.e., 3rd dimension) is an oversampled DFT codebook of length-N₃ and with oversampling factor O₃. In one example, O₁=O₂=O₃=4. In one example, O₁=O₂=4 and O₃=1. In another example, the oversampling factors Oᵢ belongs to {2, 4, 8}. In yet another example, at least one of O₁, O₂, and O₃ is higher layer configured (via RRC signaling)

As explained in Section 5.2.2.2.6 of REF8, a UE is configured with higher layer parameter codebookType set to ‘typeII-PortSelection-r16’ for an enhanced Type II CSI reporting in which the pre-coders for each of the subbands (SBs) and for a given layer l=1, . . . , ν, where ν is the associated rank indicator (RI) value, is given by either

$${W}^{l} = {AC}_{l} {B}^{H} = {[ {a}_{0} {a}_{1} ... {a}_{L - 1} ] [ \begin{matrix}{c}_{l , 0 , 0} & {c}_{l , 0 , 1} & … & {c}_{l , 0 , M - 1} \\ {c}_{l , 1 , 0} & {c}_{l , 1 , 1} & … & {c}_{l , 1 , M - 1} \\ ⋮ & ⋮ & ⋮ & ⋮ \\ {c}_{l , L - 1 , 0} & {c}_{l , L - 1 , 1} & … & {c}_{l , L - 1 , M - 1}\end{matrix} ] [ {b}_{0} {b}_{1} ... {b}_{M - 1} ]}^{H} = {\sum }_{f = 0}^{M - 1} {\sum }_{i = 0}^{L - 1} {c}_{l , i , f} ( {a}_{i} {b}_{f}^{H} ) = {\sum }_{i = 0}^{L - 1} {\sum }_{f = 0}^{M - 1} {c}_{l , i , f} ( {a}_{i} {b}_{f}^{H} ) , \qquad ( Eq . 1 )$$

$$or$$

$${W}^{l} = [ \begin{matrix}A & 0 \\ 0 & A\end{matrix} ] {C}_{l} {B}^{H} = {[ \begin{matrix}{a}_{0} {a}_{1} ... {a}_{L - 1} & 0 \\ 0 & {a}_{0} {a}_{1} ... {a}_{L - 1}\end{matrix} ] [ \begin{matrix}{c}_{l , 0 , 0} & {c}_{l , 0 , 1} & … & {c}_{l , 0 , M - 1} \\ {c}_{l , 1 , 0} & {c}_{l , 1 , 1} & … & {c}_{l , 1 , M - 1} \\ ⋮ & ⋮ & ⋮ & ⋮ \\ {c}_{l , L - 1 , 0} & {c}_{l , L - 1 , 1} & … & {c}_{l , L - 1 , M - 1}\end{matrix} ] [ {b}_{0} {b}_{1} ... {b}_{M - 1} ]}^{H} = [ \text{} \begin{matrix}{\sum }_{f = 0}^{M - 1} {\sum }_{i = 0}^{L - 1} {c}_{l , i , f} ( {a}_{i} {b}_{f}^{H} ) \\ {\sum }_{f = 0}^{M - 1} {\sum }_{i = 0}^{L - 1} {c}_{l , i + L , f} ( {a}_{i} {b}_{f}^{H} )\end{matrix} ] , \qquad ( Eq . 2 )$$

where
N₁ is a number of antenna ports in a first antenna port dimension (having the same antenna polarization).
N₂ is a number of antenna ports in a second antenna port dimension (having the same antenna polarization).
P_{CSI-RS} is a number of CSI-RS ports configured to the UE 116.
N₃ is a number of SBs for PMI reporting or number of FD units or number of FD components (that comprise the CSI reporting band) or a total number of precoding matrices indicated by the PMI (one for each FD unit/component).
aᵢ is a 2N₁N₂×1 (Eq. 1) or N₁N₂×1 (Eq. 2) column vector, or aᵢ is a

$${P}_{CSIRS} \times 1 or \frac{{P}_{CSIRS}}{2} \times 1 \qquad ( Eq . 1 )$$

port selection column vector, where a port selection vector is a defined as a vector which contains a value of 1 in one element and zeros elsewhere.
b_{f} is a N₃×1 column vector.
c_{l,i,f} is a complex coefficient.

In a variation, when the UE 116 reports a subset K<2LM coefficients (where K is either fixed, configured by the gNB 102 or reported by the UE 116), then the coefficient c_{l,i,f} in precoder equations Eq. 1 or Eq. 2 is replaced with x_{l,i,f}×c_{l,i,f}, where
x_{l,i,f}=1 if the coefficient c_{l,i,f} is reported by the UE 116 according to some embodiments of the present disclosure.
x_{l,i,f}=0 otherwise (i.e., c_{l,i,f} is not reported by the UE 116).

The indication whether x_{l,i,f}=1 or 0 is according to some embodiments of the present disclosure. For example, it can be via a bitmap.

In a variation, the precoder equations Eq. 1 or Eq. 2 are respectively generalized to

$${W}^{l} = {\sum }_{i = 0}^{L - 1} {\sum }_{f = 0}^{{M}_{i} - 1} {c}_{l , i , f} ( {a}_{i} {b}_{i , f}^{H} ) \qquad ( Eq . 3 )$$

$$and$$

$${W}^{l} = [ \begin{matrix}{\sum }_{i = 0}^{L - 1} {\sum }_{f = 0}^{{M}_{i} - 1} {c}_{l , i , f} ( {a}_{i} {b}_{i , f}^{H} ) \\ {\sum }_{i = 0}^{L - 1} {\sum }_{f = 0}^{{M}_{i} - 1} {c}_{l , i + L , f} ( {a}_{i} {b}_{i , f}^{H} )\end{matrix} ] , \qquad ( Eq . 4 )$$

where for a given i, the number of basis vectors is Mᵢ and the corresponding basis vectors are {b_{i,f}}. Note that Mᵢ is the number of coefficients c_{l,i,f} reported by the UE 116 for a given i, where Mᵢ≤M (where {Mᵢ} or ΣMᵢ is either fixed, configured by the gNB 102 or reported by the UE 116).

The columns of W^{l} are normalized to norm one. For rank R or R layers (υ=R), the pre-coding matrix is given by

$${W}^{( R )} = \frac{1}{\sqrt{R}} [ \begin{matrix}{W}^{1} & {W}^{2} & … & {W}^{R} & ] .\end{matrix}$$

Eq. 2 is assumed in the rest of the present disclosure. However, the embodiments of the present disclosure are general and are also applicable to Eq. 1, Eq. 3, and Eq. 4.

Here

$$L \leq \frac{{P}_{CSI - RS}}{2} and M \leq {N}_{3} .$$

### If

$$L = \frac{{P}_{CSI - RS}}{2} ,$$

then A is an identity matrix, and hence not reported. Likewise, if M=N₃, then B is an identity matrix, and hence not reported. Assuming M<N₃, in an example, to report columns of B, the oversampled DFT codebook is used. For instance, b_{f}=w_{f}, where the quantity w_{f} is given by

$${w}_{f} = {[ \begin{matrix}1 & {e}^{j \frac{2 π {n}_{3 , l}^{( f )}}{{O}_{3} {N}_{3}}} & {e}^{j \frac{2 π \text{.2} {n}_{3 , l}^{( f )}}{{O}_{3} {N}_{3}}} & … & {e}^{j \frac{2 π . ( {N}_{3} - 1 ) {n}_{3 , l}^{( f )}}{{O}_{3} {N}_{3}}}\end{matrix} ]}^{T} .$$

When O₃=1, the FD basis vector for layer l∈{1, . . . , υ} (where υ is the RI or rank value) is given by

w_{f}=[y_{0,l}^{(f)}y_{1,l}^{(f)} . . . y_{N}_{₃}_{-1,l}^{(f)}]^{T},

where

$${y}_{t , l}^{( f )} = {e}^{j \frac{2 π {tn}_{3 , l}^{( f )}}{{N}_{3}}}$$

and n_{3,l}=[n_{3,l}⁽⁰⁾, . . . , n_{3,l}^{(M-1)}] where n_{3,l}^{(f)}∈{0, 1, . . . , N₃−1}.

In another example, discrete cosine transform (DCT) basis is used to construct/report basis B for the 3^{rd} dimension. The m-th column of the DCT compression matrix is simply given by

$${[ {W}_{f} ]}_{n m} = \{ \begin{matrix}\frac{1}{\sqrt{K}} , n = 0 \\ \sqrt{\frac{2}{K}} cos \frac{π ( 2 m + 1 ) n}{2 K} , n = 1 , … K - 1\end{matrix} ,$$

and K=N₃, and m=0, . . . , N₃−1.

Since DCT is applied to real valued coefficients, the DCT is applied to the real and imaginary components (of the channel or channel eigenvectors) separately. Alternatively, the DCT is applied to the magnitude and phase components (of the channel or channel eigenvectors) separately. The use of DFT or DCT basis is for illustration purpose only. The present disclosure is applicable to any other basis vectors to construct/report A and B.

On a high level, a precoder W^{l} can be described as follows.

W=AₗCₗBₗ^{H}=W₁\tilde{W}₂W_{f}^{H}, (5)

where A=W₁ corresponds to the Rel. 15 W₁ in Type II CSI codebook [REF8], and B=W_{f}.

The C₁=\tilde{W}₂ matrix includes each of the necessary linear combination coefficients (e.g., amplitude and phase or real or imaginary). Each reported coefficient (c_{l,i,f}=p_{l,i,f}ϕ_{l,i,f}) in \tilde{W}₂ is quantized as amplitude coefficient (p_{l,i,f}) and phase coefficient (ϕ_{l,i,f}). In one example, the amplitude coefficient (p_{l,i,f}) is reported using a A-bit amplitude codebook where A belongs to {2, 3, 4}. If multiple values for A are supported, then one value is configured via higher layer signaling. In another example, the amplitude coefficient (p_{l,i,f}) is reported as p_{l,i,f}=p_{l,i,f}⁽¹⁾p_{l,i,f}⁽²⁾ where p_{l,i,f}⁽¹⁾ is a reference or first amplitude which is reported using a A1-bit amplitude codebook where A1 belongs to {2, 3, 4}, and p_{l,i,f}⁽²⁾ is a differential or second amplitude which is reported using a A2-bit amplitude codebook where A2≤A1 belongs to {2, 3, 4}.

For layer l, let us denote the linear combination (LC) coefficient associated with spatial domain (SD) basis vector (or beam) i∈{0, 1, . . . , 2L−1} and frequency domain (FD) basis vector (or beam) f∈{0, 1, . . . , M−1} as c_{l,i,f}, and the strongest coefficient as c_{l,i*,f*}. The strongest coefficient is reported out of the K_{NZ} non-zero (NZ) coefficients that is reported using a bitmap, where K_{NZ}≤K₀=┌β×2LM┐<2LM and β is higher layer configured. The remaining 2LM−K_{NZ} coefficients that are not reported by the UE 116 are assumed to be zero. The following quantization scheme is used to quantize/report the K_{NZ} NZ coefficients.

UE reports the following for the quantization of the NZ coefficients in \tilde{W}₂.
A X-bit indicator for the strongest coefficient index (i*, f*), where X=┌log₂ K_{NZ}┐ or ┌log₂ 2L┐.
   Strongest coefficient c_{l,i*,f*}=1 (hence its amplitude/phase are not reported).
Two antenna polarization-specific reference amplitudes are used.
   For the polarization associated with the strongest coefficient c_{l,i*,f*}=1, since the reference amplitude p_{l,i,f}⁽¹⁾=1, it is not reported.
   For the other polarization, reference amplitude p_{l,i,f}⁽¹⁾ is quantized to 4 bits.
      1. The 4-bit amplitude alphabet is

$$\{ 1 , {( \frac{1}{2} )}^{\frac{1}{4}} , {( \frac{1}{4} )}^{\frac{1}{4}} , {( \frac{1}{8} )}^{\frac{1}{4}} , … , {( \frac{1}{{2}^{14}} )}^{\frac{1}{4}} \} .$$

For {c_{l,i,f}, (i, f)≠(i*, f*)}:
   For each polarization, differential amplitudes p_{l,i,f}⁽²⁾ of the coefficients calculated relative to the associated polarization-specific reference amplitude and quantized to 3 bits.
      1. The 3-bit amplitude alphabet is

$$\{ 1 , \frac{1}{\sqrt{2}} , \frac{1}{2} , \frac{1}{2 \sqrt{2}} , \frac{1}{4} , \frac{1}{4 \sqrt{2}} , \frac{1}{8} , \frac{1}{8 \sqrt{2}} \} .$$

2. Note: The final quantized amplitude p_{l,i,f} is given by p_{l,i,f}⁽¹⁾×p_{l,i,f}⁽²⁾.
Each phase is quantized to either 8PSK (Nₚₕ=8) or 16PSK (Nₚₕ=16) (which is configurable).

For the polarization r*∈{0,1} associated with the strongest coefficient c_{l,i*,f*}, we have

$${r}^{*} = ⌊ \frac{{i}^{*}}{L} ⌋$$

and the reference amplitude p_{l,i,f}⁽¹⁾=p_{l,r*}⁽¹⁾=1. For the other polarization r∈{0,1} and r≠r*, we have

$$r = ( ⌊ \frac{{i}^{*}}{L} ⌋ + 1 )$$

mod 2 and the reference amplitude p_{l,i,f}⁽¹⁾=p_{l,r}⁽¹⁾ is quantized (reported) using the 4-bit amplitude codebook mentioned herein.

In Rel. 16 enhanced Type II and Type II port selection codebooks, a UE can be configured to report M FD basis vectors. In one example,

$$M = ⌈ p \times \frac{{N}_{3}}{R} ⌉ ,$$

where R is higher-layer configured from {1,2} and p is higher-layer configured from {¼,½}. In one example, the p value is higher-layer configured for rank 1-2 CSI reporting. For rank >2 (e.g., rank 3-4), the p value (denoted by v₀) can be different. In one example, for rank 1-4, (p, v₀) is jointly configured from {(½,¼), (¼,¼), (¼,⅛)}, i.e.

$$M = ⌈ p \times \frac{{N}_{3}}{R} ⌉$$

for rank 1-2 and

$$M = ⌈ {v}_{0} \times \frac{{N}_{3}}{R} ⌉$$

for rank 3-4. In one example, N₃=N_{SB}×R where N_{SB} is the number of SBs for channel quality information (CQI) reporting. In one example, M is replaced with M_{υ} to show its dependence on the rank value υ, hence p is replaced with p_{υ}, υ∈{1,2} and v₀ is replaced with p_{υ}, υ∈{3,4}.

A UE can be configured to report M_{υ} FD basis vectors in one-step from N₃ basis vectors freely (independently) for each layer l∈{1, . . . , υ} of a rank υ CSI reporting. Alternatively, a UE can be configured to report M_{υ} FD basis vectors in two-step as follows.
In step 1, an intermediate set (InS) comprising N₃′<N₃ basis vectors are selected/reported, wherein the InS is common for each of the layers.
In step 2, for each layer l∈{1, . . . , υ} of a rank υ CSI reporting, M_{υ} FD basis vectors are selected/reported freely (independently) from N₃′ basis vectors in the InS.

In one example, one-step method is used when N₃≤19 and two-step method is used when N₃>19. In one example, N₃′=┌αM_{υ}┐ where α>1 is either fixed (to 2 for example) or configurable.

The codebook parameters used in the DFT based frequency domain compression (eq. 5) are (L, p_{υ} for υ∈{1,2}, p_{υ} for υ∈{3,4}, β, α, Nₚₕ). The set of values for these codebook parameters are as follows.
L: the set of values is {2,4} in general, except L∈{2,4,6} for rank 1-2, 32 CSI-RS antenna ports, and R=1.
(p_{υ} for υ∈{1,2}, p_{υ} for υ∈{3,4})∈{(½,¼), (¼,¼), (¼,⅛)}.
β∈{¼,½,¾}.
α=2.
Nₚₕ=16.

The set of values for these codebook parameters are as in Table 1.

TABLE 1

p_{υ}

| | | υ | υ | |
|---|---|---|---|---|
| paramCombination-r16 | L | ∈ {1, 2} | ∈ {3, 4} | β |
| 1 | 2 | ½ | ⅛ | ¼ |
| 2 | 2 | ½ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |

In Rel. 17 (further enhanced Type II port selecting codebook), M∈{1,2},

$$L = \frac{{K}_{1}}{2}$$

where K₁=α×P_{CSIRS}, and codebook parameters (M, α, β) are configured from Table 2.

TABLE 2

| paramCombination-r17 | M | α | β |
|---|---|---|---|
| 1 | 1 | ¾ | ½ |
| 2 | 1 | 1 | ½ |
| 3 | 1 | 1 | ¾ |
| 4 | 1 | 1 | 1 |
| 5 | 2 | ½ | ½ |
| 6 | 2 | ¾ | ½ |
| 7 | 2 | 1 | ½ |
| 8 | 2 | 1 | ¾ |

The framework mentioned herein (equation 5) represents the precoding-matrices for multiple (N₃) FD units using a linear combination (double sum) over 2L (or K₁) SD beams/ports and M_{υ} FD beams. This framework can also be used to represent the precoding-matrices in time domain (TD) by replacing the FD basis matrix W_{f} with a TD basis matrix Wₜ, wherein the columns of Wₜ comprises M_{υ} TD beams that represent some form of delays or channel tap locations. Hence, a precoder W^{l} can be described as follows.

W=AₗCₗBₗ^{H}=W₁\tilde{W}₂Wₜ^{H}, (5A)

In one example, the M_{υ} TD beams (representing delays or channel tap locations) are selected from a set of N₃ TD beams, i.e., N₃ corresponds to the maximum number of TD units, where each TD unit corresponds to a delay or channel tap location. In one example, a TD beam corresponds to a single delay or channel tap location. In another example, a TD beam corresponds to multiple delays or channel tap locations. In another example, a TD beam corresponds to a combination of multiple delays or channel tap locations.

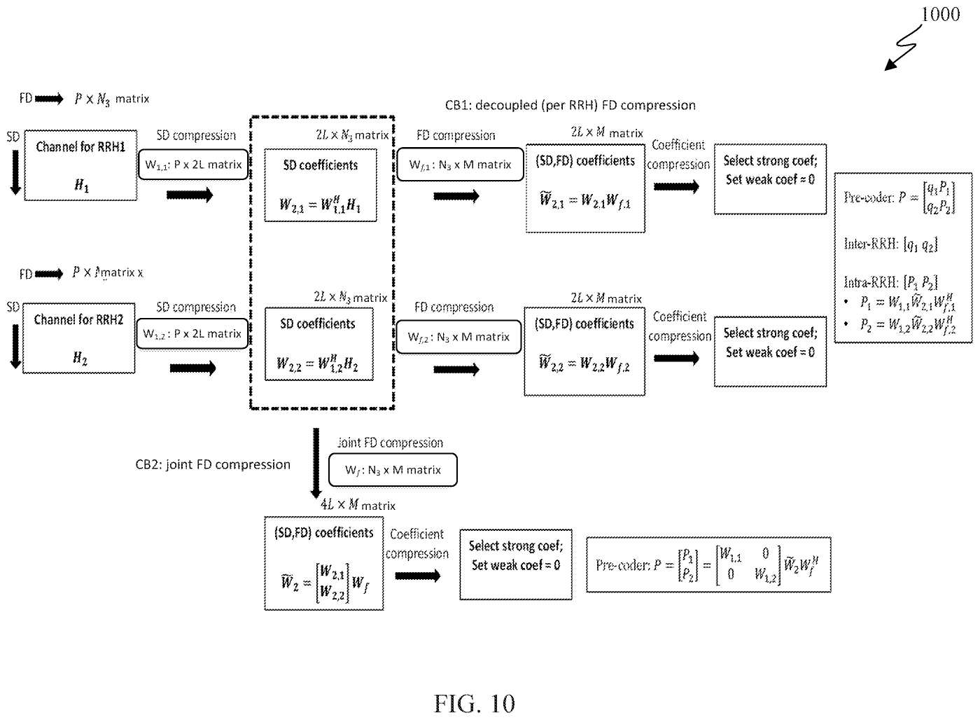

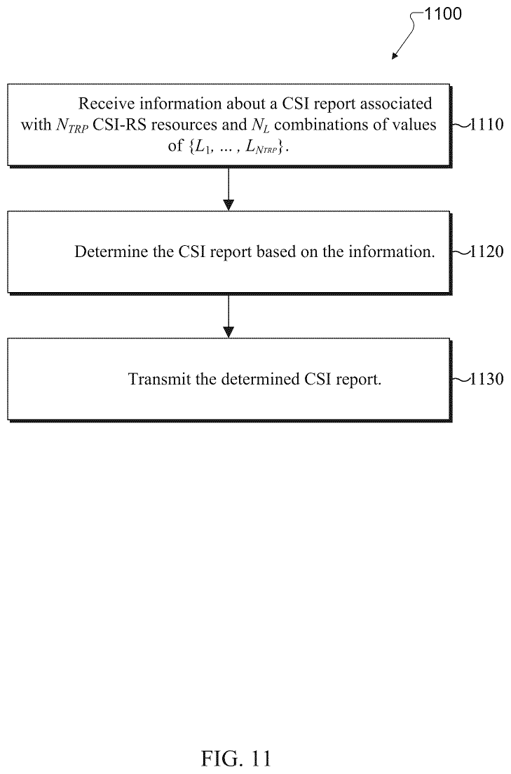

FIG. 10 illustrates an example of new codebooks 1000 according to embodiments of the present disclosure. For example, new codebooks 1000 can be implemented by the BS 102 of FIG. 1. This example is for illustration only and other embodiments can be used without departing from the scope of the present disclosure.

In one example, the codebook for the CSI report is according to at least one of the following examples.
In one example, the codebook can be a Rel. 15 Type I single-panel codebook (cf. 5.2.2.2.1, document and standard [9]).
In one example, the codebook can be a Rel. 15 Type I multi-panel codebook (cf. 5.2.2.2.2, document and standard [9]).
In one example, the codebook can be a Rel. 15 Type II codebook (cf. 5.2.2.2.3, document and standard [9]).
In one example, the codebook can be a Rel. 15 port selection Type II codebook (cf. 5.2.2.2.4, document and standard [9]).
In one example, the codebook can be a Rel. 16 enhanced Type II codebook (cf. 5.2.2.2.5, document and standard [9]).
In one example, the codebook can be a Rel. 16 enhanced port selection Type II codebook (cf. 5.2.2.2.6, document and standard [9]).
In one example, the codebook can be a Rel. 17 further enhanced port selection Type II codebook (cf. 5.2.2.2.7, document and standard [9]).
In one example, the codebook is a new codebook for C-JT CSI reporting.
   In one example, the new codebook is a decoupled codebook comprising the following components: (called ‘CB1’ hereafter)
      Intra-TRP: per TRP Rel. 16/17 Type II codebook components, i.e., SD basis vectors (W1), FD basis vectors (W_{f}), W2 components (e.g., SCI, indices of NZ coefficients, and amplitude/phase of NZ coefficients).
      Inter-TRP: co-amplitude and co-phase for each TRP.
   In one example, the new codebook is a joint codebook (called ‘CB2’ hereafter) comprising following components:
      Per TRP SD basis vectors (W1).
      Single joint FD basis vectors (Wf).
      Single joint W2 components (e.g., SCI, indices of NZ coefficients, and amplitude/phase of NZ coefficients).

In one example, when the codebook is a legacy codebook (e.g., one of Rel. 15/16/17 NR codebooks, according to one of the examples herein), then the CSI reporting is based on a CSI resource set comprising one or multiple NZP CSI-RS resource(s), where each NZP CSI-RS resource comprises CSI-RS antenna ports for each of the TRPs/RRHs, i.e., P=Σᵣ₌₁^{N} Pᵣ, where P is the total number of antenna ports, and Pᵣ is the number of antenna ports associated with r-th TRP. In this case, a TRP corresponds to (or maps to or is associated with) a group of antenna ports.

In one example, when the codebook is a new codebook (e.g., one of the two new codebooks herein), then the CSI reporting is based on a CSI resource set comprising one or multiple NZP CSI-RS resource(s).
In one example, each NZP CSI-RS resource comprises CSI-RS antenna ports for each of the TRPs/RRHs. i.e., P=Σᵣ₌₁^{N} Pᵣ, where P is the total number of antenna ports, and Pᵣ is the number of antenna ports associated with r-th TRP. In this case, a TRP corresponds to (or maps to or is associated with) a group of antenna ports.
In one example, each NZP CSI-RS resource corresponds to (or maps to or is associated with) a TRP/RRH.

In another embodiment, a UE is configured with an mTRP (or D-MIMO or C-JT) codebook, via e.g., higher layer parameter codebookType set to ‘typeII-r18-cjt’, which is designed based on Rel-16/17 Type-II codebook. For example, The mTRP codebook has a triple-stage structure which can be represented as W=W₁W₂W_{f}^{H}, where the component W₁ is used to report/indicate a spatial-domain (SD) basis matrix comprising SD basis vectors, the component W_{f} is used to report/indicate a frequency-domain (FD) basis matrix comprising FD basis vectors, and the component W₂ is used to report/indicate coefficients corresponding to SD and FD basis vectors.

In one example, in Rel-16 Type-II codebook, L vectors, vₘ_{₁}_{⁽ⁱ⁾}_{,m}_{₂}_{⁽ⁱ⁾}, i=0, 1, . . . , L−1, are identified by the indices q₁, q₂, n₁, n₂, indicated by i_{1,1}, i_{1,2}, obtained as in 5.2.2.2.3, where the values of C(x, y) are given in Table 5.2.2.2.5-4 of [9].

In Rel-18 Type-II codebook for multi-TRP, Lₙ SD basis vectors for each TRP n can be selected/reported, where we denote that Lₙ is a number of SD basis vectors for TRP n (CSI-RS resource n).

In one embodiment, on the SD basis selection for (Rel-18) Type-II codebook refinement for CJT mTRP, each of the {Lₙ, n=1, . . . , N_{TRP}} is configured by the NW 130 via higher-layer (RRC) signaling, where N_{TRP} is a number of TRPs configured by the NW 130.

In one example, Lₙ∈{2,4,6}. In one example, Lₙ∈{1,2,4,6}. In one example, Lₙ∈{1,2,3,4,5,6}. In one example, In one example, Lₙ∈{1,2,3,4}. In one example, Lₙ∈{1,2,3}. In one example, Lₙ∈{1,2,4}. In one example, Lₙ can be selected from [symbol] ₙ, where [symbol] ₙ is a subset of {1,2,3,4,5,6}.

In one embodiment, on the SD basis selection for (Rel-18) Type-II codebook refinement for CJT mTRP, Lₘₐₓ≥Σₙ₌₁^{N}^{_{TRP}} Lₙ is configured by the NW 130 via higher-layer (RRC) signaling and the relative value(s) of {Lₙ, n=1, . . . , N_{TRP}} are reported by the UE 116, where N_{TRP} is a number of TRPs configured by the NW 130. Although we denote Lₘₐₓ for an upper bound of Σₙ₌₁^{N}^{_{TRP}} Lₙ, another notation can be used for Lₘₐₓ, such as Lₛᵤₘ, L′, L̅, etc. In one example, N_{TRP}∈{1,2,3,4}.

In one example, Lₘₐₓ∈{2N_{TRP}, 4N_{TRP}, 6N_{TRP}}. In one example, Lₘₐₓ∈{1N_{TRP}, 2N_{TRP}, 4N_{TRP}, 6N_{TRP}}. In one example, Lₘₐₓ∈{1N_{TRP}, 2N_{TRP}, 3N_{TRP}, 4N_{TRP}, 5N_{TRP}, 6N_{TRP}}. In one example, In one example, Lₘₐₓ∈{1N_{TRP}, 2N_{TRP}, 3N_{TRP}, 4N_{TRP}}. In one example, Lₘₐₓ∈{1N_{TRP}, 2N_{TRP}, 3N_{TRP}}.

In one example, Lₘₐₓ∈{1N_{TRP}, 2N_{TRP}, 4N_{TRP}}. In one example, Lₘₐₓ can be selected from [symbol] ₘₐₓ, where [symbol] ₘₐₓ is a subset of {1, . . . , 24}.

In one example, Lₘₐₓ∈ [symbol] _{max,1} for N_{TRP}≥x and Lₘₐₓ ∈ [symbol] _{max,2} for N_{TRP}<x, where [symbol] _{max,1} and [symbol] _{max,2} is a subset of {1, . . . , 24} and x=1, 2, 3, or 4.

In one example, Lₘₐₓ ∈ [symbol] _{max,1} for N_{TRP}>x and Lₘₐₓ ∈ [symbol] _{max,2} for N_{TRP}≤x, where [symbol] _{max,1} and [symbol] _{max,2} is a subset of {1, . . . , 24} and x=1,2,3, or 4.

In another example, {Lₙ, n=1, . . . , N_{TRP}} are explicitly reported via a joint indicator or separate multiple indicators in CSI part 1. For example, a joint indicator can be used to indicate (L₁, . . . , L_{N}_{_{TRP}}) under the constraint of Lₘₐₓ≥Σₙ₌₁^{N}^{_{TRP}} Lₙ and Lₙ≥0, for n=1, . . . , N_{TRP} where Lₙ is a non-negative integer. In another example, an indicator can be used to indicate each Lₙ for n=1, . . . , N_{TRP} under the constraint of Lₘₐₓ≥Σₙ₌₁^{N}^{_{TRP}} Lₙ and Lₙ≥0. In one example, each Lₙ is selected from a set [symbol] and indicated via ┌log₂ | [symbol] |┐-bit indicator. So, in this case, N_{TRP} ┌log₂ | [symbol] |┐-bit indicators can be used. In one example, [symbol] ∈{2,4}. In one example, [symbol] ∈{2,4,6}. In one example, [symbol] ∈{1,2,3,4}. In one example, [symbol] ∈{1,2,3,4,5,6}. In one example, [symbol] ∈{1,2,4}. In one example, [symbol] ∈{1,2,3}. In one example, [symbol] is a subset of {1,2,3,4,5,6}.

In another example, Lₙ SD basis vector selection for each TRP n is reported via a joint indicator or separate multiple indicators in CSI part 2.
In one example, an indicator to indicate (each) Lₙ SD basis vectors has the payload of

$$⌈ {log}_{2} ( \begin{matrix}{N}_{1} {N}_{2} \\ {L}_{n}\end{matrix} ) ⌉$$

bits (bit-width), where N₁ and N₂ are the values of (N₁, N₂) configured via higher-layer (RRC) signaling by the NW 130. For any TRP n where Lₙ=0 (i.e., no SD beam selection case) and/or where TRP n is not selected which can be indicated via N_{TRP}-bit bitmap in CSI part 1, no SD basis vector for TRP n is reported, hence no payload is induced.
In one example, a joint indicator to indicate {Lₙ} SD basis vectors has the payload of

$$⌈ {log}_{2} {\sum }_{n = 1}^{{N}_{TRP}} ( \begin{matrix}{N}_{1} {N}_{2} \\ {L}_{n}\end{matrix} ) ⌉$$

bits (bit-width). For any TRP n where Lₙ=0 (i.e., no SD beam selection case) and/or where TRP n is not selected which can be indicated via N_{TRP}-bit bitmap in CSI part 1, no SD basis vector for TRP n is reported, hence no additional payload is induced in the sum.

In another example, Lₙs associated with TRPs that are selected are explicitly reported via a joint indicator or separate multiple indicators in CSI part 1. In CSI part 1, N_{TRP}-bit bitmap is used to indicate selected N TRPs out of N_{TRP} TRPs. For example, when N_{TRP}=4 and N_{TRP}-bit bitmap is ‘1001’ in CSI part 1, the first TRP and the fourth TRP are selected. In this example, Lₙ associated with the selected TRPs are explicitly reported.
In one example, a joint indicator can be used to indicate {Lₙ}_{n∈S} under the constraint of Lₘₐₓ≥Σ_{n∈S} Lₙ and Lₙ≥1, for n∈S where Lₙ is a positive integer and S is a set of selected TRP indexes (i.e., a subset of {1, 2, . . . , N_{TRP}}.
In one example, a joint indicator can be used to indicate {Lₙ}ₙ₌₁^{N} under the constraint of Lₘₐₓ≥Eₙ₌₁^{N} Lₙ and Lₙ≥1, for n=1, . . . , N where Lₙ is a positive integer.
In one example, an indicator can be used to indicate each Lₙ for n∈S under the constraint of Lₘₐₓ≥Σ_{n∈S} Lₙ and Lₙ≥1 where Lₙ is a positive integer and S is a set of selected TRP indexes (i.e., a subset of {1, 2, . . . , N_{TRP}}. In one example, each Lₙ is selected from a set [symbol] and indicated via ┌log₂ | [symbol] |┐-bit indicator. So, in this case, N ┌log₂ | [symbol] |┐-bit indicators can be used. In one example, [symbol] ∈{2,4}. In one example, [symbol] ∈{2,4,6}. In one example, [symbol] ∈{1,2,3,4}. In one example, [symbol] ∈{1,2,3,4,5,6}. In one example, [symbol] ∈{1,2,4}. In one example, [symbol] ∈{1,2,3}. In one example, [symbol] is a subset of {1,2,3,4,5,6}.
In one example, an indicator can be used to indicate each Lₙ for n=1, . . . , N under the constraint of Lₘₐₓ≥Σₙ₌₁^{N} Lₙ and Lₙ≥1, for n=1, . . . , N where Lₙ is a positive integer. In one example, each Lₙ is selected from a set [symbol] and indicated via ┌log₂ | [symbol] |┐-bit indicator. So, in this case, N ┌log₂ | [symbol] |┐-bit indicators can be used. In one example, [symbol] ∈{2,4}. In one example, [symbol] ∈{2,4,6}. In one example, [symbol] ∈{1,2,3,4}. In one example, [symbol] ∈{1,2,3,4,5,6}. In one example, [symbol] ∈{1,2,4}. In one example, [symbol] ∈{1,2,3}. In one example, [symbol] is a subset of {1,2,3,4,5,6}.

In another example, Lₙ SD basis vector selection for each TRP n is reported via a joint indicator or separate multiple indicators in CSI part 2.
In one example, an indicator to indicate (each) Lₙ SD basis vectors has the payload of

$$⌈ {log}_{2} ( \begin{matrix}{N}_{1} {N}_{2} \\ {L}_{n}\end{matrix} ) ⌉$$

bits (bit-width), where N₁ and N₂ are the values of (N₁, N₂) configured via higher-layer (RRC) signaling by the NW 130, where n∈S or n=1, . . . , N.
In one example, a joint indicator to indicate {Lₙ} SD basis vectors has the payload of

$$⌈ {log}_{2} {\sum }_{n = 1}^{N} ( \begin{matrix}{N}_{1} {N}_{2} \\ {L}_{n}\end{matrix} ) ⌉$$

bits

$$⌈ {log}_{2} {\sum }_{n ∈ s} ( \begin{matrix}{N}_{1} {N}_{2} \\ {L}_{n}\end{matrix} ) ⌉$$

bits.

In another example, Lₙs associated with TRPs that are selected are explicitly reported via a joint indicator or separate multiple indicators in CSI part 2. The remaining part is similar to one or more examples described herein. For example, when N_{TRP}=4 and N_{TRP}-bit bitmap is ‘1001’ in CSI part 1, the first TRP and the fourth TRP are selected. In this example, Lₙ associated with the selected TRPs are explicitly reported.
In one example, a joint indicator can be used to indicate {Lₙ}_{n∈S} under the constraint of Lₘₐₓ≥Σ_{n∈S} Lₙ and Lₙ≥1, for n∈S where Lₙ is a positive integer and S is a set of selected TRP indexes (i.e., a subset of {1, 2, . . . , N_{TRP}}.
In one example, a joint indicator can be used to indicate {Lₙ}ₙ₌₁^{N} under the constraint of Lₘₐₓ≥Σₙ₌₁^{N} Lₙ and Lₙ≥1, for n=1, . . . , N where Lₙ is a positive integer.
In one example, an indicator can be used to indicate each Lₙ for n∈S under the constraint of Lₘₐₓ≥Σ_{n∈S} Lₙ and Lₙ≥1 where Lₙ is a positive integer and S is a set of selected TRP indexes (i.e., a subset of {1, 2, . . . , N_{TRP}}. In one example, each Lₙ is selected from a set [symbol] and indicated via ┌log₂ | [symbol] |┐-bit indicator. So, in this case, N ┌log₂ | [symbol] |┐-bit indicators can be used. In one example, [symbol] ∈{2,4}. In one example, [symbol] ∈{2,4,6}. In one example, [symbol] ∈{1,2,3,4}. In one example, [symbol] ∈{1,2,3,4,5,6}. In one example, [symbol] ∈{1,2,4}. In one example, [symbol] ∈{1,2,3}. In one example, [symbol] is a subset of {1,2,3,4,5,6}.
In one example, an indicator can be used to indicate each Lₙ for n=1, . . . , N under the constraint of Lₘₐₓ≥Σₙ₌₁^{N} Lₙ and Lₙ≥1, for n=1, . . . , N where Lₙ is a positive integer. In one example, each Lₙ is selected from a set [symbol] and indicated via ┌log₂ | [symbol] |┐-bit indicator. So, in this case, N ┌log₂ | [symbol] |┐-bit indicators can be used. In one example, [symbol] ∈{2,4}. In one example, [symbol] ∈{2,4,6}. In one example, [symbol] ∈{1,2,3,4}. In one example, [symbol] ∈{1,2,3,4,5,6}. In one example, [symbol] ∈{1,2,4}. In one example, [symbol] ∈{1,2,3}. In one example, [symbol] is a subset of {1,2,3,4,5,6}.

In another example, Lₙ SD basis vector selection for each TRP n is reported via a joint indicator or separate multiple indicators in CSI part 2.
In one example, an indicator to indicate (each) Lₙ SD basis vectors has the payload of

$$⌈ {log}_{2} ( \begin{matrix}{N}_{1} {N}_{2} \\ {L}_{n}\end{matrix} ) ⌉$$

bits (bit-width), where N₁ and N₂ are the values of (N₁, N₂) configured via higher-layer (RRC) signaling by the NW 130, where n∈S or n=1, . . . , N.
In one example, a joint indicator to indicate {Lₙ} SD basis vectors has the payload of

$$⌈ {log}_{2} {\sum }_{n = 1}^{N} ( \begin{matrix}{N}_{1} {N}_{2} \\ {L}_{n}\end{matrix} ) ⌉$$

bits or

$$⌈ {log}_{2} {\sum }_{n ∈ s} ( \begin{matrix}{N}_{1} {N}_{2} \\ {L}_{n}\end{matrix} ) ⌉$$

bits.

In another embodiment, Lₜₒₜ is determined by UE where Lₘₐₓ≥Lₜₒₜ=Σₙ₌₁^{N}^{_{TRP}} Lₙ and the determined Lₜₒₜ is reported in CSI part 1. In one example, an indicator to indicate Lₜₒₜ has the size of payload ┌log₂ Lₘₐₓ┐ bits, i.e., Lₜₒₜ is selected from {1, 2, . . . , Lₘₐₓ}. In another example, an indicator to indicate Lₜₒₜ has the size of payload ┌log₂| [symbol] ₜₒₜ|┐ bits, where [symbol] ₜₒₜ is a set including Lₘₐₓ and positive integers less than or equal to Lₘₐₓ, and | [symbol] ₜₒₜ| is a number of the elements in [symbol] ₜₒₜ. In one example, [symbol] ₜₒₜ can be any subset of {1, 2, . . . , Lₘₐₓ}. In one example, [symbol] ₜₒₜ can be any subset of

$$\{ ⌈ \frac{{L}_{max}}{4} ⌉ , ⌈ \frac{{L}_{max}}{3} ⌉ , ⌈ \frac{{L}_{max}}{2} ⌉ , {L}_{max} \} .$$

In one example, Lₜₒₜ∈{2N_{TRP}, 4N_{TRP}, 6N_{TRP}}. In one example, Lₜₒₜ∈{1N_{TRP}>²N_{TRP}, 4N_{TRP}, 6N_{TRP}}. In one example, Lₜₒₜ∈{1N_{TRP}, 2N_{TRP}, 3N_{TRP}, 4N_{TRP}, 5N_{TRP}, 6N_{TRP}}. In one example, In one example, Lₜₒₜ∈{1N_{TRP}, 2N_{TRP}, 3N_{TRP}, 4N_{TRP}}. In one example, Lₜₒₜ∈{1N_{TRP}, 2N_{TRP}, 3N_{TRP}}.

In one example, Lₜₒₜ∈{1N_{TRP}, 2N_{TRP}, 4N_{TRP}}. In one example, Lₜₒₜ can be selected from a subset of {1, . . . , 24}.

In one example, Lₜₒₜ∈{2N_{TRP}, 4N_{TRP}, 6N_{TRP}}∩{1, 2, . . . , Lₘₐₓ}. In one example, Lₜₒₜ∈{1N_{TRP}, 2N_{TRP}, 4N_{TRP}, 6N_{TRP}}∩{1, 2, . . . , Lₘₐₓ}. In one example, Lₜₒₜ∈{1N_{TRP}, 2N_{TRP}, 3N_{TRP}, 4N_{TRP}, 5N_{TRP}, 6N_{TRP}}∩{1, 2, . . . , Lₘₐₓ}. In one example, In one example, Lₜₒₜ∈{1N_{TRP}, 2N_{TRP}, 3N_{TRP}, 4N_{TRP}}∩{1, 2, . . . Lₘₐₓ}. In one example, Lₜₒₜ∈{1N_{TRP}, 2N_{TRP}, 3N_{TRP}}∩{1, 2, . . . , Lₘₐₓ}.

In one example, Lₜₒₜ∈{1N_{TRP}, 2N_{TRP}, 4N_{TRP}}∩{1, 2, . . . , Lₘₐₓ}. In one example, Lₜₒₜ can be selected from a subset of {1, . . . , 24}∩{1, 2, . . . , Lₘₐₓ}.

In another example, some of {Lₙ, n=1, . . . , N_{TRP}} are explicitly reported via a joint indicator or separate multiple indicators in CSI part 1 and the others of {Lₙ, n=1, . . . , N_{TRP}} are reported implicitly (or determined implicitly hence not explicitly reported).
In one example, a joint indicator can be used to indicate (L₁, . . . , L_{N}_{_{TRP}}₋₁), (i.e., excluding L with the highest index), and L_{N}_{_{TRP}} is implicitly determined by (L₁, . . . , L_{N}_{_{TRP}}₋₁) and Lₜₒₜ=Σₙ₌₁^{N}^{_{TRP}} Lₙ hence L_{N}_{_{TRP}} is not reported. Here, Lₙ≥0, for n=1, . . . , N_{TRP}−1 where Lₙ is a non-negative integer.
In one example, a joint indicator can be used to indicate (L₂, . . . , L_{N}_{_{TRP}}), (i.e., excluding L with the lowest index), and L₁ is implicitly determined by (L₂, . . . , L_{N}_{_{TRP}}) and Lₜₒₜ=Σₙ₌₁^{N}^{_{TRP}} Lₙ hence L₁ is not reported. Here, Lₙ≥0, for n=2, . . . , N_{TRP} where Lₙ is a non-negative integer.
In one example, a joint indicator can be used to indicate {Lₙ}_{n∈{1, . . . , N}_{_{TRP}}_{}\{n*}} (i.e., excluding L with a reference TRP index n*, which can be determined by UE or configured by the NW 130 or determined by a pre-defined rule), and L_{n*} is implicitly determined by {Lₙ}_{n∈{1, . . . , N}_{_{TRP}}^{}\{n*}} and Lₜₒₜ=Σₙ₌₁^{N}^{_{TRP}} Lₙ hence L_{n*} is not reported. Here, Lₙ≥0, for n∈{1, . . . , N_{TRP}}\{n*} where Lₙ is a non-negative integer.
In one example, an indicator can be used to indicate each Lₙ for n=1, . . . , N_{TRP}−1 (i.e., excluding L with the highest index), and L_{N}_{_{TRP}} is implicitly determined by L₁, . . . , L_{N}_{_{TRP}}₋₁ and Lₜₒₜ=Σₙ₊₁^{N}^{_{TRP}} Lₙ hence L_{N}_{_{TRP}} is not reported. Here, Lₙ≥0, for n=1, . . . , N_{TRP}−1 where Lₙ is a non-negative integer.
In one example, an indicator can be used to indicate each Lₙ for n=2, . . . , N_{TRP} (i.e., excluding L with the lowest index), and L₁ is implicitly determined by L₂, . . . , L_{N}_{_{TRP}} and Lₜₒₜ=Σₙ₌₁^{N}^{_{RTP}} Lₙ hence L₁ is not reported. Here, Lₙ≥0, for n=2, . . . , N_{TRP} where Lₙ is a non-negative integer.
In one example, an indicator can be used to indicate each Lₙ for n∈{1, . . . , N_{TRP}}\{n*} (i.e., excluding L with a reference TRP index n*, which can be determined by UE or configured by the NW 130 or determined by a pre-defined rule), and L_{n*} is implicitly determined by {Lₙ}_{n∈{1, . . . , N}_{_{TRP}}_{}\{n*}} and Lₜₒₜ=Σₙ₊₁^{N}^{_{TRP}} Lₙ hence L_{n*} is not reported. Here, Lₙ≥0, for n∈{1, . . . , N_{TRP}}\{n*} where Lₙ is a non-negative integer.

In another example, Lₙ SD basis vector selection for each TRP n is reported via a joint indicator or separate multiple indicators in CSI part 2 (Similar to/same as one or more examples described herein).
In one example, an indicator to indicate (each) Lₙ SD basis vectors has the payload of

$$⌈ {log}_{2} ( \begin{matrix}{N}_{1} {N}_{2} \\ {L}_{n}\end{matrix} ) ⌉$$

bits (bit-width), where N₁ and N₂ are the values of (N₁, N₂) configured via higher-layer (RRC) signaling by the NW 130. For any TRP n where Lₙ=0 (i.e., no SD beam selection case) and/or where TRP n is not selected which can be indicated via N_{TRP}-bit bitmap in CSI part 1, no SD basis vector for TRP n is reported, hence no payload is induced.
In one example, a joint indicator to indicate {Lₙ} SD basis vectors has the payload of

$$⌈ {log}_{2} {\sum }_{n = 1}^{{N}_{TRP}} ( \begin{matrix}{N}_{1} {N}_{2} \\ {L}_{n}\end{matrix} ) ⌉$$

bits (bit-width). For any TRP n where Lₙ=0 (i.e., no SD beam selection case) and/or where TRP n is not selected which can be indicated via N_{TRP}-bit bitmap in CSI part 1, no SD basis vector for TRP n is reported, hence no additional payload is induced in the sum.

In another example, Lₜₒₜ SD basis vectors are selected among each of the candidates of SD basis vectors across N_{TRP} TRPs and the selection of Lₜₒₜ SD basis vectors is reported via an indicator with size of

$$⌈ {log}_{2} ( \begin{matrix}{N}_{TRP} {N}_{1} {N}_{2} \\ {L}_{tot}\end{matrix} ) ⌉$$

bits in CSI part 1. In this case, Lₙ is implicitly determined by counting the number of selected SD basis vectors that belong to the candidate SD basis vectors of each TRP.

In another example, Lₜₒₜ SD basis vectors are selected among each of the candidates of SD basis vectors across N_{TRP} TRPs and the selection of Lₜₒₜ SD basis vectors is reported via an indicator with size of

$$⌈ {log}_{2} ( \begin{matrix}{N}_{TRP} {N}_{1} {N}_{2} \\ {L}_{tot}\end{matrix} ) ⌉$$

bits in CSI part 2. In this case, Lₙ is implicitly determined by counting the number of selected SD basis vectors that belong to the candidate SD basis vectors of each TRP.

In another example, Lₜₒₜ SD basis vectors are selected among each of the candidates of SD basis vectors across N TRPs, where N is a number of selected TRPs. For example, in CSI part 1, N_{TRP}-bit bitmap is used to indicate selected N TRPs out of N_{TRP} TRPs. For example, when N_{TRP}=4 and N_{TRP}-bit bitmap is ‘1001’ in CSI part 1, the first TRP and the fourth TRP are selected. The selection of Lₜₒₜ SD basis vectors is reported via an indicator with size of

$$⌈ {log}_{2} ( \begin{matrix}{NN}_{1} {N}_{2} \\ {L}_{tot}\end{matrix} ) ⌉$$

bits in CSI part 1. In this case, Lₙ is implicitly determined by counting the number of selected SD basis vectors that belong to the candidate SD basis vectors of each of the selected TRPs.

In another example, Lₜₒₜ SD basis vectors are selected among each of the candidates of SD basis vectors across N TRPs, where N is a number of selected TRPs. For example, in CSI part 1, N_{TRP}-bit bitmap is used to indicate selected N TRPs out of N_{TRP} TRPs. For example, when N_{TRP}=4 and N_{TRP}-bit bitmap is ‘1001’ in CSI part 1, the first TRP and the fourth TRP are selected. The selection of Lₜₒₜ SD basis vectors is reported via an indicator with size of

$$⌈ {log}_{2} ( \begin{matrix}{NN}_{1} {N}_{2} \\ {L}_{tot}\end{matrix} ) ⌉$$

bits in CSI part 2. In this case, Lₙ is implicitly determined by counting the number of selected SD basis vectors that belong to the candidate SD basis vectors of each of the selected TRPs.

In another embodiment, Lₜₒₜ is determined by UE where Lₘₐₓ≥Lₜₒₜ=Σₙ₌₁^{N} Lₙ (or Lₘₐₓ≥Lₜₒₜ=Σ_{n∈S}Lₙ), and the determined Lₜₒₜ is reported in CSI part 1. Here, N is a number of selected TRPs out of N_{TRP} TRPs and S is a set of selected TRP indexes (i.e., a subset of {1, 2, . . . , N_{TRP}}). Note that in CSI part 1, N_{TRP}-bit bitmap can be used to indicate selected N TRPs out of N_{TRP} TRPs. In one example, an indicator to indicate Lₜₒₜ has the size of payload ┌log₂ Lₘₐₓ┐ bits, i.e., Lₜₒₜ is selected from {1, 2, . . . , Lₘₐₓ}. In another example, an indicator to indicate Lₜₒₜ has the size of payload ┌log₂ | [symbol] ₜₒₜ|┐ bits, where [symbol] ₜₒₜ is a set including Lₘₐₓ and positive integers less than or equal to Lₘₐₓ, and | [symbol] ₜₒₜ| is a number of the elements in [symbol] ₜₒₜ. In one example, [symbol] ₜₒₜ can be any subset of {1, 2, . . . , Lₘₐₓ}. In one example, [symbol] ₜₒₜ can be any subset of

$$\{ ⌈ \frac{{L}_{max}}{4} ⌉ , ⌈ \frac{{L}_{max}}{3} ⌉ , ⌈ \frac{{L}_{max}}{2} ⌉ , {L}_{max} \} .$$

In one example, an indicator to indicate Lₜₒₜ has the size of payload

$$⌈ {log}_{2} ( {L}_{max} \cdot \frac{N}{{N}_{TRP}} ) ⌉$$

bits, i.e., Lₜₒₜ is selected from

$$\{ 1 , 2 , … , ⌈ {L}_{max} \cdot \frac{N}{{N}_{TRP}} ⌉ \} .$$

In one example, Lₜₒₜ∈{2N, 4N, 6N}. In one example, Lₜₒₜ∈{1N, 2N, 4N, 6N}. In one example, Lₜₒₜ∈{1N, 2N, 3N, 4N, 5N, 6N}. In one example, In one example, Lₜₒₜ∈{1N, 2N, 3N, 4N}. In one example, Lₜₒₜ∈{1N, 2N, 3N}.

In one example, Lₜₒₜ∈{1N, 2N, 4N}. In one example, Lₜₒₜ can be selected from a subset of {1, . . . , 24}. In one example, Lₜₒₜ∈{2N, 4N, 6N}∩{1, 2, . . . , Lₘₐₓ}. In one example, Lₜₒₜ∈{1N, 2N, 4N, 6N}∩{1, 2, . . . , Lₘₐₓ}. In one example, Lₜₒₜ∈{1N, 2N, 3N, 4N, 5N, 6N}∩{1, 2, . . . , Lₘₐₓ}. In one example, In one example, Lₜₒₜ∈{1N, 2N, 3N, 4N}∩{1, 2, . . . , Lₘₐₓ}. In one example, Lₜₒₜ∈{1N, 2N, 3N}∩{1, 2, . . . , Lₘₐₓ}. In one example, Lₜₒₜ∈{1N, 2N, 4N}∩{1, 2, . . . , Lₘₐₓ}. In one example, Lₜₒₜ can be selected from a subset of {1, . . . , 24}∩{1, 2, . . . , Lₘₐₓ).

In another example, some of Lₙs associated with TRPs that are selected are explicitly reported via a joint indicator or separate multiple indicators in CSI part 1 and the others of Lₙs associated with TRPs that are selected are reported implicitly (or determined implicitly hence not explicitly reported). In CSI part 1, N_{TRP}-bit bitmap is used to indicate selected N TRPs out of N_{TRP} TRPs. For example, when N_{TRP}=4 and N_{TRP}-bit bitmap is ‘1001’ in CSI part 1, the first TRP and the fourth TRP are selected. In this example, some of Lₙ associated with the selected TRPs are explicitly reported and the others are implicitly determined.
In one example, a joint indicator can be used to indicate {Lₙ}_{n∈S\n}_{_{Low}}_{}} and Lₙ_{_{Low}} is implicitly determined by {Lₙ}_{n∈S\{n}_{_{Low}}_{}} and Lₜₒₜ=Σ_{n∈S}Lₙ and Lₙ≥1 for n∈S\{n_{Low}} where Lₙ is a positive integer and S is a set of selected TRP indexes (i.e., a subset of {1, 2, . . . , N_{TRP}}) and n_{Low} is the lowest index in S.
In one example, a joint indicator can be used to indicate {Lₙ}_{n∈S\{n}_{_{High}}_{}} and Lₙ_{_{High}} is implicitly determined by {Lₙ}_{n∈S\{n}_{_{High}}_{}} and Lₜₒₜ=Σ_{n∈S}Lₙ and Lₙ≥1 for n∈S\{n_{High}} where Lₙ is a positive integer and S is a set of selected TRP indexes (i.e., a subset of {1, 2, . . . , N_{TRP}}) and n_{High} is the highest index in S.
In one example, a joint indicator can be used to indicate {Lₙ}_{n∈S\{n*}} and L_{n*} is implicitly determined by {Lₙ}_{n∈S\{n*}} and Lₜₒₜ=Σ_{n∈S}Lₙ and Lₙ≥1 for n∈S\{n*} where Lₙ is a positive integer and S is a set of selected TRP indexes (i.e., a subset of {1, 2, . . . , N_{TRP}}) and n* is a reference TRP index in S, which can be determined by UE or configured by the NW 130 or determined by a pre-defined rule.
In one example, a joint indicator can be used to indicate {Lₙ}ₙ₌₁^{N-1} and L_{N} is implicitly determined by {Lₙ}ₙ₌₁^{N-1} and Lₜₒₜ=Σₙ₌₁^{N} Lₙ and Lₙ≥1, for n=1, . . . , N−1 where Lₙ is a positive integer.
In one example, a joint indicator can be used to indicate {Lₙ}ₙ₌₂^{N} and L₁ is implicitly determined by {Lₙ}ₙ₌₂^{N} and Lₜₒₜ=Σₙ₌₁^{N}Lₙ and Lₙ≥1, for n=2, . . . , N where Lₙ is a positive integer.
In one example, a joint indicator can be used to indicate {Lₙ}_{n∈{1, . . . , N}\{n*}} and L_{n*} is implicitly determined by {Lₙ}_{n∈{1, . . . , N}\{n*}} and Lₜₒₜ=Σₙ₌₁^{N} Lₙ and Lₙ≥1, for n∈{1, . . . , N}\{n*} where Lₙ is a positive integer.
In one example, an indicator can be used to indicate each Lₙ for n∈S\{n_{Low}} and Lₙ_{_{Low}} is implicitly determined by {Lₙ}_{n∈S\{n}_{_{Low}}_{}} and Lₜₒₜ=Σ_{n∈S} Lₙ and Lₙ≥1 for n∈S\{n_{Low}} where Lₙ is a positive integer and S is a set of selected TRP indexes (i.e., a subset of {1, 2, . . . , N_{TRP}}) and n_{Low} is the lowest index in S.
In one example, an indicator can be used to indicate each Lₙ for n∈S\{n_{High}} and Lₙ_{_{High}} is implicitly determined by {Lₙ}_{n∈S\{n}_{_{High}}_{}} and Lₜₒₜ=Σ_{n∈S}Lₙ and Lₙ≥1 for n∈S\{n_{High}} where Lₙ is a positive integer and S is a set of selected TRP indexes (i.e., a subset of {1, 2, . . . , N_{TRP}}) and n_{High} is the highest index in S.
In one example, an indicator can be used to indicate each Lₙ for n∈S\{n*} and Lₙ_{_{{n*}}} is implicitly determined by {Lₙ}_{n∈S\{n*}} and Lₜₒₜ=Σ_{n∈S}Lₙ and Lₙ≥1 for n∈S\{n*} where Lₙ is a positive integer and S is a set of selected TRP indexes (i.e., a subset of {1, 2, . . . , N_{TRP}}) and n* is a reference TRP index in S, which can be determined by UE or configured by the NW 130 or determined by a pre-defined rule.
In one example, an indicator can be used to indicate each Lₙ for n=1, . . . , N−1 and L_{N} is implicitly determined by {Lₙ}ₙ₌₁^{N-1} and Lₜₒₜ=Σₙ₌₁^{N} Lₙ and Lₙ≥1, for n=1, . . . , N−1 where Lₙ is a positive integer.
In one example, an indicator can be used to indicate each Lₙ for n=2, . . . , N and L₁ is implicitly determined by {Lₙ}=₂ and Lₜₒₜ=Σₙ₌₁^{N} Lₙ and Lₙ≥1, for n=1, . . . , N−1 where Lₙ is a positive integer.
In one example, an indicator can be used to indicate each Lₙ for n∈{1, . . . , N}\{n*} and L_{n*} is implicitly determined by {Lₙ}_{n∈{1, . . . , N}\{n*}} and Lₜₒₜ=Σₙ₌₁^{N} Lₙ and Lₙ≥1, for n∈{1, . . . , N}\{n*} where Lₙ is a positive integer.

In another example, Lₙ SD basis vector selection for each TRP n is reported via a joint indicator or separate multiple indicators in CSI part 2. (Similar to/same as one or more examples described herein).
In one example, an indicator to indicate (each) Lₙ SD basis vectors has the payload of

$$⌈ {log}_{2} ( \begin{matrix}{N}_{1} {N}_{2} \\ {L}_{n}\end{matrix} ) ⌉$$

bits (bit-width), where N₁ and N₂ are the values of (N₁, N₂) configured via higher-layer (RRC) signaling by the NW 130, where n∈S or n=1, . . . , N.
In one example, a joint indicator to indicate {Lₙ} SD basis vectors has the payload of

$$⌈ {log}_{2} {\sum }_{n = 1}^{N} ( \begin{matrix}{N}_{1} {N}_{2} \\ {L}_{n}\end{matrix} ) ⌉$$

bits or

$$⌈ {log}_{2} {\sum }_{n ∈ S} ( \begin{matrix}{N}_{1} {N}_{2} \\ {L}_{n}\end{matrix} ) ⌉$$

bits.

In example, some of Lₙs associated with TRPs that are selected are explicitly reported via a joint indicator or separate multiple indicators in CSI part 2 and the others of Lₙs associated with TRPs that are selected are reported implicitly (or determined implicitly hence not explicitly reported). The remaining part is similar to one or more examples described herein.

In another example, Lₜₒₜ SD basis vectors are selected among each of the candidates of SD basis vectors across N TRPs. The selection of Lₜₒₜ SD basis vectors is reported via an indicator with size of

$$⌈ {log}_{2} ( \begin{matrix}{NN}_{1} {N}_{2} \\ {L}_{tot}\end{matrix} ) ⌉$$

bits in CSI part 1. In this case, Lₙ is implicitly determined by counting the number of selected SD basis vectors that belong to the candidate SD basis vectors of each of the selected TRPs.

In another example, Lₜₒₜ SD basis vectors are selected among each of the candidates of SD basis vectors across N TRPs. The selection of Lₜₒₜ SD basis vectors is reported via an indicator with size of

$$⌈ {log}_{2} ( \begin{matrix}{NN}_{1} {N}_{2} \\ {L}_{tot}\end{matrix} ) ⌉$$

bits in CSI part 2. In this case, Lₙ is implicitly determined by counting the number of selected SD basis vectors that belong to the candidate SD basis vectors of each of the selected TRPs.

In another embodiment, a bitmap with size of NN₁N₂ is used to indicate SD basis vectors for selected N TRPs (CSI-RS resources) in CSI part 2. For example, in the bitmap, ‘0’ refers ‘not selected’ for corresponding SD vector and ‘1’ refers ‘selected’ for corresponding SD vector. In this case, Lₙ can be inferred from the bitmap, by counting the number of selected SD vectors corresponding to each TRP. In this case, a restriction can be described such as “UE shall not report a CSI with Lₜₒₜ=Σₙ Lₙ>Lₘₐₓ, where Lₙ is inferred from the bitmap.”

In another embodiment, in one or more embodiments described herein, Lₙ, Lₜₒₜ, Lₘₐₓ can be replaced by αₙ, αₜₒₜ, αₘₐₓ where

$${α}_{n} = \frac{{L}_{n}}{{N}_{1} {N}_{2}} , {α}_{tot} = \frac{{L}_{tot}}{{N}_{TRP} {N}_{1} {N}_{2}} ( or {α}_{tot} = \frac{{L}_{tot}}{{NN}_{1} {N}_{2}} ) , and$$

$${α}_{max} = \frac{{L}_{max}}{{N}_{TRP} {N}_{1} {N}_{2}} ( or {α}_{max} = \frac{{L}_{max}}{{NN}_{1} {N}_{2}} ) .$$

In another embodiment, a UE is configured with a CSI report (e.g., via higher layer CSI-ReportConfig) based on a codebook for C-JT transmission from multiple TRPs, as described in the present disclosure, where codebook parameters (such as α or L, β, p_{υ} or M_{υ}) are configured via a higher-layer parameter ‘paramCombination-r18’ or ‘paramCombinationCJT-r18’.
In one example, the Rel. 16 parameter combination table for ‘paraCombination-r16’ is reused for ‘paramCombination-r18’ (cf. Table 1).
In one example, the Rel. 17 parameter combination table for ‘paraCombination-r17’ is reused for ‘paramCombination-r18’ (cf. Table 2).
In one example, a new table of parameter combination is used for ‘paramCombination-r18’.
In one example, a table including existing Rel. 16 or Rel. 17 parameter combination(s) and new parameter combination(s) is used for ‘paramCombination-r18’.

Any table including at least one of the combinations provided in the (sub)-tables in the present disclosure can be an example for the table of ‘paraCombination-r18’.

In another embodiment, a table used for ‘paramCombination-r18’ is designed based on the following parameter candidates:
Candidate values for Lₘₐₓ (or Lₛᵤₘ): [symbol] ₘₐₓ={1,2, 3, . . . , 24}
   where Lₘₐₓ≥Σₙ₌₁^{N}^{_{TRP}} Lₙ and Lₙ is L for CSI-RS resource n (TRP n); and
   N_{TRP}∈{1,2,3,4} is a number of CSI-RS resources (or TRPs) and is configured by the NW 130 via higher-layer signaling.
Candidate values for pᵥ for v=1,2: [symbol] ₁₂={⅙,⅛,¼,⅜,½}.
Candidate values for pᵥ for v=3,4: [symbol] ₃₄={ 1/32, 3/16, 1/16,⅛,¼,⅜,½}.
Candidate values for β: [symbol] ={⅛,¼,½,¾,1}.

In one example, any table including at least one of the combinations provided in the tables in the present disclosure can be an example for the table of ‘paraCombination-r18’.

TABLE 3

p_{υ}

| | | υ | υ | |
|---|---|---|---|---|
| paramCombination-r18 | Lₘₐₓ | ∈ {1, 2} | ∈ {3, 4} | β |
| 1 | 1 | 1/16 | 1/32 | ⅛ |
| 2 | 1 | 1/16 | 1/32 | ¼ |
| 3 | 1 | 1/16 | 1/32 | ½ |
| 4 | 1 | 1/16 | 1/32 | ¾ |
| 5 | 1 | 1/16 | 1/32 | 1 |
| 6 | 1 | 1/16 | 1/16 | ⅛ |
| 7 | 1 | 1/16 | 1/16 | ¼ |
| 8 | 1 | 1/16 | 1/16 | ½ |
| 9 | 1 | 1/16 | 1/16 | ¾ |
| 10 | 1 | 1/16 | 1/16 | 1 |
| 11 | 1 | ⅛ | 1/16 | ⅛ |
| 12 | 1 | ⅛ | 1/16 | ½ |
| 13 | 1 | ⅛ | 1/16 | ½ |
| 14 | 1 | ⅛ | 1/16 | ¾ |
| 15 | 1 | ⅛ | 1/16 | 1 |
| 16 | 1 | ⅛ | ⅛ | ⅛ |
| 17 | 1 | ⅛ | ⅛ | ¼ |
| 18 | 1 | ⅛ | ⅛ | ½ |
| 19 | 1 | ⅛ | ⅛ | ¾ |
| 20 | 1 | ⅛ | ⅛ | 1 |
| 21 | 1 | ¼ | ⅛ | ⅛ |
| 22 | 1 | ¼ | ⅛ | ¼ |
| 23 | 1 | ¼ | ⅛ | ½ |
| 24 | 1 | ¼ | ⅛ | ¾ |
| 25 | 1 | ¼ | ⅛ | 1 |
| 26 | 1 | ¼ | ¼ | ⅛ |
| 27 | 1 | ¼ | ¼ | ½ |
| 28 | 1 | ¼ | ¼ | ½ |
| 29 | 1 | ¼ | ¼ | ¾ |
| 30 | 1 | ¼ | ¼ | 1 |
| 31 | 1 | ⅜ | 3/16 | ⅛ |
| 32 | 1 | ⅜ | 3/16 | ¼ |
| 33 | 1 | ⅜ | 3/16 | ½ |
| 34 | 1 | ⅜ | 3/16 | ¾ |
| 35 | 1 | ⅜ | 3/16 | 1 |
| 36 | 1 | ⅜ | ⅜ | ⅛ |
| 37 | 1 | ⅜ | ⅜ | ¼ |
| 38 | 1 | ⅜ | ⅜ | ½ |
| 39 | 1 | ⅜ | ⅜ | ¾ |
| 40 | 1 | ⅜ | ⅜ | 1 |
| 41 | 1 | ½ | ½ | ⅛ |
| 42 | 1 | ½ | ¼ | ¼ |
| 43 | 1 | ½ | ¼ | ½ |
| 44 | 1 | ½ | ¼ | ¾ |
| 45 | 1 | ½ | ¼ | 1 |
| 46 | 1 | ½ | ½ | ⅛ |
| 47 | 1 | ½ | ½ | ¼ |
| 48 | 1 | ½ | ½ | ½ |
| 49 | 1 | ½ | ½ | ¾ |
| 50 | 1 | ½ | ½ | 1 |
| 51 | 2 | 1/16 | 1/32 | ⅛ |
| 52 | 2 | 1/16 | 1/32 | ½ |
| 53 | 2 | 1/16 | 1/32 | ½ |
| 54 | 2 | 1/16 | 1/32 | ¾ |
| 55 | 2 | 1/16 | 1/32 | 1 |
| 56 | 2 | 1/16 | 1/16 | ⅛ |
| 57 | 2 | 1/16 | 1/16 | ¼ |
| 58 | 2 | 1/16 | 1/16 | ½ |
| 59 | 2 | 1/16 | 1/16 | ¾ |
| 60 | 2 | 1/16 | 1/16 | 1 |
| 61 | 2 | ⅛ | 1/16 | ⅛ |
| 62 | 2 | ⅛ | 1/16 | ¼ |
| 63 | 2 | ⅛ | 1/16 | ½ |
| 64 | 2 | ⅛ | 1/16 | ¾ |
| 65 | 2 | ⅛ | 1/16 | 1 |
| 66 | 2 | ⅛ | ⅛ | ⅛ |
| 67 | 2 | ⅛ | ⅛ | ¼ |
| 68 | 2 | ⅛ | ⅛ | ½ |
| 69 | 2 | ⅛ | ⅛ | ¾ |
| 70 | 2 | ⅛ | ⅛ | 1 |
| 71 | 2 | ¼ | ⅛ | ⅛ |
| 72 | 2 | ¼ | ⅛ | ¼ |
| 73 | 2 | ½ | ⅛ | ½ |
| 74 | 2 | ¼ | ⅛ | ¾ |
| 75 | 2 | ½ | ⅛ | 1 |
| 76 | 2 | ½ | ¼ | ⅛ |
| 77 | 2 | ¼ | ¼ | ¼ |
| 78 | 2 | ½ | ¼ | ½ |
| 79 | 2 | ¼ | ½ | ¾ |
| 80 | 2 | ¼ | ¼ | 1 |
| 81 | 2 | ⅜ | 3/16 | ⅛ |
| 82 | 2 | ⅜ | 3/16 | ¼ |
| 83 | 2 | ⅜ | 3/16 | ½ |
| 84 | 2 | ⅜ | 3/16 | ¾ |
| 85 | 2 | ⅜ | 3/16 | 1 |
| 86 | 2 | ⅜ | ⅜ | ⅛ |
| 87 | 2 | ⅜ | ⅜ | ¼ |
| 88 | 2 | ⅜ | ⅜ | ½ |
| 89 | 2 | ⅜ | ⅜ | ¾ |
| 90 | 2 | ⅜ | ⅜ | 1 |
| 91 | 2 | ½ | ¼ | ⅛ |
| 92 | 2 | ½ | ½ | ¼ |
| 93 | 2 | ½ | ½ | ½ |
| 94 | 2 | ½ | ¼ | ¾ |
| 95 | 2 | ½ | ¼ | 1 |
| 96 | 2 | ½ | ½ | ⅛ |
| 97 | 2 | ½ | ½ | ¼ |
| 98 | 2 | ½ | ½ | ½ |
| 99 | 2 | ½ | ½ | ¾ |
| 100 | 2 | ½ | ½ | 1 |
| 101 | 3 | 1/16 | 1/32 | ⅛ |
| 102 | 3 | 1/16 | 1/32 | ¼ |
| 103 | 3 | 1/16 | 1/32 | ½ |
| 104 | 3 | 1/16 | 1/32 | ¾ |
| 105 | 3 | 1/16 | 1/32 | 1 |
| . | . | . | . | . |
| . | . | . | . | . |
| . | . | . | . | . |
| 151 | 4 | 1/16 | 1/32 | ⅛ |
| 152 | 4 | 1/16 | 1/32 | ¼ |
| 153 | 4 | 1/16 | 1/32 | ½ |
| 154 | 4 | 1/16 | 1/32 | ¾ |
| 155 | 4 | 1/16 | 1/32 | 1 |
| . | . | . | . | . |
| . | . | . | . | . |
| . | . | . | . | . |
| 201 | 5 | 1/16 | 1/32 | ⅛ |
| . | . | . | . | . |
| . | . | . | . | . |
| . | . | . | . | . |
| 251 | 6 | 1/16 | 1/32 | ⅛ |
| . | . | . | . | . |
| . | . | . | . | . |
| . | . | . | . | . |
| 301 | 7 | 1/16 | 1/32 | ⅛ |
| . | . | . | . | . |
| . | . | . | . | . |
| . | . | . | . | . |
| 351 | 8 | 1/16 | 1/32 | ⅛ |
| . | . | . | . | . |
| . | . | . | . | . |
| . | . | . | . | . |
| 401 | 9 | 1/16 | 1/32 | ⅛ |
| . | . | . | . | . |
| . | . | . | . | . |
| . | . | . | . | . |
| 451 | 10 | 1/16 | 1/32 | ⅛ |
| . | . | . | . | . |
| . | . | . | . | . |
| . | . | . | . | . |
| 501 | 11 | 1/16 | 1/32 | ⅛ |
| . | . | . | . | . |
| . | . | . | . | . |
| . | . | . | . | . |
| 551 | 12 | 1/16 | 1/32 | ⅛ |
| . | . | . | . | . |
| . | . | . | . | . |
| . | . | . | . | . |
| 601 | 13 | 1/16 | 1/32 | ⅛ |
| . | . | . | . | . |
| . | . | . | . | . |
| . | . | . | . | . |
| 651 | 14 | 1/16 | 1/32 | ⅛ |
| . | . | . | . | . |
| . | . | . | . | . |
| . | . | . | . | . |
| 701 | 15 | 1/16 | 1/32 | ⅛ |
| . | . | . | . | . |
| . | . | . | . | . |
| . | . | . | . | . |
| 751 | 16 | 1/16 | 1/32 | ⅛ |
| . | . | . | . | . |
| . | . | . | . | . |
| . | . | . | . | . |
| 801 | 17 | 1/16 | 1/32 | ⅛ |
| . | . | . | . | . |
| . | . | . | . | . |
| . | . | . | . | . |
| 851 | 18 | 1/16 | 1/32 | ⅛ |
| . | . | . | . | . |
| . | . | . | . | . |
| . | . | . | . | . |
| 901 | 19 | 1/16 | 1/32 | ⅛ |
| . | . | . | . | . |
| . | . | . | . | . |
| . | . | . | . | . |
| 951 | 20 | 1/16 | 1/32 | ⅛ |
| . | . | . | . | . |
| . | . | . | . | . |
| . | . | . | . | . |
| 1001 | 21 | 1/16 | 1/32 | ⅛ |
| . | . | . | . | . |
| . | . | . | . | . |
| . | . | . | . | . |
| 1051 | 22 | 1/16 | 1/32 | ⅛ |
| . | . | . | . | . |
| . | . | . | . | . |
| . | . | . | . | . |
| 1101 | 23 | 1/16 | 1/32 | ⅛ |
| . | . | . | . | . |
| . | . | . | . | . |
| . | . | . | . | . |
| 1151 | 24 | 1/16 | 1/32 | ⅛ |
| . | . | . | . | . |
| . | . | . | . | . |
| . | . | . | . | . |
| 1196 | 24 | ½ | ½ | ⅛ |
| 1197 | 24 | ½ | ½ | ¼ |
| 1198 | 24 | ½ | ½ | ½ |
| 1199 | 24 | ½ | ½ | ¾ |
| 1200 | 24 | ½ | ½ | 1 |

In Table 3, we omitted the rows we can clearly figure it out (based on earlier rows) for the sake of space limitation. Also, the table index numbers (from 1 to 1200) in Table 3 should be interpreted as just indexes for corresponding parameter combinations. That is, the table index number can be any value based on the ordering of parameter combinations and the number of parameter combinations in a table.

In one example, any sub-table of Table 3 can be an example for the table of ‘paraCombination-r18’.

In another embodiment, any table including at least one of parameter combinations in a sub-table of Table 3 can be used for the table of ‘paramCombination-r18’, where the sub-table includes parameter combinations associated with Lₘₐₓ∈ [symbol] ₘₐₓ, where [symbol] ₘₐₓ is a subset of [symbol] max. For example, if [symbol] ₘₐₓ={8,10,12,14,16}, the sub-table includes the parameter combinations associated with Lₘₐₓ=8,10,12,14,16 in Table 3.
In one example, [symbol] ₘₐₓ={8,10,12,14,16} and the sub-table includes parameter combinations associated with Lₘₐₓ={8,10,12,14,16} in Table 3.
In one example, [symbol] ₘₐₓ={6,8,10,12} and the sub-table includes parameter combinations associated with Lₘₐₓ={6,8,10,12} in Table 3.
In one example, [symbol] ₘₐₓ={4,6,8} and the sub-table includes parameter combinations associated with Lₘₐₓ={4,6,8} in Table 3.
In one example, [symbol] ₘₐₓ={2,4} and the sub-table includes parameter combinations associated with Lₘₐₓ={2,4} in Table 3.
In one example, [symbol] ₘₐₓ={8,10,12,14,16,18,20,22,24} and the sub-table includes parameter combinations associated with Lₘₐₓ={8,10,12,14,16,18,20,22,24} in Table 3.
In one example, [symbol] ₘₐₓ={6,8,10,12,14,16,18} and the sub-table includes parameter combinations associated with Lₘₐₓ={6,8,10,12,14,16,18} in Table 3.
In one example, [symbol] ₘₐₓ={4,6,8,10,12} and the sub-table includes parameter combinations associated with Lₘₐₓ={4,6,8,10,12} in Table 3.
In one example, [symbol] ₘₐₓ={2,4,6} and the sub-table includes parameter combinations associated with Lₘₐₓ={2,4,6} in Table 3.
In one example, [symbol] ₘₐₓ={4,5,6,7,8,9,10,11,12,13,14,15,16,17,18,19,20,22,24} and the sub-table includes parameter combinations associated with Lₘₐₓ={4,5,6,7,8,9,10,11,12,13,14,15,16,17,18,19,20,22,24} in Table 3.
In one example, [symbol] ₘₐₓ={3,4,5,6,7,8,9,10,11,12,13,14,16,18} and the sub-table includes parameter combinations associated with Lₘₐₓ={3,4,5,6,7,8,9,10,11,12,13,14,16,18} in Table 3.
In one example, [symbol] ₘₐₓ={2,3,4,5,6,7,8,10,12} and the sub-table includes parameter combinations associated with Lₘₐₓ={2,3,4,5,6,7,8,10,12} in Table 3.
In one example, [symbol] ₘₐₓ={1,2,4,6} and the sub-table includes parameter combinations associated with Lₘₐₓ={1,2,4,6} in Table 3.

In one embodiment, [symbol] ₘₐₓ can be defined for each value of N_{TRP}={1,2,3,4}, and the sub-table includes parameter combinations associated with Lₘₐₓ ∈ [symbol] ₘₐₓ in Table 3 for each value of N_{TRP}={1,2,3,4}.

In one example, [symbol] ₘₐₓ can be defined as follow and the sub-table includes parameter combinations associated with [symbol] ₘₐₓ for each value of N_{TRP}:
[symbol] ₘₐₓ={8,10,12,14,16} for N_{TRP}=4,
[symbol] ₘₐₓ={6,8,10,12} for N_{TRP}=3,
[symbol] ₘₐₓ={4,6,8} for N_{TRP}=2, and
[symbol] ₘₐₓ={2,4} for N_{TRP}=1.

In one example, [symbol] ₘₐₓ can be defined as follow and the sub-table includes parameter combinations associated with [symbol] ₘₐₓ for each value of N_{TRP}:
[symbol] ₘₐₓ={8,10,12,14,16,18,20,22,24} for N_{TRP}=4,
[symbol] ₘₐₓ={6,8,10,12,14,16,18} for N_{TRP}=3,
[symbol] ₘₐₓ={4,6,8,10,12} for N_{TRP}=2, and
[symbol] ₘₐₓ={2,4,6} for N_{TRP}=1.

In one example, [symbol] ₘₐₓ can be defined as follow and the sub-table includes parameter combinations associated with [symbol] ₘₐₓ for each value of N_{TRP}:
[symbol] ₘₐₓ={4,5,6,7,8,9,10,11,12,13,14,15,16,17,18,19,20,22,24} for N_{TRP}=4,
[symbol] ₘₐₓ={3,4,5,6,7,8,9,10,11,12,13,14,16,18} for N_{TRP}=3,
[symbol] ₘₐₓ={2,3,4,5,6,7,8,10,12} for N_{TRP}=2, and
[symbol] ₘₐₓ={1,2,4,6} for N_{TRP}=1.

In another embodiment, any table including at least one of parameter combinations in a sub-table of Table 3 can be used for the table of ‘paramCombination-r18’, where the sub-table includes parameter combinations associated with ({pᵥ}_{v=1,2}, {pᵥ}_{v=3,4})∈ [symbol] , where [symbol] is a subset of [symbol] , where [symbol] ={(x,y)|x∈ [symbol] ₁₂,y∈ [symbol] ₃₄}. For example, if [symbol] ={(⅛, 1/16),(¼,⅛),(¼,¼),(½,¼),(½,½)}, the sub-table includes the parameter combinations associated with ({pᵥ}_{v=1,2}, {pᵥ}_{v=3,4})={(⅛, 1/16),(¼,⅛),(¼,¼),(½,¼)} in Table 3.
In one example, [symbol] ={(⅛, 1/16),(¼,⅛),(¼,¼),(½,½)} and the sub-table includes parameter combinations associated with if ({pᵥ}_{v=1,2}, {pᵥ}_{v=3,4})={(⅛, 1/16),(¼,⅛),(¼,¼),(½,¼)} in Table 3.
In one example, [symbol] ={(⅛, 1/16),(¼,⅛),(¼,¼),(½,½)} and the sub-table includes parameter combinations associated with if ({pᵥ}_{v=1,2}, {pᵥ}_{v=3,4})={(⅛, 1/16),(¼,⅛),(¼,¼),(½,¼)} in Table 3.
In one example, [symbol] ={(⅛, 1/16),(¼,⅛),(¼,¼),(½,¼),(½,½)} and the sub-table includes parameter combinations associated with if ({pᵥ}_{v=1,2}, {pᵥ}_{v=3,4})={(⅛, 1/16),(¼,⅛),(¼,¼),(½,¼),(½,½)} in Table 3.
In one example, [symbol] ={(¼,⅛),(¼,¼),(½,¼),(½,½)} and the sub-table includes parameter combinations associated with if ({pᵥ}_{v=1,2},{pᵥ}_{v=3,4})={(¼,⅛),(¼,¼),(½,¼),(½,½)} in Table 3.

In another embodiment, any table including at least one of parameter combinations in a sub-table of Table 3 can be used for the table of ‘paramCombination-r18’, where the sub-table includes parameter combinations associated with β∈ [symbol] , where [symbol] is a subset of [symbol] . For example, if [symbol] ={⅛,¼,½,¾}, the sub-table includes the parameter combinations associated with β=⅛,¼,½,¾, in Table 3.
In one example, [symbol] ={¼,½,¾} and the sub-table includes parameter combinations associated with β=¼,½,¾ in Table 3.
In one example, [symbol] ={⅛,¼,½,¾}, and the sub-table includes parameter combinations associated with β=⅛,¼,½,¾ in Table 3.
In one example, [symbol] ={⅛,¼,½,¾,1} and the sub-table includes parameter combinations associated with β=⅛,¼,½,¾,1 in Table 3.
In one example, [symbol] ={¼,½,¾,1} and the sub-table includes parameter combinations associated with β=¼,½,¾,1 in Table 3.
In one example, [symbol] ={⅛,¼,½} and the sub-table includes parameter combinations associated with β=⅛,¼,½ in Table 3.

In another embodiment, any table including at least one of parameter combinations in a sub-table of Table 3 can be used for the table of ‘paramCombination-r18’, where the sub-table includes parameter combinations associated with Lₘₐₓ∈ [symbol] ₘₐₓ and ({pᵥ}_{v=1,2}, {pᵥ}_{v=3,4})∈ [symbol] and β∈ [symbol] , where Lₘₐₓ ∈ [symbol] ₘₐₓ is defined in one or more embodiments described herein, ({pᵥ}_{v=1,2}, {pᵥ}_{v=3,4})∈ [symbol] is defined in one or more embodiments described herein, and β∈ [symbol] is defined in one or more embodiments described herein.

In one example, the sub-table includes parameter combinations associated with:
Lₘₐₓ ∈ [symbol] ₘₐₓ={8,10,12,14,16} and ({pᵥ}_{v=1,2},{pᵥ}_{v=3,4})∈ [symbol] ={(⅛, 1/16),(¼,⅛),(¼,¼),(½,¼)} and β∈ [symbol] ={⅛,¼,½,¾} for N_{TRP}=4,
[symbol] ₘₐₓ={6,8,10,12} and ({pᵥ}_{v=1,2}, {pᵥ}_{v=3,4})∈ [symbol] {(⅛, 1/16),(¼,⅛),(¼,¼),(½,¼)} and β∈ [symbol] ={⅛,¼,½,¾} for N_{TRP}=3,
[symbol] ₘₐₓ={4,6,8} and ({pᵥ}_{v=1,2},{pᵥ}_{v=3,4})∈ [symbol] ={(⅛, 1/16),(¼,⅛),(¼,¼),(½,¼)} and β∈={⅛,¼,½,¾} for N_{TRP}=2, and
[symbol] ₘₐₓ={2,4} and ({pᵥ}_{v=1,2},{pᵥ}_{v=3,4})∈ [symbol] ={(⅛, 1/16),(¼,⅛),(¼,¼),(½,¼)} and β= [symbol] {⅛,¼,½,¾} for N_{TRP}=1.

In another embodiment, a subset of parameter combinations in a table designed based on embodiment 1 for the table of ‘paramCombination-r18’ can be restricted not to configure based on one or more aspects such as a number of TRPs (N_{TRP}), a number of SBs K (numberOfPMI-SubbandsPerCQI-Subband), and a number of CSI-RS ports (N₁N₂ or P_{CSI-RS}).

In one example, the parameter combination with Lₙ=4 or/and 6 for any n can be used/reported (by the UE 116) or configured (by the NW 130) under a condition.
In one example (C1), the condition corresponds to the case when number of CSI-RS ports (for a TRP)=32.
In one example (C2), the condition corresponds to the case when number of CSI-RS ports (for a TRP)≥t, where t is a threshold, which can be fixed, configured, or subject to UE capability.
In one example (C3), the condition corresponds to the case when number of CSI-RS ports (for a TRP)>t, where t is a threshold, which can be fixed, configured, or subject to UE capability.
In one example (C4), the condition corresponds to the case when N_{TRP}<3 (i.e., N_{TRP}=1,2).
In one example (C5), the condition corresponds to the case when N_{TRP}<s, where s is a threshold, which can be fixed, or configured, or subject to UE capability.
In one example (C6), the condition corresponds to the case when N_{TRP}≤s, where s is a threshold, which can be fixed, or configured, or subject to UE capability.
In one example (C7), the condition corresponds to the case when N_{TRP}>s, where s is a threshold, which can be fixed, or configured, or subject to UE capability.
In one example (C8), the condition corresponds to the case when N_{TRP}>s, where s is a threshold, which can be fixed, or configured, or subject to UE capability.
In one example (C9), the condition corresponds to the case when K<k, where k is a threshold, which can be fixed, or configured, or subject to UE capability.
In one example (C10), the condition corresponds to the case when K≤k, where k is a threshold, which can be fixed, or configured, or subject to UE capability.
In one example (C11), the condition corresponds to the case when K>k, where k is a threshold, which can be fixed, or configured, or subject to UE capability.
In one example (C12), the condition corresponds to the case when K≥k, where k is a threshold, which can be fixed, or configured, or subject to UE capability.
In one example (C13), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction).
In one example (C10), the condition corresponds to C1 or/and C2 or/and C3 or/and C4 or/and C5 or/and C6 or/and C7 or/and C8 or/and C9 or/and C10 or/and C11 or/and C12 and the value of R is 1 (e.g., configured via higher layer numberOfPMIsubbandPerCQIsubband).
In one example (C11), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction), and the value of R is 1 (e.g., configured via higher layer numberOfPMIsubbandPerCQIsubband).

In one example, the parameter combination with p_{υ}=½ for any n can be used/reported (by the UE 116) or configured (by the NW 130) under a condition.
In one example (C1), the condition corresponds to the case when number of CSI-RS ports (for a TRP)=32.
In one example (C2), the condition corresponds to the case when number of CSI-RS ports (for a TRP)≥t, where t is a threshold, which can be fixed, or configured, or subject to UE capability.
In one example (C3), the condition corresponds to the case when number of CSI-RS ports (for a TRP)>t, where t is a threshold, which can be fixed, or configured, or subject to UE capability.
In one example (C4), the condition corresponds to the case when N_{TRP}<3 (i.e., N_{TRP}=1,2).
In one example (C5), the condition corresponds to the case when N_{TRP}<s, where s is a threshold, which can be fixed, or configured, or subject to UE capability.
In one example (C6), the condition corresponds to the case when N_{TRP}≤s, where s is a threshold, which can be fixed, or configured, or subject to UE capability.
In one example (C7), the condition corresponds to the case when N_{TRP}>s, where s is a threshold, which can be fixed, or configured, or subject to UE capability.
In one example (C8), the condition corresponds to the case when N_{TRP}≥s, where s is a threshold, which can be fixed, or configured, or subject to UE capability.
In one example (C9), the condition corresponds to the case when K<k, where k is a threshold, which can be fixed, or configured, or subject to UE capability.
In one example (C10), the condition corresponds to the case when K≤k, where k is a threshold, which can be fixed, or configured, or subject to UE capability.
In one example (C11), the condition corresponds to the case when K>k, where k is a threshold, which can be fixed, or configured, or subject to UE capability.
In one example (C12), the condition corresponds to the case when K≥k, where k is a threshold, which can be fixed, or configured, or subject to UE capability.
In one example (C13), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting is 2 (e.g., configured via RI-restriction).
In one example (C14), the condition corresponds to C1 or/and C2 or/and C3 or/and C4 or/and C5 or/and C6 or/and C7 or/and C8 or/and C9 or/and C10 or/and C11 or/and C12 and the value of R is 1 (e.g., configured via higher layer numberOfPMIsubbandPerCQIsubband).
In one example (C15), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction), and the value of R is 1 (e.g., configured via higher layer numberOfPMIsubbandPerCQIsubband).

In one example, the parameter combination with p_{υ}= 1/16 and/or pᵥ=⅛ for any n can be used/reported (by the UE 116) or configured (by the NW 130) under a condition.
In one example (C1), the condition corresponds to the case when number of CSI-RS ports (for a TRP)=32.
In one example (C2), the condition corresponds to the case when number of CSI-RS ports (for a TRP)≥t, where t is a threshold, which can be fixed, configured, or subject to UE capability.
In one example (C3), the condition corresponds to the case when number of CSI-RS ports (for a TRP)>t, where t is a threshold, which can be fixed, configured, or subject to UE capability.
In one example (C4), the condition corresponds to the case when N_{TRP}<3 (i.e., N_{TRP}=1,2).
In one example (C5), the condition corresponds to the case when N_{TRP}<s, where s is a threshold, which can be fixed, or configured, or subject to UE capability.
In one example (C6), the condition corresponds to the case when N_{TRP}≤s, where s is a threshold, which can be fixed, or configured, or subject to UE capability.
In one example (C7), the condition corresponds to the case when N_{TRP}>s, where s is a threshold, which can be fixed, or configured, or subject to UE capability.
In one example (C8), the condition corresponds to the case when N_{TRP}>s, where s is a threshold, which can be fixed, or configured, or subject to UE capability.
In one example (C9), the condition corresponds to the case when K<k, where k is a threshold, which can be fixed, or configured, or subject to UE capability.
In one example (C10), the condition corresponds to the case when K≤k, where k is a threshold, which can be fixed, or configured, or subject to UE capability.
In one example (C11), the condition corresponds to the case when K>k, where k is a threshold, which can be fixed, or configured, or subject to UE capability.
In one example (C12), the condition corresponds to the case when K≥k, where k is a threshold, which can be fixed, or configured, or subject to UE capability.
In one example (C13), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction).
In one example (C14), the condition corresponds to C1 or/and C2 or/and C3 or/and C4 or/and C5 or/and C6 or/and C7 or/and C8 or/and C9 or/and C10 or/and C11 or/and C12) and the value of R is 1 (e.g., configured via higher layer numberOfPMIsubbandPerCQIsubband).
In one example (C15), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction), and the value of R is 1 (e.g., configured via higher layer numberOfPMIsubbandPerCQIsubband).

In one example, the parameter combination with β=½ or/and ¾ or/and 1 for any n can be used/reported (by the UE 116) or configured (by the NW 130) under a condition.
In one example (C1), the condition corresponds to the case when number of CSI-RS ports (for a TRP)=32.
In one example (C2), the condition corresponds to the case when number of CSI-RS ports (for a TRP)≥t, where t is a threshold, which can be fixed, configured, or subject to UE capability.
In one example (C3), the condition corresponds to the case when number of CSI-RS ports (for a TRP)>t, where t is a threshold, which can be fixed, configured, or subject to UE capability.
In one example (C4), the condition corresponds to the case when N_{TRP}<3 (i.e., N_{TRP}=1,2).
In one example (C5), the condition corresponds to the case when N_{TRP}<s, where s is a threshold, which can be fixed, or configured, or subject to UE capability.
In one example (C6), the condition corresponds to the case when N_{TRP}≤s, where s is a threshold, which can be fixed, or configured, or subject to UE capability.
In one example (C7), the condition corresponds to the case when N_{TRP}>s, where s is a threshold, which can be fixed, or configured, or subject to UE capability.
In one example (C8), the condition corresponds to the case when N_{TRP}>s, where s is a threshold, which can be fixed, or configured, or subject to UE capability.
In one example (C9), the condition corresponds to the case when K<k, where k is a threshold, which can be fixed, or configured, or subject to UE capability.
In one example (C10), the condition corresponds to the case when K≤k, where k is a threshold, which can be fixed, or configured, or subject to UE capability.
In one example (C11), the condition corresponds to the case when K>k, where k is a threshold, which can be fixed, or configured, or subject to UE capability.
In one example (C12), the condition corresponds to the case when K≥k, where k is a threshold, which can be fixed, or configured, or subject to UE capability.
In one example (C13), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction).
In one example (C14), the condition corresponds to C1 or/and C2 or/and C3 or/and C4 or/and C5 or/and C6 or/and C7 or/and C8 or/and C9 or/and C10 or/and C11 or/and C12 and the value of R is 1 (e.g., configured via higher layer numberOfPMIsubbandPerCQIsubband).
In one example (C15), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction), and the value of R is 1 (e.g., configured via higher layer numberOfPMIsubbandPerCQIsubband).

In one example, the parameter combination with Lₙ=4 or/and 6 or/and p_{υ}=½ or/and ⅛ or/and 1/16 for any n can be used/reported (by the UE 116) or configured (by the NW 130) under a condition.
In one example (C1), the condition corresponds to the case when number of CSI-RS ports (for a TRP)=32.
In one example (C2), the condition corresponds to the case when number of CSI-RS ports (for a TRP)≥t, where t is a threshold, which can be fixed, configured, or subject to UE capability.
In one example (C3), the condition corresponds to the case when number of CSI-RS ports (for a TRP)>t, where t is a threshold, which can be fixed, configured, or subject to UE capability.
In one example (C4), the condition corresponds to the case when N_{TRP}<3 (i.e., N_{TRP}=1,2).
In one example (C5), the condition corresponds to the case when N_{TRP}<s, where s is a threshold, which can be fixed, or configured, or subject to UE capability.
In one example (C6), the condition corresponds to the case when N_{TRP}≤s, where s is a threshold, which can be fixed, or configured, or subject to UE capability.
In one example (C7), the condition corresponds to the case when N_{TRP}>s, where s is a threshold, which can be fixed, or configured, or subject to UE capability.
In one example (C8), the condition corresponds to the case when N_{TRP}>s, where s is a threshold, which can be fixed, or configured, or subject to UE capability.
In one example (C9), the condition corresponds to the case when K<k, where k is a threshold, which can be fixed, or configured, or subject to UE capability.
In one example (C10), the condition corresponds to the case when K≤k, where k is a threshold, which can be fixed, or configured, or subject to UE capability.
In one example (C11), the condition corresponds to the case when K>k, where k is a threshold, which can be fixed, or configured, or subject to UE capability.
In one example (C12), the condition corresponds to the case when K≥k, where k is a threshold, which can be fixed, or configured, or subject to UE capability.
In one example (C13), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction).
In one example (C14), the condition corresponds to C1 or/and C2 or/and C3 or/and C4 or/and C5 or/and C6 or/and C7 or/and C8 or/and C9 or/and C10 or/and C11 or/and C12 and the value of R is 1 (e.g., configured via higher layer numberOfPMIsubbandPerCQIsubband).
In one example (C15), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction), and the value of R is 1 (e.g., configured via higher layer numberOfPMIsubbandPerCQIsubband).

In one example, the parameter combination with Lₙ=4 or/and 6 or/and β=½ or/and ¾ or/and 1 for any n can be used/reported (by the UE 116) or configured (by the NW 130) under a condition.
In one example (C1), the condition corresponds to the case when number of CSI-RS ports (for a TRP)=32.
In one example (C2), the condition corresponds to the case when number of CSI-RS ports (for a TRP)≥t, where t is a threshold, which can be fixed, configured, or subject to UE capability.
In one example (C3), the condition corresponds to the case when number of CSI-RS ports (for a TRP)>t, where t is a threshold, which can be fixed, configured, or subject to UE capability.
In one example (C4), the condition corresponds to the case when N_{TRP}<3 (i.e., N_{TRP}=1,2).
In one example (C5), the condition corresponds to the case when N_{TRP}<s, where s is a threshold, which can be fixed, or configured, or subject to UE capability.
In one example (C6), the condition corresponds to the case when N_{TRP}≤s, where s is a threshold, which can be fixed, or configured, or subject to UE capability.
In one example (C7), the condition corresponds to the case when N_{TRP}>s, where s is a threshold, which can be fixed, or configured, or subject to UE capability.
In one example (C8), the condition corresponds to the case when N_{TRP}>s, where s is a threshold, which can be fixed, or configured, or subject to UE capability.
In one example (C9), the condition corresponds to the case when K<k, where k is a threshold, which can be fixed, or configured, or subject to UE capability.
In one example (C10), the condition corresponds to the case when K≤k, where k is a threshold, which can be fixed, or configured, or subject to UE capability.
In one example (C11), the condition corresponds to the case when K>k, where k is a threshold, which can be fixed, or configured, or subject to UE capability.
In one example (C12), the condition corresponds to the case when K≥k, where k is a threshold, which can be fixed, or configured, or subject to UE capability.
In one example (C13), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction).
In one example (C14), the condition corresponds to C1 or/and C2 or/and C3 or/and C4 or/and C5 or/and C6 or/and C7 or/and C8 or/and C9 or/and C10 or/and C11 or/and C12 and the value of R is 1 (e.g., configured via higher layer numberOfPMIsubbandPerCQIsubband).
In one example (C15), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction), and the value of R is 1 (e.g., configured via higher layer numberOfPMIsubbandPerCQIsubband).

In one example, the parameter combination with p_{υ}=½ or/and ⅛ or/and 1/16 or/and β=½ or/and ¾ or/and 1 for any n can be used/reported (by the UE 116) or configured (by the NW 130) under a condition.
In one example (C1), the condition corresponds to the case when number of CSI-RS ports (for a TRP)=32.
In one example (C2), the condition corresponds to the case when number of CSI-RS ports (for a TRP)≥t, where t is a threshold, which can be fixed, configured, or subject to UE capability.
In one example (C3), the condition corresponds to the case when number of CSI-RS ports (for a TRP)>t, where t is a threshold, which can be fixed, configured, or subject to UE capability.
In one example (C4), the condition corresponds to the case when N_{TRP}<3 (i.e., N_{TRP}=1,2).
In one example (C5), the condition corresponds to the case when N_{TRP}<s, where s is a threshold, which can be fixed, or configured, or subject to UE capability.
In one example (C6), the condition corresponds to the case when N_{TRP}≤s, where s is a threshold, which can be fixed, or configured, or subject to UE capability.
In one example (C7), the condition corresponds to the case when N_{TRP}>s, where s is a threshold, which can be fixed, or configured, or subject to UE capability.
In one example (C8), the condition corresponds to the case when N_{TRP}>s, where s is a threshold, which can be fixed, or configured, or subject to UE capability.
In one example (C9), the condition corresponds to the case when K<k, where k is a threshold, which can be fixed, or configured, or subject to UE capability.
In one example (C10), the condition corresponds to the case when K≤k, where k is a threshold, which can be fixed, or configured, or subject to UE capability.
In one example (C11), the condition corresponds to the case when K>k, where k is a threshold, which can be fixed, or configured, or subject to UE capability.
In one example (C12), the condition corresponds to the case when K≥k, where k is a threshold, which can be fixed, or configured, or subject to UE capability.
In one example (C13), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction).
In one example (C14), the condition corresponds to C1 or/and C2 or/and C3 or/and C4 or/and C5 or/and C6 or/and C7 or/and C8 or/and C9 or/and C10 or/and C11 or/and C12 and the value of R is 1 (e.g., configured via higher layer numberOfPMIsubbandPerCQIsubband).
In one example (C15), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction), and the value of R is 1 (e.g., configured via higher layer numberOfPMIsubbandPerCQIsubband).

In one example, the parameter combination with Lₙ=4 or/and 6 or/and p_{υ}=½ or/and ⅛ or/and 1/16 or/and β=½ or/and ¾ or/and 1 for any n can be used/reported (by the UE 116) or configured (by the NW 130) under a condition.
In one example (C1), the condition corresponds to the case when number of CSI-RS ports (for a TRP)=32.
In one example (C2), the condition corresponds to the case when number of CSI-RS ports (for a TRP)≥t, where t is a threshold, which can be fixed, configured, or subject to UE capability.
In one example (C3), the condition corresponds to the case when number of CSI-RS ports (for a TRP)>t, where t is a threshold, which can be fixed, configured, or subject to UE capability.
In one example (C4), the condition corresponds to the case when N_{TRP}<3 (i.e., N_{TRP}=1,2).
In one example (C5), the condition corresponds to the case when N_{TRP}<s, where s is a threshold, which can be fixed, or configured, or subject to UE capability.
In one example (C6), the condition corresponds to the case when N_{TRP}≤s, where s is a threshold, which can be fixed, or configured, or subject to UE capability.
In one example (C7), the condition corresponds to the case when N_{TRP}>s, where s is a threshold, which can be fixed, or configured, or subject to UE capability.
In one example (C8), the condition corresponds to the case when N_{TRP}>s, where s is a threshold, which can be fixed, or configured, or subject to UE capability.
In one example (C9), the condition corresponds to the case when K<k, where k is a threshold, which can be fixed, or configured, or subject to UE capability.
In one example (C10), the condition corresponds to the case when K≤k, where k is a threshold, which can be fixed, or configured, or subject to UE capability.
In one example (C11), the condition corresponds to the case when K>k, where k is a threshold, which can be fixed, or configured, or subject to UE capability.
In one example (C12), the condition corresponds to the case when K≥k, where k is a threshold, which can be fixed, or configured, or subject to UE capability.
In one example (C13), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction).
In one example (C14), the condition corresponds to C1 or/and C2 or/and C3 or/and C4 or/and C5 or/and C6 or/and C7 or/and C8 or/and C9 or/and C10 or/and C11 or/and C12 and the value of R is 1 (e.g., configured via higher layer numberOfPMIsubbandPerCQIsubband).
In one example (C15), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction), and the value of R is 1 (e.g., configured via higher layer numberOfPMIsubbandPerCQIsubband).

In one example, any table constructed in a way that one of the examples described in the present disclosure and without the column of Lₘₐₓ can be an example for a table of ‘paraCombination-r18’.

For example, a table including at least one of the combinations in the following table can be an example for a table of ‘paraCombination-r18’.

TABLE 4

| | p_{υ} | | |
|---|---|---|---|
| | υ | υ | |
| paramCombination-r18 | ∈ {1, 2} | ∈ {3, 4} | β |
| 1 | 1/16 | 1/32 | ⅛ |
| 2 | 1/16 | 1/32 | ¼ |
| 3 | 1/16 | 1/32 | ½ |
| 4 | 1/16 | 1/32 | ¾ |
| 5 | 1/16 | 1/32 | 1 |
| 6 | 1/16 | 1/16 | ⅛ |
| 7 | 1/16 | 1/16 | ¼ |
| 8 | 1/16 | 1/16 | ½ |
| 9 | 1/16 | 1/16 | ¾ |
| 10 | 1/16 | 1/16 | 1 |
| 11 | ⅛ | 1/16 | ⅛ |
| 12 | ⅛ | 1/16 | ¼ |
| 13 | ⅛ | 1/16 | ½ |
| 14 | ⅛ | 1/16 | ¾ |
| 15 | ⅛ | 1/16 | 1 |
| 16 | ⅛ | ⅛ | ⅛ |
| 17 | ⅛ | ⅛ | ½ |
| 18 | ⅛ | ⅛ | ½ |
| 19 | ⅛ | ⅛ | ¾ |
| 20 | ⅛ | ⅛ | 1 |
| 21 | ¼ | ⅛ | ⅛ |
| 22 | ¼ | ⅛ | ¼ |
| 23 | ¼ | ⅛ | ½ |
| 24 | ¼ | ⅛ | ¾ |
| 25 | ¼ | ⅛ | 1 |
| 26 | ¼ | ¼ | ⅛ |
| 27 | ¼ | ¼ | ¼ |
| 28 | ¼ | ¼ | ½ |
| 29 | ¼ | ¼ | ¾ |
| 30 | ¼ | ¼ | 1 |
| 31 | ⅜ | 3/16 | ⅛ |
| 32 | ⅜ | 3/16 | ¼ |
| 33 | ⅜ | 3/16 | ½ |
| 34 | ⅜ | 3/16 | ¾ |
| 35 | ⅜ | 3/16 | 1 |
| 36 | ⅜ | ⅜ | ⅛ |
| 37 | ⅜ | ⅜ | ¼ |
| 38 | ⅜ | ⅜ | ½ |
| 39 | ⅜ | ⅜ | ¾ |
| 40 | ⅜ | ⅜ | 1 |
| 41 | ½ | ¼ | ⅛ |
| 42 | ½ | ¼ | ¼ |
| 43 | ½ | ¼ | ½ |
| 44 | ½ | ¼ | ¾ |
| 45 | ½ | ¼ | 1 |
| 46 | ½ | ½ | ⅛ |
| 47 | ½ | ½ | ½ |
| 48 | ½ | ½ | ½ |
| 49 | ½ | ½ | ¾ |
| 50 | ½ | ½ | 1 |

In one embodiment, a table for (pᵥ, β) (which can be one of the possible tables described in the present disclosure) includes at least one of the (pᵥ, β) combinations shown in the following table:

TABLE 5

p_{υ}

| label | Index | ν ∈ {1, 2} | ν ∈ {3, 4} | β |
|---|---|---|---|---|
| C1 | 1 | ⅛ | 1/16 | ⅛ |
| C2 | 2 | ⅛ | 1/16 | ¼ |
| C3 | 3 | ⅛ | 1/16 | ½ |
| C4 | 4 | ¼ | ⅛ | ¼ |
| C5 | 5 | ¼ | ⅛ | ½ |
| C6 | 6 | ½ | ¼ | ¼ |
| C7 | 7 | ½ | ¼ | ½ |
| C8 | 8 | ¼ | ¼ | ¾ |
| C9 | 9 | ½ | ½ | ½ |
| C10 | 10 | ¼ | ¼ | ¼ |
| C11 | 11 | ¼ | ¼ | a |
| C12 | 12 | ½ | ½ | b |

In one example, a in C11 is fixed, e.g., ½ or (½+¾)/2=⅝. In another example, a is ¼ or ⅛.

In one example, b in C12 is fixed, e.g., ¼ or (½+¼)/2=⅜. In another example, b is ⅛.

In one example, a supported number of combinations for the table of (pᵥ, β) is at most S, e.g., S=8, and at least T of C2-C5 combinations, where 1<T<4, or one of C2-C5 or each of the C2-C5 combinations in Table 5 are included in the at most S combinations. In addition, among the remaining (12-T) combinations in Table 5 (i.e., C1, C7-C12), at least one combination is/are included the at most S combinations. In one example, each of the C2-C5 combinations in Table 5 are included (i.e., T=4) in the at most S combinations.
In one example, one of the remaining (pᵥ, β) combinations in Table 5 (i.e., C1, C7-C12) is included in the at most S combinations.

$$( ( \begin{matrix}7 \\ 1\end{matrix} )$$

examples are omitted.)
In one example, two of the remaining (pᵥ, β) combinations in Table 5 (i.e., C1, C7-C12) are included in the at most S combinations.

$$( ( \begin{matrix}7 \\ 2\end{matrix} )$$

examples are omitted.)
In one example three of the remaining (pᵥ, β) combinations in Table 5 (i.e., C1, C7-C12) are included in the at most S combinations

$$( ( \begin{matrix}7 \\ 3\end{matrix} )$$

examples are omitted.)
In one example four of the remaining (pᵥ, β) combinations in Table 5 (i.e., C1, C7-C12) are included in the at most S combinations

$$( ( \begin{matrix}7 \\ 4\end{matrix} )$$

examples are omitted.)
In one example five of the remaining (pᵥ, β) combinations in Table 5 (i.e., C1, C7-C12) are included in the at most S combinations.

$$( ( \begin{matrix}7 \\ 5\end{matrix} )$$

examples are omitted.)
In one example six of the remaining (pᵥ, β) combinations in Table 5 (i.e., C1, C7-C12) are included in the at most S combinations.

$$( ( \begin{matrix}7 \\ 6\end{matrix} )$$

examples are omitted.)
In one example each of the remaining (pᵥ, β) combinations in Table 5 (i.e., C1, C7-C12) are included in the at most S combinations.

In one example, there is restriction on configuring C7 in Table 5, where the restriction is associated with (related to/based on) {Lₙ}.
In one example, the UE 116 is expected to be configured with C7 when Lₙ≤x. For example, x can be only one of x=2, x=4, or x=6.
In one example, the UE 116 is not expected to be configured with C7 when Lₙ<x. For example, x can be only one of x=2, x=4, or x=6.
In one example, the UE 116 is expected to be configured with C7 when Lₙ>x. For example, x can be only one of x=2, x=4, or x=6.
In one example, the UE 116 is not expected to be configured with C7 when Lₙ>x. For example, x can be only one of x=2, x=4, or x=6.
In one example, the UE 116 is expected to be configured with C7 when Lₙ=x. For example, x can be only one of x=2, x=4, or x=6.
In one example, the UE 116 is not expected to be configured with C7 when Lₙ=x. For example, x can be only one of x=2, x=4, or x=6.
In one example, the UE 116 is expected to be configured with C7 when Lₙ=x. For example, x can be only one of x=2, x=4, or x=6.
In one example, the UE 116 is not expected to be configured with C7 when Lₙ=x. For example, x can be only one of x=2, x=4, or x=6.
In one example, the UE 116 is expected to be configured with C7 when Lₙ<x. For example, x can be only one of x=2, x=4, or x=6.
In one example, the UE 116 is not expected to be configured with C7 when Lₙ<x. For example, x can be only one of x=2, x=4, or x=6.
In one example the UE 116 is expected to be configured with C7 when Lₙ>x. For example, x can be only one of x=2, x=4, or x=6.
In one example, the UE 116 is not expected to be configured with C7 when Lₙ>x. For example, x can be only one of x=2, x=4, or x=6.
In one example, the UE 116 is expected to be configured with C7 when x≤Lₙ≤y. For example, x can be only one of x=2, x=4, or x=6. For example, y can be only one of y=2, y=4, or y=6.
In one example, the UE 116 is not expected to be configured with C7 when x<Lₙ≤y. For example, x can be only one of x=2, x=4, or x=6. For example, y can be only one of y=2, y=4, or y=6.
In one example, the UE 116 is expected to be configured with C7 when x<Lₙ≤y. For example, x can be only one of x=2, x=4, or x=6. For example, y can be only one of y=2, y=4, or y=6.
In one example, the UE 116 is not expected to be configured with C7 when x<Lₙ≤y. For example, x can be only one of x=2, x=4, or x=6. For example, y can be only one of y=2, y=4, or y=6.
In one example, the UE 116 is expected to be configured with C7 when x<Lₙ<y. For example, x can be only one of x=2, x=4, or x=6. For example, y can be only one of y=2, y=4, or y=6.
In one example, the UE 116 is not expected to be configured with C7 when x<Lₙ<y. For example, x can be only one of x=2, x=4, or x=6. For example, y can be only one of y=2, y=4, or y=6.
In one example, the UE 116 is expected to be configured with C7 when x<Lₙ<y. For example, x can be only one of x=2, x=4, or x=6. For example, y can be only one of y=2, y=4, or y=6.
In one example, the UE 116 is not expected to be configured with C7 when x<Lₙ<y. For example, x can be only one of x=2, x=4, or x=6. For example, y can be only one of y=2, y=4, or y=6.
In one example, the UE 116 is expected to be configured with C7 when

$${max}_{n} {L}_{n} \leq x .$$

For example, x can be only one of x=2, x=4, or x=6.
In one example, the UE 116 is expected to be configured with C7 when

$${max}_{n} {L}_{n} \leq x .$$

For example, x can be only one of x=2, x=4, or x=6.
In one example, the UE 116 is expected to be configured with C7 when

$${max}_{n} {L}_{n} \geq x .$$

For example, x can be only one of x=2, x=4, or x=6.
In one example the UE 116 is not expected to be configured with C7 when

$${max}_{n} {L}_{n} \geq x .$$

For example, x can be only one of x=2, x=4, or x=6.
In one example, the UE 116 is expected to be configured with C7 when

$${max}_{n} {L}_{n} = x .$$

For example, x can be only one of x=2, x=4, or x=6.
In one example the UE 116 is not expected to be configured with C7 when

$${max}_{n} {L}_{n} = x .$$

For example, x can be only one of x=2, x=4, or x=6.
In one example the UE 116 is expected to be configured with C7 when

$${max}_{n} {L}_{n} = x .$$

For example, x can be only one of x=2, x=4, or x=6.
In one example, the UE 116 is not expected to be configured with C7 when

$${max}_{n} {L}_{n} = x .$$

For example, x can be only one of x=2, x=4, or x=6.
In one example, the UE 116 is expected to be configured with C7 when

$${max}_{n} {L}_{n} < x .$$

For example, x can be only one of x=2, x=4, or x=6.
In one example, the UE 116 is not expected to be configured with C7 when

$${max}_{n} {L}_{n} < x .$$

For example, x can be only one of x=2, x=4, or x=6.
In one example the UE 116 is expected to be configured with C7 when

$${max}_{n} {L}_{n} > x .$$

For example, x can be only one of x=2, x=4, or x=6.
In one example the UE 116 is not expected to be configured with C7 when

$${max}_{n} {L}_{n} > x .$$

For example, x can be only one of x=2, x=4, or x=6.
In one example, the UE 116 is expected to be configured with C7 when

$$x \leq {max}_{n} {L}_{n} \leq y .$$

For example, x can be only one of x=2, x=4, or x=6. For example, y can be only one of y=2, y=4, or y=6.
In one example, the UE 116 is not expected to be configured with C7 when

$$x \leq {max}_{n} {L}_{n} \leq y .$$

For example, x can be only one of x=2, x=4, or x=6. For example, y can be only one of y=2, y=4, or y=6.
In one example, the UE 116 is expected to be configured with C7 when

$$x < {max}_{n} {L}_{n} \leq y .$$

For example, x can be only one of x=2, x=4, or x=6. For example, y can be only one of y=2, y=4, or y=6.
In one example the UE 116 is not expected to be configured with C7 when

$$x < {max}_{n} {L}_{n} \leq y .$$

For example, x can be only one of x=2, x=4, or x=6. For example, y can be only one of y=2, y=4, or y=6.
In one example, the UE 116 is expected to be configured with C7 when

$$x \leq {max}_{n} {L}_{n} \leq y .$$

For example, x can be only one of x=2, x=4, or x=6. For example, y can be only one of y=2, y=4, or y=6.
In one example the UE 116 is not expected to be configured with C7 when

$$x \leq {max}_{n} {L}_{n} < y .$$

For example, x can be only one of x=2, x=4, or x=6. For example, y can be only one of y=2, y=4, or y=6.
In one example the UE 116 is expected to be configured with C7 when

$$x < {max}_{n} {L}_{n} < y .$$

For example, x can be only one of x=2, x=4, or x=6. For example, y can be only one of y=2, y=4, or y=6.
In one example, the UE 116 is not expected to be configured with C7 when

$$x < {max}_{n} {L}_{n} < y .$$

For example, x can be only one of x=2, x=4, or x=6. For example, y can be only one of y=2, y=4, or y=6.
In one example, the UE 116 is expected to be configured with C7 when Σₙ Lₙ≤x×t or Σₙ Lₙ≤z. For example, x can be only one of x=2, x=4, or x=6. Here, t can be fixed, e.g., t=N_{TRP} or 3. For example, z can be only one of z=2, z=4, . . . , or z=24.
In one example, the UE 116 is not expected to be configured with C7 when Σₙ Lₙ≥x×t or Σₙ Lₙ<z. For example, x can be only one of x=2, x=4, or x=6. Here, t can be fixed, e.g., t=N_{TRP} or 3. For example, z can be only one of z=2, z=4, . . . , or z=24.
In one example, the UE 116 is expected to be configured with C7 when Σₙ Lₙ>x×t or Σₙ Lₙ≥z. For example, x can be only one of x=2, x=4, or x=6. Here, t can be fixed, e.g., t=N_{TRP} or 3. For example, z can be only one of z=2, z=4, . . . , or z=24.
In one example, the UE 116 is not expected to be configured with C7 when Σₙ Lₙ≥x×t or Σₙ Lₙ>z. For example, x can be only one of x=2, x=4, or x=6. Here, t can be fixed, e.g., t=N_{TRP} or 3. For example, z can be only one of z=2, z=4, . . . , or z=24.
In one example, the UE 116 is expected to be configured with C7 when Σₙ Lₙ=x×t or Σₙ Lₙ=z. For example, x can be only one of x=2, x=4, or x=6. Here, t can be fixed, e.g., t=N_{TRP} or 3. For example, z can be only one of z=2, z=4, . . . , or z=24.
In one example, the UE 116 is not expected to be configured with C7 when Σₙ Lₙ=x×t or Σₙ Lₙ=z. For example, x can be only one of x=2, x=4, or x=6. Here, t can be fixed, e.g., t=N_{TRP} or 3. For example, z can be only one of z=2, z=4, . . . , or z=24.
In one example, the UE 116 is expected to be configured with C7 when Σₙ Lₙ<x×t or Σₙ Lₙ<z. For example, x can be only one of x=2, x=4, or x=6. Here, t can be fixed, e.g., t=N_{TRP} or 3. For example, z can be only one of z=2, z=4, . . . , or z=24.
In one example, the UE 116 is not expected to be configured with C7 when Σₙ Lₙ<x×t or Σₙ Lₙ<z. For example, x can be only one of x=2, x=4, or x=6. Here, t can be fixed, e.g., t=N_{TRP} or 3. For example, z can be only one of z=2, z=4, . . . , or z=24.
In one example, the UE 116 is expected to be configured with C7 when Σₙ Lₙ>x×t or Σₙ Lₙ>z. For example, x can be only one of x=2, x=4, or x=6. Here, t can be fixed, e.g., t=N_{TRP} or 3. For example, z can be only one of z=2, z=4, . . . , or z=24.
In one example the UE 116 is not expected to be configured with C7 when Σₙ Lₙ>x×t or Σₙ Lₙ>z. For example, x can be only one of x=2, x=4, or x=6. Here, t can be fixed, e.g., t=N_{TRP} or 3. For example, z can be only one of z=2, z=4, . . . , or z=24.
In one example, the UE 116 is expected to be configured with C7 when x×t Σₙ Lₙ≤y×t or z₁≤Σₙ Lₙ≤z₂. For example, x can be only one of x=2, x=4, or x=6. For example, y can be only one of y=2, y=4, or y=6. Here, t can be fixed, e.g., t=N_{TRP} or 3. For example, z₁ can be only one of z=2, z=4, . . . , or z=24. For example, z₂ can be only one of z=2, z=4, . . . , or z=24.
In one example, the UE 116 is not expected to be configured with C7 when x×t≤Σₙ Lₙ≤y×t or z₁≤Σₙ Lₙ≤z₂. For example, x can be only one of x=2, x=4, or x=6. For example, y can be only one of y=2, y=4, or y=6. Here, t can be fixed, e.g., t=N_{TRP} or 3. For example, z₁ can be only one of z=2, z=4, . . . , or z=24. For example, z₂ can be only one of z=2, z=4, . . . , or z=24.
In one example, the UE 116 is expected to be configured with C7 when x×t<Σₙ Lₙ≤y×t or z₁<Σₙ Lₙ≤z₂. For example, x can be only one of x=2, x=4, or x=6. For example, y can be only one of y=2, y=4, or y=6. Here, t can be fixed, e.g., t=N_{TRP} or 3. For example, z₁ can be only one of z=2, z=4, . . . , or z=24. For example, z₂ can be only one of z=2, z=4, . . . , or z=24.
In one example, the UE 116 is not expected to be configured with C7 when x×t<Σₙ Lₙ≤y×t or z₁<Σₙ Lₙ≤z₂. For example, x can be only one of x=2, x=4, or x=6. For example, y can be only one of y=2, y=4, or y=6. Here, t can be fixed, e.g., t=N_{TRP} or 3. For example, z₁ can be only one of z=2, z=4, . . . , or z=24. For example, z₂ can be only one of z=2, z=4, . . . , or z=24.
In one example, the UE 116 is expected to be configured with C7 when x×t≤Σₙ Lₙ<y×t or z₁Σₙ Lₙ<z₂. For example, x can be only one of x=2, x=4, or x=6. For example, y can be only one of y=2, y=4, or y=6. Here, t can be fixed, e.g., t=N_{TRP} or 3. For example, z₁ can be only one of z=2, z=4, . . . , or z=24. For example, z₂ can be only one of z=2, z=4, . . . , or z=24.
In one example, the UE 116 is not expected to be configured with C7 when x×t≤Σₙ Lₙ<y×t or z₁≤Σₙ Lₙ<z₂. For example, x can be only one of x=2, x=4, or x=6. For example, y can be only one of y=2, y=4, or y=6. Here, t can be fixed, e.g., t=N_{TRP} or 3. For example, z₁ can be only one of z=2, z=4, . . . , or z=24. For example, z₂ can be only one of z=2, z=4, . . . , or z=24.
In one example, the UE 116 is expected to be configured with C7 when x×t<Σₙ Lₙ<y×t or z₁<Σₙ Lₙ<z₂. For example, x can be only one of x=2, x=4, or x=6. For example, y can be only one of y=2, y=4, or y=6. Here, t can be fixed, e.g., t=N_{TRP} or 3. For example, z₁ can be only one of z=2, z=4, . . . , or z=24. For example, z₂ can be only one of z=2, z=4, . . . , or z=24.
In one example the UE 116 is not expected to be configured with C7 when x×t<Σₙ Lₙ<y×t or z₁<Σₙ Lₙ<z₂. For example, x can be only one of x=2, x=4, or x=6. For example, y can be only one of y=2, y=4, or y=6. Here, t can be fixed, e.g., t=N_{TRP} or 3. For example, z₁ can be only one of z=2, z=4, . . . , or z=24. For example, z₂ can be only one of z=2, z=4, . . . , or z=24.
In one example, the UE 116 is expected to be configured with C7 when s∈S₀ is configured, where S₀ is an index or a set of multiple indices, each index indicates, or corresponds to a combination of {Lₙ} from a table of {Lₙ}.
In one example, the UE 116 is not expected to be configured with C7 when s∈S₀ is configured, where S₀ is an index or a set of multiple indices, each index indicates, or corresponds to a combination of {Lₙ} from a table of {Lₙ}.

In one example, S₀ can be per (pᵥ, β) combination, i.e., case for C7. For example, linkage between a list/table of {Lₙ} combinations (which can be one of the possible tables described in the present disclosure) and a list/table of (pᵥ,β) combinations (which can be one of the possible tables described in the present disclosure) can be via pairing each combination for (pᵥ, β) with at least one combination for {Lₙ}. For example, S₀, . . . , S_{S-1} index sets can be used for linking each combination for (pᵥ, β) with at least one combination for {Lₙ}.

In one example, there is restriction on configuring C7 according to one of the examples herein. In addition, the restriction is UE-optional, i.e., the restriction is on/off depending on UE capability. The UE 116 reports its capability on the restriction, whether it is necessary or not, and the NW 130 then follows the reported UE capability. For the restriction in each example, the restriction is UE-optional or UE-capability.

In one example, there is restriction on configuring C7 according to one of the examples herein. In addition, the C7 is UE-optional, i.e., C7 can be configured depending on UE capability. The UE 116 reports its capability on the support of C7, and then only the NW 130 can configure C7. This UE-optional feature can correspond to a separate UE capability.

In one example, there is restriction on configuring C7 in Table 5, where the restriction is associated with (related to/based on) N_{L}.
In one example, the UE 116 is expected to be configured with C7 when N_{L}≤x. For example, x can be only one of x=1, x=2, or x=4.
In one example, the UE 116 is not expected to be configured with C7 when N_{L}≤x. For example, x can be only one of x=1, x=2, or x=4.
In one example, the UE 116 is expected to be configured with C7 when N_{L}>x. For example, x can be only one of x=1, x=2, or x=4.
In one example, the UE 116 is not expected to be configured with C7 when N_{L}≥x. For example, x can be only one of x=1, x=2, or x=4.
In one example the UE 116 is expected to be configured with C7 when N_{L}=x. For example, x can be only one of x=1, x=2, or x=4.
In one example, the UE 116 is not expected to be configured with C7 when N_{L}=x. For example, x can be only one of x=1, x=2, or x=4.
In one example, the UE 116 is expected to be configured with C7 when N_{L}<x. For example, x can be only one of x=1, x=2, or x=4.
In one example, the UE 116 is not expected to be configured with C7 when N_{L}<x. For example, x can be only one of x=1, x=2, or x=4.
In one example, the UE 116 is expected to be configured with C7 when N_{L}>x. For example, x can be only one of x=1, x=2, or x=4.
In one example, the UE 116 is not expected to be configured with C7 when N_{L}>x. For example, x can be only one of x=1, x=2, or x=4.
In one example, the UE 116 is expected to be configured with C7 when x≤N_{L}≤y. For example, x can be only one of x=1, x=2, or x=4. For example, y can be only one of y=1, y=2, or y=4.
In one example, the UE 116 is not expected to be configured with C7 when x≤N_{L}≤y. For example, x can be only one of x=1, x=2, or x=4. For example, y can be only one of y=1, y=2, or y=4.
In one example, the UE 116 is expected to be configured with C7 when x<N_{L}≤y. For example, x can be only one of x=1, x=2, or x=4. For example, y can be only one of y=1, y=2, or y=4.
In one example, the UE 116 is not expected to be configured with C7 when x<N_{L}≤y. For example, x can be only one of x=1, x=2, or x=4. For example, y can be only one of y=1, y=2, or y=4.
In one example, the UE 116 is expected to be configured with C7 when x≤N_{L}<y. For example, x can be only one of x=1, x=2, or x=4. For example, y can be only one of y=1, y=2, or y=4.
In one example, the UE 116 is not expected to be configured with C7 when x≤N_{L}<y. For example, x can be only one of x=1, x=2, or x=4. For example, y can be only one of y=1, y=2, or y=4.
In one example, the UE 116 is expected to be configured with C7 when x<N_{L}<y. For example, x can be only one of x=1, x=2, or x=4. For example, y can be only one of y=1, y=2, or y=4.
In one example, the UE 116 is not expected to be configured with C7 when x<N_{L}<y. For example, x can be only one of x=1, x=2, or x=4. For example, y can be only one of y=1, y=2, or y=4.

In one example, there is restriction on configuring C7 according to one of the examples herein. In addition, the restriction is UE-optional, i.e., the restriction is on/off depending on UE capability. The UE 116 reports its capability on the restriction, whether it is necessary or not, and the NW 130 then follows the reported UE capability. For the restriction in each example, the restriction is UE-optional or UE-capability.

In one example, there is restriction on configuring C7 according to one of the examples herein. In addition, the C7 is UE-optional, i.e., C7 can be configured depending on UE capability. The UE 116 reports its capability on the support of C7, and then only the NW 130 can configure C7. This UE-optional feature can correspond to a separate UE capability.

In one example, there is restriction on configuring C7 in Table 5, where the restriction is associated with (related to/based on) P_{CSI-RS}. In one example, P_{CSI-RS} is a number of CSI-RS ports per CSI-RS-resource (per TRP).
In one example, the UE 116 is expected to be configured with C7 when P_{CSI-RS}≤x. For example, x can be only one of x=4, x=8, x=12, x=16, x=24, or x=32.
In one example, the UE 116 is not expected to be configured with C7 when P_{CSI-RS}≤x. For example, x can be only one of x=4, x=8, x=12, x=16, x=24, or x=32.
In one example, the UE 116 is expected to be configured with C7 when P_{CSI-RS}≤x. For example, x can be only one of x=4, x=8, x=12, x=16, x=24, or x=32.
In one example, the UE 116 is not expected to be configured with C7 when P_{CSI-RS}≥x. For example, x can be only one of x=4, x=8, x=12, x=16, x=24, or x=32.
In one example, the UE 116 is expected to be configured with C7 when P_{CSI-RS}=x. For example, x can be only one of x=4, x=8, x=12, x=16, x=24, or x=32.
In one example, the UE 116 is not expected to be configured with C7 when P_{CSI-RS}=x. For example, x can be only one of x=4, x=8, x=12, x=16, x=24, or x=32.
In one example, the UE 116 is expected to be configured with C7 when P_{CSI-RS}<x. For example, x can be only one of x=4, x=8, x=12, x=16, x=24, or x=32.
In one example, the UE 116 is not expected to be configured with C7 when P_{CSI-RS}<x. For example, x can be only one of x=4, x=8, x=12, x=16, x=24, or x=32.
In one example, the UE 116 is expected to be configured with C7 when P_{CSI-RS}>x. For example, x can be only one of x=4, x=8, x=12, x=16, x=24, or x=32.
In one example, the UE 116 is not expected to be configured with C7 when P_{CSI-RS}>x. For example, x can be only one of x=4, x=8, x=12, x=16, x=24, or x=32.
In one example, the UE 116 is expected to be configured with C7 when x≤P_{CSI-RS}≤y. For example, x can be only one of x=4, x=8, x=12, x=16, x=24, or x=32. For example, y can be only one of y=4, y=8, y=12, y=16, y=24, or y=32.
In one example, the UE 116 is not expected to be configured with C7 when x≤P_{CSI-RS}≤y. For example, x can be only one of x=4, x=8, x=12, x=16, x=24, or x=32. For example, y can be only one of y=4, y=8, y=12, y=16, y=24, or y=32.
In one example the UE 116 is expected to be configured with C7 when x<P_{CSI-RS}≤y. For example, x can be only one of x=4, x=8, x=12, x=16, x=24, or x=32. For example, y can be only one of y=4, y=8, y=12, y=16, y=24, or y=32.
In one example, the UE 116 is not expected to be configured with C7 when x<P_{CSI-RS}≤y. For example, x can be only one of x=4, x=8, x=12, x=16, x=24, or x=32. For example, y can be only one of y=4, y=8, y=12, y=16, y=24, or y=32.
In one example, the UE 116 is expected to be configured with C7 when x≤P_{CSI-RS}<y. For example, x can be only one of x=4, x=8, x=12, x=16, x=24, or x=32. For example, y can be only one of y=4, y=8, y=12, y=16, y=24, or y=32.
In one example, the UE 116 is not expected to be configured with C7 when x≤P_{CSI-RS}<y. For example, x can be only one of x=4, x=8, x=12, x=16, x=24, or x=32. For example, y can be only one of y=4, y=8, y=12, y=16, y=24, or y=32.
In one example, the UE 116 is expected to be configured with C7 when x<P_{CSI-RS}<y. For example, x can be only one of x=4, x=8, x=12, x=16, x=24, or x=32. For example, y can be only one of y=4, y=8, y=12, y=16, y=24, or y=32.
In one example, the UE 116 is not expected to be configured with C7 when x<P_{CSI-RS}<y. For example, x can be only one of x=4, x=8, x=12, x=16, x=24, or x=32. For example, y can be only one of y=4, y=8, y=12, y=16, y=24, or y=32.

In one example, there is restriction on configuring C7 according to one of the examples herein. In addition, the restriction is UE-optional, i.e., the restriction is on/off depending on UE capability. The UE 116 reports its capability on the restriction, whether it is necessary or not, and the NW 130 then follows the reported UE capability. For the restriction in each example, the restriction is UE-optional or UE-capability.

In one example, there is restriction on configuring C7 according to one of the examples herein. In addition, the C7 is UE-optional, i.e., C7 can be configured depending on UE capability. The UE 116 reports its capability on the support of C7, and then only the NW 130 can configure C7. This UE-optional feature can correspond to a separate UE capability.

In one example, there is restriction on configuring C7 in Table 5, where the restriction is associated with (related to/based on) v, where v is a number of layers, i.e., rank.
In one example, the UE 116 is expected to be configured with C7 when v≤x. For example, x can be only one of x=1, x=2, x=3, or x=4.
In one example, the UE 116 is not expected to be configured with C7 when v≤x. For example, x can be only one of x=1, x=2, x=3, or x=4.
In one example, the UE 116 is expected to be configured with C7 when v≥x. For example, x can be only one of x=1, x=2, x=3, or x=4.
In one example the UE 116 is not expected to be configured with C7 when v≥x. For example, x can be only one of x=1, x=2, x=3, or x=4.
In one example, the UE 116 is expected to be configured with C7 when v=x. For example, x can be only one of x=1, x=2, x=3, or x=4.
In one example, the UE 116 is not expected to be configured with C7 when v=x. For example, x can be only one of x=1, x=2, x=3, or x=4.
In one example, the UE 116 is expected to be configured with C7 when v<x. For example, x can be only one of x=1, x=2, x=3, or x=4.
In one example, the UE 116 is not expected to be configured with C7 when v<x. For example, x can be only one of x=1, x=2, x=3, or x=4.
In one example, the UE 116 is expected to be configured with C7 when v>x. For example, x can be only one of x=1, x=2, x=3, or x=4.
In one example, the UE 116 is not expected to be configured with C7 when v>x. For example, x can be only one of x=1, x=2, x=3, or x=4.
In one example, the UE 116 is expected to be configured with C7 when x≤v≤y. For example, x can be only one of x=1, x=2, x=3, or x=4. For example, y can be only one of y=1, y=2, y=3, or y=4.
In one example, the UE 116 is not expected to be configured with C7 when x≤v≤y. For example, x can be only one of x=1, x=2, x=3, or x=4. For example, y can be only one of y=1, y=2, y=3, or y=4.
In one example, the UE 116 is expected to be configured with C7 when x<v≤y. For example, x can be only one of x=1, x=2, x=3, or x=4. For example, y can be only one of y=1, y=2, y=3, or y=4.
In one example, the UE 116 is not expected to be configured with C7 when x<v≤y. For example, x can be only one of x=1, x=2, x=3, or x=4. For example, y can be only one of y=1, y=2, y=3, or y=4.
In one example, the UE 116 is expected to be configured with C7 when x≤v<y. For example, x can be only one of x=1, x=2, x=3, or x=4. For example, y can be only one of y=1, y=2, y=3, or y=4.
In one example, the UE 116 is not expected to be configured with C7 when x≤v<y. For example, x can be only one of x=1, x=2, x=3, or x=4. For example, y can be only one of y=1, y=2, y=3, or y=4.
In one example, the UE 116 is expected to be configured with C7 when x<v<y. For example, x can be only one of x=1, x=2, x=3, or x=4. For example, y can be only one of y=1, y=2, y=3, or y=4.
In one example, the UE 116 is not expected to be configured with C7 when x<v<y. For example, x can be only one of x=1, x=2, x=3, or x=4. For example, y can be only one of y=1, y=2, y=3, or y=4.

In one example (D4-a), there is restriction on configuring C7 according to one of the examples herein. In addition, the restriction is UE-optional, i.e., the restriction is on/off depending on UE capability. The UE 116 reports its capability on the restriction, whether it is necessary or not, and the NW 130 then follows the reported UE capability. For the restriction in each example, the restriction is UE-optional or UE-capability.

In one example, there is restriction on configuring C7 according to one of the examples herein. In addition, the C7 is UE-optional, i.e., C7 can be configured depending on UE capability. The UE 116 reports its capability on the support of C7, and then only the NW 130 can configure C7. This UE-optional feature can correspond to a separate UE capability.

In one example, there is restriction on configuring C7 in Table 5, where the restriction is associated with (related to/based on) R, where R is a number of precoders per subband.
In one example, the UE 116 is expected to be configured with C7 when R=1.
In one example, the UE 116 is not expected to be configured with C7 when R=2.
In one example, the UE 116 is expected to be configured with C7 when R>x or R<x. Here x can be fixed or configured or can be subject to UE capability.
In one example, the UE 116 is not expected to be configured with C7 when R>x R≥x. Here x can be fixed or configured or can be subject to UE capability.

In one example, there is restriction on configuring C7 according to one of the examples herein. In addition, the restriction is UE-optional, i.e., the restriction is on/off depending on UE capability. The UE 116 reports its capability on the restriction, whether it is necessary or not, and the NW 130 then follows the reported UE capability. For the restriction in each example, the restriction is UE-optional or UE-capability.

In one example, there is restriction on configuring C7 according to one of the examples herein. In addition, the C7 is UE-optional, i.e., C7 can be configured depending on UE capability. The UE 116 reports its capability on the support of C7, and then only the NW 130 can configure C7. This UE-optional feature can correspond to a separate UE capability.

In one example, there is restriction on configuring C7 in Table 5, where the restriction is associated with (related to/based on) N_{TRP}, where N_{TRP} is a number of TRPs, i.e., a number of CSI-RS resources.
In one example, the UE 116 is expected to be configured with C7 when N_{TRP}≤x. For example, x can be only one of x=1, x=2, x=3, or x=4.
In one example, the UE 116 is not expected to be configured with C7 when N_{TRP}≤x. For example, x can be only one of x=1, x=2, x=3, or x=4.
In one example, the UE 116 is expected to be configured with C7 when N_{TRP}≥x. For example, x can be only one of x=1, x=2, x=3, or x=4.
In one example the UE 116 is not expected to be configured with C7 when N_{TRP}≥x. For example, x can be only one of x=1, x=2, x=3, or x=4.
In one example, the UE 116 is expected to be configured with C7 when N_{TRP}=x. For example, x can be only one of x=1, x=2, x=3, or x=4.
In one example, the UE 116 is not expected to be configured with C7 when N_{TRP}=x. For example, x can be only one of x=1, x=2, x=3, or x=4.
In one example, the UE 116 is expected to be configured with C7 when N_{TRP}<x. For example, x can be only one of x=1, x=2, x=3, or x=4.
In one example, the UE 116 is not expected to be configured with C7 when N_{TRP}<x. For example, x can be only one of x=1, x=2, x=3, or x=4.
In one example, the UE 116 is expected to be configured with C7 when N_{TRP}>x. For example, x can be only one of x=1, x=2, x=3, or x=4.
In one example, the UE 116 is not expected to be configured with C7 when N_{TRP}>x. For example, x can be only one of x=1, x=2, x=3, or x=4.
In one example, the UE 116 is expected to be configured with C7 when x≤N_{TRP}≤y. For example, x can be only one of x=1, x=2, x=3, or x=4. For example, y can be only one of y=1, y=2, y=3, or y=4.
In one example, the UE 116 is not expected to be configured with C7 when x≤N_{TRP}≤y. For example, x can be only one of x=1, x=2, x=3, or x=4. For example, y can be only one of y=1,y=2, y=3, or y=4.
In one example, the UE 116 is expected to be configured with C7 when x<N_{TRP}≤y. For example, x can be only one of x=1, x=2, x=3, or x=4. For example, y can be only one of y=1, y=2, y=3, or y=4.
In one example, the UE 116 is not expected to be configured with C7 when x<N_{TRP}≤y. For example, x can be only one of x=1, x=2, x=3, or x=4. For example, y can be only one of y=1,y=2, y=3, or y=4.
In one example, the UE 116 is expected to be configured with C7 when x≤N_{TRP}<y. For example, x can be only one of x=1, x=2, x=3, or x=4. For example, y can be only one of y=1, y=2, y=3, or y=4.
In one example, the UE 116 is not expected to be configured with C7 when x≤N_{TRP}<y. For example, x can be only one of x=1, x=2, x=3, or x=4. For example, y can be only one of y=1,y=2, y=3, or y=4.
In one example, the UE 116 is expected to be configured with C7 when x<N_{TRP}<y. For example, x can be only one of x=1, x=2, x=3, or x=4. For example, y can be only one of y=1, y=2, y=3, or y=4.
In one example, the UE 116 is not expected to be configured with C7 when x<N_{TRP}<y. For example, x can be only one of x=1, x=2, x=3, or x=4. For example, y can be only one of y=1,y=2, y=3, or y=4.

In one example, there is restriction on configuring according to one of the examples herein. In addition, the restriction is UE-optional, i.e., the restriction is on/off depending on UE capability. The UE 116 reports its capability on the restriction, whether it is necessary or not, and the NW 130 then follows the reported UE capability. For the restriction in each example, the restriction is UE-optional or UE-capability.

In one example, there is restriction on configuring C7 according to one of the examples herein. In addition, the C7 is UE-optional, i.e., C7 can be configured depending on UE capability. The UE 116 reports its capability on the support of C7, and then only the NW 130 can configure C7. This UE-optional feature can correspond to a separate UE capability.

In one example, there is restriction on configuring C7 in Table 5, where the restriction is associated with (related to/based on) K, where K is a number of subbands.
In one example, the UE 116 is expected to be configured with C7 when K≥x. For example, x can be only one of x=1, . . . or x=19.
In one example, the UE 116 is not expected to be configured with C7 when K≥x. For example, x can be only one of x=1, . . . or x=19
In one example the UE 116 is expected to be configured with C7 when K≥x. For example, x can be only one of x=1, . . . or x=19.
In one example, the UE 116 is not expected to be configured with C7 when K≥x. For example, x can be only one of x=1, . . . or x=19.
In one example, the UE 116 is expected to be configured with C7 when K=x. For example, x can be only one of x=1, . . . or x=19.
In one example, the UE 116 is not expected to be configured with C7 when K=x. For example, x can be only one of x=1, . . . or x=19.
In one example, the UE 116 is expected to be configured with C7 when K<x. For example, x can be only one of x=1, . . . or x=19.
In one example, the UE 116 is not expected to be configured with C7 when K<x. For example, x can be only one of x=1, . . . or x=19.
In one example, the UE 116 is expected to be configured with C7 when K>x. For example, x can be only one of x=1, . . . or x=19.
In one example, the UE 116 is not expected to be configured with C7 when K>x. For example, x can be only one of x=1, . . . or x=19.
In one example, the UE 116 is expected to be configured with C7 when x≤K≤y. For example, x can be only one of x=1, . . . or x=19. For example, y can be only one of y=1, . . . or y=19.
In one example the UE 116 is not expected to be configured with C7 when x≤K≤y. For example, x can be only one of x=1, . . . or x=19. For example, y can be only one of y=1, . . . or y=19.
In one example, the UE 116 is expected to be configured with C7 when x<K≤y. For example, x can be only one of x=1, . . . or x=19. For example, y can be only one of y=1, . . . or y=19.
In one example, the UE 116 is not expected to be configured with C7 when x<K≤y. For example, x can be only one of xx=1, . . . or x=19. For example, y can be only one of y=1, . . . or y=19.
In one example, the UE 116 is expected to be configured with C7 when x≤K<y. For example, x can be only one of x=1, . . . or x=19. For example, y can be only one of y=1, . . . or y=19.
In one example, the UE 116 is not expected to be configured with C7 when x≤K<y. For example, x can be only one of x=1, . . . or x=19. For example, y can be only one of y=1, . . . or y=19.
In one example, the UE 116 is expected to be configured with C7 when x<K<y. For example, x can be only one of x=1, . . . or x=19. For example, y can be only one of y=1, . . . or y=19.
In one example, the UE 116 is not expected to be configured with C7 when x<K<y. For example, x can be only one of x=1, . . . or x=19. For example, y can be only one of y=1, . . . or y=19.

In one example, there is restriction on configuring according to one of the examples herein. In addition, the restriction is UE-optional, i.e., the restriction is on/off depending on UE capability. The UE 116 reports its capability on the restriction, whether it is necessary or not, and the NW 130 then follows the reported UE capability. For the restriction in each example, the restriction is UE-optional or UE-capability.

In one example, there is restriction on configuring C7 according to one of the examples herein. In addition, the C7 is UE-optional, i.e., C7 can be configured depending on UE capability. The UE 1116 reports its capability on the support of C7, and then only the NW 130 can configure C7. This UE-optional feature can correspond to a separate UE capability.

In one example (any combination of one or more examples described herein), there are multiple restrictions on configuring C7 in Table 5, where the multiple restrictions include at least one of the restrictions D1-D7 (D1-a to D7-a, D1-b-D7-b), described herein. The multiple restrictions are associated with (related to/based on) {Lₙ}, N_{L}, P_{CSI-RS}, v, R, N_{TRP}, and/or K.
In one example, there are 2 restrictions (r₁, r₂) on configuring C7, the restrictions are associated with parameters or parameter combinations, where rᵢ is one of {Lₙ}, N_{L}, P_{CSI-RS}, v, R, N_{TRP} and K.
   In one example, (r₁, r₂)=(N_{L}, {Lₙ}).
   In one example, (r₁, r₂)=(N_{L}, P_{CSI-RS}).
   In one example, (r₁, r₂)=(P_{CSI-RS}, {Lₙ}).
   In one example, (r₁, r₂)=(N_{L},N_{TRP}).
   In one example, (r₁, r₂)=({Lₙ}, N_{TRP}).
   In one example, (r₁, r₂)=(P_{CSI-RS}, N_{TRP}).
In one example there are 3 restrictions (r₁, r₂, r₃) on configuring C7, the restrictions are associated with parameters or parameter combinations, where r₁ is one of {Lₙ}, N_{L}, P_{CSI-RS}, v, R, N_{TRP} and K.
   In one example, (r₁, r₂, r₃)=(N_{L}, {Lₙ}, P_{CSI-RS}).
   In one example, (r₁, r₂, r₃)=(N_{L}, {Lₙ}, N_{TRP}).
   In one example, (r₁, r₂, r₃)=(N_{L}, {Lₙ}, P_{CSI-RS}).
   In one example, (r₁, r₂, r₃)=(N_{TRP}, {Lₙ}, P_{CSI-RS}).
In one example there are 4 restrictions (r₁, . . . , r₄) on configuring C7, the restrictions are associated with parameters or parameter combinations, where r₁ is one of {Lₙ}, N_{L}, P_{CSI-RS}, v, R, N_{TRP} and K.
   In one example, (r₁, . . . , r₄)=(N_{L}, {Lₙ}, P_{CSI-RS}, N_{TRP}).
In one example, there are q restrictions (r₁, . . . , r_{q}) on configuring C7, the restrictions are associated with parameters or parameter combinations, where r₁ is one of {Lₙ}, N_{L}, P_{CSI-RS}, v, R, N_{TRP} and K, and q∈{2, . . . ,7].

In one example, in addition to the multiple restrictions, as described herein, the combination C7 can only be configured when the UE 116 reports via UE a separate UE capability that it can support C7.
In one example (similar to one or more examples described herein), there is restriction on configuring C8 in Table 5, where the restriction is associated with (related to/based on) {Lₙ}, N_{L}, P_{CSI-RS}, v, R, N_{TRP}, and/or K.
In one example (similar to one or more examples described herein), there is restriction on configuring C9 in Table 5, where the restriction is associated with (related to/based on) {Lₙ}, N_{L}, P_{CSI-RS}, v, R, N_{TRP}, and/or K
In one example (similar to one or more examples described herein), there is restriction on configuring C10 in Table 5, where the restriction is associated with (related to/based on) {Lₙ}, N_{L}, P_{CSI-RS}, v, R, N_{TRP}, and/or K.
In one example (similar to one or more examples described herein), there is restriction on configuring C11 in Table 5, where the restriction is associated with (related to/based on) {Lₙ}, N_{L}, P_{CSI-RS}, v, R, N_{TRP}, and/or K.
In one example (similar to one or more examples described herein), there is restriction on configuring C12 in Table 5, where the restriction is associated with (related to/based on) {Lₙ}, N_{L}, P_{CSI-RS}, v, R, N_{TRP}, and/or K.
In one example (similar to one or more examples described herein), there is restriction on configuring C6 in Table 5, where the restriction is associated with (related to/based on) {Lₙ}, N_{L}, P_{CSI-RS}, v, R, N_{TRP}, and/or K.
In one example (similar to one or more examples described herein), there is restriction on configuring C5 in Table 5, where the restriction is associated with (related to/based on) {Lₙ}, N_{L}, P_{CSI-RS}, v, R, N_{TRP}, and/or K.

In another embodiment, on the SD basis selection for (Rel-18) Type-II codebook refinement for CJT mTRP, a value of Lₘₐₓ, where Lₘₐₓ≤Σₙ₊₁^{N}^{_{TRP}} Lₙ is configured by the NW 130, e.g., via higher-layer (RRC) signaling, or the relative value(s) of {Lₙ, n=1, . . . , N_{TRP}} are reported by the UE 116, where N_{TRP} is a number of TRPs (CSI-RS resources) configured by the NW 130. The relative value(s) of {Lₙ, n=1, . . . , N_{TRP}} can be selected from a table (or by using a joint indicator) and reported in CSI part 1 (of a two-part CSI comprising CSI part 1 and CSI part 2).

In one example, when N_{TRP} is configured, the UE 116 can be configured to select N(N_{TRP}) out of N_{TRP} TRPs and report the information (e.g., a length-N_{TRP} bitmap) about the selection of N TRPs in CSI part 1. For the selected N TRPs, associated Lₙ values are selected and indicated via an indicator. The indicator can be included in CSI part 1 or CSI part 2.

For each table that shall be described in the present disclosure, another table, which is the table replacing blanks by 0 values, can be another example for each relevant embodiment.

In one example, each Lₙ is selected from {2,4} for selected N TRPs and Table 6 can be used for {Lₙ} values (or Lₜₒₜ=Σₙ Lₙ). In one example, only a subset of the table is used/configured for {Lₙ} reporting. For example, the portion of the table corresponding to Lₜₒₜ>t can't be used for {Lₙ} reporting, where t is threshold that can be fixed (e.g., 8 or 10 or 12), or configured, or reported by the UE 116 (via UE capability).

TABLE 6

| Index | N | L₁ | L₂ | L₃ | L₄ | Lₜₒₜ |
|---|---|---|---|---|---|---|
| 1 | 1 | 2 | | | | 2 |
| 2 | | 4 | | | | 4 |
| 3 | 2 | 2 | 2 | | | 4 |
| 4 | | 2 | 4 | | | 6 |
| 5 | | 4 | 2 | | | 6 |
| 6 | | 4 | 4 | | | 8 |
| 7 | 3 | 2 | 2 | 2 | | 6 |
| 8 | | 2 | 2 | 4 | | 8 |
| 9 | | 2 | 4 | 2 | | 8 |
| 10 | | 2 | 4 | 4 | | 10 |
| 11 | | 4 | 2 | 2 | | 8 |
| 12 | | 4 | 2 | 4 | | 10 |
| 13 | | 4 | 4 | 2 | | 10 |
| 14 | | 4 | 4 | 4 | | 12 |
| 15 | 4 | 2 | 2 | 2 | 2 | 8 |
| 16 | | 2 | 2 | 2 | 4 | 10 |
| 17 | | 2 | 2 | 4 | 2 | 10 |
| 18 | | 2 | 2 | 4 | 4 | 12 |
| 19 | | 2 | 4 | 2 | 2 | 10 |
| 20 | | 2 | 4 | 2 | 4 | 12 |
| 21 | | 2 | 4 | 4 | 2 | 12 |
| 22 | | 2 | 4 | 4 | 4 | 14 |
| 23 | | 4 | 2 | 2 | 2 | 10 |
| 24 | | 4 | 2 | 2 | 4 | 12 |
| 25 | | 4 | 2 | 4 | 2 | 12 |
| 26 | | 4 | 2 | 4 | 4 | 14 |
| 27 | | 4 | 4 | 2 | 2 | 12 |
| 28 | | 4 | 4 | 2 | 4 | 14 |
| 29 | | 4 | 4 | 4 | 2 | 14 |
| 30 | | 4 | 4 | 4 | 4 | 16 |

In one example, UE evaluates the sub-table of Table 6 associated with N≤N_{TRP} and selects one index in the sub-table.
For example, when N_{TRP}=4 is configured by higher-layer signaling, the UE 116 evaluates the whole table of Table 6 and selects/reports one index. In this case, an indicator with ┌log₂ 30┐=5 bits is necessary to indicate {Lₙ} values.
For example, when N_{TRP}=3 is configured by higher-layer signaling, the UE 116 evaluates the sub-table of Table 6 having from index 1 to index 14 (those are associated with N≤N_{TRP}=3) and selects/reports one index. In this case, an indicator with ┌log₂ 14┐=4 bits is necessary to indicate {Lₙ} values.
For example, when N_{TRP}=2 is configured by higher-layer signaling, the UE 116 evaluates the sub-table of Table 6 having from index 1 to index 6 (those are associated with N≤N_{TRP}=2) and selects/reports one index. In this case, an indicator with ┌log₂ 6┐=3 bits is necessary to indicate {Lₙ} values.
For example, when N_{TRP}=1 is configured by higher-layer signaling, the UE 116 evaluates the sub-table of Table 6 having from index 1 to index 2 (those are associated with N≤N_{TRP}=1) and selects/reports one index. In this case, an indicator with ┌log₂ 2┐=1 bit is necessary to indicate {Lₙ} values.

When N<N_{TRP} is selected (via N_{TRP}-bit bitmap), the indexes of the selected TRPs (or CSI-RS resources) can be remapped to 1 to N, which will be corresponding to the indexes of selected {Lₙ}. In one example, from the lowest index to highest index for the selected TRPs, their indexes are remapped to 1 to N. For example, when N_{TRP}=4 and the 4-bit bitmap indicator for TRP selection is ‘0101’ (assuming least significant bit (LSB) corresponds to TRP 1 . . . most significant bit (MSB) corresponds to TRP 4), the selected TRP 1 and TRP 3 are associated with L₁ and L₂, respectively. In another example, from the highest index to lowest index for the selected TRPs, their indexes are remapped to 1 to N. For example, when N_{TRP}=4 and the 4-bit bitmap indicator for TRP selection is ‘0101’ (assuming LSB corresponds to TRP 1 . . . MSB corresponds to TRP 4), the selected TRP 3 and TRP 1 are associated with L₁ and L₂, respectively.

In one example, the UE 116 shall not report any index associated with N′≠N, i.e., any index associated with not the number of selected TRPs.

In one embodiment, a value of Lₜₒₜ is reported in CSI part 1, and {Lₙ} values can be reported in CSI part 2 (e.g., via separate indicator, or via a joint indicator).

In one example:
when N_{TRP}=2 (or N=2), Lₜₒₜ is selected from {2,4,6,8} and reported in CSI part 1, and {Lₙ} values are selected from a sub-table of Table 6 associated with the selected value of Lₜₒₜ and reported in CSI part 2.
When N_{TRP}=3 (or N=3), Lₜₒₜ is selected from {2,4,6,8,10,12} and reported in CSI part 1, and {Lₙ} values are selected from a sub-table of Table 6 associated with the selected value of Lₜₒₜ and reported in CSI part 2.
When N_{TRP}=4 (or N=4), Lₜₒₜ is selected from {2,4,6,8,10,12,14,16} and reported in CSI part 1, and {Lₙ} values are selected from a sub-table of Table 6 associated with the selected value of Lₜₒₜ and reported in CSI part 2.

In another example/embodiment, Lₙ can allow 0 in addition to {2,4}. For example, Table 7 can be used for one or more examples/embodiments described herein or the examples/embodiments described herein that are related to Table 6.

TABLE 7

| Index | N | L₁ | L₂ | L₃ | L₄ | Lₜₒₜ |
|---|---|---|---|---|---|---|
| 1 | 1 | 2 | 0 | 0 | 0 | 2 |
| 2 | | 4 | 0 | 0 | 0 | 4 |
| 3 | 2 | 2 | 2 | 0 | 0 | 4 |
| 4 | | 2 | 4 | 0 | 0 | 6 |
| 5 | | 4 | 2 | 0 | 0 | 6 |
| 6 | | 4 | 4 | 0 | 0 | 8 |
| 7 | 3 | 2 | 2 | 2 | 0 | 6 |
| 8 | | 2 | 2 | 4 | 0 | 8 |
| 9 | | 2 | 4 | 2 | 0 | 8 |
| 10 | | 2 | 4 | 4 | 0 | 10 |
| 11 | | 4 | 2 | 2 | 0 | 8 |
| 12 | | 4 | 2 | 4 | 0 | 10 |
| 13 | | 4 | 4 | 2 | 0 | 10 |
| 14 | | 4 | 4 | 4 | 0 | 12 |
| 15 | 4 | 2 | 2 | 2 | 2 | 8 |
| 16 | | 2 | 2 | 2 | 4 | 10 |
| 17 | | 2 | 2 | 4 | 2 | 10 |
| 18 | | 2 | 2 | 4 | 4 | 12 |
| 19 | | 2 | 4 | 2 | 2 | 10 |
| 20 | | 2 | 4 | 2 | 4 | 12 |
| 21 | | 2 | 4 | 4 | 2 | 12 |
| 22 | | 2 | 4 | 4 | 4 | 14 |
| 23 | | 4 | 2 | 2 | 2 | 10 |
| 24 | | 4 | 2 | 2 | 4 | 12 |
| 25 | | 4 | 2 | 4 | 2 | 12 |
| 26 | | 4 | 2 | 4 | 4 | 14 |
| 27 | | 4 | 4 | 2 | 2 | 12 |
| 28 | | 4 | 4 | 2 | 4 | 14 |
| 29 | | 4 | 4 | 4 | 2 | 14 |
| 30 | | 4 | 4 | 4 | 4 | 16 |

In one embodiment, a UE evaluates a sub-table of Table 6 associated with {Lₙ} such that Lₙ₁≥Lₙ₂ (non-increasing order) when n1<n2, as shown in Table 8, and selects one index in the sub table.

TABLE 8

| Index | N | L₁ | L₂ | L₃ | L₄ | Lₜₒₜ |
|---|---|---|---|---|---|---|
| 1 | 1 | 2 | | | | 2 |
| 2 | | 4 | | | | 4 |
| 3 | 2 | 2 | 2 | | | 4 |
| 5 | | 4 | 2 | | | 6 |
| 6 | | 4 | 4 | | | 8 |
| 7 | 3 | 2 | 2 | 2 | | 6 |
| 11 | | 4 | 2 | 2 | | 8 |
| 13 | | 4 | 4 | 2 | | 10 |
| 14 | | 4 | 4 | 4 | | 12 |
| 15 | 4 | 2 | 2 | 2 | 2 | 8 |
| 23 | | 4 | 2 | 2 | 2 | 10 |
| 27 | | 4 | 4 | 2 | 2 | 12 |
| 29 | | 4 | 4 | 4 | 2 | 14 |
| 30 | | 4 | 4 | 4 | 4 | 16 |

In one example, the ordering of the TRP can be configured by the NW 130, via e.g., RRC, or MAC CE or, downlink control information (DCI).

In one embodiment, a UE evaluates a sub-table including at least one of the rows in Table 6 or Table 7.

In one example, each Lₙ is selected from {2,4,6} for selected N TRPs and Table 9 can be used for {Lₙ} values (or Lₜₒₜ=Σₙ Lₙ). In one example, only a subset of the table is used/configured for {Lₙ} reporting. For example, the portion of the table corresponding to Lₜₒₜ>t can't be used for {Lₙ} reporting, where t is threshold that can be fixed (e.g., 18 or 20 or 22 or 24), or configured, or reported by the UE 116 (via UE capability).

TABLE 9

| Index | N | L₁ | L₂ | L₃ | L₄ | Lₜₒₜ |
|---|---|---|---|---|---|---|
| 1 | 1 | 2 | | | | 2 |
| 2 | | 4 | | | | 4 |
| 3 | | 6 | | | | 6 |
| 4 | 2 | 2 | 2 | | | 4 |
| 5 | | 2 | 4 | | | 6 |
| 6 | | 2 | 6 | | | 8 |
| 7 | | 4 | 2 | | | 6 |
| 8 | | 4 | 4 | | | 8 |
| 9 | | 4 | 6 | | | 10 |
| 10 | | 6 | 2 | | | 8 |
| 11 | | 6 | 4 | | | 10 |
| 12 | | 6 | 6 | | | 12 |
| 13 | 3 | 2 | 2 | 2 | | 6 |
| 14 | | 2 | 2 | 4 | | 8 |
| 15 | | 2 | 2 | 6 | | 10 |
| 16 | | 2 | 4 | 2 | | 8 |
| 17 | | 2 | 4 | 4 | | 10 |
| 18 | | 2 | 4 | 6 | | 12 |
| 19 | | 2 | 6 | 2 | | 10 |
| 20 | | 2 | 6 | 4 | | 12 |
| 21 | | 2 | 6 | 6 | | 14 |
| 22 | | 4 | 2 | 2 | | 8 |
| 23 | | 4 | 2 | 4 | | 10 |
| 24 | | 4 | 2 | 6 | | 12 |
| 25 | | 4 | 4 | 2 | | 10 |
| 26 | | 4 | 4 | 4 | | 12 |
| 27 | | 4 | 4 | 6 | | 14 |
| 28 | | 4 | 6 | 2 | | 12 |
| 29 | | 4 | 6 | 4 | | 14 |
| 30 | | 4 | 6 | 6 | | 16 |
| 31 | | 6 | 2 | 2 | | 10 |
| 32 | | 6 | 2 | 4 | | 12 |
| 33 | | 6 | 2 | 6 | | 14 |
| 34 | | 6 | 4 | 2 | | 12 |
| 35 | | 6 | 4 | 4 | | 14 |
| 36 | | 6 | 4 | 6 | | 16 |
| 37 | | 6 | 6 | 2 | | 14 |
| 38 | | 6 | 6 | 4 | | 16 |
| 39 | | 6 | 6 | 6 | | 18 |
| 40 | 4 | 2 | 2 | 2 | 2 | 8 |
| 41 | | 2 | 2 | 2 | 4 | 10 |
| 42 | | 2 | 2 | 2 | 6 | 12 |
| 43 | | 2 | 2 | 4 | 2 | 10 |
| 44 | | 2 | 2 | 4 | 4 | 12 |
| 45 | | 2 | 2 | 4 | 6 | 14 |
| 46 | | 2 | 2 | 6 | 2 | 12 |
| 47 | | 2 | 2 | 6 | 4 | 14 |
| 48 | | 2 | 2 | 6 | 6 | 16 |
| 49 | | 2 | 4 | 2 | 2 | 10 |
| 50 | | 2 | 4 | 2 | 4 | 12 |
| 51 | | 2 | 4 | 2 | 6 | 14 |
| 52 | | 2 | 4 | 4 | 2 | 12 |
| 53 | | 2 | 4 | 4 | 4 | 14 |
| 54 | | 2 | 4 | 4 | 6 | 16 |
| 55 | | 2 | 4 | 6 | 2 | 14 |
| 56 | | 2 | 4 | 6 | 4 | 16 |
| 57 | | 2 | 4 | 6 | 6 | 18 |
| 58 | | 2 | 6 | 2 | 2 | 12 |
| 59 | | 2 | 6 | 2 | 4 | 14 |
| 60 | | 2 | 6 | 2 | 6 | 16 |
| 61 | | 2 | 6 | 4 | 2 | 14 |
| 62 | | 2 | 6 | 4 | 4 | 16 |
| 63 | | 2 | 6 | 4 | 6 | 18 |
| 64 | | 2 | 6 | 6 | 2 | 16 |
| 65 | | 2 | 6 | 6 | 4 | 18 |
| 66 | | 2 | 6 | 6 | 6 | 20 |
| 67 | | 4 | 2 | 2 | 2 | 10 |
| 68 | | 4 | 2 | 2 | 4 | 12 |
| 69 | | 4 | 2 | 2 | 6 | 14 |
| 70 | | 4 | 2 | 4 | 2 | 12 |
| 71 | | 4 | 2 | 4 | 4 | 14 |
| 72 | | 4 | 2 | 4 | 6 | 16 |
| 73 | | 4 | 2 | 6 | 2 | 14 |
| 74 | | 4 | 2 | 6 | 4 | 16 |
| 75 | | 4 | 2 | 6 | 6 | 18 |
| 76 | | 4 | 4 | 2 | 2 | 12 |
| 77 | | 4 | 4 | 2 | 4 | 14 |
| 78 | | 4 | 4 | 2 | 6 | 16 |
| 79 | | 4 | 4 | 4 | 2 | 14 |
| 80 | | 4 | 4 | 4 | 4 | 16 |
| 81 | | 4 | 4 | 4 | 6 | 18 |
| 82 | | 4 | 4 | 6 | 2 | 16 |
| 83 | | 4 | 4 | 6 | 4 | 18 |
| 84 | | 4 | 4 | 6 | 6 | 20 |
| 85 | | 4 | 6 | 2 | 2 | 14 |
| 86 | | 4 | 6 | 2 | 4 | 16 |
| 87 | | 4 | 6 | 2 | 6 | 18 |
| 88 | | 4 | 6 | 4 | 2 | 16 |
| 89 | | 4 | 6 | 4 | 4 | 18 |
| 90 | | 4 | 6 | 4 | 6 | 20 |
| 91 | | 4 | 6 | 6 | 2 | 18 |
| 92 | | 4 | 6 | 6 | 4 | 20 |
| 93 | | 4 | 6 | 6 | 6 | 22 |
| 94 | | 6 | 2 | 2 | 2 | 12 |
| 95 | | 6 | 2 | 2 | 4 | 14 |
| 96 | | 6 | 2 | 2 | 6 | 16 |
| 97 | | 6 | 2 | 4 | 2 | 14 |
| 98 | | 6 | 2 | 4 | 4 | 16 |
| 99 | | 6 | 2 | 4 | 6 | 18 |
| 100 | | 6 | 2 | 6 | 2 | 16 |
| 101 | | 6 | 2 | 6 | 4 | 18 |
| 102 | | 6 | 2 | 6 | 6 | 20 |
| 103 | | 6 | 4 | 2 | 2 | 14 |
| 104 | | 6 | 4 | 2 | 4 | 16 |
| 105 | | 6 | 4 | 2 | 6 | 18 |
| 106 | | 6 | 4 | 4 | 2 | 16 |
| 107 | | 6 | 4 | 4 | 4 | 18 |
| 108 | | 6 | 4 | 4 | 6 | 20 |
| 109 | | 6 | 4 | 6 | 2 | 18 |
| 110 | | 6 | 4 | 6 | 4 | 20 |
| 111 | | 6 | 4 | 6 | 6 | 22 |
| 112 | | 6 | 6 | 2 | 2 | 16 |
| 113 | | 6 | 6 | 2 | 4 | 18 |
| 114 | | 6 | 6 | 2 | 6 | 20 |
| 115 | | 6 | 6 | 4 | 2 | 18 |
| 116 | | 6 | 6 | 4 | 4 | 20 |
| 117 | | 6 | 6 | 4 | 6 | 22 |
| 118 | | 6 | 6 | 6 | 2 | 20 |
| 119 | | 6 | 6 | 6 | 4 | 22 |
| 120 | | 6 | 6 | 6 | 6 | 24 |

In one example, the UE 116 evaluates the sub-table of Table 9 associated with N≤N_{TRP} and selects one index in the sub-table.
For example, when N_{TRP}=4 is configured by higher-layer signaling, the UE 116 evaluates the whole table of Table 9 and selects/reports one index. In this case, an indicator with ┌log₂ 120┐=7 bits is necessary to indicate {Lₙ} values.
For example, when N_{TRP}=3 is configured by higher-layer signaling, the UE 116 evaluates the sub-table of Table 9 having from index 1 to index 39 (those are associated with N≤N_{TRP}=3) and selects/reports one index. In this case, an indicator with ┌log₂ 39┐=6 bits is necessary to indicate {Lₙ} values.
For example, when N_{TRP}=2 is configured by higher-layer signaling, the UE 116 evaluates the sub-table of Table 9 having from index 1 to index 12 (those are associated with N≤N_{TRP}=2) and selects/reports one index. In this case, an indicator with ┌log₂ 12┐=4 bits is necessary to indicate {Lₙ} values.
For example, when N_{TRP}=1 is configured by higher-layer signaling, the UE 116 evaluates the sub-table of Table 9 having from index 1 to index 3 (those are associated with N≤N_{TRP}=1) and selects/reports one index. In this case, an indicator with ┌log₂ 3┐=2 bit is necessary to indicate {Lₙ} values.

When N<N_{TRP} is selected (via N_{TRP}-bit bitmap), the indexes of the selected TRPs (or CSI-RS resources) can be remapped to 1 to N, which will be corresponding to the indexes of selected {Lₙ}. In one example, from the lowest index to highest index for the selected TRPs, their indexes are remapped to 1 to N. For example, when N_{TRP}=4 and the 4-bit bitmap indicator for TRP selection is ‘0101’ (assuming LSB corresponds to TRP 1 . . . MSB corresponds to TRP 4), the selected TRP 1 and TRP 3 are associated with L₁ and L₂, respectively. In another example, from the highest index to lowest index for the selected TRPs, their indexes are remapped to 1 to N. For example, when N_{TRP}=4 and the 4-bit bitmap indicator for TRP selection is ‘0101’ (assuming LSB corresponds to TRP 1 . . . MSB corresponds to TRP 4), the selected TRP 3 and TRP 1 are associated with L₁ and L₂, respectively.

In one example, the UE 116 shall not report any index associated with N′≠N, i.e., any index associated with not the number of selected TRPs.

In one embodiment, a value of Lₜₒₜ is reported in CSI part 1, and {Lₙ} values can be reported in CSI part 2 (e.g., via separate indicator, or via a joint indicator).

In one example:
when N_{TRP}=2 (or N=2), Lₜₒₜ is selected from {2,4,6,8,10,12} and reported in CSI part 1, and {Lₙ} values are selected from a sub-table of Table 6 associated with the selected value of Lₜₒₜ and reported in CSI part 2.
When N_{TRP}=3 (or N=3), Lₜₒₜ is selected from {2,4,6,8,10,12,14,16,18} and reported in CSI part 1, and {Lₙ} values are selected from a sub-table of Table 6 associated with the selected value of Lₜₒₜ and reported in CSI part 2.
When N_{TRP}=4 (or N=4), Lₜₒₜ is selected from {2,4,6,8,10,12,14,16,18,20,22,24} and reported in CSI part 1, and {Lₙ} values are selected from a sub-table of Table 6 associated with the selected value of Lₜₒₜ and reported in CSI part 2.

In one embodiment, a UE evaluates a sub-table of Table 9 associated with {Lₙ} such that Lₙ₁≥Lₙ₂ (non-increasing order) when n1<n2, (similar way as shown in Table 8), and selects one index in the sub table.

In one example, the ordering of the TRP can be configured by the NW 130, via e.g., RRC, or MAC CE or, DCI.

In another example/embodiment, Lₙ can allow 0 in addition to {2,4,6}. For example, Table 9 can be used for the examples/embodiments described herein or the examples/embodiments described herein that are related to Table 10.

TABLE 10

| Index | N | L₁ | L₂ | L₃ | L₄ | Lₜₒₜ |
|---|---|---|---|---|---|---|
| 1 | 1 | 2 | 0 | 0 | 0 | 2 |
| 2 | | 4 | 0 | 0 | 0 | 4 |
| 3 | | 6 | 0 | 0 | 0 | 6 |
| 4 | 2 | 2 | 2 | 0 | 0 | 4 |
| 5 | | 2 | 4 | 0 | 0 | 6 |
| 6 | | 2 | 6 | 0 | 0 | 8 |
| 7 | | 4 | 2 | 0 | 0 | 6 |
| 8 | | 4 | 4 | 0 | 0 | 8 |
| 9 | | 4 | 6 | 0 | 0 | 10 |
| 10 | | 6 | 2 | 0 | 0 | 8 |
| 11 | | 6 | 4 | 0 | 0 | 10 |
| 12 | | 6 | 6 | 0 | 0 | 12 |
| 13 | 3 | 2 | 2 | 2 | 0 | 6 |
| 14 | | 2 | 2 | 4 | 0 | 8 |
| 15 | | 2 | 2 | 6 | 0 | 10 |
| 16 | | 2 | 4 | 2 | 0 | 8 |
| 17 | | 2 | 4 | 4 | 0 | 10 |
| 18 | | 2 | 4 | 6 | 0 | 12 |
| 19 | | 2 | 6 | 2 | 0 | 10 |
| 20 | | 2 | 6 | 4 | 0 | 12 |
| 21 | | 2 | 6 | 6 | 0 | 14 |
| 22 | | 4 | 2 | 2 | 0 | 8 |
| 23 | | 4 | 2 | 4 | 0 | 10 |
| 24 | | 4 | 2 | 6 | 0 | 12 |
| 25 | | 4 | 4 | 2 | 0 | 10 |
| 26 | | 4 | 4 | 4 | 0 | 12 |
| 27 | | 4 | 4 | 6 | 0 | 14 |
| 28 | | 4 | 6 | 2 | 0 | 12 |
| 29 | | 4 | 6 | 4 | 0 | 14 |
| 30 | | 4 | 6 | 6 | 0 | 16 |
| 31 | | 6 | 2 | 2 | 0 | 10 |
| 32 | | 6 | 2 | 4 | 0 | 12 |
| 33 | | 6 | 2 | 6 | 0 | 14 |
| 34 | | 6 | 4 | 2 | 0 | 12 |
| 35 | | 6 | 4 | 4 | 0 | 14 |
| 36 | | 6 | 4 | 6 | 0 | 16 |
| 37 | | 6 | 6 | 2 | 0 | 14 |
| 38 | | 6 | 6 | 4 | 0 | 16 |
| 39 | | 6 | 6 | 6 | 0 | 18 |
| 40 | 4 | 2 | 2 | 2 | 2 | 8 |
| 41 | | 2 | 2 | 2 | 4 | 10 |
| 42 | | 2 | 2 | 2 | 6 | 12 |
| 43 | | 2 | 2 | 4 | 2 | 10 |
| 44 | | 2 | 2 | 4 | 4 | 12 |
| 45 | | 2 | 2 | 4 | 6 | 14 |
| 46 | | 2 | 2 | 6 | 2 | 12 |
| 47 | | 2 | 2 | 6 | 4 | 14 |
| 48 | | 2 | 2 | 6 | 6 | 16 |
| 49 | | 2 | 4 | 2 | 2 | 10 |
| 50 | | 2 | 4 | 2 | 4 | 12 |
| 51 | | 2 | 4 | 2 | 6 | 14 |
| 52 | | 2 | 4 | 4 | 2 | 12 |
| 53 | | 2 | 4 | 4 | 4 | 14 |
| 54 | | 2 | 4 | 4 | 6 | 16 |
| 55 | | 2 | 4 | 6 | 2 | 14 |
| 56 | | 2 | 4 | 6 | 4 | 16 |
| 57 | | 2 | 4 | 6 | 6 | 18 |
| 58 | | 2 | 6 | 2 | 2 | 12 |
| 59 | | 2 | 6 | 2 | 4 | 14 |
| 60 | | 2 | 6 | 2 | 6 | 16 |
| 61 | | 2 | 6 | 4 | 2 | 14 |
| 62 | | 2 | 6 | 4 | 4 | 16 |
| 63 | | 2 | 6 | 4 | 6 | 18 |
| 64 | | 2 | 6 | 6 | 2 | 16 |
| 65 | | 2 | 6 | 6 | 4 | 18 |
| 66 | | 2 | 6 | 6 | 6 | 20 |
| 67 | | 4 | 2 | 2 | 2 | 10 |
| 68 | | 4 | 2 | 2 | 4 | 12 |
| 69 | | 4 | 2 | 2 | 6 | 14 |
| 70 | | 4 | 2 | 4 | 2 | 12 |
| 71 | | 4 | 2 | 4 | 4 | 14 |
| 72 | | 4 | 2 | 4 | 6 | 16 |
| 73 | | 4 | 2 | 6 | 2 | 14 |
| 74 | | 4 | 2 | 6 | 4 | 16 |
| 75 | | 4 | 2 | 6 | 6 | 18 |
| 76 | | 4 | 4 | 2 | 2 | 12 |
| 77 | | 4 | 4 | 2 | 4 | 14 |
| 78 | | 4 | 4 | 2 | 6 | 16 |
| 79 | | 4 | 4 | 4 | 2 | 14 |
| 80 | | 4 | 4 | 4 | 4 | 16 |
| 81 | | 4 | 4 | 4 | 6 | 18 |
| 82 | | 4 | 4 | 6 | 2 | 16 |
| 83 | | 4 | 4 | 6 | 4 | 18 |
| 84 | | 4 | 4 | 6 | 6 | 20 |
| 85 | | 4 | 6 | 2 | 2 | 14 |
| 86 | | 4 | 6 | 2 | 4 | 16 |
| 87 | | 4 | 6 | 2 | 6 | 18 |
| 88 | | 4 | 6 | 4 | 2 | 16 |
| 89 | | 4 | 6 | 4 | 4 | 18 |
| 90 | | 4 | 6 | 4 | 6 | 20 |
| 91 | | 4 | 6 | 6 | 2 | 18 |
| 92 | | 4 | 6 | 6 | 4 | 20 |
| 93 | | 4 | 6 | 6 | 6 | 22 |
| 94 | | 6 | 2 | 2 | 2 | 12 |
| 95 | | 6 | 2 | 2 | 4 | 14 |
| 96 | | 6 | 2 | 2 | 6 | 16 |
| 97 | | 6 | 2 | 4 | 2 | 14 |
| 98 | | 6 | 2 | 4 | 4 | 16 |
| 99 | | 6 | 2 | 4 | 6 | 18 |
| 100 | | 6 | 2 | 6 | 2 | 16 |
| 101 | | 6 | 2 | 6 | 4 | 18 |
| 102 | | 6 | 2 | 6 | 6 | 20 |
| 103 | | 6 | 4 | 2 | 2 | 14 |
| 104 | | 6 | 4 | 2 | 4 | 16 |
| 105 | | 6 | 4 | 2 | 6 | 18 |
| 106 | | 6 | 4 | 4 | 2 | 16 |
| 107 | | 6 | 4 | 4 | 4 | 18 |
| 108 | | 6 | 4 | 4 | 6 | 20 |
| 109 | | 6 | 4 | 6 | 2 | 18 |
| 110 | | 6 | 4 | 6 | 4 | 20 |
| 111 | | 6 | 4 | 6 | 6 | 22 |
| 112 | | 6 | 6 | 2 | 2 | 16 |
| 113 | | 6 | 6 | 2 | 4 | 18 |
| 114 | | 6 | 6 | 2 | 6 | 20 |
| 115 | | 6 | 6 | 4 | 2 | 18 |
| 116 | | 6 | 6 | 4 | 4 | 20 |
| 117 | | 6 | 6 | 4 | 6 | 22 |
| 118 | | 6 | 6 | 6 | 2 | 20 |
| 119 | | 6 | 6 | 6 | 4 | 22 |
| 120 | | 6 | 6 | 6 | 6 | 24 |

In one embodiment, a UE evaluates a sub-table including at least one of the rows in Table 9 or Table 10.

In one example, each Lₙ is selected from {1,2,4} for selected N TRPs and Table 11 can be used for {Lₙ} values (or Lₜₒₜ=Σₙ Lₙ). In one example, only a subset of the table is used/configured for {Lₙ} reporting. For example, the portion of the table corresponding to Lₜₒₜ>t can't be used for {Lₙ} reporting, where t is threshold that can be fixed (e.g., 12 or 14 or 16), or configured, or reported by the UE 116 (via UE capability).

TABLE 11

| Index | N | L₁ | L₂ | L₃ | L₄ | Lₜₒₜ |
|---|---|---|---|---|---|---|
| 1 | 1 | 1 | | | | 1 |
| 2 | | 2 | | | | 2 |
| 3 | | 4 | | | | 4 |
| 4 | 2 | 1 | 1 | | | 2 |
| 5 | | 1 | 2 | | | 3 |
| 6 | | 1 | 4 | | | 5 |
| 7 | | 2 | 1 | | | 3 |
| 8 | | 2 | 2 | | | 4 |
| 9 | | 2 | 4 | | | 6 |
| 10 | | 4 | 1 | | | 5 |
| 11 | | 4 | 2 | | | 6 |
| 12 | | 4 | 4 | | | 8 |
| 13 | 3 | 1 | 1 | 1 | | 3 |
| 14 | | 1 | 1 | 2 | | 4 |
| 15 | | 1 | 1 | 4 | | 6 |
| 16 | | 1 | 2 | 1 | | 4 |
| 17 | | 1 | 2 | 2 | | 5 |
| 18 | | 1 | 2 | 4 | | 7 |
| 19 | | 1 | 4 | 1 | | 6 |
| 20 | | 1 | 4 | 2 | | 7 |
| 21 | | 1 | 4 | 4 | | 9 |
| 22 | | 2 | 1 | 1 | | 4 |
| 23 | | 2 | 1 | 2 | | 5 |
| 24 | | 2 | 1 | 4 | | 7 |
| 25 | | 2 | 2 | 1 | | 5 |
| 26 | | 2 | 2 | 2 | | 6 |
| 27 | | 2 | 2 | 4 | | 8 |
| 28 | | 2 | 4 | 1 | | 7 |
| 29 | | 2 | 4 | 2 | | 8 |
| 30 | | 2 | 4 | 4 | | 10 |
| 31 | | 4 | 1 | 1 | | 6 |
| 32 | | 4 | 1 | 2 | | 7 |
| 33 | | 4 | 1 | 4 | | 9 |
| 34 | | 4 | 2 | 1 | | 7 |
| 35 | | 4 | 2 | 2 | | 8 |
| 36 | | 4 | 2 | 4 | | 10 |
| 37 | | 4 | 4 | 1 | | 9 |
| 38 | | 4 | 4 | 2 | | 10 |
| 39 | | 4 | 4 | 4 | | 12 |
| 40 | 4 | 1 | 1 | 1 | 1 | 4 |
| 41 | | 1 | 1 | 1 | 2 | 5 |
| 42 | | 1 | 1 | 1 | 4 | 7 |
| 43 | | 1 | 1 | 2 | 1 | 5 |
| 44 | | 1 | 1 | 2 | 2 | 6 |
| 45 | | 1 | 1 | 2 | 4 | 8 |
| 46 | | 1 | 1 | 4 | 1 | 7 |
| 47 | | 1 | 1 | 4 | 2 | 8 |
| 48 | | 1 | 1 | 4 | 4 | 10 |
| 49 | | 1 | 2 | 1 | 1 | 5 |
| 50 | | 1 | 2 | 1 | 2 | 6 |
| 51 | | 1 | 2 | 1 | 4 | 8 |
| 52 | | 1 | 2 | 2 | 1 | 6 |
| 53 | | 1 | 2 | 2 | 2 | 7 |
| 54 | | 1 | 2 | 2 | 4 | 9 |
| 55 | | 1 | 2 | 4 | 1 | 8 |
| 56 | | 1 | 2 | 4 | 2 | 9 |
| 57 | | 1 | 2 | 4 | 4 | 11 |
| 58 | | 1 | 4 | 1 | 1 | 7 |
| 59 | | 1 | 4 | 1 | 2 | 8 |
| 60 | | 1 | 4 | 1 | 4 | 10 |
| 61 | | 1 | 4 | 2 | 1 | 8 |
| 62 | | 1 | 4 | 2 | 2 | 9 |
| 63 | | 1 | 4 | 2 | 4 | 11 |
| 64 | | 1 | 4 | 4 | 1 | 10 |
| 65 | | 1 | 4 | 4 | 2 | 11 |
| 66 | | 1 | 4 | 4 | 4 | 13 |
| 67 | | 2 | 1 | 1 | 1 | 5 |
| 68 | | 2 | 1 | 1 | 2 | 6 |
| 69 | | 2 | 1 | 1 | 4 | 8 |
| 70 | | 2 | 1 | 2 | 1 | 6 |
| 71 | | 2 | 1 | 2 | 2 | 7 |
| 72 | | 2 | 1 | 2 | 4 | 9 |
| 73 | | 2 | 1 | 4 | 1 | 8 |
| 74 | | 2 | 1 | 4 | 2 | 9 |
| 75 | | 2 | 1 | 4 | 4 | 11 |
| 76 | | 2 | 2 | 1 | 1 | 6 |
| 77 | | 2 | 2 | 1 | 2 | 7 |
| 78 | | 2 | 2 | 1 | 4 | 9 |
| 79 | | 2 | 2 | 2 | 1 | 7 |
| 80 | | 2 | 2 | 2 | 2 | 8 |
| 81 | | 2 | 2 | 2 | 4 | 10 |
| 82 | | 2 | 2 | 4 | 1 | 9 |
| 83 | | 2 | 2 | 4 | 2 | 10 |
| 84 | | 2 | 2 | 4 | 4 | 12 |
| 85 | | 2 | 4 | 1 | 1 | 8 |
| 86 | | 2 | 4 | 1 | 2 | 9 |
| 87 | | 2 | 4 | 1 | 4 | 11 |
| 88 | | 2 | 4 | 2 | 1 | 9 |
| 89 | | 2 | 4 | 2 | 2 | 10 |
| 90 | | 2 | 4 | 2 | 4 | 12 |
| 91 | | 2 | 4 | 4 | 1 | 11 |
| 92 | | 2 | 4 | 4 | 2 | 12 |
| 93 | | 2 | 4 | 4 | 4 | 14 |
| 94 | | 4 | 1 | 1 | 1 | 7 |
| 95 | | 4 | 1 | 1 | 2 | 8 |
| 96 | | 4 | 1 | 1 | 4 | 10 |
| 97 | | 4 | 1 | 2 | 1 | 8 |
| 98 | | 4 | 1 | 2 | 2 | 9 |
| 99 | | 4 | 1 | 2 | 4 | 11 |
| 100 | | 4 | 1 | 4 | 1 | 10 |
| 101 | | 4 | 1 | 4 | 2 | 11 |
| 102 | | 4 | 1 | 4 | 4 | 13 |
| 103 | | 4 | 2 | 1 | 1 | 8 |
| 104 | | 4 | 2 | 1 | 2 | 9 |
| 105 | | 4 | 2 | 1 | 4 | 11 |
| 106 | | 4 | 2 | 2 | 1 | 9 |
| 107 | | 4 | 2 | 2 | 2 | 10 |
| 108 | | 4 | 2 | 2 | 4 | 12 |
| 109 | | 4 | 2 | 4 | 1 | 11 |
| 110 | | 4 | 2 | 4 | 2 | 12 |
| 111 | | 4 | 2 | 4 | 4 | 14 |
| 112 | | 4 | 4 | 1 | 1 | 10 |
| 113 | | 4 | 4 | 1 | 2 | 11 |
| 114 | | 4 | 4 | 1 | 4 | 13 |
| 115 | | 4 | 4 | 2 | 1 | 11 |
| 116 | | 4 | 4 | 2 | 2 | 12 |
| 117 | | 4 | 4 | 2 | 4 | 14 |
| 118 | | 4 | 4 | 4 | 1 | 13 |
| 119 | | 4 | 4 | 4 | 2 | 14 |
| 120 | | 4 | 4 | 4 | 4 | 16 |

In one example, UE evaluates the sub-table of Table 11 associated with N≤N_{TRP} and selects one index in the sub-table.
For example, when N_{TRP}=4 is configured by higher-layer signaling, the UE 116 evaluates the whole table of Table 11 and selects/reports one index. In this case, an indicator with ┌log₂ 120┐=7 bits is necessary to indicate {Lₙ} values.
For example, when N_{TRP}=3 is configured by higher-layer signaling, the UE 116 evaluates the sub-table of Table 11 having from index 1 to index 39 (those are associated with N≤N_{TRP}=3) and selects/reports one index. In this case, an indicator with ┌log₂ 39┐=6 bits is necessary to indicate {Lₙ} values.
For example, when N_{TRP}=2 is configured by higher-layer signaling, the UE 116 evaluates the sub-table of Table 11 having from index 1 to index 12 (those are associated with N≤N_{TRP}=2) and selects/reports one index. In this case, an indicator with ┌log₂ 12┐=4 bits is necessary to indicate {Lₙ} values.
For example, when N_{TRP}=1 is configured by higher-layer signaling, the UE 116 evaluates the sub-table of Table 11 having from index 1 to index 3 (those are associated with N≤N_{TRP}=1) and selects/reports one index. In this case, an indicator with ┌log₂ 3┐=2 bit is necessary to indicate {Lₙ} values.

When N<N_{TRP} is selected (via N_{TRP}-bit bitmap), the indexes of the selected TRPs (or CSI-RS resources) can be remapped to 1 to N, which will be corresponding to the indexes of selected {Lₙ}. In one example, from the lowest index to highest index for the selected TRPs, their indexes are remapped to 1 to N. For example, when N_{TRP}=4 and the 4-bit bitmap indicator for TRP selection is ‘0101’ (assuming LSB corresponds to TRP 1 . . . MSB corresponds to TRP 4), the selected TRP 1 and TRP 3 are associated with L₁ and L₂, respectively. In another example, from the highest index to lowest index for the selected TRPs, their indexes are remapped to 1 to N. For example, when N_{TRP}=4 and the 4-bit bitmap indicator for TRP selection is ‘0101’ (assuming LSB corresponds to TRP 1 . . . MSB corresponds to TRP 4), the selected TRP 3 and TRP 1 are associated with L₁ and L₂, respectively.

In one example, the UE 116 shall not report any index associated with N′≠N, i.e., any index associated with not the number of selected TRPs.

In one embodiment, a value of Lₜₒₜ is reported in CSI part 1, and {Lₙ} values can be reported in CSI part 2 (e.g., via separate indicator, or via a joint indicator).

In one example:
when N_{TRP}=2 (or N=2), Lₜₒₜ is selected from {1,2,3,4,5,6,8} and reported in CSI part 1, and {Lₙ} values are selected from a sub-table of Table 6 associated with the selected value of Lₜₒₜ and reported in CSI part 2.
When N_{TRP}=3 (or N=3), Lₜₒₜ is selected from {1,2,3,4,5,6,7,8,9,10,12} and reported in CSI part 1, and {Lₙ} values are selected from a sub-table of Table 6 associated with the selected value of Lₜₒₜ and reported in CSI part 2.
When N_{TRP}=4 (or N=4), Lₜₒₜ is selected from {1,2,3,4,5,6,7,8,9,10,11,12,13,14,16} and reported in CSI part 1, and {Lₙ} values are selected from a sub-table of Table 6 associated with the selected value of Lₜₒₜ and reported in CSI part 2.

In one embodiment, a UE evaluates a sub-table of Table 11 associated with {Lₙ} such that Lₙ₁≥Lₙ₂ (non-increasing order) when n1<n2, (similar way as shown in Table 8), and selects one index in the sub table.

In one example, the ordering of the TRP can be configured by the NW 130, via e.g., RRC, or MAC CE or, DCI.

In another example/embodiment, Lₙ can allow 0 in addition to {1,2,4}. For example, similar to Table 7 and Table 9 construction, Table 10 replacing blanks with 0 values can be used for the examples/embodiments described herein or the examples/embodiments described herein that are related to Table 10. For the space limitation, we omitted showing Table 10 replacing blanks with 0 values, but it can be understood as another example/embodiment.

In one example, each Lₙ is selected from {1,2,4} for selected N TRPs and Table 12 can be used for {Lₙ} values (or Lₜₒₜ=Σₙ Lₙ). In one example, only a subset of the table is used/configured for {Lₙ} reporting. For example, the portion of the table corresponding to Lₜₒₜ>t can't be used for {Lₙ} reporting, where t is threshold that can be fixed (e.g., 18 or 20 or 22 or 24), or configured, or reported by the UE 116 (via UE capability).

TABLE 12

| Index | N | L₁ | L₂ | L₃ | L₄ | Lₜₒₜ |
|---|---|---|---|---|---|---|
| 1 | 1 | 1 | | | | 1 |
| 2 | | 2 | | | | 2 |
| 3 | | 4 | | | | 4 |
| 4 | | 6 | | | | 6 |
| 5 | 2 | 1 | 1 | | | 2 |
| 6 | | 1 | 2 | | | 3 |
| 7 | | 1 | 4 | | | 5 |
| 8 | | 1 | 6 | | | 7 |
| 9 | | 2 | 1 | | | 3 |
| 10 | | 2 | 2 | | | 4 |
| 11 | | 2 | 4 | | | 6 |
| 12 | | 2 | 6 | | | 8 |
| 13 | | 4 | 1 | | | 5 |
| 14 | | 4 | 2 | | | 6 |
| 15 | | 4 | 4 | | | 8 |
| 16 | | 4 | 6 | | | 10 |
| 17 | | 6 | 1 | | | 7 |
| 18 | | 6 | 2 | | | 8 |
| 19 | | 6 | 4 | | | 10 |
| 20 | | 6 | 6 | | | 12 |
| 21 | 3 | 1 | 1 | 1 | | 3 |
| 22 | | 1 | 1 | 2 | | 4 |
| 23 | | 1 | 1 | 4 | | 6 |
| 24 | | 1 | 1 | 6 | | 8 |
| 25 | | 1 | 2 | 1 | | 4 |
| 26 | | 1 | 2 | 2 | | 5 |
| 27 | | 1 | 2 | 4 | | 7 |
| 28 | | 1 | 2 | 6 | | 9 |
| 29 | | 1 | 4 | 1 | | 6 |
| 30 | | 1 | 4 | 2 | | 7 |
| 31 | | 1 | 4 | 4 | | 9 |
| 32 | | 1 | 4 | 6 | | 11 |
| 33 | | 1 | 6 | 1 | | 8 |
| 34 | | 1 | 6 | 2 | | 9 |
| 35 | | 1 | 6 | 4 | | 11 |
| 36 | | 1 | 6 | 6 | | 13 |
| 37 | | 2 | 1 | 1 | | 4 |
| 38 | | 2 | 1 | 2 | | 5 |
| 39 | | 2 | 1 | 4 | | 7 |
| 40 | | 2 | 1 | 6 | | 9 |
| 41 | | 2 | 2 | 1 | | 5 |
| 42 | | 2 | 2 | 2 | | 6 |
| 43 | | 2 | 2 | 4 | | 8 |
| 44 | | 2 | 2 | 6 | | 10 |
| 45 | | 2 | 4 | 1 | | 7 |
| 46 | | 2 | 4 | 2 | | 8 |
| 47 | | 2 | 4 | 4 | | 10 |
| 48 | | 2 | 4 | 6 | | 12 |
| 49 | | 2 | 6 | 1 | | 9 |
| 50 | | 2 | 6 | 2 | | 10 |
| 51 | | 2 | 6 | 4 | | 12 |
| 52 | | 2 | 6 | 6 | | 14 |
| 53 | | 4 | 1 | 1 | | 6 |
| 54 | | 4 | 1 | 2 | | 7 |
| 55 | | 4 | 1 | 4 | | 9 |
| 56 | | 4 | 1 | 6 | | 11 |
| 57 | | 4 | 2 | 1 | | 7 |
| 58 | | 4 | 2 | 2 | | 8 |
| 59 | | 4 | 2 | 4 | | 10 |
| 60 | | 4 | 2 | 6 | | 12 |
| 61 | | 4 | 4 | 1 | | 9 |
| 62 | | 4 | 4 | 2 | | 10 |
| 63 | | 4 | 4 | 4 | | 12 |
| 64 | | 4 | 4 | 6 | | 14 |
| 65 | | 4 | 6 | 1 | | 11 |
| 66 | | 4 | 6 | 2 | | 12 |
| 67 | | 4 | 6 | 4 | | 14 |
| 68 | | 4 | 6 | 6 | | 16 |
| 69 | | 6 | 1 | 1 | | 8 |
| 70 | | 6 | 1 | 2 | | 9 |
| 71 | | 6 | 1 | 4 | | 11 |
| 72 | | 6 | 1 | 6 | | 13 |
| 73 | | 6 | 2 | 1 | | 9 |
| 74 | | 6 | 2 | 2 | | 10 |
| 75 | | 6 | 2 | 4 | | 12 |
| 76 | | 6 | 2 | 6 | | 14 |
| 77 | | 6 | 4 | 1 | | 11 |
| 78 | | 6 | 4 | 2 | | 12 |
| 79 | | 6 | 4 | 4 | | 14 |
| 80 | | 6 | 4 | 6 | | 16 |
| 81 | | 6 | 6 | 1 | | 13 |
| 82 | | 6 | 6 | 2 | | 14 |
| 83 | | 6 | 6 | 4 | | 16 |
| 84 | | 6 | 6 | 6 | | 18 |
| 85 | 4 | 1 | 1 | 1 | 1 | 4 |
| 86 | | 1 | 1 | 1 | 2 | 5 |
| 87 | | 1 | 1 | 1 | 4 | 7 |
| 88 | | 1 | 1 | 1 | 6 | 9 |
| 89 | | 1 | 1 | 2 | 1 | 5 |
| 90 | | 1 | 1 | 2 | 2 | 6 |
| 91 | | 1 | 1 | 2 | 4 | 8 |
| 92 | | 1 | 1 | 2 | 6 | 10 |
| 93 | | 1 | 1 | 4 | 1 | 7 |
| 94 | | 1 | 1 | 4 | 2 | 8 |
| 95 | | 1 | 1 | 4 | 4 | 10 |
| 96 | | 1 | 1 | 4 | 6 | 12 |
| 97 | | 1 | 1 | 6 | 1 | 9 |
| 98 | | 1 | 1 | 6 | 2 | 10 |
| 99 | | 1 | 1 | 6 | 4 | 12 |
| 100 | | 1 | 1 | 6 | 6 | 14 |
| 101 | | 1 | 2 | 1 | 1 | 5 |
| 102 | | 1 | 2 | 1 | 2 | 6 |
| 103 | | 1 | 2 | 1 | 4 | 8 |
| 104 | | 1 | 2 | 1 | 6 | 10 |
| 105 | | 1 | 2 | 2 | 1 | 6 |
| 106 | | 1 | 2 | 2 | 2 | 7 |
| 107 | | 1 | 2 | 2 | 4 | 9 |
| 108 | | 1 | 2 | 2 | 6 | 11 |
| 109 | | 1 | 2 | 4 | 1 | 8 |
| 110 | | 1 | 2 | 4 | 2 | 9 |
| 111 | | 1 | 2 | 4 | 4 | 11 |
| 112 | | 1 | 2 | 4 | 6 | 13 |
| 113 | | 1 | 2 | 6 | 1 | 10 |
| 114 | | 1 | 2 | 6 | 2 | 11 |
| 115 | | 1 | 2 | 6 | 4 | 13 |
| 116 | | 1 | 2 | 6 | 6 | 15 |
| 117 | | 1 | 4 | 1 | 1 | 7 |
| 118 | | 1 | 4 | 1 | 2 | 8 |
| 119 | | 1 | 4 | 1 | 4 | 10 |
| 120 | | 1 | 4 | 1 | 6 | 12 |
| 121 | | 1 | 4 | 2 | 1 | 8 |
| 122 | | 1 | 4 | 2 | 2 | 9 |
| 123 | | 1 | 4 | 2 | 4 | 11 |
| 124 | | 1 | 4 | 2 | 6 | 13 |
| 125 | | 1 | 4 | 4 | 1 | 10 |
| 126 | | 1 | 4 | 4 | 2 | 11 |
| 127 | | 1 | 4 | 4 | 4 | 13 |
| 128 | | 1 | 4 | 4 | 6 | 15 |
| 129 | | 1 | 4 | 6 | 1 | 12 |
| 130 | | 1 | 4 | 6 | 2 | 13 |
| 131 | | 1 | 4 | 6 | 4 | 15 |
| 132 | | 1 | 4 | 6 | 6 | 17 |
| 133 | | 1 | 6 | 1 | 1 | 9 |
| 134 | | 1 | 6 | 1 | 2 | 10 |
| 135 | | 1 | 6 | 1 | 4 | 12 |
| 136 | | 1 | 6 | 1 | 6 | 14 |
| 137 | | 1 | 6 | 2 | 1 | 10 |
| 138 | | 1 | 6 | 2 | 2 | 11 |
| 139 | | 1 | 6 | 2 | 4 | 13 |
| 140 | | 1 | 6 | 2 | 6 | 15 |
| 141 | | 1 | 6 | 4 | 1 | 12 |
| 142 | | 1 | 6 | 4 | 2 | 13 |
| 143 | | 1 | 6 | 4 | 4 | 15 |
| 144 | | 1 | 6 | 4 | 6 | 17 |
| 145 | | 1 | 6 | 6 | 1 | 14 |
| 146 | | 1 | 6 | 6 | 2 | 15 |
| 147 | | 1 | 6 | 6 | 4 | 17 |
| 148 | | 1 | 6 | 6 | 6 | 19 |
| 149 | | 2 | 1 | 1 | 1 | 5 |
| 150 | | 2 | 1 | 1 | 2 | 6 |
| 151 | | 2 | 1 | 1 | 4 | 8 |
| 152 | | 2 | 1 | 1 | 6 | 10 |
| 153 | | 2 | 1 | 2 | 1 | 6 |
| 154 | | 2 | 1 | 2 | 2 | 7 |
| 155 | | 2 | 1 | 2 | 4 | 9 |
| 156 | | 2 | 1 | 2 | 6 | 11 |
| 157 | | 2 | 1 | 4 | 1 | 8 |
| 158 | | 2 | 1 | 4 | 2 | 9 |
| 159 | | 2 | 1 | 4 | 4 | 11 |
| 160 | | 2 | 1 | 4 | 6 | 13 |
| 161 | | 2 | 1 | 6 | 1 | 10 |
| 162 | | 2 | 1 | 6 | 2 | 11 |
| 163 | | 2 | 1 | 6 | 4 | 13 |
| 164 | | 2 | 1 | 6 | 6 | 15 |
| 165 | | 2 | 2 | 1 | 1 | 6 |
| 166 | | 2 | 2 | 1 | 2 | 7 |
| 167 | | 2 | 2 | 1 | 4 | 9 |
| 168 | | 2 | 2 | 1 | 6 | 11 |
| 169 | | 2 | 2 | 2 | 1 | 7 |
| 170 | | 2 | 2 | 2 | 2 | 8 |
| 171 | | 2 | 2 | 2 | 4 | 10 |
| 172 | | 2 | 2 | 2 | 6 | 12 |
| 173 | | 2 | 2 | 4 | 1 | 9 |
| 174 | | 2 | 2 | 4 | 2 | 10 |
| 175 | | 2 | 2 | 4 | 4 | 12 |
| 176 | | 2 | 2 | 4 | 6 | 14 |
| 177 | | 2 | 2 | 6 | 1 | 11 |
| 178 | | 2 | 2 | 6 | 2 | 12 |
| 179 | | 2 | 2 | 6 | 4 | 14 |
| 180 | | 2 | 2 | 6 | 6 | 16 |
| 181 | | 2 | 4 | 1 | 1 | 8 |
| 182 | | 2 | 4 | 1 | 2 | 9 |
| 183 | | 2 | 4 | 1 | 4 | 11 |
| 184 | | 2 | 4 | 1 | 6 | 13 |
| 185 | | 2 | 4 | 2 | 1 | 9 |
| 186 | | 2 | 4 | 2 | 2 | 10 |
| 187 | | 2 | 4 | 2 | 4 | 12 |
| 188 | | 2 | 4 | 2 | 6 | 14 |
| 189 | | 2 | 4 | 4 | 1 | 11 |
| 190 | | 2 | 4 | 4 | 2 | 12 |
| 191 | | 2 | 4 | 4 | 4 | 14 |
| 192 | | 2 | 4 | 4 | 6 | 16 |
| 193 | | 2 | 4 | 6 | 1 | 13 |
| 194 | | 2 | 4 | 6 | 2 | 14 |
| 195 | | 2 | 4 | 6 | 4 | 16 |
| 196 | | 2 | 4 | 6 | 6 | 18 |
| 197 | | 2 | 6 | 1 | 1 | 10 |
| 198 | | 2 | 6 | 1 | 2 | 11 |
| 199 | | 2 | 6 | 1 | 4 | 13 |
| 200 | | 2 | 6 | 1 | 6 | 15 |
| 201 | | 2 | 6 | 2 | 1 | 11 |
| 202 | | 2 | 6 | 2 | 2 | 12 |
| 203 | | 2 | 6 | 2 | 4 | 14 |
| 204 | | 2 | 6 | 2 | 6 | 16 |
| 205 | | 2 | 6 | 4 | 1 | 13 |
| 206 | | 2 | 6 | 4 | 2 | 14 |
| 207 | | 2 | 6 | 4 | 4 | 16 |
| 208 | | 2 | 6 | 4 | 6 | 18 |
| 209 | | 2 | 6 | 6 | 1 | 15 |
| 210 | | 2 | 6 | 6 | 2 | 16 |
| 211 | | 2 | 6 | 6 | 4 | 18 |
| 212 | | 2 | 6 | 6 | 6 | 20 |
| 213 | | 4 | 1 | 1 | 1 | 7 |
| 214 | | 4 | 1 | 1 | 2 | 8 |
| 215 | | 4 | 1 | 1 | 4 | 10 |
| 216 | | 4 | 1 | 1 | 6 | 12 |
| 217 | | 4 | 1 | 2 | 1 | 8 |
| 218 | | 4 | 1 | 2 | 2 | 9 |
| 219 | | 4 | 1 | 2 | 4 | 11 |
| 220 | | 4 | 1 | 2 | 6 | 13 |
| 221 | | 4 | 1 | 4 | 1 | 10 |
| 222 | | 4 | 1 | 4 | 2 | 11 |
| 223 | | 4 | 1 | 4 | 4 | 13 |
| 224 | | 4 | 1 | 4 | 6 | 15 |
| 225 | | 4 | 1 | 6 | 1 | 12 |
| 226 | | 4 | 1 | 6 | 2 | 13 |
| 227 | | 4 | 1 | 6 | 4 | 15 |
| 228 | | 4 | 1 | 6 | 6 | 17 |
| 229 | | 4 | 2 | 1 | 1 | 8 |
| 230 | | 4 | 2 | 1 | 2 | 9 |
| 231 | | 4 | 2 | 1 | 4 | 11 |
| 232 | | 4 | 2 | 1 | 6 | 13 |
| 233 | | 4 | 2 | 2 | 1 | 9 |
| 234 | | 4 | 2 | 2 | 2 | 10 |
| 235 | | 4 | 2 | 2 | 4 | 12 |
| 236 | | 4 | 2 | 2 | 6 | 14 |
| 237 | | 4 | 2 | 4 | 1 | 11 |
| 238 | | 4 | 2 | 4 | 2 | 12 |
| 239 | | 4 | 2 | 4 | 4 | 14 |
| 240 | | 4 | 2 | 4 | 6 | 16 |
| 241 | | 4 | 2 | 6 | 1 | 13 |
| 242 | | 4 | 2 | 6 | 2 | 14 |
| 243 | | 4 | 2 | 6 | 4 | 16 |
| 244 | | 4 | 2 | 6 | 6 | 18 |
| 245 | | 4 | 4 | 1 | 1 | 10 |
| 246 | | 4 | 4 | 1 | 2 | 11 |
| 247 | | 4 | 4 | 1 | 4 | 13 |
| 248 | | 4 | 4 | 1 | 6 | 15 |
| 249 | | 4 | 4 | 2 | 1 | 11 |
| 250 | | 4 | 4 | 2 | 2 | 12 |
| 251 | | 4 | 4 | 2 | 4 | 14 |
| 252 | | 4 | 4 | 2 | 6 | 16 |
| 253 | | 4 | 4 | 4 | 1 | 13 |
| 254 | | 4 | 4 | 4 | 2 | 14 |
| 255 | | 4 | 4 | 4 | 4 | 16 |
| 256 | | 4 | 4 | 4 | 6 | 18 |
| 257 | | 4 | 4 | 6 | 1 | 15 |
| 258 | | 4 | 4 | 6 | 2 | 16 |
| 259 | | 4 | 4 | 6 | 4 | 18 |
| 260 | | 4 | 4 | 6 | 6 | 20 |
| 261 | | 4 | 6 | 1 | 1 | 12 |
| 262 | | 4 | 6 | 1 | 2 | 13 |
| 263 | | 4 | 6 | 1 | 4 | 15 |
| 264 | | 4 | 6 | 1 | 6 | 17 |
| 265 | | 4 | 6 | 2 | 1 | 13 |
| 266 | | 4 | 6 | 2 | 2 | 14 |
| 267 | | 4 | 6 | 2 | 4 | 16 |
| 268 | | 4 | 6 | 2 | 6 | 18 |
| 269 | | 4 | 6 | 4 | 1 | 15 |
| 270 | | 4 | 6 | 4 | 2 | 16 |
| 271 | | 4 | 6 | 4 | 4 | 18 |
| 272 | | 4 | 6 | 4 | 6 | 20 |
| 273 | | 4 | 6 | 6 | 1 | 17 |
| 274 | | 4 | 6 | 6 | 2 | 18 |
| 275 | | 4 | 6 | 6 | 4 | 20 |
| 276 | | 4 | 6 | 6 | 6 | 22 |
| 277 | | 6 | 1 | 1 | 1 | 9 |
| 278 | | 6 | 1 | 1 | 2 | 10 |
| 279 | | 6 | 1 | 1 | 4 | 12 |
| 280 | | 6 | 1 | 1 | 6 | 14 |
| 281 | | 6 | 1 | 2 | 1 | 10 |
| 282 | | 6 | 1 | 2 | 2 | 11 |
| 283 | | 6 | 1 | 2 | 4 | 13 |
| 284 | | 6 | 1 | 2 | 6 | 15 |
| 285 | | 6 | 1 | 4 | 1 | 12 |
| 286 | | 6 | 1 | 4 | 2 | 13 |
| 287 | | 6 | 1 | 4 | 4 | 15 |
| 288 | | 6 | 1 | 4 | 6 | 17 |
| 289 | | 6 | 1 | 6 | 1 | 14 |
| 290 | | 6 | 1 | 6 | 2 | 15 |
| 291 | | 6 | 1 | 6 | 4 | 17 |
| 292 | | 6 | 1 | 6 | 6 | 19 |
| 293 | | 6 | 2 | 1 | 1 | 10 |
| 294 | | 6 | 2 | 1 | 2 | 11 |
| 295 | | 6 | 2 | 1 | 4 | 13 |
| 296 | | 6 | 2 | 1 | 6 | 15 |
| 297 | | 6 | 2 | 2 | 1 | 11 |
| 298 | | 6 | 2 | 2 | 2 | 12 |
| 299 | | 6 | 2 | 2 | 4 | 14 |
| 300 | | 6 | 2 | 2 | 6 | 16 |
| 301 | | 6 | 2 | 4 | 1 | 13 |
| 302 | | 6 | 2 | 4 | 2 | 14 |
| 303 | | 6 | 2 | 4 | 4 | 16 |
| 304 | | 6 | 2 | 4 | 6 | 18 |
| 305 | | 6 | 2 | 6 | 1 | 15 |
| 306 | | 6 | 2 | 6 | 2 | 16 |
| 307 | | 6 | 2 | 6 | 4 | 18 |
| 308 | | 6 | 2 | 6 | 6 | 20 |
| 309 | | 6 | 4 | 1 | 1 | 12 |
| 310 | | 6 | 4 | 1 | 2 | 13 |
| 311 | | 6 | 4 | 1 | 4 | 15 |
| 312 | | 6 | 4 | 1 | 6 | 17 |
| 313 | | 6 | 4 | 2 | 1 | 13 |
| 314 | | 6 | 4 | 2 | 2 | 14 |
| 315 | | 6 | 4 | 2 | 4 | 16 |
| 316 | | 6 | 4 | 2 | 6 | 18 |
| 317 | | 6 | 4 | 4 | 1 | 15 |
| 318 | | 6 | 4 | 4 | 2 | 16 |
| 319 | | 6 | 4 | 4 | 4 | 18 |
| 320 | | 6 | 4 | 4 | 6 | 20 |
| 321 | | 6 | 4 | 6 | 1 | 17 |
| 322 | | 6 | 4 | 6 | 2 | 18 |
| 323 | | 6 | 4 | 6 | 4 | 20 |
| 324 | | 6 | 4 | 6 | 6 | 22 |
| 325 | | 6 | 6 | 1 | 1 | 14 |
| 326 | | 6 | 6 | 1 | 2 | 15 |
| 327 | | 6 | 6 | 1 | 4 | 17 |
| 328 | | 6 | 6 | 1 | 6 | 19 |
| 329 | | 6 | 6 | 2 | 1 | 15 |
| 330 | | 6 | 6 | 2 | 2 | 16 |
| 331 | | 6 | 6 | 2 | 4 | 18 |
| 332 | | 6 | 6 | 2 | 6 | 20 |
| 333 | | 6 | 6 | 4 | 1 | 17 |
| 334 | | 6 | 6 | 4 | 2 | 18 |
| 335 | | 6 | 6 | 4 | 4 | 20 |
| 336 | | 6 | 6 | 4 | 6 | 22 |
| 337 | | 6 | 6 | 6 | 1 | 19 |
| 338 | | 6 | 6 | 6 | 2 | 20 |
| 339 | | 6 | 6 | 6 | 4 | 22 |
| 340 | | 6 | 6 | 6 | 6 | 24 |

In one example, UE evaluates the sub-table of Table 12 associated with N≤N_{TRP} and selects one index in the sub-table.
For example, when N_{TRP}=4 is configured by higher-layer signaling, the UE 116 evaluates the whole table of Table 12 and selects/reports one index. In this case, an indicator with ┌log₂ 340┐=9 bits is necessary to indicate {Lₙ} values.
For example, when N_{TRP}=3 is configured by higher-layer signaling, the UE 116 evaluates the sub-table of Table 12 having from index 1 to index 84 (those are associated with N≤N_{TRP}=3) and selects/reports one index. In this case, an indicator with ┌log₂ 84┐=7 bits is necessary to indicate {Lₙ} values.
For example, when N_{TRP}=2 is configured by higher-layer signaling, the UE 116 evaluates the sub-table of Table 12 having from index 1 to index 20 (those are associated with N≤N_{TRP}=2) and selects/reports one index. In this case, an indicator with ┌log₂ 20┐=5 bits is necessary to indicate {Lₙ} values.
For example, when N_{TRP}=1 is configured by higher-layer signaling, the UE 116 evaluates the sub-table of Table 12 having from index 1 to index 3 (those are associated with N≤N_{TRP}=1) and selects/reports one index. In this case, an indicator with ┌log₂ 4┐=2 bit is necessary to indicate {Lₙ} values.

When N<N_{TRP} is selected (via N_{TRP}-bit bitmap), the indexes of the selected TRPs (or CSI-RS resources) can be remapped to 1 to N, which will be corresponding to the indexes of selected {Lₙ}. In one example, from the lowest index to highest index for the selected TRPs, their indexes are remapped to 1 to N. For example, when N_{TRP}=4 and the 4-bit bitmap indicator for TRP selection is ‘0101’ (assuming LSB corresponds to TRP 1 and MSB corresponds to TRP 4), the selected TRP 1 and TRP 3 are associated with L₁ and L₂, respectively. In another example, from the highest index to lowest index for the selected TRPs, their indexes are remapped to 1 to N. For example, when N_{TRP}=4 and the 4-bit bitmap indicator for TRP selection is ‘0101’ (assuming LSB corresponds to TRP 1 and MSB corresponds to TRP 4), the selected TRP 3 and TRP 1 are associated with L₁ and L₂, respectively.

In one example, the UE 116 shall not report any index associated with N′≠N, i.e., any index associated with not the number of selected TRPs.

In one embodiment, a value of Lₜₒₜ is reported in CSI part 1, and {Lₙ} values can be reported in CSI part 2 (e.g., via separate indicator, or via a joint indicator).

In one example:
when N_{TRP}=2 (or N=2), Lₜₒₜ is selected from {1,2,3,4,5,6,7,8,10,12} and reported in CSI part 1, and {Lₙ} values are selected from a sub-table of Table 6 associated with the selected value of Lₜₒₜ and reported in CSI part 2.
When N_{TRP}=3 (or N=3), Lₜₒₜ is selected from {1,2,3,4,5,6,7,8,9,10,11,12,13,14,16,18} and reported in CSI part 1, and {Lₙ} values are selected from a sub-table of Table 6 associated with the selected value of Lₜₒₜ and reported in CSI part 2.
When N_{TRP}=4 (or N=4), Lₜₒₜ is selected from {1,2,3,4,5,6,7,8,9,10,11,12,13,14,15,16,17,18,19,20,22,24} and reported in CSI part 1, and {Lₙ} values are selected from a sub-table of Table 6 associated with the selected value of Lₜₒₜ and reported in CSI part 2.

In one embodiment, a UE evaluates a sub-table of Table 12 associated with {Lₙ} such that Lₙ₁≥Lₙ₂ (non-increasing order) when n1<n2, (similar way as shown in Table 8), and selects one index in the sub table.

In one example, the ordering of the TRP can be configured by the NW 130, via e.g., RRC, or MAC CE or, DCI.

In another example/embodiment, Lₙ can allow 0 in addition to {1,2,4}. For example, similar to Table 7 and Table 9 construction, Table 12 replacing blanks with 0 values can be used for the examples/embodiments described herein or the examples/embodiments described herein that are related to Table 12. For the space limitation, we omitted showing Table 12 replacing blanks with 0 values, but it can be understood as another example/embodiment.

The approach described herein for the cases of Lₙ∈{2,4}, Lₙ∈{2,4,6}, Lₙ∈{1,2,4}, and Lₙ∈{1,2,4,6} can be extended to the case of any subset of {1,2,3,4,5,6} in the same manner. The tables provided in the present disclosure can include different parameter names, e.g., N can be replaced by N_{TRP} or/and Lₜₒₜ can be replaced by Lₘₐₓ. The parameter names can be used interchangeably. For the sake of space limitation, we omitted those in the present disclosure, but it should be interpreted as those variations being included in embodiments of the present disclosure.

In another embodiment, for one or more embodiments described herein, some combinations of the relative values of {Lₙ} (e.g., shown in each table of embodiment 1) can be restricted (cannot be used to report {Lₙ} or Lₜₒₜ) based on one or more aspects such as configured value of Lₘₐₓ, candidate-value restriction for {Lₙ}, the number of selected TRPs N, multiple candidate values of N, and UE capability.

In one embodiment, a UE evaluates a sub-table having {Lₙ} values such that Lₜₒₜ≤Lₘₐₓ, where Lₘₐₓ is NW-configured via higher-layer (RRC) signaling and selects one index in the sub-table. Hence, an indicator with a smaller size of bits (corresponding to the size of the sub-table) is necessary to indicate {Lₙ} values.

In one example, for the case that Lₙ is selected from {2,4} (i.e., for the case of Table 6), when Lₘₐₓ=8 and N_{TRP}=4 are configured, the sub-table having {Lₙ} values such that Lₜₒₜ≤Lₘₐₓ is as follows:

TABLE 13

| Index | N | L₁ | L₂ | L₃ | L₄ | Lₜₒₜ |
|---|---|---|---|---|---|---|
| 1 | 1 | 2 | | | | 2 |
| 2 | | 4 | | | | 4 |
| 3 | 2 | 2 | 2 | | | 4 |
| 4 | | 2 | 4 | | | 6 |
| 5 | | 4 | 2 | | | 6 |
| 6 | | 4 | 4 | | | 8 |
| 7 | 3 | 2 | 2 | 2 | | 6 |
| 8 | | 2 | 2 | 4 | | 8 |
| 9 | | 2 | 4 | 2 | | 8 |
| 11 | | 4 | 2 | 2 | | 8 |
| 15 | 4 | 2 | 2 | 2 | 2 | 8 |

In this case, the UE 116 selects one index from the sub-table (shown in Table 13) and an indicator with ┌log₂ 11┐=4 bits is necessary to indicate {Lₙ} values.

Similarly, we can evaluate other cases using another table (e.g., Table 6, Table 9 Table 11, Table 12) described in one or more embodiments described herein, when N_{TRP} and Lₘₐₓ are given (via higher-layer signaling).

In one embodiment, a UE evaluates a sub-table having {Lₙ} values associated with the value of N, where N is the number of selected TRPs, which is inferred from N_{TRP}-bit bitmap in CSI part 1, and the UE 116 selects one index in the sub-table and reports it. Hence, an indicator with a smaller size of bits (corresponding to the size of the sub-table) is necessary to indicate {Lₙ} values.

In one example, for the case that Lₙ is selected from {2,4} (i.e., for the case of Table 6), when N=3 is inferred from N_{TRP}-bit bitmap in CSI part 1, the sub-table having {Lₙ} values associated with the value of N=3 is as follows:

TABLE 14

| Index | N | L₁ | L₂ | L₃ | L₄ | Lₜₒₜ |
|---|---|---|---|---|---|---|
| 7 | 3 | 2 | 2 | 2 | | 6 |
| 8 | | 2 | 2 | 4 | | 8 |
| 9 | | 2 | 4 | 2 | | 8 |
| 10 | | 2 | 4 | 4 | | 10 |
| 11 | | 4 | 2 | 2 | | 8 |
| 12 | | 4 | 2 | 4 | | 10 |
| 13 | | 4 | 4 | 2 | | 10 |
| 14 | | 4 | 4 | 4 | | 12 |

In this case, the UE 116 selects one index from the sub-table (shown in Table 14) and an indicator with ┌log₂ 8┐=3 bits is necessary to indicate {Lₙ} values.

Similarly, we can evaluate other cases using another table (e.g., Table 6, Table 9, Table 11, Table 12) described in one or more embodiments described herein, when N is inferred from N_{TRP}-bit bitmap in CSI part 1.

In one embodiment, a UE evaluates a sub-table having {Lₙ} values associated with multiple values (or candidate values) of N, where the multiple values of N are configured by the NW 130 via higher-layer signaling (RRC), and the UE 116 selects one index in the sub-table and reports it. Hence, an indicator with a smaller size of bits (corresponding to the size of the sub-table) is necessary to indicate {Lₙ} values.

In one example, for the case that Lₙ is selected from {2,4} (i.e., for the case of Table 6), when multiple values of N, e.g., 2 and 3, are configured, the sub-table having {Lₙ} values associated with the values of N=2 and N=3 is as follows:

TABLE 15

| | | | | | | |
|---|---|---|---|---|---|---|
| Index | N | L₁ | L₂ | L₃ | L₄ | Lₜₒₜ |

| | | | | | |
|---|---|---|---|---|---|
| 3 | 2 | 2 | 2 | | 4 |
| 4 | | 2 | 4 | | 6 |
| 5 | | 4 | 2 | | 6 |
| 6 | | 4 | 4 | | 8 |
| 7 | 3 | 2 | 2 | 2 | 6 |
| 8 | | 2 | 2 | 4 | 8 |
| 9 | | 2 | 4 | 2 | 8 |
| 10 | | 2 | 4 | 4 | 10 |
| 11 | | 4 | 2 | 2 | 8 |
| 12 | | 4 | 2 | 4 | 10 |
| 13 | | 4 | 4 | 2 | 10 |
| 14 | | 4 | 4 | 4 | 12 |

In this case, the UE 116 selects one index from the sub-table (shown in 15) and an indicator with ┌log₂ 12┐=4 bits is necessary to indicate {Lₙ} values.

Similarly, we can evaluate other cases using another table (e.g., Table 6, Table 9, Table 11, Table 12) described one or more embodiments herein, when multiple values (candidate values) of N are configured by the NW 130.

In one example, for the case that Lₙ is selected from {2,4} (i.e., for the case of Table 6), when N=N_{TRP} is configured, the sub-table having {Lₙ} values associated with the value of N=N_{TRP} is evaluated and the UE 116 selects and reports one index from the sub-table.

Similarly, we can evaluate other cases using another table (e.g., Table 6, Table 9, Table 11, Table 12) described in one or more embodiments herein, when N=N_{TRP} is configured by the NW 130.

In one embodiment, a UE does not report {Lₙ} values when N=N_{TRP} is configured by the NW 130 via higher-layer signaling, i.e., no reporting on {Lₙ} values in neither CSI part 1 nor CSI part 2.

In one example, Lₙ=L∈ [symbol] for each n=1, . . . , N_{TRP}, can be configured by the NW 130, where [symbol] ={2,4}, {2,4,6}, {1,2,4,6}, {1,2,4} or a subset of {1,2,3,4,5,6}.

In one embodiment, a UE evaluates a sub-table having {Lₙ} values associated with candidate values of {Lₙ} (a subset of the whole set [symbol] ), where the candidate values of {Lₙ} are configured by the NW 130 via higher-layer signaling (RRC), and the UE 116 selects one index in the sub-table and reports it. Hence, an indicator with a smaller size of bits (corresponding to the size of the sub-table) is necessary to indicate {Lₙ} values.

In one embodiment, a UE evaluates a sub-table having {Lₙ} values associated with any joint of the restrictions described in one or more embodiments herein, and the UE 116 selects one index in the sub-table and reports it. Hence, an indicator with a smaller size of bits (corresponding to the size of the sub-table) is necessary to indicate {Lₙ} values.

In one embodiment, a UE reports its capability such as not supporting Lₙ or Lₘₐₓ or Lₜₒₜ values, not supporting N or N_{TRP} values, or supporting Lₙ or Lₘₐₓ or Lₜₒₜ values, or supporting N or N_{TRP} values. In this case, the NW 130 has to evaluate the UE 116 capability and configures parameters associated with the reported UE capability. Also, the NW 130 expects that the UE 116 reports {Lₙ} values associated with the UE 116 capability.

In one embodiment, a UE may not report {Lₙ} values (e.g., in uplink control information (UCI)/CSI part 1).

In one example, for cases where one combination can be possible to select given a configuration, e.g., a sub-table size by the configuration is equal to 1.
In one example, N_{TRP}=1 and Lₘₐₓ=2
In one example, N_{TRP}=N, Lₘₐₓ=2N_{TRP}, in which Lₙ=2 for n=1, . . . , N_{TRP}.
. . .

In one example, {Lₙ} is not reported when N_{TRP}=1.

In one example, {Lₙ} is not reported when Lₙ=2 for each n is the only possible candidate value.

In one example, {Lₙ} is not reported when only one candidate value for {Lₙ} is possible (e.g., by configuration). For example, codebook subset restriction or other higher layer (RRC) signaling can be used for this configuration.

In another embodiment, on the SD basis selection for (Rel-18) Type-II codebook refinement for CJT mTRP, each of the {Lₙ, n=1, . . . , N_{TRP}} is configured by the NW 130 via higher-layer (RRC) signaling, where N_{TRP} is a number of TRPs configured by the NW 130.

In one example, Lₙ∈{2,4,6}. In one example, Lₙ∈{1,2,4,6}. In one example, Lₙ∈{1,2,3,4,5,6}. In one example, In one example, Lₙ∈{1,2,3,4}. In one example, Lₙ∈{1,2,3}. In one example, Lₙ∈{1,2,4}. In one example, Lₙ can be selected from [symbol] ₙ, where [symbol] ₙ is a subset of {1,2,3,4,5,6}.

In another embodiment, on the SD basis selection for (Rel-18) Type-II codebook refinement for CJT mTRP, a value of Lₘₐₓ, where Lₘₐₓ≥Σₙ₌₁^{N}^{_{TRP}} Lₙ or/and the (relative) value(s) of {Lₙ, n=1, . . . , N_{TRP}} are configured by the NW 130 via higher-layer (RRC) signaling, where N_{TRP} is a number of TRPs (CSI-RS resources) configured by the NW 130. The relative value(s) of {Lₙ, n=1, . . . , N_{TRP}} can be signaled by using a joint indicator or multiple separate indicators.

In one embodiment, on the SD basis selection for (Rel-18) Type-II codebook refinement for CJT mTRP, a set of N_{L}≥>1 combinations of values for {Lₙ, n=1, . . . , N_{TRP}} is configured by the NW 130 via higher-layer (RRC) signaling, where N_{TRP} is a number of TRPs (CSI-RS resources) configured by the NW 130. The N_{L} combinations of value(s) for {Lₙ, n=1, . . . , N_{TRP}} can be signaled by using a joint indicator or multiple separate indicators. In one example, N_{L}=1. In another example, N_{L}≥>1.

In one example, Lₙ∈{2,4,6}. In one example, Lₙ∈{1,2,4,6}. In one example, Lₙ∈{1,2,3,4,5,6}. In one example, In one example, Lₙ∈{1,2,3,4}. In one example, Lₙ∈{1,2,3}. In one example, Lₙ∈{1,2,4}. In one example, Lₙ can be selected from [symbol] ₙ, where [symbol] ₙ is a subset of {1,2,3,4,5,6}.

In one example, {Lₙ} values can be configured based on at least one of the tables (or any table (i.e., sub-table, whole table) that can be constructed as) described in the present disclosure (especially in one or more embodiments described herein).

In one example, N_{L} can be explicitly configured via higher-layer (RRC) signaling with a separate parameter. The possible values for N_{L} are a set of [symbol] , i.e., one of the values is selected from [symbol] . Let denote a total number of a table including combinations of values for {Lₙ, n=1, . . . , N_{TRP}} by N_{T}. In one example,

$$⌈ {log}_{2} ( \begin{matrix}{N}_{T} \\ {N}_{L}\end{matrix} ) ⌉$$

bit size parameter can be configured to indicate N_{L} combinations of values for {Lₙ,n=1, . . . , N_{TRP}}. In one example, the table can be any table (whole table or sub-table) described in the present disclosure or any table that can be constructed as described in the present disclosure (especially in one or more embodiments described herein). In one example, the table can be any table described in the present disclosure (or any table that can be constructed as described in the present disclosure) wherein N is replaced by N_{TRP}. In one example, when N is replaced by N_{TRP} in the table, a UE applies Lₙ for CSI-RS resource (or TRP index) n, for n=1, . . . , N_{TRP}. For example, when an N_{TRP}-bit bitmap for TRP selection is reported, the UE 116 uses Lₙ values for n values corresponding to the selected TRPs only, which are indicated in the bitmap.

In one example, N_{L} is implicitly determined or configured via higher-layer RRC signaling.
In one example, an N_{T}-bit bitmap is used to indicate N_{L} combinations of values for {Lₙ, n=1, . . . , N_{TRP}}, and N_{L} can be inferred from the configured N_{T}-bit bitmap.
(a) In one example, N_{L} combinations of values for {Lₙ, n=1, . . . , N_{TRP}} are determined from the configured {Lₙ} values and its associated Lₜₒₜ value. For example, one combination of the values for {Lₙ, n=1, . . . , N_{TRP}} is configured, and other combinations of the values for {Lₙ, n=1, . . . , N_{TRP}} associated with the same Lₜₒₜ for the configured combination are determined as N_{L}−1 combinations of values {Lₙ, n=1, . . . , N_{TRP}}.
(b) N_{L} combinations whose Lₜₒₜ(or Lₘₐₓ) value is less than (or equal to) Lₜₒₜ(or Lₘₐₓ) value associated with the configured {Lₙ} values can be determined.
In one example, N_{L} combinations of values for {Lₙ, n=1, . . . , N_{TRP}} are determined from the configured N_{TRP} (or N) and Lₜₒₜ(or Lₘₐₓ). For example, the combinations of values for {Lₙ, n=1, . . . , N_{TRP}} are determined, in one of the tables described in the present disclosure, corresponding to the configured N_{TRP} (or N) and Lₜₒₜ (or Lₘₐₓ).

In one example, when N_{L}≥>1, a UE reports an indicator with the size of ┌log₂ N_{L}┐-bit to indicate one selected combination of values for {Lₙ, n=1, . . . , N_{TRP}} in CSI part 1.

In one example, when N_{L}=1, a UE follows the configured {Lₙ} values, hence not reported.

In one example, N_{L} combinations of {Lₙ} is subject to the UE 116 capability on Lₜₒₜ or Lₘₐₓ.

When N=N_{TRP} is configured, (a) can be applied. When N=N_{TRP} is not configured (i.e., N<=N_{TRP}), (b) can be applied.

When N=N_{TRP} is configured, one example herein can be applied. When N=N_{TRP} is not configured (i.e., N<=N_{TRP}), another example herein can be applied.

In another embodiment, any combination of one or more embodiments described herein can be configured by the NW 130 via higher-layer (RRC) signaling. In one example, any combination or one or more embodiments described herein can be configured by the NW 130 via higher-layer RRC signaling.

In one embodiment, one or more embodiments described herein can be configured by the NW 130 via higher-layer (RRC) signaling.

In one embodiment, one or more embodiments described herein can be used only when N=N_{TRP} is configured, and one or more embodiments described herein can be used otherwise.

In one embodiment, one or more embodiments described herein can be used only when N=N_{TRP} is configured, and one or more embodiments described herein can be used otherwise.

In another embodiment, on the SD basis selection for (Rel-18) Type-II codebook refinement for CJT mTRP (Rel-17 port-selection codebook-based refinement), one or more embodiments described herein are also used for Rel-17 port selection codebook-based refinement. For example, Lₙ, Lₜₒₜ, Lₘₐₓ can be replaced by αₙ, αₜₒₜ, αₘₐₓ where

$${α}_{n} = \frac{{L}_{n}}{{N}_{1} {N}_{2}} , {α}_{tot} = \frac{{L}_{tot}}{{N}_{TRP} {N}_{1} {N}_{2}} ( or {α}_{tot} = \frac{{L}_{tot}}{{NN}_{1} {N}_{2}} ) , and$$

$${α}_{max} = \frac{{L}_{max}}{{N}_{TRP} {N}_{1} {N}_{2}} ( or {α}_{max} = \frac{{L}_{max}}{{NN}_{1} {N}_{2}} ) .$$

In another embodiment, on the SD basis selection for (Rel-18) Type-II codebook refinement for CJT mTRP (Rel-17 port-selection codebook based refinement),

$${α}_{max} \geq \frac{{\sum }_{n = 1}^{{N}_{TRP}} {L}_{n}}{{N}_{TRP} {N}_{1} {N}_{2}} = {α}_{tot}$$

is configured by the NW 130 via higher-layer (RRC) signaling and the value(s) of {αₙ, n=1, . . . , N_{TRP}} are reported by the UE 116, where N_{TRP} is a number of TRPs (CSI-RS resources) configured by the NW 130. The relative value(s) of {αₙ, n=1, . . . , N_{TRP}} can be selected from a table (or by using a joint indicator) and reported in CSI part 1.

When N_{TRP} is configured, N(≤N_{TRP}) out of N_{TRP} can be selected and reported in CSI part 1. For the selected N TRPs, associated an values are selected and indicated via an indicator. The indicator is included in CSI part 1 or CSI part 2.

In one embodiment, a table for {Lₙ} (which can be one of the possible tables described in the present disclosure) does not include at least one of the following combinations {Lₙ}=(4,4,2) and its permutations (e.g., (4,2,4), (2,4,4)) for N_{TRP}=3 and {Lₙ}=(4,4,4,2) and its permutations (e.g., (4,2,4,4), (4,4,2,4), (2,4,4,4)) for N_{TRP}=4.

TABLE 16

| Label | Index | N_{TRP} | {Lₙ} combinations |
|---|---|---|---|
| E1 | 1 | 1 | {2} |
| E2 | 2 | | {4} |
| E3 | 3 | | {6} |
| E4 | 4 | 2 | {2, 2} |
| E5 | 5 | | {2, 4} (and its permutation, {4, 2}) |
| E6 | 6 | | {4, 4} |
| E7 | 7 | | {2, 6} (and its permutation, {6, 2}) |
| E8 | 8 | | {4, 6} (and its permutation, {6, 4}) |
| E9 | 9 | 3 | {2, 2, 2} |
| E10 | 10 | | {2, 2, 4} (and its permutations) |
| E11 | 11 | | {4, 4, 4} |
| E12 | 12 | | {2, 2, 6} (and its permutations) |
| E13 | 13 | | {2, 4, 6} (and its permutations) |
| E14 | 14 | | {4, 4, 6} (and its permutations) |
| E15 | 15 | 4 | {2, 2, 2, 2} |
| E16 | 16 | | {2, 2, 2, 4} (and its permutations) |
| E17 | 17 | | {2, 2, 4, 4} (and its permutations) |
| E18 | 18 | | {4, 4, 4, 4} |
| E19 | 19 | | {2, 2, 2, 6} (and its permutations) |
| E20 | 20 | | {2, 2, 4, 6} (and its permutations) |
| E21 | 21 | | {2, 4, 4, 6} (and its permutations) |
| E22 | 22 | | {4, 4, 4, 6} (and its permutations) |

In one example, a supported number of combinations for the table of {Lₙ} is at most Q, e.g., Q=34, or Q=16 or Q=120, and at least U of {E1-E6 and E9-E11 and E15-E18} combinations, where 1≤U≤13, or one of {E1-E6 and E9-E11 and E15-E18} or each of {E1-E6 and E9-E11 and E15-E18} combinations in Table 16 are included in the at most Q combinations. In one example, each of {E1-E6 and E9-E11 and E15-E18} combinations in Table 16 is included (i.e., U=13) in the at most Q combinations.

Note that in Table 16 there are rows having one {Ln} combination and its permutation(s) in Table 16. In one example, for such a row, one combination (among the permutations) can be written as shown in Table 16. In another example, each permutation can be written in another row. In another example, each of the permutations can be written in one row. In one example, for only some of rows having one {Ln} combination and its permutation(s) (e.g., E5 and E10), each permutation can be written in another row.

In another example, a subset (some) of permutations can be written in one row. In another example, for each combination in a subset (some) of permutations can be written in another row of the table.

In one example, in addition to the U combinations, among the remaining (22-13) combinations in Table 16 (i.e., E7, E8, E12-E14, E19-E22), at least one combination is/are included the at most Q combinations.
In one example, one of the remaining {Lₙ} combinations in Table 16 (i.e., E7, E8, E12-E14, E19-E22) is included in the at most Q combinations.

$$( ( \begin{matrix}9 \\ 1\end{matrix} )$$

examples are omitted.)
In one example two of the remaining {Lₙ} combinations in Table 16 (i.e., E7, E8, E12-E14, E19-E22) are included in the at most Q combinations.

$$( ( \begin{matrix}9 \\ 2\end{matrix} )$$

examples are omitted.)
In one example three of the remaining {Lₙ} combinations in Table 16 (i.e., E7, E8, E12-E14, E19-E22) are included in the at most Q combinations.

$$( ( \begin{matrix}9 \\ 3\end{matrix} )$$

examples are omitted.)
In one example four of the remaining {Lₙ} combinations in Table 16 (i.e., E7, E8, E12-E14, E19-E22) are included in the at most Q combinations.

$$( ( \begin{matrix}9 \\ 4\end{matrix} )$$

examples are omitted.)
In one example five of the remaining {Lₙ} combinations in Table 16 (i.e., E7, E8, E12-E14, E19-E22) are included in the at most Q combinations.

$$( ( \begin{matrix}9 \\ 5\end{matrix} )$$

examples are omitted.)
In one example six of the remaining {Lₙ} combinations in Table 16 (i.e., E7, E8, E12-E14, E19-E22) are included in the at most Q combinations.

$$( ( \begin{matrix}9 \\ 6\end{matrix} )$$

examples are omitted.)
In one example seven of the remaining {Lₙ} combinations in Table 16 (i.e., E7, E8, E12-E14, E19-E22) are included in the at most Q combinations.

$$( ( \begin{matrix}9 \\ 7\end{matrix} )$$

examples are omitted.)
In one example eight of the remaining {Lₙ} combinations in Table 16 (i.e., E7, E8, E12-E14, E19-E22) are included in the at most Q combinations.

$$( ( \begin{matrix}9 \\ 8\end{matrix} )$$

examples are omitted.)
In one example each of the remaining {Lₙ} combinations in Table 16 (i.e., E7, E8, E12-E14, E19-E22) are included in the at most Q combinations.

In one example, in addition to the U combinations, among the remaining (22-13) combinations in Table 16 (i.e., E7, E8, E12-E14, E19-E22), at least one combination is/are included the at most Q combinations.
In one example, each of the {Lₙ} combinations associated with N_{TRP}=2 (i.e., E7 and E8) are included in the at most Q combinations.
In one example, each of the {Lₙ} combinations associated with N_{TRP}=2,3 (i.e., E7 and E8, E12-E14) are included in the at most Q combinations.
In one example, each of the {Lₙ} combinations associated with N_{TRP}=2,3,4 (i.e., E7 and E8, E12-E14, E19-E22) are included in the at most Q combinations.
In one example, one of the {Lₙ} combinations associated with N_{TRP}=2 (i.e., E7 and E8) is included in the at most Q combinations.
In one example, one of the {Lₙ} combinations associated with N_{TRP}=3 (i.e., E12-E14) is included in the at most Q combinations.
In one example, one of the {Lₙ} combinations associated with N_{TRP}=4 (i.e., E19-E22) is included in the at most Q combinations.
In one example, two of the {Lₙ} combinations associated with N_{TRP}=2 (i.e., E7 and E8) are included in the at most Q combinations.
In one example, two of the {Lₙ} combinations associated with N_{TRP}=3 (i.e., E12-E14) are included in the at most Q combinations.
In one example, two of the {Lₙ} combinations associated with N_{TRP}=4 (i.e., E19-E22) are included in the at most Q combinations.
In one example, any combination of the examples herein can be an example, e.g., one or more examples described herein, i.e., E7 and E8, and one of E12-E14, and one of E10-E22 are included in the at most Q combinations.

In one example, a table for {Lₙ} includes at least one of the {Lₙ} combinations of {E1-E6 and E9-E11 and E15-E18}. For example, a table for {Lₙ} including {E1-E6 and E9-E 11 and E15-E18} can be written as in the following tables:

TABLE 17

| Index | N_{TRP} | L₁ | L₂ | L₃ | L₄ |
|---|---|---|---|---|---|
| 1 | 1 | 2 | | | |
| 2 | | 4 | | | |
| 3 | | 6 | | | |
| 4 | 2 | 2 | 2 | | |
| 5 | | 2 | 4 | | |
| 6 | | 4 | 2 | | |
| 7 | | 4 | 4 | | |
| 8 | 3 | 2 | 2 | 2 | |
| 9 | | 2 | 2 | 4 | |
| 10 | | 2 | 4 | 2 | |
| 11 | | 4 | 2 | 2 | |
| 12 | | 4 | 4 | 4 | |
| 13 | 4 | 2 | 2 | 2 | 2 |
| 14 | | 2 | 2 | 2 | 4 |
| 15 | | 2 | 2 | 4 | 4 |
| 16 | | 4 | 4 | 4 | 4 |

Ex1) including permutations for some {Lₙ} combinations, i.e., {2,4} and {2,2,4}

TABLE 18

| Index | N_{TRP} | L₁ | L₂ | L₃ | L₄ |
|---|---|---|---|---|---|
| 1 | 1 | 2 | | | |
| 2 | | 4 | | | |
| 3 | | 6 | | | |
| 4 | 2 | 2 | 2 | | |
| 5 | | 4 | 2 | | |
| 6 | | 2 | 4 | | |
| 7 | | 4 | 4 | | |
| 8 | 3 | 2 | 2 | 2 | |
| 9 | | 4 | 2 | 2 | |
| 10 | | 2 | 4 | 2 | |
| 11 | | 2 | 2 | 4 | |
| 12 | | 4 | 4 | 4 | |
| 13 | 4 | 2 | 2 | 2 | 2 |
| 14 | | 4 | 2 | 2 | 2 |
| 15 | | 4 | 4 | 2 | 2 |
| 16 | | 4 | 4 | 4 | 4 |

Ex2) including permutations for some {Lₙ} combinations, i.e., {2,4} and {2,2,4}

TABLE 19

| Index | N_{TRP} | {Lₙ} combinations |
|---|---|---|
| 1 | 1 | {2} |
| 2 | | {4} |
| 3 | | {6} |
| 4 | 2 | {2, 2} |
| 5 | | {2, 4}, {4, 2} |
| 6 | | {4, 4} |
| 7 | 3 | {2, 2, 2} |
| 8 | | {2, 2, 4}, {2, 4, 2}, {4, 2, 2} |
| 9 | | {4, 4, 4} |
| 10 | 4 | {2, 2, 2, 2} |
| 11 | | {2, 2, 2, 4} |
| 12 | | {2, 2, 4, 4} |
| 13 | | {4, 4, 4, 4} |

Ex3) including permutations for some {Lₙ} combinations, i.e., {2,4} and {2,2,4}

In one example, a table for {Lₙ} includes 0 in blank. For example, in the tables of Ex1) and Ex2) herein, the blanks are filled with 0s.

In another example, the order of {Lₙ} combinations can be different from one or more examples described herein. For example, from top to bottom, {Lₙ} combinations can be written in the order of N_{TRP}=4 to N_{TRP}=1. The tables herein are in the order of N_{TRP}=1 to N_{TRP}=4 from top to bottom for example.

In one example, αₙ is selected from {½,¾,1} for selected N TRPs and Table 20 can be used for {αₙ} values.

TABLE 20

| | | | | | | αₜₒₜ | αₜₒₜ | αₜₒₜ | αₜₒₜ |
|---|---|---|---|---|---|---|---|---|---|
| Index | N | α₁ | α₂ | α₃ | α₄ | (N_{TRP} = 1) | (N_{TRP} = 2) | (N_{TRP} = 3) | (N_{TRP} = 4) |
| 1 | 1 | 0.50 | | | | 0.50 | 0.25 | 0.17 | 0.13 |
| 2 | | 0.75 | | | | 0.75 | 0.38 | 0.25 | 0.19 |
| 3 | | 1.00 | | | | 1.00 | 0.50 | 0.33 | 0.25 |
| 4 | 2 | 0.50 | 0.50 | | | | 0.50 | 0.33 | 0.25 |
| 5 | | 0.50 | 0.75 | | | | 0.63 | 0.42 | 0.31 |
| 6 | | 0.50 | 1.00 | | | | 0.75 | 0.50 | 0.38 |
| 7 | | 0.75 | 0.50 | | | | 0.63 | 0.42 | 0.31 |
| 8 | | 0.75 | 0.75 | | | | 0.75 | 0.50 | 0.38 |
| 9 | | 0.75 | 1.00 | | | | 0.88 | 0.58 | 0.44 |
| 10 | | 1.00 | 0.50 | | | | 0.75 | 0.50 | 0.38 |
| 11 | | 1.00 | 0.75 | | | | 0.88 | 0.58 | 0.44 |
| 12 | | 1.00 | 1.00 | | | | 1.00 | 0.67 | 0.50 |
| 13 | 3 | 0.50 | 0.50 | 0.50 | | | | 0.50 | 0.38 |
| 14 | | 0.50 | 0.50 | 0.75 | | | | 0.58 | 0.44 |
| 15 | | 0.50 | 0.50 | 1.00 | | | | 0.67 | 0.50 |
| 16 | | 0.50 | 0.75 | 0.50 | | | | 0.58 | 0.44 |
| 17 | | 0.50 | 0.75 | 0.75 | | | | 0.67 | 0.50 |
| 18 | | 0.50 | 0.75 | 1.00 | | | | 0.75 | 0.56 |
| 19 | | 0.50 | 1.00 | 0.50 | | | | 0.67 | 0.50 |
| 20 | | 0.50 | 1.00 | 0.75 | | | | 0.75 | 0.56 |
| 21 | | 0.50 | 1.00 | 1.00 | | | | 0.83 | 0.63 |
| 22 | | 0.75 | 0.50 | 0.50 | | | | 0.58 | 0.44 |
| 23 | | 0.75 | 0.50 | 0.75 | | | | 0.67 | 0.50 |
| 24 | | 0.75 | 0.50 | 1.00 | | | | 0.75 | 0.56 |
| 25 | | 0.75 | 0.75 | 0.50 | | | | 0.67 | 0.50 |
| 26 | | 0.75 | 0.75 | 0.75 | | | | 0.75 | 0.56 |
| 27 | | 0.75 | 0.75 | 1.00 | | | | 0.83 | 0.63 |
| 28 | | 0.75 | 1.00 | 0.50 | | | | 0.75 | 0.56 |
| 29 | | 0.75 | 1.00 | 0.75 | | | | 0.83 | 0.63 |
| 30 | | 0.75 | 1.00 | 1.00 | | | | 0.92 | 0.69 |
| 31 | | 1.00 | 0.50 | 0.50 | | | | 0.67 | 0.50 |
| 32 | | 1.00 | 0.50 | 0.75 | | | | 0.75 | 0.56 |
| 33 | | 1.00 | 0.50 | 1.00 | | | | 0.83 | 0.63 |
| 34 | | 1.00 | 0.75 | 0.50 | | | | 0.75 | 0.56 |
| 35 | | 1.00 | 0.75 | 0.75 | | | | 0.83 | 0.63 |
| 36 | | 1.00 | 0.75 | 1.00 | | | | 0.92 | 0.69 |
| 37 | | 1.00 | 1.00 | 0.50 | | | | 0.83 | 0.63 |
| 38 | | 1.00 | 1.00 | 0.75 | | | | 0.92 | 0.69 |
| 39 | | 1.00 | 1.00 | 1.00 | | | | 1.00 | 0.75 |
| 40 | 4 | 0.50 | 0.50 | 0.50 | 0.50 | | | | 0.50 |
| 41 | | 0.50 | 0.50 | 0.50 | 0.75 | | | | 0.56 |
| 42 | | 0.50 | 0.50 | 0.50 | 1.00 | | | | 0.63 |
| 43 | | 0.50 | 0.50 | 0.75 | 0.50 | | | | 0.56 |
| 44 | | 0.50 | 0.50 | 0.75 | 0.75 | | | | 0.63 |
| 45 | | 0.50 | 0.50 | 0.75 | 1.00 | | | | 0.69 |
| 46 | | 0.50 | 0.50 | 1.00 | 0.50 | | | | 0.63 |
| 47 | | 0.50 | 0.50 | 1.00 | 0.75 | | | | 0.69 |
| 48 | | 0.50 | 0.50 | 1.00 | 1.00 | | | | 0.75 |
| 49 | | 0.50 | 0.75 | 0.50 | 0.50 | | | | 0.56 |
| 50 | | 0.50 | 0.75 | 0.50 | 0.75 | | | | 0.63 |
| 51 | | 0.50 | 0.75 | 0.50 | 1.00 | | | | 0.69 |
| 52 | | 0.50 | 0.75 | 0.75 | 0.50 | | | | 0.63 |
| 53 | | 0.50 | 0.75 | 0.75 | 0.75 | | | | 0.69 |
| 54 | | 0.50 | 0.75 | 0.75 | 1.00 | | | | 0.75 |
| 55 | | 0.50 | 0.75 | 1.00 | 0.50 | | | | 0.69 |
| 56 | | 0.50 | 0.75 | 1.00 | 0.75 | | | | 0.75 |
| 57 | | 0.50 | 0.75 | 1.00 | 1.00 | | | | 0.81 |
| 58 | | 0.50 | 1.00 | 0.50 | 0.50 | | | | 0.63 |
| 59 | | 0.50 | 1.00 | 0.50 | 0.75 | | | | 0.69 |
| 60 | | 0.50 | 1.00 | 0.50 | 1.00 | | | | 0.75 |
| 61 | | 0.50 | 1.00 | 0.75 | 0.50 | | | | 0.69 |
| 62 | | 0.50 | 1.00 | 0.75 | 0.75 | | | | 0.75 |
| 63 | | 0.50 | 1.00 | 0.75 | 1.00 | | | | 0.81 |
| 64 | | 0.50 | 1.00 | 1.00 | 0.50 | | | | 0.75 |
| 65 | | 0.50 | 1.00 | 1.00 | 0.75 | | | | 0.81 |
| 66 | | 0.50 | 1.00 | 1.00 | 1.00 | | | | 0.88 |
| 67 | | 0.75 | 0.50 | 0.50 | 0.50 | | | | 0.56 |
| 68 | | 0.75 | 0.50 | 0.50 | 0.75 | | | | 0.63 |
| 69 | | 0.75 | 0.50 | 0.50 | 1.00 | | | | 0.69 |
| 70 | | 0.75 | 0.50 | 0.75 | 0.50 | | | | 0.63 |
| 71 | | 0.75 | 0.50 | 0.75 | 0.75 | | | | 0.69 |
| 72 | | 0.75 | 0.50 | 0.75 | 1.00 | | | | 0.75 |
| 73 | | 0.75 | 0.50 | 1.00 | 0.50 | | | | 0.69 |
| 74 | | 0.75 | 0.50 | 1.00 | 0.75 | | | | 0.75 |
| 75 | | 0.75 | 0.50 | 1.00 | 1.00 | | | | 0.81 |
| 76 | | 0.75 | 0.75 | 0.50 | 0.50 | | | | 0.63 |
| 77 | | 0.75 | 0.75 | 0.50 | 0.75 | | | | 0.69 |
| 78 | | 0.75 | 0.75 | 0.50 | 1.00 | | | | 0.75 |
| 79 | | 0.75 | 0.75 | 0.75 | 0.50 | | | | 0.69 |
| 80 | | 0.75 | 0.75 | 0.75 | 0.75 | | | | 0.75 |
| 81 | | 0.75 | 0.75 | 0.75 | 1.00 | | | | 0.81 |
| 82 | | 0.75 | 0.75 | 1.00 | 0.50 | | | | 0.75 |
| 83 | | 0.75 | 0.75 | 1.00 | 0.75 | | | | 0.81 |
| 84 | | 0.75 | 0.75 | 1.00 | 1.00 | | | | 0.88 |
| 85 | | 0.75 | 1.00 | 0.50 | 0.50 | | | | 0.69 |
| 86 | | 0.75 | 1.00 | 0.50 | 0.75 | | | | 0.75 |
| 87 | | 0.75 | 1.00 | 0.50 | 1.00 | | | | 0.81 |
| 88 | | 0.75 | 1.00 | 0.75 | 0.50 | | | | 0.75 |
| 89 | | 0.75 | 1.00 | 0.75 | 0.75 | | | | 0.81 |
| 90 | | 0.75 | 1.00 | 0.75 | 1.00 | | | | 0.88 |
| 91 | | 0.75 | 1.00 | 1.00 | 0.50 | | | | 0.81 |
| 92 | | 0.75 | 1.00 | 1.00 | 0.75 | | | | 0.88 |
| 93 | | 0.75 | 1.00 | 1.00 | 1.00 | | | | 0.94 |
| 94 | | 1.00 | 0.50 | 0.50 | 0.50 | | | | 0.63 |
| 95 | | 1.00 | 0.50 | 0.50 | 0.75 | | | | 0.69 |
| 96 | | 1.00 | 0.50 | 0.50 | 1.00 | | | | 0.75 |
| 97 | | 1.00 | 0.50 | 0.75 | 0.50 | | | | 0.69 |
| 98 | | 1.00 | 0.50 | 0.75 | 0.75 | | | | 0.75 |
| 99 | | 1.00 | 0.50 | 0.75 | 1.00 | | | | 0.81 |
| 100 | | 1.00 | 0.50 | 1.00 | 0.50 | | | | 0.75 |
| 101 | | 1.00 | 0.50 | 1.00 | 0.75 | | | | 0.81 |
| 102 | | 1.00 | 0.50 | 1.00 | 1.00 | | | | 0.88 |
| 103 | | 1.00 | 0.75 | 0.50 | 0.50 | | | | 0.69 |
| 104 | | 1.00 | 0.75 | 0.50 | 0.75 | | | | 0.75 |
| 105 | | 1.00 | 0.75 | 0.50 | 1.00 | | | | 0.81 |
| 106 | | 1.00 | 0.75 | 0.75 | 0.50 | | | | 0.75 |
| 107 | | 1.00 | 0.75 | 0.75 | 0.75 | | | | 0.81 |
| 108 | | 1.00 | 0.75 | 0.75 | 1.00 | | | | 0.88 |
| 109 | | 1.00 | 0.75 | 1.00 | 0.50 | | | | 0.81 |
| 110 | | 1.00 | 0.75 | 1.00 | 0.75 | | | | 0.88 |
| 111 | | 1.00 | 0.75 | 1.00 | 1.00 | | | | 0.94 |
| 112 | | 1.00 | 1.00 | 0.50 | 0.50 | | | | 0.75 |
| 113 | | 1.00 | 1.00 | 0.50 | 0.75 | | | | 0.81 |
| 114 | | 1.00 | 1.00 | 0.50 | 1.00 | | | | 0.88 |
| 115 | | 1.00 | 1.00 | 0.75 | 0.50 | | | | 0.81 |
| 116 | | 1.00 | 1.00 | 0.75 | 0.75 | | | | 0.88 |
| 117 | | 1.00 | 1.00 | 0.75 | 1.00 | | | | 0.94 |
| 118 | | 1.00 | 1.00 | 1.00 | 0.50 | | | | 0.88 |
| 119 | | 1.00 | 1.00 | 1.00 | 0.75 | | | | 0.94 |
| 120 | | 1.00 | 1.00 | 1.00 | 1.00 | | | | 1.00 |

When N<N_{TRP} is selected (via N_{TRP}-bit bitmap), the indexes of the selected TRPs (or CSI-RS resources) can be remapped to 1 to N, which will be corresponding to the indexes of selected {αₙ}. In one example, from the lowest index to highest index for the selected TRPs, their indexes are remapped to 1 to N. For example, when N_{TRP}=4 and the 4-bit bitmap indicator for TRP selection is ‘0101’ (assuming LSB corresponds to TRP 1 . . . MSB corresponds to TRP 4), the selected TRP 1 and TRP 3 are associated with α₁ and α₂, respectively. In another example, from the highest index to lowest index for the selected TRPs, their indexes are remapped to 1 to N. For example, when N_{TRP}=4 and the 4-bit bitmap indicator for TRP selection is ‘0101’ (assuming LSB corresponds to TRP 1 . . . MSB corresponds to TRP 4), the selected TRP 3 and TRP 1 are associated with α₁ and α₂, respectively.

In one example, the UE 116 shall not report any index associated with N′≠N, i.e., any index associated with not the number of selected TRPs.

In another embodiment, on the SD basis selection for (Rel-18) Type-II codebook refinement for CIT mTRP (Rel-17 port-selection codebook based refinement), a set of N_{L}≥>1 combinations value(s) of {αₙ, n=1, . . . , N_{TRP}} is configured by the NW 130 via higher-layer (RRC) signaling, where N_{TRP} is a number of TRPs (CSI-RS resources) configured by the NW 130. The N_{L} combinations of value(s) for {αₙ, n=1, . . . , N_{TRP}} can be signaled by using a joint indicator or multiple separate indicators, where

$${L}_{n} = \frac{{α}_{n} {P}_{CSI - RS}}{2}$$

where αₙ={½,¾,1}. In one example, N_{L}=1. In another example, N_{L}>1.

In one example, {αₙ} values can be configured based on at least one of the tables (or any table (i.e., sub-table, whole table) that can be constructed as) described in the present disclosure.

In one example, N_{L} can be explicitly configured via higher-layer (RRC) signaling with a separate parameter. The possible values for N_{L} are a set of [symbol] . Let denote a total number of a table including combinations of values for {αₙ, n=1, . . . , N_{TRP}} by N_{T}. In one example,

$$⌈ {log}_{2} ( \begin{matrix}{N}_{T} \\ {N}_{L}\end{matrix} ) ⌉$$

bit size parameter can be configured to indicate N_{L} combinations of values for {Lₙ, n=1, . . . , N_{TRP}}. In one example, the table can be any table (whole table or sub-table) described in the present disclosure or any table that can be constructed as described in the present disclosure. In one example, the table can be any table described in the present disclosure (or any table that can be constructed as described in the present disclosure) wherein N is replaced by N_{TRP}. In one example, when N is replaced by N_{TRP} in the table, a UE applies αₙ for CSI-RS resource (or TRP index) n, for n=1, . . . , N_{TRP}. For example, when an N_{TRP}-bit bitmap for TRP selection is reported, the UE 116 uses αₙ values for n values corresponding to the selected TRPs only, which are indicated in the bitmap.

In one example, N_{T} combinations of values for {αₙ} can be configured by using Table 20 or a sub-table including at least one of the rows in Table 21.

TABLE 21

| Index | N_{TRP} | α₁ | α₂ | α₃ | α₄ | αₜₒₜ |
|---|---|---|---|---|---|---|
| 1 | 1 | 0.50 | | | | 0.50 |
| 2 | | 0.75 | | | | 0.75 |
| 3 | | 1.00 | | | | 1.00 |
| 4 | 2 | 0.50 | 0.50 | | | 0.50 |
| 5 | | 0.50 | 0.75 | | | 0.63 |
| 6 | | 0.50 | 1.00 | | | 0.75 |
| 7 | | 0.75 | 0.50 | | | 0.63 |
| 8 | | 0.75 | 0.75 | | | 0.75 |
| 9 | | 0.75 | 1.00 | | | 0.88 |
| 10 | | 1.00 | 0.50 | | | 0.75 |
| 11 | | 1.00 | 0.75 | | | 0.88 |
| 12 | | 1.00 | 1.00 | | | 1.00 |
| 13 | 3 | 0.50 | 0.50 | 0.50 | | 0.50 |
| 14 | | 0.50 | 0.50 | 0.75 | | 0.58 |
| 15 | | 0.50 | 0.50 | 1.00 | | 0.67 |
| 16 | | 0.50 | 0.75 | 0.50 | | 0.58 |
| 17 | | 0.50 | 0.75 | 0.75 | | 0.67 |
| 18 | | 0.50 | 0.75 | 1.00 | | 0.75 |
| 19 | | 0.50 | 1.00 | 0.50 | | 0.67 |
| 20 | | 0.50 | 1.00 | 0.75 | | 0.75 |
| 21 | | 0.50 | 1.00 | 1.00 | | 0.83 |
| 22 | | 0.75 | 0.50 | 0.50 | | 0.58 |
| 23 | | 0.75 | 0.50 | 0.75 | | 0.67 |
| 24 | | 0.75 | 0.50 | 1.00 | | 0.75 |
| 25 | | 0.75 | 0.75 | 0.50 | | 0.67 |
| 26 | | 0.75 | 0.75 | 0.75 | | 0.75 |
| 27 | | 0.75 | 0.75 | 1.00 | | 0.83 |
| 28 | | 0.75 | 1.00 | 0.50 | | 0.75 |
| 29 | | 0.75 | 1.00 | 0.75 | | 0.83 |
| 30 | | 0.75 | 1.00 | 1.00 | | 0.92 |
| 31 | | 1.00 | 0.50 | 0.50 | | 0.67 |
| 32 | | 1.00 | 0.50 | 0.75 | | 0.75 |
| 33 | | 1.00 | 0.50 | 1.00 | | 0.83 |
| 34 | | 1.00 | 0.75 | 0.50 | | 0.75 |
| 35 | | 1.00 | 0.75 | 0.75 | | 0.83 |
| 36 | | 1.00 | 0.75 | 1.00 | | 0.92 |
| 37 | | 1.00 | 1.00 | 0.50 | | 0.83 |
| 38 | | 1.00 | 1.00 | 0.75 | | 0.92 |
| 39 | | 1.00 | 1.00 | 1.00 | | 1.00 |
| 40 | 4 | 0.50 | 0.50 | 0.50 | 0.50 | 0.50 |
| 41 | | 0.50 | 0.50 | 0.50 | 0.75 | 0.56 |
| 42 | | 0.50 | 0.50 | 0.50 | 1.00 | 0.63 |
| 43 | | 0.50 | 0.50 | 0.75 | 0.50 | 0.56 |
| 44 | | 0.50 | 0.50 | 0.75 | 0.75 | 0.63 |
| 45 | | 0.50 | 0.50 | 0.75 | 1.00 | 0.69 |
| 46 | | 0.50 | 0.50 | 1.00 | 0.50 | 0.63 |
| 47 | | 0.50 | 0.50 | 1.00 | 0.75 | 0.69 |
| 48 | | 0.50 | 0.50 | 1.00 | 1.00 | 0.75 |
| 49 | | 0.50 | 0.75 | 0.50 | 0.50 | 0.56 |
| 50 | | 0.50 | 0.75 | 0.50 | 0.75 | 0.63 |
| 51 | | 0.50 | 0.75 | 0.50 | 1.00 | 0.69 |
| 52 | | 0.50 | 0.75 | 0.75 | 0.50 | 0.63 |
| 53 | | 0.50 | 0.75 | 0.75 | 0.75 | 0.69 |
| 54 | | 0.50 | 0.75 | 0.75 | 1.00 | 0.75 |
| 55 | | 0.50 | 0.75 | 1.00 | 0.50 | 0.69 |
| 56 | | 0.50 | 0.75 | 1.00 | 0.75 | 0.75 |
| 57 | | 0.50 | 0.75 | 1.00 | 1.00 | 0.81 |
| 58 | | 0.50 | 1.00 | 0.50 | 0.50 | 0.63 |
| 59 | | 0.50 | 1.00 | 0.50 | 0.75 | 0.69 |
| 60 | | 0.50 | 1.00 | 0.50 | 1.00 | 0.75 |
| 61 | | 0.50 | 1.00 | 0.75 | 0.50 | 0.69 |
| 62 | | 0.50 | 1.00 | 0.75 | 0.75 | 0.75 |
| 63 | | 0.50 | 1.00 | 0.75 | 1.00 | 0.81 |
| 64 | | 0.50 | 1.00 | 1.00 | 0.50 | 0.75 |
| 65 | | 0.50 | 1.00 | 1.00 | 0.75 | 0.81 |
| 66 | | 0.50 | 1.00 | 1.00 | 1.00 | 0.88 |
| 67 | | 0.75 | 0.50 | 0.50 | 0.50 | 0.56 |
| 68 | | 0.75 | 0.50 | 0.50 | 0.75 | 0.63 |
| 69 | | 0.75 | 0.50 | 0.50 | 1.00 | 0.69 |
| 70 | | 0.75 | 0.50 | 0.75 | 0.50 | 0.63 |
| 71 | | 0.75 | 0.50 | 0.75 | 0.75 | 0.69 |
| 72 | | 0.75 | 0.50 | 0.75 | 1.00 | 0.75 |
| 73 | | 0.75 | 0.50 | 1.00 | 0.50 | 0.69 |
| 74 | | 0.75 | 0.50 | 1.00 | 0.75 | 0.75 |
| 75 | | 0.75 | 0.50 | 1.00 | 1.00 | 0.81 |
| 76 | | 0.75 | 0.75 | 0.50 | 0.50 | 0.63 |
| 77 | | 0.75 | 0.75 | 0.50 | 0.75 | 0.69 |
| 78 | | 0.75 | 0.75 | 0.50 | 1.00 | 0.75 |
| 79 | | 0.75 | 0.75 | 0.75 | 0.50 | 0.69 |
| 80 | | 0.75 | 0.75 | 0.75 | 0.75 | 0.75 |
| 81 | | 0.75 | 0.75 | 0.75 | 1.00 | 0.81 |
| 82 | | 0.75 | 0.75 | 1.00 | 0.50 | 0.75 |
| 83 | | 0.75 | 0.75 | 1.00 | 0.75 | 0.81 |
| 84 | | 0.75 | 0.75 | 1.00 | 1.00 | 0.88 |
| 85 | | 0.75 | 1.00 | 0.50 | 0.50 | 0.69 |
| 86 | | 0.75 | 1.00 | 0.50 | 0.75 | 0.75 |
| 87 | | 0.75 | 1.00 | 0.50 | 1.00 | 0.81 |
| 88 | | 0.75 | 1.00 | 0.75 | 0.50 | 0.75 |
| 89 | | 0.75 | 1.00 | 0.75 | 0.75 | 0.81 |
| 90 | | 0.75 | 1.00 | 0.75 | 1.00 | 0.88 |
| 91 | | 0.75 | 1.00 | 1.00 | 0.50 | 0.81 |
| 92 | | 0.75 | 1.00 | 1.00 | 0.75 | 0.88 |
| 93 | | 0.75 | 1.00 | 1.00 | 1.00 | 0.94 |
| 94 | | 1.00 | 0.50 | 0.50 | 0.50 | 0.63 |
| 95 | | 1.00 | 0.50 | 0.50 | 0.75 | 0.69 |
| 96 | | 1.00 | 0.50 | 0.50 | 1.00 | 0.75 |
| 97 | | 1.00 | 0.50 | 0.75 | 0.50 | 0.69 |
| 98 | | 1.00 | 0.50 | 0.75 | 0.75 | 0.75 |
| 99 | | 1.00 | 0.50 | 0.75 | 1.00 | 0.81 |
| 100 | | 1.00 | 0.50 | 1.00 | 0.50 | 0.75 |
| 101 | | 1.00 | 0.50 | 1.00 | 0.75 | 0.81 |
| 102 | | 1.00 | 0.50 | 1.00 | 1.00 | 0.88 |
| 103 | | 1.00 | 0.75 | 0.50 | 0.50 | 0.69 |
| 104 | | 1.00 | 0.75 | 0.50 | 0.75 | 0.75 |
| 105 | | 1.00 | 0.75 | 0.50 | 1.00 | 0.81 |
| 106 | | 1.00 | 0.75 | 0.75 | 0.50 | 0.75 |
| 107 | | 1.00 | 0.75 | 0.75 | 0.75 | 0.81 |
| 108 | | 1.00 | 0.75 | 0.75 | 1.00 | 0.88 |
| 109 | | 1.00 | 0.75 | 1.00 | 0.50 | 0.81 |
| 110 | | 1.00 | 0.75 | 1.00 | 0.75 | 0.88 |
| 111 | | 1.00 | 0.75 | 1.00 | 1.00 | 0.94 |
| 112 | | 1.00 | 1.00 | 0.50 | 0.50 | 0.75 |
| 113 | | 1.00 | 1.00 | 0.50 | 0.75 | 0.81 |
| 114 | | 1.00 | 1.00 | 0.50 | 1.00 | 0.88 |
| 115 | | 1.00 | 1.00 | 0.75 | 0.50 | 0.81 |
| 116 | | 1.00 | 1.00 | 0.75 | 0.75 | 0.88 |
| 117 | | 1.00 | 1.00 | 0.75 | 1.00 | 0.94 |
| 118 | | 1.00 | 1.00 | 1.00 | 0.50 | 0.88 |
| 119 | | 1.00 | 1.00 | 1.00 | 0.75 | 0.94 |
| 120 | | 1.00 | 1.00 | 1.00 | 1.00 | 1.00 |

Although we use a decimal form for {αₙ}, αₜₒₜ in the table, it can be denoted in a fractional form, e.g., ½, ¾, 1 instead of 0.50, 0.75, 1.

In one example, N_{L} is implicitly determined or configured via higher-layer RRC signaling.
In one example, an N_{T}-bit bitmap is used to indicate N_{L} combinations of values for {αₙ,n=1, . . . , N_{TRP}}, and N_{L} can be inferred from the configured N_{T}-bit bitmap.
In one example, N_{L} combinations of values for {αₙ,n=1, . . . , N_{TRP}} are determined from the configured {αₙ} values and its associated αₜₒₜ value. For example, one combination of the values for {αₙ, n=1, . . . , N_{TRP}} is configured, and other combinations of the values for {αₙ,n=1, . . . , N_{TRP}} associated with the same αₜₒₜ for the configured combination are determined as N_{L}−1 combinations of values {αₙ, n=1, . . . , N_{TRP}}.

In one example, when N_{L}≥>1, a UE reports an indicator with the size of ┌log₂ N_{L}┐-bit to indicate one selected combination of values for {αₙ, n=1, . . . , N_{TRP}} in CSI part 1.

In one example, when N_{L}=1, a UE follows the configured {αₙ} values, hence no report is necessary for {αₙ} values.

In one example, N_{L} combinations of {αₙ} is subject to the UE 116 capability on αₜₒₜ or αₘₐₓ.

The tables provided in the present disclosure can include different parameter names, e.g., N can be replaced by N_{TRP} or/and αₜₒₜ can be replaced by αₘₐₓ. The parameter names can be used interchangeably.

In one embodiment, on the SD basis selection for (Rel-18) Type-II codebook refinement for CJT mTRP, each of the {Lₙ, n=1, . . . , N_{TRP}} is configured by the NW 130 via higher-layer (RRC) signaling, where N_{TRP} is a number of TRPs configured by the NW 130.

In one example, Lₙ∈{2,4,6}. In one example, Lₙ∈{1,2,4,6}. In one example, Lₙ∈{1,2,3,4,5,6}. In one example, In one example, Lₙ∈{1,2,3,4}. In one example, Lₙ∈{1,2,3}. In one example, Lₙ∈{1,2,4}. In one example, Lₙ can be selected from [symbol] ₙ, where [symbol] ₙ is a subset of {1,2,3,4,5,6}. In one example, Lₙ∈{2,4}.

In another embodiment, on the SD basis selection for (Rel-18) Type-II codebook refinement for CJT mTRP, each of the {Lₙ, n=1, . . . , N_{TRP}} is configured by the NW 130 via higher-layer (RRC) signaling, where N_{TRP} is a number of TRPs configured by the NW 130.

In one example, Lₙ∈{2,4,6}. In one example, Lₙ∈{1,2,4,6}. In one example, Lₙ∈{1,2,3,4,5,6}. In one example, In one example, Lₙ∈{1,2,3,4}. In one example, Lₙ∈{1,2,3}. In one example, Lₙ∈{1,2,4}. In one example, Lₙ can be selected from [symbol] ₙ, where [symbol] ₙ is a subset of {1,2,3,4,5,6}.

In one embodiment, on the SD basis selection for (Rel-18) Type-II codebook refinement for CJT mTRP, a set of N_{L}≥>1 combinations of values for {Lₙ, n=1, . . . , N_{TRP}} is configured by the NW 130 via higher-layer (RRC) signaling, where N_{TRP} is a number of TRPs (CSI-RS resources) configured by the NW 130. The N_{L} combinations of value(s) for {Lₙ, n=1, . . . , N_{TRP}} can be signaled by using a joint indicator or multiple separate indicators. In one example, N_{L}=1. In another example, N_{L}>>1.

In one example, {Lₙ} values can be configured based on at least one of the tables (or any table (i.e., a sub-table, or whole table) that can be constructed as) described in the present disclosure.

In one example, N_{L} can be explicitly configured via higher-layer (RRC) signaling with a separate parameter. The possible values for N_{L} are a set of [symbol] . Let denote a total number of a table including combinations of values for {Lₙ, n=1, . . . , N_{TRP}} by N_{T}. In one example,

$$⌈ {log}_{2} ( \begin{matrix}{N}_{T} \\ {N}_{L}\end{matrix} ) ⌉$$

bit size parameter can be used to indicate N_{L} combinations of values for {Lₙ, n=1, . . . , N_{TRP}}. In one example, the table can be any table (whole table or sub-table) described in the present disclosure or any table that can be constructed as described in the present disclosure.

In one example, N_{L} is implicitly determined or configured via higher-layer RRC signaling.
In one example, an N_{T}-bit bitmap is used to indicate N_{L} combinations of values for {Lₙ, n=1, . . . , N_{TRP}}, and N_{L} can be inferred from the configured N_{T}-bit bitmap.
In one example, N_{L} combinations of values for {Lₙ,n=1, . . . , N_{TRP}} are determined from the configured {Lₙ} values and its associated Lₜₒₜ value. For example, one combination of the values for {Lₙ, n=1, . . . , N_{TRP}} is configured, and other combinations of the values for {Lₙ,n=1, . . . , N_{TRP}} associated with the same Lₜₒₜ for the configured combination are determined as N_{L}−1 combinations of values {Lₙ, n=1, . . . , N_{TRP}}, where Lₜₒₜ=Σₙ₌₁^{N} Lₙ.

In one example, when N_{L}≥>1, a UE reports an indicator with the size of ┌log₂ N_{L}┐-bit to indicate one selected combination of values for {Lₙ, n=1, . . . , N_{TRP}} in CSI part 1.

In one example, when N_{L}=1, a UE follows the configured {Lₙ} values, hence no report is necessary for {Lₙ} values.

In one example, N_{L} combinations of {Lₙ} is subject to the UE 116 capability on Lₜₒₜ=ΣΣₙ₌₁^{N} Lₙ or Lₘₐₓ≥Σₙ₌₁^{N}Lₙ.

In one embodiment, a UE is configured with a CSI report (e.g., via higher layer CSI-ReportConfig) based on a codebook for C-JT transmission from multiple TRPs, as described in the present disclosure, where codebook parameters (such as α or L, β, p_{υ} or M_{υ}) are configured via a higher-layer parameter ‘paramCombination-r18’ or ‘paramCombinationCJT-r18’.
In one example, the Rel. 16 parameter combination table for ‘paraCombination-r16’ is reused for ‘paramCombination-r18’ (cf. Table 1).
In one example, the Rel. 17 parameter combination table for ‘paraCombination-r17’ is reused for ‘paramCombination-r18’ (cf. Table 2).
In one example, a new table of parameter combination is used for ‘paramCombination-r18’.
In one example, a table including existing Rel. 16 or Rel. 17 parameter combination(s) and new parameter combination(s) is used for ‘paramCombination-r18’.

In another embodiment, a table used for ‘paramCombination-r18’ is designed based on the following parameter candidates:
Candidate values for Lₙ: [symbol] ₙ={2,4}
   where Lₙ is L for CSI-RS resource n (TRP n); and
   N_{TRP}∈{1,2,3,4} is a number of CSI-RS resources (or TRPs) and is configured by the NW 130 via higher-layer signaling.
Candidate values for pᵥ for v=1,2: [symbol] ₂={ 1/16,⅛,¼,⅜,½}.
Candidate values for pᵥ for v=3,4: [symbol] ₃₄={ 1/32, 3/16, 1/16,⅛,¼,⅜,½}.
Candidate values for β: [symbol] ={⅛,¼,½,¾,1}.

In one example, any table including at least one of the combinations provided in the tables in the present disclosure can be an example for the table of ‘paraCombination-r18’.

In one example, when N_{TRP}=1, any table including at least one of parameter combinations in a sub-table of Table 3 can be used for the table of ‘paramCombination-r18’.

The table index numbers (from 1 to 100) in Table 22 should be interpreted as just indexes for corresponding parameter combinations. That is, the table index number can be any value based on the ordering of parameter combinations and the number of parameter combinations in a table.

In one example, any sub-table of Table 22 can be an example for the table of ‘paraCombination-r18’.

TABLE 22

| | | p_{υ} | | |
|---|---|---|---|---|
| paramCombination-r18 | L₁ | υ ∈ {1, 2} | υ ∈ {3, 4} | β |
| 1 | 2 | 1/16 | 1/32 | ⅛ |
| 2 | 2 | 1/16 | 1/32 | ¼ |
| 3 | 2 | 1/16 | 1/32 | ½ |
| 4 | 2 | 1/16 | 1/32 | ¾ |
| 5 | 2 | 1/16 | 1/32 | 1 |
| 6 | 2 | 1/16 | 1/16 | ⅛ |
| 7 | 2 | 1/16 | 1/16 | ¼ |
| 8 | 2 | 1/16 | 1/16 | ½ |
| 9 | 2 | 1/16 | 1/16 | ¾ |
| 10 | 2 | 1/16 | 1/16 | 1 |
| 11 | 2 | ⅛ | 1/16 | ⅛ |
| 12 | 2 | ⅛ | 1/16 | ¼ |
| 13 | 2 | ⅛ | 1/16 | ½ |
| 14 | 2 | ⅛ | 1/16 | ¾ |
| 15 | 2 | ⅛ | 1/16 | 1 |
| 16 | 2 | ⅛ | ⅛ | ⅛ |
| 17 | 2 | ⅛ | ⅛ | ¼ |
| 18 | 2 | ⅛ | ⅛ | ½ |
| 19 | 2 | ⅛ | ⅛ | ¾ |
| 20 | 2 | ⅛ | ⅛ | 1 |
| 21 | 2 | ¼ | ⅛ | ⅛ |
| 22 | 2 | ¼ | ⅛ | ¼ |
| 23 | 2 | ¼ | ⅛ | ½ |
| 24 | 2 | ½ | ⅛ | ¾ |
| 25 | 2 | ½ | ⅛ | 1 |
| 26 | 2 | ½ | ¼ | ⅛ |
| 27 | 2 | ¼ | ¼ | ¼ |
| 28 | 2 | ¼ | ½ | ½ |
| 29 | 2 | ¼ | ¼ | ¾ |
| 30 | 2 | ¼ | ¼ | 1 |
| 31 | 2 | ⅜ | 3/16 | ⅛ |
| 32 | 2 | ⅜ | 3/16 | ¼ |
| 33 | 2 | ⅜ | 3/16 | ½ |
| 34 | 2 | ⅜ | 3/16 | ¾ |
| 35 | 2 | ⅜ | 3/16 | 1 |
| 36 | 2 | ⅜ | ⅜ | ⅛ |
| 37 | 2 | ⅜ | ⅜ | ¼ |
| 38 | 2 | ⅜ | ⅜ | ½ |
| 39 | 2 | ⅜ | ⅜ | ¾ |
| 40 | 2 | ⅜ | ⅜ | 1 |
| 41 | 2 | ½ | ¼ | ⅛ |
| 42 | 2 | ½ | ½ | ¼ |
| 43 | 2 | ½ | ¼ | ½ |
| 44 | 2 | ½ | ¼ | ¾ |
| 45 | 2 | ½ | ½ | 1 |
| 46 | 2 | ½ | ½ | ⅛ |
| 47 | 2 | ½ | ½ | ¼ |
| 48 | 2 | ½ | ½ | ½ |
| 49 | 2 | ½ | ½ | ¾ |
| 50 | 2 | ½ | ½ | 1 |
| 51 | 4 | 1/16 | 1/32 | ⅛ |
| 52 | 4 | 1/16 | 1/32 | ¼ |
| 53 | 4 | 1/16 | 1/32 | ½ |
| 54 | 4 | 1/16 | 1/32 | ¾ |
| 55 | 4 | 1/16 | 1/32 | 1 |
| 56 | 4 | 1/16 | 1/16 | ⅛ |
| 57 | 4 | 1/16 | 1/16 | ¼ |
| 58 | 4 | 1/16 | 1/16 | ½ |
| 59 | 4 | 1/16 | 1/16 | ¾ |
| 60 | 4 | 1/16 | 1/16 | 1 |
| 61 | 4 | ⅛ | 1/16 | ⅛ |
| 62 | 4 | ⅛ | 1/16 | ½ |
| 63 | 4 | ⅛ | 1/16 | ½ |
| 64 | 4 | ⅛ | 1/16 | ¾ |
| 65 | 4 | ⅛ | 1/16 | 1 |
| 66 | 4 | ⅛ | ⅛ | ⅛ |
| 67 | 4 | ⅛ | ⅛ | ¼ |
| 68 | 4 | ⅛ | ⅛ | ½ |
| 69 | 4 | ⅛ | ⅛ | ¾ |
| 70 | 4 | ⅛ | ⅛ | 1 |
| 71 | 4 | ¼ | ⅛ | ⅛ |
| 72 | 4 | ¼ | ⅛ | ¼ |
| 73 | 4 | ¼ | ⅛ | ½ |
| 74 | 4 | ½ | ⅛ | ¾ |
| 75 | 4 | ¼ | ⅛ | 1 |
| 76 | 4 | ¼ | ¼ | ⅛ |
| 77 | 4 | ½ | ¼ | ¼ |
| 78 | 4 | ¼ | ¼ | ½ |
| 79 | 4 | ¼ | ¼ | ¾ |
| 80 | 4 | ¼ | ¼ | 1 |
| 81 | 4 | ⅜ | 3/16 | ⅛ |
| 82 | 4 | ⅜ | 3/16 | ¼ |
| 83 | 4 | ⅜ | 3/16 | ½ |
| 84 | 4 | ⅜ | 3/16 | ¾ |
| 85 | 4 | ⅜ | 3/16 | 1 |
| 86 | 4 | ⅜ | ⅜ | ⅛ |
| 87 | 4 | ⅜ | ⅜ | ¼ |
| 88 | 4 | ⅜ | ⅜ | ½ |
| 89 | 4 | ⅜ | ⅜ | ¾ |
| 90 | 4 | ⅜ | ⅜ | 1 |
| 91 | 4 | ½ | ¼ | ⅛ |
| 92 | 4 | ½ | ¼ | ¼ |
| 93 | 4 | ½ | ¼ | ½ |
| 94 | 4 | ½ | ¼ | ¾ |
| 95 | 4 | ½ | ¼ | 1 |
| 96 | 4 | ½ | ½ | ⅛ |
| 97 | 4 | ½ | ½ | ¼ |
| 98 | 4 | ½ | ½ | ½ |
| 99 | 4 | ½ | ½ | ¾ |
| 100 | 4 | ½ | ½ | 1 |

In one example, when N_{TRP}=2, any table including at least one of parameter combinations in a sub-table of Table 23 can be used for the table of ‘paramCombination-r18’.

In Table 23, we omitted the rows we can clearly figure it out (based on earlier rows) for the sake of space limitation. Also, the table index numbers (from 1 to 200) in Table 23 should be interpreted as just indexes for corresponding parameter combinations. That is, the table index number can be any value based on the ordering of parameter combinations and the number of parameter combinations in a table.

In one example, any sub-table of Table 23 can be an example for the table of ‘paraCombination-r18’.

TABLE 23

| | | | p_{υ} | | |
|---|---|---|---|---|---|
| paramCombination-r18 | L₁ | L₂ | υ ∈ {1, 2} | υ ∈ {3, 4} | β |
| 1 | 2 | 2 | 1/16 | 1/32 | ⅛ |
| 2 | 2 | 2 | 1/16 | 1/32 | ¼ |
| 3 | 2 | 2 | 1/16 | 1/32 | ½ |
| 4 | 2 | 2 | 1/16 | 1/32 | ¾ |
| 5 | 2 | 2 | 1/16 | 1/32 | 1 |
| 6 | 2 | 2 | 1/16 | 1/16 | ⅛ |
| 7 | 2 | 2 | 1/16 | 1/16 | ¼ |
| 8 | 2 | 2 | 1/16 | 1/16 | ½ |
| 9 | 2 | 2 | 1/16 | 1/16 | ¾ |
| 10 | 2 | 2 | 1/16 | 1/16 | 1 |
| 11 | 2 | 2 | ⅛ | 1/16 | ⅛ |
| 12 | 2 | 2 | ⅛ | 1/16 | ¼ |
| 13 | 2 | 2 | ⅛ | 1/16 | ½ |
| 14 | 2 | 2 | ⅛ | 1/16 | ¾ |
| 15 | 2 | 2 | ⅛ | 1/16 | 1 |
| 16 | 2 | 2 | ⅛ | ⅛ | ⅛ |
| 17 | 2 | 2 | ⅛ | ⅛ | ¼ |
| 18 | 2 | 2 | ⅛ | ⅛ | ½ |
| 19 | 2 | 2 | ⅛ | ⅛ | ¾ |
| 20 | 2 | 2 | ⅛ | ⅛ | 1 |
| 21 | 2 | 2 | ¼ | ⅛ | ⅛ |
| 22 | 2 | 2 | ¼ | ⅛ | ¼ |
| 23 | 2 | 2 | ¼ | ⅛ | ½ |
| 24 | 2 | 2 | ¼ | ⅛ | ¾ |
| 25 | 2 | 2 | ¼ | ⅛ | 1 |
| 26 | 2 | 2 | ½ | ¼ | ⅛ |
| 27 | 2 | 2 | ¼ | ¼ | ¼ |
| 28 | 2 | 2 | ¼ | ¼ | ½ |
| 29 | 2 | 2 | ¼ | ¼ | ¾ |
| 30 | 2 | 2 | ¼ | ¼ | 1 |
| 31 | 2 | 2 | ⅜ | 3/16 | ⅛ |
| 32 | 2 | 2 | ⅜ | 3/16 | ¼ |
| 33 | 2 | 2 | ⅜ | 3/16 | ½ |
| 34 | 2 | 2 | ⅜ | 3/16 | ¾ |
| 35 | 2 | 2 | ⅜ | 3/16 | 1 |
| 36 | 2 | 2 | ⅜ | ⅜ | ⅛ |
| 37 | 2 | 2 | ⅜ | ⅜ | ¼ |
| 38 | 2 | 2 | ⅜ | ⅜ | ½ |
| 39 | 2 | 2 | ⅜ | ⅜ | ¾ |
| 40 | 2 | 2 | ⅜ | ⅜ | 1 |
| 41 | 2 | 2 | ½ | ¼ | ⅛ |
| 42 | 2 | 2 | ½ | ¼ | ¼ |
| 43 | 2 | 2 | ½ | ½ | ½ |
| 44 | 2 | 2 | ½ | ¼ | ¾ |
| 45 | 2 | 2 | ½ | ½ | 1 |
| 46 | 2 | 2 | ½ | ½ | ⅛ |
| 47 | 2 | 2 | ½ | ½ | ¼ |
| 48 | 2 | 2 | ½ | ½ | ½ |
| 49 | 2 | 2 | ½ | ½ | ¾ |
| 50 | 2 | 2 | ½ | ½ | 1 |
| 51 | 2 | 4 | 1/16 | 1/32 | ⅛ |
| 52 | 2 | 4 | 1/16 | 1/32 | ¼ |
| 53 | 2 | 4 | 1/16 | 1/32 | ½ |
| 54 | 2 | 4 | 1/16 | 1/32 | ¾ |
| 55 | 2 | 4 | 1/16 | 1/32 | 1 |
| 56 | 2 | 4 | 1/16 | 1/16 | ⅛ |
| 57 | 2 | 4 | 1/16 | 1/16 | ¼ |
| 58 | 2 | 4 | 1/16 | 1/16 | ½ |
| 59 | 2 | 4 | 1/16 | 1/16 | ¾ |
| 60 | 2 | 4 | 1/16 | 1/16 | 1 |
| 61 | 2 | 4 | ⅛ | 1/16 | ⅛ |
| 62 | 2 | 4 | ⅛ | 1/16 | ¼ |
| 63 | 2 | 4 | ⅛ | 1/16 | ½ |
| 64 | 2 | 4 | ⅛ | 1/16 | ¾ |
| 65 | 2 | 4 | ⅛ | 1/16 | 1 |
| 66 | 2 | 4 | ⅛ | ⅛ | ⅛ |
| 67 | 2 | 4 | ⅛ | ⅛ | ¼ |
| 68 | 2 | 4 | ⅛ | ⅛ | ½ |
| 69 | 2 | 4 | ⅛ | ⅛ | ¾ |
| 70 | 2 | 4 | ⅛ | ⅛ | 1 |
| 71 | 2 | 4 | ½ | ⅛ | ⅛ |
| 72 | 2 | 4 | ¼ | ⅛ | ¼ |
| 73 | 2 | 4 | ¼ | ⅛ | ½ |
| 74 | 2 | 4 | ¼ | ⅛ | ¾ |
| 75 | 2 | 4 | ¼ | ⅛ | 1 |
| 76 | 2 | 4 | ¼ | ¼ | ⅛ |
| 77 | 2 | 4 | ¼ | ¼ | ¼ |
| 78 | 2 | 4 | ¼ | ¼ | ½ |
| 79 | 2 | 4 | ¼ | ¼ | ¾ |
| 80 | 2 | 4 | ¼ | ¼ | 1 |
| 81 | 2 | 4 | ⅜ | 3/16 | ⅛ |
| 82 | 2 | 4 | ⅜ | 3/16 | ¼ |
| 83 | 2 | 4 | ⅜ | 3/16 | ½ |
| 84 | 2 | 4 | ⅜ | 3/16 | ¾ |
| 85 | 2 | 4 | ⅜ | 3/16 | 1 |
| 86 | 2 | 4 | ⅜ | ⅜ | ⅛ |
| 87 | 2 | 4 | ⅜ | ⅜ | ½ |
| 88 | 2 | 4 | ⅜ | ⅜ | ½ |
| 89 | 2 | 4 | ⅜ | ⅜ | ¾ |
| 90 | 2 | 4 | ⅜ | ⅜ | 1 |
| 91 | 2 | 4 | ½ | ½ | ⅛ |
| 92 | 2 | 4 | ½ | ¼ | ¼ |
| 93 | 2 | 4 | ½ | ½ | ½ |
| 94 | 2 | 4 | ½ | ¼ | ¾ |
| 95 | 2 | 4 | ½ | ¼ | 1 |
| 96 | 2 | 4 | ½ | ½ | ⅛ |
| 97 | 2 | 4 | ½ | ½ | ¼ |
| 98 | 2 | 4 | ½ | ½ | ½ |
| 99 | 2 | 4 | ½ | ½ | ¾ |
| 100 | 2 | 4 | ½ | ½ | 1 |
| 101 | 4 | 2 | 1/16 | 1/32 | ⅛ |
| 102 | 4 | 2 | 1/16 | 1/32 | ¼ |
| 103 | 4 | 2 | 1/16 | 1/32 | ½ |
| 104 | 4 | 2 | 1/16 | 1/32 | ¾ |
| 105 | 4 | 2 | 1/16 | 1/32 | 1 |
| . | . | | . | . | . |
| . | . | | . | . | . |
| . | . | | . | . | . |
| 151 | 4 | 4 | 1/16 | 1/32 | ⅛ |
| 152 | 4 | 4 | 1/16 | 1/32 | ¼ |
| 153 | 4 | 4 | 1/16 | 1/32 | ½ |
| 154 | 4 | 4 | 1/16 | 1/32 | ¾ |
| 155 | 4 | 4 | 1/16 | 1/32 | 1 |
| . | . | | . | . | . |
| . | . | | . | . | . |
| . | . | | . | . | . |
| 196 | 4 | 4 | ½ | ½ | ⅛ |
| 197 | 4 | 4 | ½ | ½ | ¼ |
| 198 | 4 | 4 | ½ | ½ | ½ |
| 199 | 4 | 4 | ½ | ½ | ¾ |
| 200 | 4 | 4 | ½ | ½ | 1 |

In one example, when N_{TRP}=3, any table including at least one of parameter combinations in a sub-table of Table can be used for the table of ‘paramCombination-r18’.

In Table 24, we omitted the rows we can clearly figure it out (based on earlier rows) for the sake of space limitation. Also, the table index numbers (from 1 to 400) in Table 24 should be interpreted as just indexes for corresponding parameter combinations. That is, the table index number can be any value based on the ordering of parameter combinations and the number of parameter combinations in a table.

In one example, any sub-table of Table 24 can be an example for the table of ‘paraCombination-r18’.

TABLE 24

| paramCombination- | | | | p_{υ} | | |
|---|---|---|---|---|---|---|
| r18 | L₁ | L₂ | L₃ | υ ∈ {1, 2} | υ ∈ {3, 4} | β |
| 1 | 2 | 2 | 2 | 1/16 | 1/32 | ⅛ |
| 2 | 2 | 2 | 2 | 1/16 | 1/32 | ¼ |
| 3 | 2 | 2 | 2 | 1/16 | 1/32 | ½ |
| 4 | 2 | 2 | 2 | 1/16 | 1/32 | ¾ |
| 5 | 2 | 2 | 2 | 1/16 | 1/32 | 1 |
| 6 | 2 | 2 | 2 | 1/16 | 1/16 | ⅛ |
| 7 | 2 | 2 | 2 | 1/16 | 1/16 | ¼ |
| 8 | 2 | 2 | 2 | 1/16 | 1/16 | ½ |
| 9 | 2 | 2 | 2 | 1/16 | 1/16 | ¾ |
| 10 | 2 | 2 | 2 | 1/16 | 1/16 | 1 |
| 11 | 2 | 2 | 2 | ⅛ | 1/16 | ⅛ |
| 12 | 2 | 2 | 2 | ⅛ | 1/16 | ¼ |
| 13 | 2 | 2 | 2 | ⅛ | 1/16 | ½ |
| 14 | 2 | 2 | 2 | ⅛ | 1/16 | ¾ |
| 15 | 2 | 2 | 2 | ⅛ | 1/16 | 1 |
| 16 | 2 | 2 | 2 | ⅛ | ⅛ | ⅛ |
| 17 | 2 | 2 | 2 | ⅛ | ⅛ | ¼ |
| 18 | 2 | 2 | 2 | ⅛ | ⅛ | ½ |
| 19 | 2 | 2 | 2 | ⅛ | ⅛ | ¾ |
| 20 | 2 | 2 | 2 | ⅛ | ⅛ | 1 |
| 21 | 2 | 2 | 2 | ¼ | ⅛ | ⅛ |
| 22 | 2 | 2 | 2 | ¼ | ⅛ | ¼ |
| 23 | 2 | 2 | 2 | ¼ | ⅛ | ½ |
| 24 | 2 | 2 | 2 | ½ | ⅛ | ¾ |
| 25 | 2 | 2 | 2 | ¼ | ⅛ | 1 |
| 26 | 2 | 2 | 2 | ¼ | ¼ | ⅛ |
| 27 | 2 | 2 | 2 | ¼ | ¼ | ¼ |
| 28 | 2 | 2 | 2 | ¼ | ¼ | ½ |
| 29 | 2 | 2 | 2 | ¼ | ¼ | ¾ |
| 30 | 2 | 2 | 2 | ¼ | ¼ | 1 |
| 31 | 2 | 2 | 2 | ⅜ | 3/16 | ⅛ |
| 32 | 2 | 2 | 2 | ⅜ | 3/16 | ¼ |
| 33 | 2 | 2 | 2 | ⅜ | 3/16 | ½ |
| 34 | 2 | 2 | 2 | ⅜ | 3/16 | ¾ |
| 35 | 2 | 2 | 2 | ⅜ | 3/16 | 1 |
| 36 | 2 | 2 | 2 | ⅜ | ⅜ | ⅛ |
| 37 | 2 | 2 | 2 | ⅜ | ⅜ | ¼ |
| 38 | 2 | 2 | 2 | ⅜ | ⅜ | ½ |
| 39 | 2 | 2 | 2 | ⅜ | ⅜ | ¾ |
| 40 | 2 | 2 | 2 | ⅜ | ⅜ | 1 |
| 41 | 2 | 2 | 2 | ½ | ¼ | ⅛ |
| 42 | 2 | 2 | 2 | ½ | ¼ | ¼ |
| 43 | 2 | 2 | 2 | ½ | ¼ | ½ |
| 44 | 2 | 2 | 2 | ½ | ¼ | ¾ |
| 45 | 2 | 2 | 2 | ½ | ¼ | 1 |
| 46 | 2 | 2 | 2 | ½ | ½ | ⅛ |
| 47 | 2 | 2 | 2 | ½ | ½ | ¼ |
| 48 | 2 | 2 | 2 | ½ | ½ | ½ |
| 49 | 2 | 2 | 2 | ½ | ½ | ¾ |
| 50 | 2 | 2 | 2 | ½ | ½ | 1 |
| 51 | 2 | 2 | 4 | 1/16 | 1/32 | ⅛ |
| 52 | 2 | 2 | 4 | 1/16 | 1/32 | ¼ |
| 53 | 2 | 2 | 4 | 1/16 | 1/32 | ½ |
| 54 | 2 | 2 | 4 | 1/16 | 1/32 | ¾ |
| 55 | 2 | 2 | 4 | 1/16 | 1/32 | 1 |
| 56 | 2 | 2 | 4 | 1/16 | 1/16 | ⅛ |
| 57 | 2 | 2 | 4 | 1/16 | 1/16 | ¼ |
| 58 | 2 | 2 | 4 | 1/16 | 1/16 | ½ |
| 59 | 2 | 2 | 4 | 1/16 | 1/16 | ¾ |
| 60 | 2 | 2 | 4 | 1/16 | 1/16 | 1 |
| 61 | 2 | 2 | 4 | ⅛ | 1/16 | ⅛ |
| 62 | 2 | 2 | 4 | ⅛ | 1/16 | ¼ |
| 63 | 2 | 2 | 4 | ⅛ | 1/16 | ½ |
| 64 | 2 | 2 | 4 | ⅛ | 1/16 | ¾ |
| 65 | 2 | 2 | 4 | ⅛ | 1/16 | 1 |
| 66 | 2 | 2 | 4 | ⅛ | ⅛ | ⅛ |
| 67 | 2 | 2 | 4 | ⅛ | ⅛ | ¼ |
| 68 | 2 | 2 | 4 | ⅛ | ⅛ | ½ |
| 69 | 2 | 2 | 4 | ⅛ | ⅛ | ¾ |
| 70 | 2 | 2 | 4 | ⅛ | ⅛ | 1 |
| 71 | 2 | 2 | 4 | ¼ | ⅛ | ⅛ |
| 72 | 2 | 2 | 4 | ¼ | ⅛ | ¼ |
| 73 | 2 | 2 | 4 | ¼ | ⅛ | ½ |
| 74 | 2 | 2 | 4 | ¼ | ⅛ | ¾ |
| 75 | 2 | 2 | 4 | ¼ | ⅛ | 1 |
| 76 | 2 | 2 | 4 | ¼ | ¼ | ⅛ |
| 77 | 2 | 2 | 4 | ¼ | ¼ | ¼ |
| 78 | 2 | 2 | 4 | ¼ | ¼ | ½ |
| 79 | 2 | 2 | 4 | ¼ | ¼ | ¾ |
| 80 | 2 | 2 | 4 | ¼ | ¼ | 1 |
| 81 | 2 | 2 | 4 | ⅜ | 3/16 | ⅛ |
| 82 | 2 | 2 | 4 | ⅜ | 3/16 | ¼ |
| 83 | 2 | 2 | 4 | ⅜ | 3/16 | ½ |
| 84 | 2 | 2 | 4 | ⅜ | 3/16 | ¾ |
| 85 | 2 | 2 | 4 | ⅜ | 3/16 | 1 |
| 86 | 2 | 2 | 4 | ⅜ | ⅜ | ⅛ |
| 87 | 2 | 2 | 4 | ⅜ | ⅜ | ¼ |
| 88 | 2 | 2 | 4 | ⅜ | ⅜ | ½ |
| 89 | 2 | 2 | 4 | ⅜ | ⅜ | ¾ |
| 90 | 2 | 2 | 4 | ⅜ | ⅜ | 1 |
| 91 | 2 | 2 | 4 | ½ | ¼ | ⅛ |
| 92 | 2 | 2 | 4 | ½ | ¼ | ¼ |
| 93 | 2 | 2 | 4 | ½ | ¼ | ½ |
| 94 | 2 | 2 | 4 | ½ | ¼ | ¾ |
| 95 | 2 | 2 | 4 | ½ | ¼ | 1 |
| 96 | 2 | 2 | 4 | ½ | ½ | ⅛ |
| 97 | 2 | 2 | 4 | ½ | ½ | ¼ |
| 98 | 2 | 2 | 4 | ½ | ½ | ½ |
| 99 | 2 | 2 | 4 | ½ | ½ | ¾ |
| 100 | 2 | 2 | 4 | ½ | ½ | 1 |
| 101 | 2 | 4 | 2 | 1/16 | 1/32 | ⅛ |
| 102 | 2 | 4 | 2 | 1/16 | 1/32 | ¼ |
| 103 | 2 | 4 | 2 | 1/16 | 1/32 | ½ |
| 104 | 2 | 4 | 2 | 1/16 | 1/32 | ¾ |
| 105 | 2 | 4 | 2 | 1/16 | 1/32 | 1 |
| . | . | . | . | . | . | . |
| . | . | . | . | . | . | . |
| . | . | . | . | . | . | . |
| 151 | 2 | 4 | 4 | 1/16 | 1/32 | ⅛ |
| 152 | 2 | 4 | 4 | 1/16 | 1/32 | ¼ |
| 153 | 2 | 4 | 4 | 1/16 | 1/32 | ½ |
| 154 | 2 | 4 | 4 | 1/16 | 1/32 | ¾ |
| 155 | 2 | 4 | 4 | 1/16 | 1/32 | 1 |
| . | . | . | . | . | . | . |
| . | . | . | . | . | . | . |
| . | . | . | . | . | . | . |
| 201 | 4 | 2 | 2 | 1/16 | 1/32 | ⅛ |
| . | . | . | . | . | . | . |
| . | . | . | . | . | . | . |
| . | . | . | . | . | . | . |
| 251 | 4 | 2 | 4 | 1/16 | 1/32 | ⅛ |
| . | . | . | . | . | . | . |
| . | . | . | . | . | . | . |
| . | . | . | . | . | . | . |
| 301 | 4 | 4 | 2 | 1/16 | 1/32 | ⅛ |
| . | . | . | . | . | . | . |
| . | . | . | . | . | . | . |
| . | . | . | . | . | . | . |
| 351 | 4 | 4 | 4 | 1/16 | 1/32 | ⅛ |
| . | . | . | . | . | . | . |
| . | . | . | . | . | . | . |
| . | . | . | . | . | . | . |
| 396 | 4 | 4 | 4 | ½ | ½ | ⅛ |
| 397 | 4 | 4 | 4 | ½ | ½ | ¼ |
| 398 | 4 | 4 | 4 | ½ | ½ | ½ |
| 399 | 4 | 4 | 4 | ½ | ½ | ¾ |
| 400 | 4 | 4 | 4 | ½ | ½ | 1 |

In one example, when N_{TRP}=4, any table including at least one of parameter combinations in a sub-table of Table 25 can be used for the table of ‘paramCombination-r18’.

In Table 25 we omitted the rows we can clearly figure it out (based on earlier rows) for the sake of space limitation. Also, the table index numbers (from 1 to 800) in Table 25 should be interpreted as just indexes for corresponding parameter combinations. That is, the table index number can be any value based on the ordering of parameter combinations and the number of parameter combinations in a table.

In one example, any sub-table of Table 25 can be an example for the table of ‘paraCombination-r18’.

TABLE 25

| paramCom- | | | | | p_{υ} | | |
|---|---|---|---|---|---|---|---|
| bination-r18 | L₁ | L₂ | L₃ | L₄ | υ ∈ {1, 2} | υ ∈ {3, 4} | β |
| 1 | 2 | 2 | 2 | 2 | 1/16 | 1/32 | ⅛ |
| 2 | 2 | 2 | 2 | 2 | 1/16 | 1/32 | ¼ |
| 3 | 2 | 2 | 2 | 2 | 1/16 | 1/32 | ½ |
| 4 | 2 | 2 | 2 | 2 | 1/16 | 1/32 | ¾ |
| 5 | 2 | 2 | 2 | 2 | 1/16 | 1/32 | 1 |
| 6 | 2 | 2 | 2 | 2 | 1/16 | 1/16 | ⅛ |
| 7 | 2 | 2 | 2 | 2 | 1/16 | 1/16 | ¼ |
| 8 | 2 | 2 | 2 | 2 | 1/16 | 1/16 | ½ |
| 9 | 2 | 2 | 2 | 2 | 1/16 | 1/16 | ¾ |
| 10 | 2 | 2 | 2 | 2 | 1/16 | 1/16 | 1 |
| 11 | 2 | 2 | 2 | 2 | ⅛ | 1/16 | ⅛ |
| 12 | 2 | 2 | 2 | 2 | ⅛ | 1/16 | ¼ |
| 13 | 2 | 2 | 2 | 2 | ⅛ | 1/16 | ½ |
| 14 | 2 | 2 | 2 | 2 | ⅛ | 1/16 | ¾ |
| 15 | 2 | 2 | 2 | 2 | ⅛ | 1/16 | 1 |
| 16 | 2 | 2 | 2 | 2 | ⅛ | ⅛ | ⅛ |
| 17 | 2 | 2 | 2 | 2 | ⅛ | ⅛ | ¼ |
| 18 | 2 | 2 | 2 | 2 | ⅛ | ⅛ | ½ |
| 19 | 2 | 2 | 2 | 2 | ⅛ | ⅛ | ¾ |
| 20 | 2 | 2 | 2 | 2 | ⅛ | ⅛ | 1 |
| 21 | 2 | 2 | 2 | 2 | ¼ | ⅛ | ⅛ |
| 22 | 2 | 2 | 2 | 2 | ¼ | ⅛ | ¼ |
| 23 | 2 | 2 | 2 | 2 | ¼ | ⅛ | ½ |
| 24 | 2 | 2 | 2 | 2 | ¼ | ⅛ | ¾ |
| 25 | 2 | 2 | 2 | 2 | ¼ | ⅛ | 1 |
| 26 | 2 | 2 | 2 | 2 | ¼ | ¼ | ⅛ |
| 27 | 2 | 2 | 2 | 2 | ¼ | ¼ | ¼ |
| 28 | 2 | 2 | 2 | 2 | ¼ | ¼ | ½ |
| 29 | 2 | 2 | 2 | 2 | ¼ | ¼ | ¾ |
| 30 | 2 | 2 | 2 | 2 | ¼ | ¼ | 1 |
| 31 | 2 | 2 | 2 | 2 | ⅜ | 3/16 | ⅛ |
| 32 | 2 | 2 | 2 | 2 | ⅜ | 3/16 | ¼ |
| 33 | 2 | 2 | 2 | 2 | ⅜ | 3/16 | ½ |
| 34 | 2 | 2 | 2 | 2 | ⅜ | 3/16 | ¾ |
| 35 | 2 | 2 | 2 | 2 | ⅜ | 3/16 | 1 |
| 36 | 2 | 2 | 2 | 2 | ⅜ | ⅜ | ⅛ |
| 37 | 2 | 2 | 2 | 2 | ⅜ | ⅜ | ¼ |
| 38 | 2 | 2 | 2 | 2 | ⅜ | ⅜ | ½ |
| 39 | 2 | 2 | 2 | 2 | ⅜ | ⅜ | ¾ |
| 40 | 2 | 2 | 2 | 2 | ⅜ | ⅜ | 1 |
| 41 | 2 | 2 | 2 | 2 | ½ | ¼ | ⅛ |
| 42 | 2 | 2 | 2 | 2 | ½ | ¼ | ¼ |
| 43 | 2 | 2 | 2 | 2 | ½ | ¼ | ½ |
| 44 | 2 | 2 | 2 | 2 | ½ | ¼ | ¾ |
| 45 | 2 | 2 | 2 | 2 | ½ | ¼ | 1 |
| 46 | 2 | 2 | 2 | 2 | ½ | ½ | ⅛ |
| 47 | 2 | 2 | 2 | 2 | ½ | ½ | ¼ |
| 48 | 2 | 2 | 2 | 2 | ½ | ½ | ½ |
| 49 | 2 | 2 | 2 | 2 | ½ | ½ | ¾ |
| 50 | 2 | 2 | 2 | 2 | ½ | ½ | 1 |
| 51 | 2 | 2 | 2 | 4 | 1/16 | 1/32 | ⅛ |
| 52 | 2 | 2 | 2 | 4 | 1/16 | 1/32 | ¼ |
| 53 | 2 | 2 | 2 | 4 | 1/16 | 1/32 | ½ |
| 54 | 2 | 2 | 2 | 4 | 1/16 | 1/32 | ¾ |
| 55 | 2 | 2 | 2 | 4 | 1/16 | 1/32 | 1 |
| 56 | 2 | 2 | 2 | 4 | 1/16 | 1/16 | ⅛ |
| 57 | 2 | 2 | 2 | 4 | 1/16 | 1/16 | ¼ |
| 58 | 2 | 2 | 2 | 4 | 1/16 | 1/16 | ½ |
| 59 | 2 | 2 | 2 | 4 | 1/16 | 1/16 | ¾ |
| 60 | 2 | 2 | 2 | 4 | 1/16 | 1/16 | 1 |
| 61 | 2 | 2 | 2 | 4 | ⅛ | 1/16 | ⅛ |
| 62 | 2 | 2 | 2 | 4 | ⅛ | 1/16 | ¼ |
| 63 | 2 | 2 | 2 | 4 | ⅛ | 1/16 | ½ |
| 64 | 2 | 2 | 2 | 4 | ⅛ | 1/16 | ¾ |
| 65 | 2 | 2 | 2 | 4 | ⅛ | 1/16 | 1 |
| 66 | 2 | 2 | 2 | 4 | ⅛ | ⅛ | ⅛ |
| 67 | 2 | 2 | 2 | 4 | ⅛ | ⅛ | ¼ |
| 68 | 2 | 2 | 2 | 4 | ⅛ | ⅛ | ½ |
| 69 | 2 | 2 | 2 | 4 | ⅛ | ⅛ | ¾ |
| 70 | 2 | 2 | 2 | 4 | ⅛ | ⅛ | 1 |
| 71 | 2 | 2 | 2 | 4 | ¼ | ⅛ | ⅛ |
| 72 | 2 | 2 | 2 | 4 | ¼ | ⅛ | ¼ |
| 73 | 2 | 2 | 2 | 4 | ¼ | ⅛ | ½ |
| 74 | 2 | 2 | 2 | 4 | ¼ | ⅛ | ¾ |
| 75 | 2 | 2 | 2 | 4 | ¼ | ⅛ | 1 |
| 76 | 2 | 2 | 2 | 4 | ¼ | ¼ | ⅛ |
| 77 | 2 | 2 | 2 | 4 | ¼ | ¼ | ¼ |
| 78 | 2 | 2 | 2 | 4 | ¼ | ¼ | ½ |
| 79 | 2 | 2 | 2 | 4 | ¼ | ¼ | ¾ |
| 80 | 2 | 2 | 2 | 4 | ¼ | ¼ | 1 |
| 81 | 2 | 2 | 2 | 4 | ⅜ | 3/16 | ⅛ |
| 82 | 2 | 2 | 2 | 4 | ⅜ | 3/16 | ¼ |
| 83 | 2 | 2 | 2 | 4 | ⅜ | 3/16 | ½ |
| 84 | 2 | 2 | 2 | 4 | ⅜ | 3/16 | ¾ |
| 85 | 2 | 2 | 2 | 4 | ⅜ | 3/16 | 1 |
| 86 | 2 | 2 | 2 | 4 | ⅜ | ⅜ | ⅛ |
| 87 | 2 | 2 | 2 | 4 | ⅜ | ⅜ | ¼ |
| 88 | 2 | 2 | 2 | 4 | ⅜ | ⅜ | ½ |
| 89 | 2 | 2 | 2 | 4 | ⅜ | ⅜ | ¾ |
| 90 | 2 | 2 | 2 | 4 | ⅜ | ⅜ | 1 |
| 91 | 2 | 2 | 2 | 4 | ½ | ¼ | ⅛ |
| 92 | 2 | 2 | 2 | 4 | ½ | ¼ | ¼ |
| 93 | 2 | 2 | 2 | 4 | ½ | ¼ | ½ |
| 94 | 2 | 2 | 2 | 4 | ½ | ¼ | ¾ |
| 95 | 2 | 2 | 2 | 4 | ½ | ¼ | 1 |
| 96 | 2 | 2 | 2 | 4 | ½ | ½ | ⅛ |
| 97 | 2 | 2 | 2 | 4 | ½ | ½ | ¼ |
| 98 | 2 | 2 | 2 | 4 | ½ | ½ | ½ |
| 99 | 2 | 2 | 2 | 4 | ½ | ½ | ¾ |
| 100 | 2 | 2 | 2 | 4 | ½ | ½ | 1 |
| 101 | 2 | 2 | 4 | 2 | 1/16 | 1/32 | ⅛ |
| 102 | 2 | 2 | 4 | 2 | 1/16 | 1/32 | ¼ |
| 103 | 2 | 2 | 4 | 2 | 1/16 | 1/32 | ½ |
| 104 | 2 | 2 | 4 | 2 | 1/16 | 1/32 | ¾ |
| 105 | 2 | 2 | 4 | 2 | 1/16 | 1/32 | 1 |
| . | . | | | | . | . | . |
| . | . | | | | . | . | . |
| . | . | | | | . | . | . |
| 151 | 2 | 2 | 4 | 4 | 1/16 | 1/32 | ⅛ |
| 152 | 2 | 2 | 4 | 4 | 1/16 | 1/32 | ¼ |
| 153 | 2 | 2 | 4 | 4 | 1/16 | 1/32 | ½ |
| 154 | 2 | 2 | 4 | 4 | 1/16 | 1/32 | ¾ |
| 155 | 2 | 2 | 4 | 4 | 1/16 | 1/32 | 1 |
| . | . | | | | . | . | . |
| . | . | | | | . | . | . |
| . | . | | | | . | . | . |
| 201 | 2 | 4 | 2 | 2 | 1/16 | 1/32 | ⅛ |
| . | . | | | | . | . | . |
| . | . | | | | . | . | . |
| . | . | | | | . | . | . |
| 251 | 2 | 4 | 2 | 4 | 1/16 | 1/32 | ⅛ |
| . | . | | | | . | . | . |
| . | . | | | | . | . | . |
| . | . | | | | . | . | . |
| 301 | 2 | 4 | 4 | 2 | 1/16 | 1/32 | ⅛ |
| . | . | | | | . | . | . |
| . | . | | | | . | . | . |
| . | . | | | | . | . | . |
| 351 | 2 | 4 | 4 | 4 | 1/16 | 1/32 | ⅛ |
| . | . | | | | . | . | . |
| . | . | | | | . | . | . |
| . | . | | | | . | . | . |
| 401 | 4 | 2 | 2 | 2 | 1/16 | 1/32 | ⅛ |
| . | . | | | | . | . | . |
| . | . | | | | . | . | . |
| . | . | | | | . | . | . |
| 451 | 4 | 2 | 2 | 4 | 1/16 | 1/32 | ⅛ |
| . | . | | | | . | . | . |
| . | . | | | | . | . | . |
| . | . | | | | . | . | . |
| 501 | 4 | 2 | 4 | 2 | 1/16 | 1/32 | ⅛ |
| . | . | | | | . | . | . |
| . | . | | | | . | . | . |
| . | . | | | | . | . | . |
| 551 | 4 | 2 | 4 | 4 | 1/16 | 1/32 | ⅛ |
| . | . | | | | . | . | . |
| . | . | | | | . | . | . |
| . | . | | | | . | . | . |
| 601 | 4 | 4 | 2 | 2 | 1/16 | 1/32 | ⅛ |
| . | . | | | | . | . | . |
| . | . | | | | . | . | . |
| . | . | | | | . | . | . |
| 651 | 4 | 4 | 2 | 4 | 1/16 | 1/32 | ⅛ |
| . | . | | | | . | . | . |
| . | . | | | | . | . | . |
| . | . | | | | . | . | . |
| 701 | 4 | 4 | 4 | 2 | 1/16 | 1/32 | ⅛ |
| . | . | | | | . | . | . |
| . | . | | | | . | . | . |
| . | . | | | | . | . | . |
| 751 | 4 | 4 | 4 | 4 | 1/16 | 1/32 | ⅛ |
| . | . | | | | . | . | . |
| . | . | | | | . | . | . |
| . | . | | | | . | . | . |
| 796 | 4 | 4 | 4 | 4 | ½ | ½ | ⅛ |
| 797 | 4 | 4 | 4 | 4 | ½ | ½ | ¼ |
| 798 | 4 | 4 | 4 | 4 | ½ | ½ | ½ |
| 799 | 4 | 4 | 4 | 4 | ½ | ½ | ¾ |
| 800 | 4 | 4 | 4 | 4 | ½ | ½ | 1 |

In one embodiment, any table including at least one of parameter combinations in a sub-table of Table 322/Table 23/Table 24/Table 25 associated with {Lₙ} such that Lₙ₁≥Lₙ₂ (non-increasing order) when n1<n2 can be used for the table of ‘paramCombination-r18’.

In one example, the ordering of the TRP can be configured by the NW 130, via e.g., RRC, MAC CE, or DCI.

In one embodiment, any table including at least one of parameter combinations in a sub-table of Table 22/Table 23/Table 24/Table 25 associated with {Lₙ} such that Lₙ₁≥Lₙ₂ (non-increasing order) when n1>n2 can be used for the table of ‘paramCombination-r18’.

In one example, the ordering of the TRP can be configured by the NW 130, via e.g., RRC, MAC CE, or DCI.

In another embodiment, any table including at least one of parameter combinations in a sub-table of Table 22/Table 23/Table 24/Table 25 can be used for the table of ‘paramCombination-r18’, where the sub-table includes parameter combinations associated with ({pᵥ}_{v=1,2}, {pᵥ}_{v=3,4})∈ [symbol] , where [symbol] is a subset of [symbol] , where [symbol] ={(x, y)|x∈ [symbol] ₁₂, y∈ [symbol] ₃₄}. For example, if [symbol] ={(⅛, 1/16),(¼,⅛),(¼,¼),(½,¼),(½,½)}, the sub-table includes the parameter combinations associated with ({pᵥ}_{v+1,2}, {pᵥ}_{v=3,4})={(⅛, 1/16),(¼,⅛),(¼,¼),(½,¼),(½,½)} in Table 22/Table 23/Table 24/Table 25.
In one example, [symbol] ={(¼,⅛),(¼,¼),(½,¼)} and the sub-table includes parameter combinations associated with if ({pᵥ}_{v=1,2},{pᵥ}_{v=3,4})={(¼,⅛),(¼,¼),(½,¼)} in Table 22/Table 23/Table 24/Table 25.
In one example, [symbol] ={(⅛, 1/16),(¼,⅛),(¼,¼),(½,¼)} and the sub-table includes parameter combinations associated with if ({pᵥ}_{v=1,2}, {pᵥ}_{v=3,4})={(⅛, 1/16),(¼,⅛),(¼,¼),(½,¼)} in Table 22/Table 23/Table 24/Table 25.
In one example [symbol] ={(⅛, 1/16),(¼,⅛),(¼,¼),(½,¼),(½,½)} and the sub-table includes parameter combinations associated with if ({pᵥ}_{v=1,2}, {pᵥ}_{v=3,4})={(⅛, 1/16),(¼,⅛),(¼,¼),(½,¼),(½,½)} in Table 22/Table 23/Table 24/Table 25.
In one example, [symbol] ={(¼,⅛),(¼,¼),(½,¼),(½,½)} and the sub-table includes parameter combinations associated with if ({pᵥ}_{v=1,2}, {Pᵥ}_{v=3,4})={(¼,⅛),(¼,¼),(½,¼),(½,½)} in Table 22/Table 23/Table 24/Table 25.

In another embodiment, any table including at least one of parameter combinations in a sub-table of Table 22/Table 23/Table 24/Table 25 can be used for the table of ‘paramCombination-r18’, where the sub-table includes parameter combinations associated with β∈ [symbol] , where [symbol] is a subset of [symbol] . For example, if [symbol] ={⅛,¼,½,¾}, the sub-table includes the parameter combinations associated with β=⅛,¼,½,¾, in Table 22/Table 23/Table 24/Table 25. [symbol]
In one example [symbol] ={¼,½,¾} and the sub-table includes parameter combinations associated with β=¼,½,¾, in Table 22/Table 23/Table 24/Table 25.
In one example, [symbol] ={⅛,¼,½,¾} and the sub-table includes parameter combinations associated with β=⅛,¼,½,¾ in Table 22/Table 23/Table 24/Table 25.
In one example, [symbol] ={⅛,¼,½,¾,1} and the sub-table includes parameter combinations associated with β=⅛,¼,½,¾,1 in Table 22/Table 23/Table 24/Table 25.
In one example, [symbol] ={¼,½,¾,1} and the sub-table includes parameter combinations associated with β=¼,½,¾,1 in Table 322/Table 23/Table 24/Table 25.
In one example [symbol] ={⅛,¼,½} and the sub-table includes parameter combinations associated with β=⅛,¼,½ in Table 22/Table 23/Table 24/Table 25.

In another embodiment, any table including at least one of parameter combinations in a sub-table of Table 22/Table 23/Table 24/Table 25 can be used for the table of ‘paramCombination-r18’, where the sub-table includes parameter combinations associated ({pᵥ}_{v=1,2}, {pᵥ}_{v=3,4})∈ [symbol] and β∈ [symbol] , where ({pᵥ}_{v=1,2}, {pᵥ}_{v=3,4})∈ [symbol] is defined in one or more embodiments described herein, and β∈ [symbol] is defined in one or more embodiments described herein.

In one example, the sub-table includes parameter combinations associated with:
({pᵥ}_{v=1,2},{pᵥ}_{v=3,4})∈ [symbol] ={(⅛, 1/16),(¼,⅛),(¼,¼),(½,¼)} and β∈ [symbol] ={⅛,¼,½,¾}.

In another embodiment, a table used for ‘paramCombination-r18’ is designed based on the following parameter candidates:
Candidate values for Lₙ: [symbol] ₙ={2,4,6}
   where Lₙ is L for CSI-RS resource n (TRP n); and
   N_{TRP}∈{1,2,3,4} is a number of CSI-RS resources (or TRPs) and is configured by the NW 130 via higher-layer signaling.
Candidate values for pᵥ for v=1,2: [symbol] ₁₂={ 1/16,⅛,¼,⅜,½}.
Candidate values for pᵥ for v=3,4: [symbol] ₃₄={ 1/32, 3/16, 1/16,⅛,¼,⅜,½}.
Candidate values for β: [symbol] ={⅛,¼,½,¾,1}.

In one example, similar to one or more embodiments described herein, a table for each value of N_{TRP} can be constructed (we omitted due to space limitation) using the candidate values, such as Table 22/Table 23/Table 24/Table 25.
In one example, any table including at least one of parameter combinations in a sub-table of the table can be used for the table of ‘paramCombination-r18’.
In one example, any sub-table of the table can be an example for the table of ‘paraCombination-r18’.

In another embodiment, any table including at least one of parameter combinations in a sub-table of any table constructed in one or more embodiments described herein can be used for the table of ‘paramCombination-r18’, where the sub-table includes parameter combinations associated with ({pᵥ}_{v=1,2}, {pᵥ}_{v=3,4})∈ [symbol] , where [symbol] is a subset of [symbol] , where [symbol] ={(x, y)|x∈ [symbol] ₁₂, y∈ [symbol] ₃₄}. The rest part can be the same as the remaining part of one or more embodiments described herein.

In another embodiment, any table including at least one of parameter combinations in a sub-table of any table constructed in one or more embodiments described herein can be used for the table of ‘paramCombination-r18’, where the sub-table includes parameter combinations associated with β∈ [symbol] , where [symbol] is a subset of [symbol] . The rest part can be the same as the remaining part of one or more embodiments described herein.

In another embodiment, any table including at least one of parameter combinations in a sub-table of any table constructed in one or more embodiments described herein can be used for the table of ‘paramCombination-r18’, where the sub-table includes parameter combinations associated ({pᵥ}_{v=1,2}, {pᵥ}_{v=3,4})∈ [symbol] and β∈ [symbol] , where ({pᵥ}_{v=1,2}, {pᵥ}_{v=3,4})∈ [symbol] is defined in one or more embodiments described herein, and β∈ [symbol] is defined in one or more embodiments described herein. The rest part can be the same as the remaining part of one or more embodiments described herein.

In another embodiment, a table used for ‘paramCombination-r18’ is designed based on the following parameter candidates:
Candidate values for Lₙ: [symbol] ₙ={1,2,4,6}
   where Lₙ is L for CSI-RS resource n (TRP n); and
   N_{TRP}∈{1,2,3,4} is a number of CSI-RS resources (or TRPs) and is configured by the NW 130 via higher-layer signaling.
Candidate values for pᵥ for v=1,2: [symbol] ₁₂={ 1/16,⅛,¼,⅜,½}.
Candidate values for pᵥ for v=3,4: [symbol] ₃₄={ 1/32, 3/16, 1/16,⅛,¼,⅜,½}.
Candidate values for β: [symbol] ={⅛,¼,½,¾,1}.

In one example, similar to one or more embodiments described herein, a table for each value of N_{TRP} can be constructed (we omitted due to space limitation) using the candidate values, such as Table 22/Table 23/Table 24/Table 25.
In one example, any table including at least one of parameter combinations in a sub-table of the table can be used for the table of ‘paramCombination-r18’.
In one example, any sub-table of the table can be an example for the table of ‘paraCombination-r18’.

In another embodiment, any table including at least one of parameter combinations in a sub-table of any table constructed in one or more embodiments described herein can be used for the table of ‘paramCombination-r18’, where the sub-table includes parameter combinations associated with ({pᵥ}_{v=1,2}, {pᵥ}_{v=3,4})∈ [symbol] , where [symbol] is a subset of [symbol] , where [symbol] ={(x, y)|x∈ [symbol] ₁₂, y∈ [symbol] ₃₄}. The rest part can be the same as the remaining part of one or more embodiments described herein.

In another embodiment, any table including at least one of parameter combinations in a sub-table of any table constructed in one or more embodiments described herein can be used for the table of ‘paramCombination-r18’, where the sub-table includes parameter combinations associated with β∈ [symbol] , where [symbol] is a subset of [symbol] . The rest part can be the same as the remaining part of one or more embodiments described herein.

In another embodiment, any table including at least one of parameter combinations in a sub-table of any table constructed in one or more embodiments described herein can be used for the table of ‘paramCombination-r18’, where the sub-table includes parameter combinations associated ({pᵥ}_{v=1,2}, {pᵥ}_{v=3,4})∈ [symbol] and β∈ [symbol] , where ({pᵥ}_{v=1,2}, {pᵥ}_{v=3,4})∈ [symbol] is defined in one or more embodiments described herein, and β∈ [symbol] is defined in one or more embodiments described herein. The rest part can be the same as the remaining part of one or more embodiments described herein.

In another embodiment, for any table described in one or more embodiments described herein or any table (whole-table or a sub-table) that can be constructed by one or more embodiments described herein, the table can further include Lₜₒₜ in addition to Lₙ, pᵥ and β, and can be used for the table of ‘paramCombination-r18’.

In one example, Table 26 can be an example describing a table including Lₜₒₜ in addition to Lₙ, pᵥ and β, which is based on Table 26.

TABLE 26

| paramCom- | | | | | | p_{υ} | | |
|---|---|---|---|---|---|---|---|---|
| bination-r18 | L₁ | L₂ | L₃ | L₄ | Lₜₒₜ | υ ∈ {1, 2} | υ ∈ {3, 4} | β |
| 1 | 2 | 2 | 2 | 2 | 8 | 1/16 | 1/32 | ⅛ |
| 2 | 2 | 2 | 2 | 2 | 8 | 1/16 | 1/32 | ¼ |
| 3 | 2 | 2 | 2 | 2 | 8 | 1/16 | 1/32 | ½ |
| 4 | 2 | 2 | 2 | 2 | 8 | 1/16 | 1/32 | ¾ |
| 5 | 2 | 2 | 2 | 2 | 8 | 1/16 | 1/32 | 1 |
| 6 | 2 | 2 | 2 | 2 | 8 | 1/16 | 1/16 | ⅛ |
| 7 | 2 | 2 | 2 | 2 | 8 | 1/16 | 1/16 | ¼ |
| 8 | 2 | 2 | 2 | 2 | 8 | 1/16 | 1/16 | ½ |
| . | . | . | . | . | . | . | . | . |
| . | . | . | . | . | . | . | . | . |
| . | . | . | . | . | . | . | . | . |

In another embodiment, for any table described or any table (whole-table or a sub-table) that can be constructed by one or more embodiments described herein, the table can further include Lₜₒₜ and N (or N_{TRP}) in addition to Lₙ, pᵥ and β, and can be used for the table of ‘paramCombination-r18’.

In one example, Table 27 can be an example describing a table including Lₜₒₜ and N (or N_{TRP}) in addition to Lₙ, pᵥ and β, which is based on Table 25.

TABLE 27

| | | | | | | | p_{υ} | | |
|---|---|---|---|---|---|---|---|---|---|
| paramCom- | | | | | | | υ ∈ | υ ∈ | |
| bination-r18 | L₁ | L₂ | L₃ | L₄ | Lₜₒₜ | N | {1, 2} | {3, 4} | β |
| 1 | 2 | 2 | 2 | 2 | 8 | 4 | 1/16 | 1/32 | ⅛ |
| 2 | 2 | 2 | 2 | 2 | 8 | 4 | 1/16 | 1/32 | ¼ |
| 3 | 2 | 2 | 2 | 2 | 8 | 4 | 1/16 | 1/32 | ½ |
| 4 | 2 | 2 | 2 | 2 | 8 | 4 | 1/16 | 1/32 | ¾ |
| 5 | 2 | 2 | 2 | 2 | 8 | 4 | 1/16 | 1/32 | 1 |
| 6 | 2 | 2 | 2 | 2 | 8 | 4 | 1/16 | 1/16 | ⅛ |
| 7 | 2 | 2 | 2 | 2 | 8 | 4 | 1/16 | 1/16 | ¼ |
| 8 | 2 | 2 | 2 | 2 | 8 | 4 | 1/16 | 1/16 | ½ |
| . | . | . | . | . | . | . | . | . | . |
| . | . | . | . | . | . | . | . | . | . |
| . | . | . | . | . | . | . | . | . | . |

In one example, Table 28 can be an example describing a table including Lₜₒₜ and N (or N_{TRP}) in addition to Lₙ, pᵥ and β, which is based on a combination of Table 22/Table 23/Table 24/Table 25.

TABLE 28

| | | | | | | | p_{υ} | | |
|---|---|---|---|---|---|---|---|---|---|
| paramCom- | | | | | | | υ ∈ | υ ∈ | |
| bination-r18 | L₁ | L₂ | L₃ | L₄ | Lₜₒₜ | N | {1, 2} | {3, 4} | β |
| 1 | 2 | | | | 2 | 1 | 1/16 | 1/32 | ⅛ |
| . | . | . | . | . | . | . | . | . | . |
| . | . | . | . | . | . | . | . | . | . |
| . | . | . | . | . | . | . | . | . | . |
| a | 4 | | | | 4 | 1 | 1/16 | 1/32 | ⅛ |
| . | . | . | . | . | . | . | . | . | . |
| . | . | . | . | . | . | . | . | . | . |
| . | . | . | . | . | . | . | . | . | . |
| b | 2 | 2 | | | 4 | 2 | 1/16 | 1/32 | ⅛ |
| . | . | . | . | . | . | . | . | . | . |
| . | . | . | . | . | . | . | . | . | . |
| . | . | . | . | . | . | . | . | . | . |
| c | 2 | 4 | | | 6 | 2 | 1/16 | 1/32 | ⅛ |
| . | . | . | . | . | . | . | . | . | . |
| . | . | . | . | . | . | . | . | . | . |
| . | . | . | . | . | . | . | . | . | . |
| d | 4 | 2 | | | 6 | 2 | 1/16 | 1/32 | ⅛ |
| . | . | . | . | . | . | . | . | . | . |
| . | . | . | . | . | . | . | . | . | . |
| . | . | . | . | . | . | . | . | . | . |
| e | 4 | 4 | | | 8 | 2 | 1/16 | 1/32 | ⅛ |
| . | . | . | . | . | . | . | . | . | . |
| . | . | . | . | . | . | . | . | . | . |
| . | . | . | . | . | . | . | . | . | . |
| f | 2 | 2 | 2 | | 6 | 3 | 1/16 | 1/32 | ⅛ |
| . | . | . | . | . | . | . | . | . | . |
| . | . | . | . | . | . | . | . | . | . |
| . | . | . | . | . | . | . | . | . | . |
| g | 2 | 2 | 4 | | 8 | 3 | 1/16 | 1/32 | ⅛ |
| . | . | . | . | . | . | . | . | . | . |
| . | . | . | . | . | . | . | . | . | . |
| . | . | . | . | . | . | . | . | . | . |
| h | 2 | 4 | 2 | | 8 | 3 | 1/16 | 1/32 | ⅛ |
| . | . | . | . | . | . | . | . | . | . |
| . | . | . | . | . | . | . | . | . | . |
| . | . | . | . | . | . | . | . | . | . |
| i | 2 | 4 | 4 | | 10 | 3 | 1/16 | 1/32 | ⅛ |
| . | . | . | . | . | . | . | . | . | . |
| . | . | . | . | . | . | . | . | . | . |
| . | . | . | . | . | . | . | . | . | . |
| j | 4 | 2 | 2 | | 8 | 3 | 1/16 | 1/32 | ⅛ |
| . | . | . | . | . | . | . | . | . | . |
| . | . | . | . | . | . | . | . | . | . |
| . | . | . | . | . | . | . | . | . | . |
| k | 4 | 2 | 4 | | 10 | 3 | 1/16 | 1/32 | ⅛ |
| . | . | . | . | . | . | . | . | . | . |
| . | . | . | . | . | . | . | . | . | . |
| . | . | . | . | . | . | . | . | . | . |
| l | 4 | 4 | 2 | | 10 | 3 | 1/16 | 1/32 | ⅛ |
| . | . | . | . | . | . | . | . | . | . |
| . | . | . | . | . | . | . | . | . | . |
| . | . | . | . | . | . | . | . | . | . |
| m | 4 | 4 | 4 | | 12 | 3 | 1/16 | 1/32 | ⅛ |
| . | . | . | . | . | . | . | . | . | . |
| . | . | . | . | . | . | . | . | . | . |
| . | . | . | . | . | . | . | . | . | . |
| n | 2 | 2 | 2 | 2 | 8 | 4 | 1/16 | 1/32 | ⅛ |
| . | . | . | . | . | . | . | . | . | . |
| . | . | . | . | . | . | . | . | . | . |
| . | . | . | . | . | . | . | . | . | . |
| o | 4 | 4 | 4 | 4 | 16 | 4 | ½ | ½ | 1 |

In another example, blanks of the table can be replaced by 0 values, which is as follows for example:

TABLE 29

| | | | | | | | p_{υ} | | |
|---|---|---|---|---|---|---|---|---|---|
| paramCom- | | | | | | | υ ∈ | υ ∈ | |
| bination-r18 | L₁ | L₂ | L₃ | L₄ | Lₜₒₜ | N | {1, 2} | {3, 4} | β |
| 1 | 2 | 0 | 0 | 0 | 2 | 1 | 1/16 | 1/32 | ⅛ |
| . | . | . | . | . | . | . | . | . | . |
| . | . | . | . | . | . | . | . | . | . |
| . | . | . | . | . | . | . | . | . | . |
| a | 4 | 0 | 0 | 0 | 4 | 1 | 1/16 | 1/32 | ⅛ |
| . | . | . | . | . | . | . | . | . | . |
| . | . | . | . | . | . | . | . | . | . |
| . | . | . | . | . | . | . | . | . | . |
| b | 2 | 2 | 0 | 0 | 4 | 2 | 1/16 | 1/32 | ⅛ |
| . | . | . | . | . | . | . | . | . | . |
| . | . | . | . | . | . | . | . | . | . |
| . | . | . | . | . | . | . | . | . | . |
| c | 2 | 4 | 0 | 0 | 6 | 2 | 1/16 | 1/32 | ⅛ |
| . | . | . | . | . | . | . | . | . | . |
| . | . | . | . | . | . | . | . | . | . |
| . | . | . | . | . | . | . | . | . | . |
| d | 4 | 2 | 0 | 0 | 6 | 2 | 1/16 | 1/32 | ⅛ |
| . | . | . | . | . | . | . | . | . | . |
| . | . | . | . | . | . | . | . | . | . |
| . | . | . | . | . | . | . | . | . | . |
| e | 4 | 4 | 0 | 0 | 8 | 2 | 1/16 | 1/32 | ⅛ |
| . | . | . | . | . | . | . | . | . | . |
| . | . | . | . | . | . | . | . | . | . |
| . | . | . | . | . | . | . | . | . | . |
| f | 2 | 2 | 2 | 0 | 6 | 3 | 1/16 | 1/32 | ⅛ |
| . | . | . | . | . | . | . | . | . | . |
| . | . | . | . | . | . | . | . | . | . |
| . | . | . | . | . | . | . | . | . | . |
| g | 2 | 2 | 4 | 0 | 8 | 3 | 1/16 | 1/32 | ⅛ |
| . | . | . | . | . | . | . | . | . | . |
| . | . | . | . | . | . | . | . | . | . |
| . | . | . | . | . | . | . | . | . | . |
| h | 2 | 4 | 2 | 0 | 8 | 3 | 1/16 | 1/32 | ⅛ |
| . | . | . | . | . | . | . | . | . | . |
| . | . | . | . | . | . | . | . | . | . |
| . | . | . | . | . | . | . | . | . | . |
| i | 2 | 4 | 4 | 0 | 10 | 3 | 1/16 | 1/32 | ⅛ |
| . | . | . | . | . | . | . | . | . | . |
| . | . | . | . | . | . | . | . | . | . |
| . | . | . | . | . | . | . | . | . | . |
| j | 4 | 2 | 2 | 0 | 8 | 3 | 1/16 | 1/32 | ⅛ |
| . | . | . | . | . | . | . | . | . | . |
| . | . | . | . | . | . | . | . | . | . |
| . | . | . | . | . | . | . | . | . | . |
| k | 4 | 2 | 4 | 0 | 10 | 3 | 1/16 | 1/32 | ⅛ |
| . | . | . | . | . | . | . | . | . | . |
| . | . | . | . | . | . | . | . | . | . |
| . | . | . | . | . | . | . | . | . | . |
| l | 4 | 4 | 2 | 0 | 10 | 3 | 1/16 | 1/32 | ⅛ |
| . | . | . | . | . | . | . | . | . | . |
| . | . | . | . | . | . | . | . | . | . |
| . | . | . | . | . | . | . | . | . | . |
| m | 4 | 4 | 4 | 0 | 12 | 3 | 1/16 | 1/32 | ⅛ |
| . | . | . | . | . | . | . | . | . | . |
| . | . | . | . | . | . | . | . | . | . |
| . | . | . | . | . | . | . | . | . | . |
| n | 2 | 2 | 2 | 2 | 8 | 4 | 1/16 | 1/32 | ⅛ |
| . | . | . | . | . | . | . | . | . | . |
| . | . | . | . | . | . | . | . | . | . |
| . | . | . | . | . | . | . | . | . | . |
| o | 4 | 4 | 4 | 4 | 16 | 4 | ½ | ½ | 1 |

In another embodiment, for any table described or any table (whole-table or a sub-table) that can be constructed by one or more embodiments described herein, the table can further include N (or N_{TRP}) in addition to Lₙ, pᵥ and β, and can be used for the table of ‘paramCombination-r18’.

In one example, Table 30 can be an example describing a table including N (or N_{TRP}) in addition to Lₙ, pᵥ and β, which is based on Table 25.

TABLE 30

| paramCom- | | | | | | p_{υ} | | |
|---|---|---|---|---|---|---|---|---|
| bination-r18 | L₁ | L₂ | L₃ | L₄ | N | υ ∈ {1, 2} | υ ∈ {3, 4} | β |
| 1 | 2 | 2 | 2 | 2 | 4 | 1/16 | 1/32 | ⅛ |
| 2 | 2 | 2 | 2 | 2 | 4 | 1/16 | 1/32 | ¼ |
| 3 | 2 | 2 | 2 | 2 | 4 | 1/16 | 1/32 | ½ |
| 4 | 2 | 2 | 2 | 2 | 4 | 1/16 | 1/32 | ¾ |
| 5 | 2 | 2 | 2 | 2 | 4 | 1/16 | 1/32 | 1 |
| 6 | 2 | 2 | 2 | 2 | 4 | 1/16 | 1/16 | ⅛ |
| 7 | 2 | 2 | 2 | 2 | 4 | 1/16 | 1/16 | ¼ |
| 8 | 2 | 2 | 2 | 2 | 4 | 1/16 | 1/16 | ½ |
| . | . | . | . | . | . | . | . | . |
| . | . | . | . | . | . | . | . | . |
| . | . | . | . | . | . | . | . | . |

In one example, Table 31 can be an example describing a table including Lₜₒₜ and N (or N_{TRP}) in addition to Lₙ, pᵥ and β, which is based on a combination of Table 22/Table 23/Table 24/Table 25.

TABLE 31

| paramCom- | | | | | | p_{υ} | | |
|---|---|---|---|---|---|---|---|---|
| bination-r18 | L₁ | L₂ | L₃ | L₄ | N | υ ∈ {1, 2} | υ ∈ {3, 4} | β |
| 1 | 2 | | | | 1 | 1/16 | 1/32 | ⅛ |
| . | . | . | . | . | . | . | . | . |
| . | . | . | . | . | . | . | . | . |
| . | . | . | . | . | . | . | . | . |
| a | 4 | | | | 1 | 1/16 | 1/32 | ⅛ |
| . | . | . | . | . | . | . | . | . |
| . | . | . | . | . | . | . | . | . |
| . | . | . | . | . | . | . | . | . |
| b | 2 | 2 | | | 2 | 1/16 | 1/32 | ⅛ |
| . | . | . | . | . | . | . | . | . |
| . | . | . | . | . | . | . | . | . |
| . | . | . | . | . | . | . | . | . |
| c | 2 | 4 | | | 2 | 1/16 | 1/32 | ⅛ |
| . | . | . | . | . | . | . | . | . |
| . | . | . | . | . | . | . | . | . |
| . | . | . | . | . | . | . | . | . |
| d | 4 | 2 | | | 2 | 1/16 | 1/32 | ⅛ |
| . | . | . | . | . | . | . | . | . |
| . | . | . | . | . | . | . | . | . |
| . | . | . | . | . | . | . | . | . |
| e | 4 | 4 | | | 2 | 1/16 | 1/32 | ⅛ |
| . | . | . | . | . | . | . | . | . |
| . | . | . | . | . | . | . | . | . |
| . | . | . | . | . | . | . | . | . |
| f | 2 | 2 | 2 | | 3 | 1/16 | 1/32 | ⅛ |
| . | . | . | . | . | . | . | . | . |
| . | . | . | . | . | . | . | . | . |
| . | . | . | . | . | . | . | . | . |
| g | 2 | 2 | 4 | | 3 | 1/16 | 1/32 | ⅛ |
| . | . | . | . | . | . | . | . | . |
| . | . | . | . | . | . | . | . | . |
| . | . | . | . | . | . | . | . | . |
| h | 2 | 4 | 2 | | 3 | 1/16 | 1/32 | ⅛ |
| . | . | . | . | . | . | . | . | . |
| . | . | . | . | . | . | . | . | . |
| . | . | . | . | . | . | . | . | . |
| i | 2 | 4 | 4 | | 3 | 1/16 | 1/32 | ⅛ |
| . | . | . | . | . | . | . | . | . |
| . | . | . | . | . | . | . | . | . |
| . | . | . | . | . | . | . | . | . |
| j | 4 | 2 | 2 | | 3 | 1/16 | 1/32 | ⅛ |
| . | . | . | . | . | . | . | . | . |
| . | . | . | . | . | . | . | . | . |
| . | . | . | . | . | . | . | . | . |
| k | 4 | 2 | 4 | | 3 | 1/16 | 1/32 | ⅛ |
| . | . | . | . | . | . | . | . | . |
| . | . | . | . | . | . | . | . | . |
| . | . | . | . | . | . | . | . | . |
| l | 4 | 4 | 2 | | 3 | 1/16 | 1/32 | ⅛ |
| . | . | . | . | . | . | . | . | . |
| . | . | . | . | . | . | . | . | . |
| . | . | . | . | . | . | . | . | . |
| m | 4 | 4 | 4 | | 3 | 1/16 | 1/32 | ⅛ |
| . | . | . | . | . | . | . | . | . |
| . | . | . | . | . | . | . | . | . |
| . | . | . | . | . | . | . | . | . |
| n | 2 | 2 | 2 | 2 | 4 | 1/16 | 1/32 | ⅛ |
| . | . | . | . | . | . | . | . | . |
| . | . | . | . | . | . | . | . | . |
| . | . | . | . | . | . | . | . | . |
| o | 4 | 4 | 4 | 4 | 4 | ½ | ½ | 1 |

In another example, blanks of the table can be replaced by 0 values, which is as follows for example:

TABLE 32

| paramCom- | | | | | | p_{υ} | | |
|---|---|---|---|---|---|---|---|---|
| bination-r18 | L₁ | L₂ | L₃ | L₄ | N | υ ∈ {1, 2} | υ ∈ {3, 4} | β |
| 1 | 2 | 0 | 0 | 0 | 1 | 1/16 | 1/32 | ⅛ |
| . | . | . | . | . | . | . | . | . |
| . | . | . | . | . | . | . | . | . |
| . | . | . | . | . | . | . | . | . |
| a | 4 | 0 | 0 | 0 | 1 | 1/16 | 1/32 | ⅛ |
| . | . | . | . | . | . | . | . | . |
| . | . | . | . | . | . | . | . | . |
| . | . | . | . | . | . | . | . | . |
| b | 2 | 2 | 0 | 0 | 2 | 1/16 | 1/32 | ⅛ |
| . | . | . | . | . | . | . | . | . |
| . | . | . | . | . | . | . | . | . |
| . | . | . | . | . | . | . | . | . |
| c | 2 | 4 | 0 | 0 | 2 | 1/16 | 1/32 | ⅛ |
| . | . | . | . | . | . | . | . | . |
| . | . | . | . | . | . | . | . | . |
| . | . | . | . | . | . | . | . | . |
| d | 4 | 2 | 0 | 0 | 2 | 1/16 | 1/32 | ⅛ |
| . | . | . | . | . | . | . | . | . |
| . | . | . | . | . | . | . | . | . |
| . | . | . | . | . | . | . | . | . |
| e | 4 | 4 | 0 | 0 | 2 | 1/16 | 1/32 | ⅛ |
| . | . | . | . | . | . | . | . | . |
| . | . | . | . | . | . | . | . | . |
| . | . | . | . | . | . | . | . | . |
| f | 2 | 2 | 2 | 0 | 3 | 1/16 | 1/32 | ⅛ |
| . | . | . | . | . | . | . | . | . |
| . | . | . | . | . | . | . | . | . |
| . | . | . | . | . | . | . | . | . |
| g | 2 | 2 | 4 | 0 | 3 | 1/16 | 1/32 | ⅛ |
| . | . | . | . | . | . | . | . | . |
| . | . | . | . | . | . | . | . | . |
| . | . | . | . | . | . | . | . | . |
| h | 2 | 4 | 2 | 0 | 3 | 1/16 | 1/32 | ⅛ |
| . | . | . | . | . | . | . | . | . |
| . | . | . | . | . | . | . | . | . |
| . | . | . | . | . | . | . | . | . |
| i | 2 | 4 | 4 | 0 | 3 | 1/16 | 1/32 | ⅛ |
| . | . | . | . | . | . | . | . | . |
| . | . | . | . | . | . | . | . | . |
| . | . | . | . | . | . | . | . | . |
| j | 4 | 2 | 2 | 0 | 3 | 1/16 | 1/32 | ⅛ |
| . | . | . | . | . | . | . | . | . |
| . | . | . | . | . | . | . | . | . |
| . | . | . | . | . | . | . | . | . |
| k | 4 | 2 | 4 | 0 | 3 | 1/16 | 1/32 | ⅛ |
| . | . | . | . | . | . | . | . | . |
| . | . | . | . | . | . | . | . | . |
| . | . | . | . | . | . | . | . | . |
| l | 4 | 4 | 2 | 0 | 3 | 1/16 | 1/32 | ⅛ |
| . | . | . | . | . | . | . | . | . |
| . | . | . | . | . | . | . | . | . |
| . | . | . | . | . | . | . | . | . |
| m | 4 | 4 | 4 | 0 | 3 | 1/16 | 1/32 | ⅛ |
| . | . | . | . | . | . | . | . | . |
| . | . | . | . | . | . | . | . | . |
| . | . | . | . | . | . | . | . | . |
| n | 2 | 2 | 2 | 2 | 4 | 1/16 | 1/32 | ⅛ |
| . | . | . | . | . | . | . | . | . |
| . | . | . | . | . | . | . | . | . |
| . | . | . | . | . | . | . | . | . |
| o | 4 | 4 | 4 | 4 | 4 | ½ | ½ | 1 |

In another embodiment, a subset of parameter combinations in a table designed based on one or more embodiments described herein for the table of ‘paramCombination-r18’ can be restricted not to configure based on one or more aspects such as a number of TRPs (N_{TRP}), a number of SBs K (numberOfPMI-SubbandsPerCQI-Subband), and a number of CSI-RS ports (2N₁N₂ or P_{CSI-RS}).

In one example, the parameter combination with Lₙ=4 or/and 6 for any n can be used/reported (by the UE 116) or configured (by the NW 130) under a condition.
In one example (C1), the condition corresponds to the case when number of CSI-RS ports (for a TRP)=32.
In one example (C2), the condition corresponds to the case when number of CSI-RS ports (for a TRP)≥t, where t is a threshold, which can be fixed, configured, or subject to UE capability.
In one example (C3), the condition corresponds to the case when number of CSI-RS ports (for a TRP)>t, where t is a threshold, which can be fixed, configured, or subject to UE capability.
In one example (C4), the condition corresponds to the case when N_{TRP}<3 (i.e., N_{TRP}=1,2).
In one example (C5), the condition corresponds to the case when N_{TRP}<s, where s is a threshold, which can be fixed, or configured, or subject to UE capability.
In one example (C6), the condition corresponds to the case when N_{TRP}≤s, where s is a threshold, which can be fixed, or configured, or subject to UE capability.
In one example (C7), the condition corresponds to the case when N_{TRP}>s, where s is a threshold, which can be fixed, or configured, or subject to UE capability.
In one example (C8), the condition corresponds to the case when N_{TRP}≥s, where s is a threshold, which can be fixed, or configured, or subject to UE capability.
In one example (C9), the condition corresponds to the case when K<k, where k is a threshold, which can be fixed, or configured, or subject to UE capability.
In one example (C10), the condition corresponds to the case when K≤k, where k is a threshold, which can be fixed, or configured, or subject to UE capability.
In one example (C11), the condition corresponds to the case when K>k, where k is a threshold, which can be fixed, or configured, or subject to UE capability.
In one example (C12), the condition corresponds to the case when K≥k, where k is a threshold, which can be fixed, or configured, or subject to UE capability.
In one example (C13), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction).
In one example (C10), the condition corresponds to C1 or/and C2 or/and C3 or/and C4 or/and C5 or/and C6 or/and C7 or/and C8 or/and C9 or/and C10 or/and C11 or/and C12 and the value of R is 1 (e.g., configured via higher layer numberOfPMIsubbandPerCQIsubband).
In one example (C11), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction), and the value of R is 1 (e.g., configured via higher layer numberOfPMIsubbandPerCQIsubband).

In one example, the parameter combination with p_{υ}=½ for any n can be used/reported (by the UE 116) or configured (by the NW 130) under a condition.
In one example (C1), the condition corresponds to the case when number of CSI-RS ports (for a TRP)=32.
In one example (C2), the condition corresponds to the case when number of CSI-RS ports (for a TRP)>t, where t is a threshold, which can be fixed, or configured, or subject to UE capability.
In one example (C3), the condition corresponds to the case when number of CSI-RS ports (for a TRP)>t, where t is a threshold, which can be fixed, or configured, or subject to UE capability.
In one example (C4), the condition corresponds to the case when N_{TRP}<3 (i.e., N_{TRP}=1,2).
In one example (C5), the condition corresponds to the case when N_{TRP}<s, where s is a threshold, which can be fixed, or configured, or subject to UE capability.
In one example (C6), the condition corresponds to the case when N_{TRP}<s, where s is a threshold, which can be fixed, or configured, or subject to UE capability.
In one example (C7), the condition corresponds to the case when N_{TRP}>s, where s is a threshold, which can be fixed, or configured, or subject to UE capability.
In one example (C8), the condition corresponds to the case when N_{TRP}>s, where s is a threshold, which can be fixed, or configured, or subject to UE capability.
In one example (C9), the condition corresponds to the case when K<k, where k is a threshold, which can be fixed, or configured, or subject to UE capability.
In one example (C10), the condition corresponds to the case when K≥k, where k is a threshold, which can be fixed, or configured, or subject to UE capability.
In one example (C11), the condition corresponds to the case when K>k, where k is a threshold, which can be fixed, or configured, or subject to UE capability.
In one example (C12), the condition corresponds to the case when K≥k, where k is a threshold, which can be fixed, or configured, or subject to UE capability.
In one example (C13), the condition corresponds to C1 or/and C2 or/and C3 or/and C4 or/and C5 or/and C6 or/and C7 or/and C8 or/and C9 or/and C10 or/and C11 or/and C12) and the max rank value (for RI reporting) is 2 (e.g., configured via RI-restriction.
In one example (C14), the condition corresponds to C1 or/and C2 or/and C3 or/and C4 or/and C5 or/and C6 or/and C7 or/and C8 or/and C9 or/and C10 or/and C11 or/and C12 and the value of R is 1 (e.g., configured via higher layer numberOfPMIsubbandPerCQIsubband).
In one example (C15), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction), and the value of R is 1 (e.g., configured via higher layer numberOfPMIsubbandPerCQIsubband).

In one example, the parameter combination with pᵥ= 1/16 and/or pᵥ=⅛ for any n can be used/reported (by the UE 116) or configured (by the NW 130) under a condition.
In one example (C1), the condition corresponds to the case when number of CSI-RS ports (for a TRP)=32.
In one example (C2), the condition corresponds to the case when number of CSI-RS ports (for a TRP)≥t, where t is a threshold, which can be fixed, configured, or subject to UE capability.
In one example (C3), the condition corresponds to the case when number of CSI-RS ports (for a TRP)>t, where t is a threshold, which can be fixed, configured, or subject to UE capability.
In one example (C4), the condition corresponds to the case when N_{TRP}<3 (i.e., N_{TRP}=1,2).
In one example (C5), the condition corresponds to the case when N_{TRP}<s, where s is a threshold, which can be fixed, or configured, or subject to UE capability.
In one example (C6), the condition corresponds to the case when N_{TRP}≤s, where s is a threshold, which can be fixed, or configured, or subject to UE capability.
In one example (C7), the condition corresponds to the case when N_{TRP}>s, where s is a threshold, which can be fixed, or configured, or subject to UE capability.
In one example (C8), the condition corresponds to the case when N_{TRP}>s, where s is a threshold, which can be fixed, or configured, or subject to UE capability.
In one example (C9), the condition corresponds to the case when K<k, where k is a threshold, which can be fixed, or configured, or subject to UE capability.
In one example (C10), the condition corresponds to the case when K≤k, where k is a threshold, which can be fixed, or configured, or subject to UE capability.
In one example (C11), the condition corresponds to the case when K>k, where k is a threshold, which can be fixed, or configured, or subject to UE capability.
In one example (C12), the condition corresponds to the case when K≥k, where k is a threshold, which can be fixed, or configured, or subject to UE capability.
In one example (C13), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction).
In one example (C14), the condition corresponds to C1 or/and C2 or/and C3 or/and C4 or/and C5 or/and C6 or/and C7 or/and C8 or/and C9 or/and C10 or/and C11 or/and C12 and the value of R is 1 (e.g., configured via higher layer numberOfPMIsubbandPerCQIsubband).
In one example (C15), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction), and the value of R is 1 (e.g., configured via higher layer numberOfPMIsubbandPerCQIsubband).

In one example, the parameter combination with β=½ or/and ¾ or/and 1 for any n can be used/reported (by the UE 116) or configured (by the NW 130) under a condition.
In one example (C1), the condition corresponds to the case when number of CSI-RS ports (for a TRP)=32.
In one example (C2), the condition corresponds to the case when number of CSI-RS ports (for a TRP)≥t, where t is a threshold, which can be fixed, configured, or subject to UE capability.
In one example (C3), the condition corresponds to the case when number of CSI-RS ports (for a TRP)>t, where t is a threshold, which can be fixed, configured, or subject to UE capability.
In one example (C4), the condition corresponds to the case when N_{TRP}<3 (i.e., N_{TRP}=1,2).
In one example (C5), the condition corresponds to the case when N_{TRP}<s, where s is a threshold, which can be fixed, or configured, or subject to UE capability.
In one example (C6), the condition corresponds to the case when N_{TRP}<s, where s is a threshold, which can be fixed, or configured, or subject to UE capability.
In one example (C7), the condition corresponds to the case when N_{TRP}>s, where s is a threshold, which can be fixed, or configured, or subject to UE capability.
In one example (C8), the condition corresponds to the case when N_{TRP}>s, where s is a threshold, which can be fixed, or configured, or subject to UE capability.
In one example (C9), the condition corresponds to the case when K<k, where k is a threshold, which can be fixed, or configured, or subject to UE capability.
In one example (C10), the condition corresponds to the case when K≤k, where k is a threshold, which can be fixed, or configured, or subject to UE capability.
In one example (C11), the condition corresponds to the case when K>k, where k is a threshold, which can be fixed, or configured, or subject to UE capability.
In one example (C12), the condition corresponds to the case when K≥k, where k is a threshold, which can be fixed, or configured, or subject to UE capability.
In one example (C13), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction).
In one example (C14), the condition corresponds to C1 or/and C2 or/and C3 or/and C4 or/and C5 or/and C6 or/and C7 or/and C8 or/and C9 or/and C10 or/and C11 or/and C12 and the value of R is 1 (e.g., configured via higher layer numberOfPMIsubbandPerCQIsubband).
In one example (C15), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction), and the value of R is 1 (e.g., configured via higher layer numberOfPMIsubbandPerCQIsubband).

In one example, the parameter combination with Lₙ=4 or/and 6 or/and p_{υ}=½ or/and ⅛ or/and 1/16 for any n can be used/reported (by the UE 116) or configured (by the NW 130) under a condition.
In one example (C1), the condition corresponds to the case when number of CSI-RS ports (for a TRP)=32.
In one example (C2), the condition corresponds to the case when number of CSI-RS ports (for a TRP)>t, where t is a threshold, which can be fixed, or configured, or subject to UE capability.
In one example (C3), the condition corresponds to the case when number of CSI-RS ports (for a TRP)>t, where t is a threshold, which can be fixed, or configured, or subject to UE capability.
In one example (C4), the condition corresponds to the case when N_{TRP}<3 (i.e., N_{TRP}=1,2).
In one example (C5), the condition corresponds to the case when N_{TRP}<s, where s is a threshold, which can be fixed, or configured, or subject to UE capability.
In one example (C6), the condition corresponds to the case when N_{TRP}<s, where s is a threshold, which can be fixed, or configured, or subject to UE capability.
In one example (C7), the condition corresponds to the case when N_{TRP}>s, where s is a threshold, which can be fixed, or configured, or subject to UE capability.
In one example (C8), the condition corresponds to the case when N_{TRP}>s, where s is a threshold, which can be fixed, or configured, or subject to UE capability.
In one example (C9), the condition corresponds to the case when K<k, where k is a threshold, which can be fixed, or configured, or subject to UE capability.
In one example (C10), the condition corresponds to the case when K≥k, where k is a threshold, which can be fixed, or configured, or subject to UE capability.
In one example (C11), the condition corresponds to the case when K>k, where k is a threshold, which can be fixed, or configured, or subject to UE capability.
In one example (C12), the condition corresponds to the case when K≥k, where k is a threshold, which can be fixed, or configured, or subject to UE capability.
In one example (C13), the condition corresponds to (C1 or/and C2 or/and C3 or/and C4 or/and C5 or/and C6 or/and C7 or/and C8 or/and C9 or/and C10 or/and C11 or/and C12) and the max rank value (for RI reporting) is 2 (e.g., configured via RI-restriction).
In one example (C14), the condition corresponds to C1 or/and C2 or/and C3 or/and C4 or/and C5 or/and C6 or/and C7 or/and C8 or/and C9 or/and C10 or/and C11 or/and C12 and the value of R is 1 (e.g., configured via higher layer numberOfPMIsubbandPerCQIsubband).
In one example (C15), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction), and the value of R is 1 (e.g., configured via higher layer numberOfPMIsubbandPerCQIsubband).

In one example, the parameter combination with Lₙ=4 or/and 6 or/and β=½ or/and ¾ or/and 1 for any n can be used/reported (by the UE 116) or configured (by the NW 130) under a condition.
In one example (C1), the condition corresponds to the case when number of CSI-RS ports (for a TRP)=32.
In one example (C2), the condition corresponds to the case when number of CSI-RS ports (for a TRP)≥t, where t is a threshold, which can be fixed, configured, or subject to UE capability.
In one example (C3), the condition corresponds to the case when number of CSI-RS ports (for a TRP)>t, where t is a threshold, which can be fixed, configured, or subject to UE capability.
In one example (C4), the condition corresponds to the case when N_{TRP}<3 (i.e., N_{TRP}=1,2).
In one example (C5), the condition corresponds to the case when N_{TRP}<s, where s is a threshold, which can be fixed, or configured, or subject to UE capability.
In one example (C6), the condition corresponds to the case when N_{TRP}<s, where s is a threshold, which can be fixed, or configured, or subject to UE capability.
In one example (C7), the condition corresponds to the case when N_{TRP}>s, where s is a threshold, which can be fixed, or configured, or subject to UE capability.
In one example (C8), the condition corresponds to the case when N_{TRP}>s, where s is a threshold, which can be fixed, or configured, or subject to UE capability.
In one example (C9), the condition corresponds to the case when K<k, where k is a threshold, which can be fixed, or configured, or subject to UE capability.
In one example (C10), the condition corresponds to the case when K≤k, where k is a threshold, which can be fixed, or configured, or subject to UE capability.
In one example (C11), the condition corresponds to the case when K>k, where k is a threshold, which can be fixed, or configured, or subject to UE capability.
In one example (C12), the condition corresponds to the case when K≥k, where k is a threshold, which can be fixed, or configured, or subject to UE capability.
In one example (C13), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction).
In one example (C14), the condition corresponds to C1 or/and C2 or/and C3 or/and C4 or/and C5 or/and C6 or/and C7 or/and C8 or/and C9 or/and C10 or/and C11 or/and C12 and the value of R is 1 (e.g., configured via higher layer numberOfPMIsubbandPerCQIsubband).
In one example (C15), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction), and the value of R is 1 (e.g., configured via higher layer numberOfPMIsubbandPerCQIsubband).

In one example, the parameter combination with p_{υ}=½ or/and ⅛ or/and 1/16 or/and β=½ or/and ¾ or/and 1 for any n can be used/reported (by the UE 116) or configured (by the NW 130) under a condition.
In one example (C1), the condition corresponds to the case when number of CSI-RS ports (for a TRP)=32.
In one example (C2), the condition corresponds to the case when number of CSI-RS ports (for a TRP)≥t, where t is a threshold, which can be fixed, configured, or subject to UE capability.
In one example (C3), the condition corresponds to the case when number of CSI-RS ports (for a TRP)>t, where t is a threshold, which can be fixed, configured, or subject to UE capability.
In one example (C4), the condition corresponds to the case when N_{TRP}<3 (i.e., N_{TRP}=1,2).
In one example (C5), the condition corresponds to the case when N_{TRP}<s, where s is a threshold, which can be fixed, or configured, or subject to UE capability.
In one example (C6), the condition corresponds to the case when N_{TRP}<s, where s is a threshold, which can be fixed, or configured, or subject to UE capability.
In one example (C7), the condition corresponds to the case when N_{TRP}>s, where s is a threshold, which can be fixed, or configured, or subject to UE capability.
In one example (C8), the condition corresponds to the case when N_{TRP}>s, where s is a threshold, which can be fixed, or configured, or subject to UE capability.
In one example (C9), the condition corresponds to the case when K<k, where k is a threshold, which can be fixed, or configured, or subject to UE capability.
In one example (C10), the condition corresponds to the case when K≤k, where k is a threshold, which can be fixed, or configured, or subject to UE capability.
In one example (C11), the condition corresponds to the case when K>k, where k is a threshold, which can be fixed, or configured, or subject to UE capability.
In one example (C12), the condition corresponds to the case when K≥k, where k is a threshold, which can be fixed, or configured, or subject to UE capability.
In one example (C13), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction).
In one example (C14), the condition corresponds to C1 or/and C2 or/and C3 or/and C4 or/and C5 or/and C6 or/and C7 or/and C8 or/and C9 or/and C10 or/and C11 or/and C12 and the value of R is 1 (e.g., configured via higher layer numberOfPMIsubbandPerCQIsubband).
In one example (C15), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction), and the value of R is 1 (e.g., configured via higher layer numberOfPMIsubbandPerCQIsubband).

In one example, the parameter combination with Lₙ=4 or/and 6 or/and pᵥ=½ or/and ⅛ or/and 1/16 or/and β=½ or/and ¾ or/and 1 for any n can be used/reported (by the UE 116) or configured (by the NW 130) under a condition.
In one example (C1), the condition corresponds to the case when number of CSI-RS ports (for a TRP)=32.
In one example (C2), the condition corresponds to the case when number of CSI-RS ports (for a TRP)≥t, where t is a threshold, which can be fixed, configured, or subject to UE capability.
In one example (C3), the condition corresponds to the case when number of CSI-RS ports (for a TRP)>t, where t is a threshold, which can be fixed, configured, or subject to UE capability.
In one example (C4), the condition corresponds to the case when N_{TRP}<3 (i.e., N_{TRP}=1,2).
In one example (C5), the condition corresponds to the case when N_{TRP}<s, where s is a threshold, which can be fixed, or configured, or subject to UE capability.
In one example (C6), the condition corresponds to the case when N_{TRP}<s, where s is a threshold, which can be fixed, or configured, or subject to UE capability.
In one example (C7), the condition corresponds to the case when N_{TRP}>s, where s is a threshold, which can be fixed, or configured, or subject to UE capability.
In one example (C8), the condition corresponds to the case when N_{TRP}>s, where s is a threshold, which can be fixed, or configured, or subject to UE capability.
In one example (C9), the condition corresponds to the case when K<k, where k is a threshold, which can be fixed, or configured, or subject to UE capability.
In one example (C10), the condition corresponds to the case when K≤k, where k is a threshold, which can be fixed, or configured, or subject to UE capability.
In one example (C11), the condition corresponds to the case when K>k, where k is a threshold, which can be fixed, or configured, or subject to UE capability.
In one example (C12), the condition corresponds to the case when K≥k, where k is a threshold, which can be fixed, or configured, or subject to UE capability.
In one example (C13), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction).
In one example (C13), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction).
In one example (C14), the condition corresponds to C1 or/and C2 or/and C3 or/and C4 or/and C5 or/and C6 or/and C7 or/and C8 or/and C9 or/and C10 or/and C11 or/and C12 and the value of R is 1 (e.g., configured via higher layer numberOfPMIsubbandPerCQIsubband).
In one example (C15), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction), and the value of R is 1 (e.g., configured via higher layer numberOfPMIsubbandPerCQIsubband).

In one example, in Rel-17 Type-II codebook, K₁ ports are selected from P_{CSI-RS} ports based on L vectors, vₘ_{⁽ⁱ⁾}, i=0,1, . . . , L−1, which are identified by:

$$m = [ {m}^{( 0 )} … {m}^{( L - 1 )} ] \\ {m}^{( i )} ∈ \{ 0 , 1 , … , \frac{{P}_{CSI - RS}}{2} - 1 \} ,$$

which are indicated by the index i_{1,2}, where:

$${i}_{1 , 2} ∈ \{ 0 , 1 , … , ( \begin{matrix}{P}_{CSI - RS} / 2 \\ L\end{matrix} ) - 1 \} .$$

The elements of m are found from i_{1,2} using C(x, y) as defined in Tables 5.2.2.2.5-4 and 5.2.2.2.7-2 and the algorithm.

In one embodiment, on the SD basis selection for (Rel-18) Type-II codebook refinement for CJT mTRP, which is designed based on Rel-17 Type-II port-selection codebook, a set of N_{L}≥>1 combinations of values for {αₙ, n=1, . . . , N_{TRP}} is configured by the NW 130 via higher-layer (RRC) signaling, where N_{TRP} is a number of TRPs (CSI-RS resources) configured by the NW 130. The N_{L} combinations of value(s) for {αₙ, n=1, . . . , N_{TRP}} can be signaled by using a joint indicator or multiple separate indicators. In one example, N_{L}=1. In another example, N_{L}≥>1.

In one example, {αₙ} values can be configured based on at least one of the tables (or any table (i.e., a sub-table, or whole table) that can be constructed as) described in the present disclosure.

In one example, N_{L} can be explicitly configured via higher-layer (RRC) signaling with a separate parameter. The possible values for N_{L} are a set of [symbol] . Let denote a total number of a table including combinations of values for {αₙ, n=1, . . . , N_{TRP}} by N_{T}. In one example,

$$⌈ {log}_{2} ( \begin{matrix}{N}_{T} \\ {N}_{L}\end{matrix} ) ⌉$$

bit size parameter can be used to indicate N_{L} combinations of values for {αₙ n=1, . . . , N_{TRP}}. In one example, the table can be any table (whole table or a sub-table) described in the present disclosure or any table that can be constructed as described in the present disclosure.

In one example, N_{L} is implicitly determined or configured via higher-layer RRC signaling.
In one example an N_{T}-bit bitmap is used to indicate N_{L} combinations of values for {αₙ,n=1, . . . , N_{TRP}}, and N_{L} can be inferred from the configured N_{T}-bit bitmap.
In one example, N_{L} combinations of values for {αₙ,n=1, . . . , N_{TRP}} are determined from the configured {αₙ} values and its associated αₜₒₜ value. For example, one combination of the values for {αₙ, n=1, . . . , N_{TRP}} is configured, and other combinations of the values for {αₙ,n=1, . . . , N_{TRP}} associated with the same αₜₒₜ for the configured combination are determined as N_{L}−1 combinations of values {αₙ, n=1, . . . , N_{TRP}}, where

$${α}_{tot} = {\sum }_{n = 1}^{{N}_{TRP}} \frac{{α}_{n}}{{N}_{TRP}} or {α}_{tot} = {\sum }_{n = 1}^{N} \frac{{α}_{n}}{N} .$$

In one example, when N_{L}≥>1, a UE reports an indicator with the size of ┌log₂ N_{L}┐-bit to indicate one selected combination of values for {αₙ, n=1, . . . , N_{TRP}} in CSI part 1.

In one example, when N_{L}=1, a UE follows the configured {αₙ} values, hence no report is necessary for {αₙ} values.

In one example, N_{L} combinations of {αₙ} is subject to the UE 116 capability on

$${α}_{tot} = {\sum }_{n = 1}^{N} \frac{{α}_{n}}{N} or {α}_{max} \geq {\sum }_{n = 1}^{N} \frac{{α}_{n}}{N} .$$

In one example, N_{L} combinations of {αₙ} is subject to the UE 116 capability on

$${α}_{tot} = {\sum }_{n = 1}^{{N}_{TRP}} \frac{{α}_{n}}{{N}_{TRP}} or {α}_{max} \geq {\sum }_{n = 1}^{{N}_{TRP}} \frac{{α}_{n}}{{N}_{TRP}} .$$

In another embodiment, a UE is configured with a CSI report (e.g., via higher layer CSI-ReportConfig) based on a codebook for C-JT transmission from multiple TRPs, as described in the present disclosure, where codebook parameters (such as α or L, β, p_{υ} or M_{υ}) are configured via a higher-layer parameter ‘paramCombination-r18’ or ‘paramCombinationCJT-r18’.
In one example, the Rel. 16 parameter combination table for ‘paraCombination-r16’ is reused for ‘paramCombination-r18’ (cf. Table 1).
In one example, the Rel. 17 parameter combination table for ‘paraCombination-r17’ is reused for ‘paramCombination-r18’ (cf. Table 2).
In one example, a new table of parameter combination is used for ‘paramCombination-r18’.
In one example, a table including existing Rel. 16 or Rel. 17 parameter combination(s) and new parameter combination(s) is used for ‘paramCombination-r18’.

In another embodiment, a table used for ‘paramCombination-r18’ is designed based on the following parameter candidates:
Candidate values for αₙ: [symbol] ={½,¾,1}.
   where αₙ is a for CSI-RS resource n (TRP n); and
   N_{TRP}∈{1,2,3,4} is a number of CSI-RS resources (or TRPs) and is configured by the NW 130 via higher-layer signaling.
Candidate values for M: [symbol] ={1,2,3,4}.
Candidate values for β: [symbol] ={⅛,¼,⅜,½,¾,1}.

In one example, any table including at least one of the combinations provided in the tables in the present disclosure can be an example for the table of ‘paraCombination-r18’.

In one example, when N_{TRP}=1, any table including at least one of parameter combinations in a sub-table of Table 33 can be used for the table of ‘paramCombination-r18’.

The table index numbers (from 1 to 72) in Table 33 should be interpreted as just indexes for corresponding parameter combinations. That is, the table index number can be any value based on the ordering of parameter combinations and the number of parameter combinations in a table.

In one example, any sub-table of Table 33 can be an example for the table of ‘paraCombination-r18’.

Although we write α₁, M, β in second, third, and fourth columns of Table 33 as an example, they can be arranged in any order of columns, for example, M, α₁, β are written in second, third and fourth.

TABLE 33

| paramCombination-r18 | α₁ | M | β |
|---|---|---|---|
| 1 | ½ | 1 | ⅛ |
| 2 | ½ | 1 | ¼ |
| 3 | ½ | 1 | ⅜ |
| 4 | ½ | 1 | ½ |
| 5 | ½ | 1 | ¾ |
| 6 | ½ | 1 | 1 |
| 7 | ½ | 2 | ⅛ |
| 8 | ½ | 2 | ¼ |
| 9 | ½ | 2 | ⅜ |
| 10 | ½ | 2 | ½ |
| 11 | ½ | 2 | ¾ |
| 12 | ½ | 2 | 1 |
| 13 | ½ | 3 | ⅛ |
| 14 | ½ | 3 | ¼ |
| 15 | ½ | 3 | ⅜ |
| 16 | ½ | 3 | ½ |
| 17 | ½ | 3 | ¾ |
| 18 | ½ | 3 | 1 |
| 19 | ½ | 4 | ⅛ |
| 20 | ½ | 4 | ¼ |
| 21 | ½ | 4 | ⅜ |
| 22 | ½ | 4 | ½ |
| 23 | ½ | 4 | ¾ |
| 24 | ½ | 4 | 1 |
| 25 | ¾ | 1 | ⅛ |
| 26 | ¾ | 1 | ¼ |
| 27 | ¾ | 1 | ⅜ |
| 28 | ¾ | 1 | ½ |
| 29 | ¾ | 1 | ¾ |
| 30 | ¾ | 1 | 1 |
| 31 | ¾ | 2 | ⅛ |
| 32 | ¾ | 2 | ¼ |
| 33 | ¾ | 2 | ⅜ |
| 34 | ¾ | 2 | ½ |
| 35 | ¾ | 2 | ¾ |
| 36 | ¾ | 2 | 1 |
| 37 | ¾ | 3 | ⅛ |
| 38 | ¾ | 3 | ¼ |
| 39 | ¾ | 3 | ⅜ |
| 40 | ¾ | 3 | ½ |
| 41 | ¾ | 3 | ¾ |
| 42 | ¾ | 3 | 1 |
| 43 | ¾ | 4 | ⅛ |
| 44 | ¾ | 4 | ¼ |
| 45 | ¾ | 4 | ⅜ |
| 46 | ¾ | 4 | ½ |
| 47 | ¾ | 4 | ¾ |
| 48 | ¾ | 4 | 1 |
| 49 | 1 | 1 | ⅛ |
| 50 | 1 | 1 | ¼ |
| 51 | 1 | 1 | ⅜ |
| 52 | 1 | 1 | ½ |
| 53 | 1 | 1 | ¾ |
| 54 | 1 | 1 | 1 |
| 55 | 1 | 2 | ⅛ |
| 56 | 1 | 2 | ¼ |
| 57 | 1 | 2 | ⅜ |
| 58 | 1 | 2 | ½ |
| 59 | 1 | 2 | ¾ |
| 60 | 1 | 2 | 1 |
| 61 | 1 | 3 | ⅛ |
| 62 | 1 | 3 | ¼ |
| 63 | 1 | 3 | ⅜ |
| 64 | 1 | 3 | ½ |
| 65 | 1 | 3 | ¾ |
| 66 | 1 | 3 | 1 |
| 67 | 1 | 4 | ⅛ |
| 68 | 1 | 4 | ¼ |
| 69 | 1 | 4 | ⅜ |
| 70 | 1 | 4 | ½ |
| 71 | 1 | 4 | ¾ |
| 72 | 1 | 4 | 1 |

In one example, when N_{TRP}=2, any table including at least one of parameter combinations in a sub-table of Table can be used for the table of ‘paramCombination-r18’.

In Table 34, we omitted the rows we can clearly figure it out (based on earlier rows) for the sake of space limitation. Also, the table index numbers (from 1 to 216) in Table 34 should be interpreted as just indexes for corresponding parameter combinations. That is, the table index number can be any value based on the ordering of parameter combinations and the number of parameter combinations in a table.

In one example, any sub-table of Table 34 can be an example for the table of ‘paraCombination-r18’.

Although we write α₁, α₂, M, β in second, third, fourth, fifth columns of Table 34 as an example, they can be arranged in any order of columns, for example, M, α₁, α₂, β are written in second, third, fourth, and fifth columns.

TABLE 34

| paramCombination-r18 | α₁ | α₂ | M | β |
|---|---|---|---|---|
| 1 | ½ | ½ | 1 | ⅛ |
| 2 | ½ | ½ | 1 | ¼ |
| 3 | ½ | ½ | 1 | ⅜ |
| 4 | ½ | ½ | 1 | ½ |
| 5 | ½ | ½ | 1 | ¾ |
| 6 | ½ | ½ | 1 | 1 |
| 7 | ½ | ½ | 2 | ⅛ |
| 8 | ½ | ½ | 2 | ¼ |
| 9 | ½ | ½ | 2 | ⅜ |
| 10 | ½ | ½ | 2 | ½ |
| 11 | ½ | ½ | 2 | ¾ |
| 12 | ½ | ½ | 2 | 1 |
| 13 | ½ | ½ | 3 | ⅛ |
| 14 | ½ | ½ | 3 | ¼ |
| 15 | ½ | ½ | 3 | ⅜ |
| 16 | ½ | ½ | 3 | ½ |
| 17 | ½ | ½ | 3 | ¾ |
| 18 | ½ | ½ | 3 | 1 |
| 19 | ½ | ½ | 4 | ⅛ |
| 20 | ½ | ½ | 4 | ¼ |
| 21 | ½ | ½ | 4 | ⅜ |
| 22 | ½ | ½ | 4 | ½ |
| 23 | ½ | ½ | 4 | ¾ |
| 24 | ½ | ½ | 4 | 1 |
| 25 | ½ | ¾ | 1 | ⅛ |
| 26 | ½ | ¾ | 1 | ¼ |
| 27 | ½ | ¾ | 1 | ⅜ |
| 28 | ½ | ¾ | 1 | ½ |
| 29 | ½ | ¾ | 1 | ¾ |
| 30 | ½ | ¾ | 1 | 1 |
| 31 | ½ | ¾ | 2 | ⅛ |
| 32 | ½ | ¾ | 2 | ¼ |
| 33 | ½ | ¾ | 2 | ⅜ |
| 34 | ½ | ¾ | 2 | ½ |
| 35 | ½ | ¾ | 2 | ¾ |
| 36 | ½ | ¾ | 2 | 1 |
| 37 | ½ | ¾ | 3 | ⅛ |
| 38 | ½ | ¾ | 3 | ¼ |
| 39 | ½ | ¾ | 3 | ⅜ |
| 40 | ½ | ¾ | 3 | ½ |
| 41 | ½ | ¾ | 3 | ¾ |
| 42 | ½ | ¾ | 3 | 1 |
| 43 | ½ | ¾ | 4 | ⅛ |
| 44 | ½ | ¾ | 4 | ¼ |
| 45 | ½ | ¾ | 4 | ⅜ |
| 46 | ½ | ¾ | 4 | ½ |
| 47 | ½ | ¾ | 4 | ¾ |
| 48 | ½ | ¾ | 4 | 1 |
| 49 | ½ | 1 | 1 | ⅛ |
| 50 | ½ | 1 | 1 | ¼ |
| 51 | ½ | 1 | 1 | ⅜ |
| 52 | ½ | 1 | 1 | ½ |
| 53 | ½ | 1 | 1 | ¾ |
| 54 | ½ | 1 | 1 | 1 |
| 55 | ½ | 1 | 2 | ⅛ |
| 56 | ½ | 1 | 2 | ¼ |
| 57 | ½ | 1 | 2 | ⅜ |
| 58 | ½ | 1 | 2 | ½ |
| 59 | ½ | 1 | 2 | ¾ |
| 60 | ½ | 1 | 2 | 1 |
| 61 | ½ | 1 | 3 | ⅛ |
| 62 | ½ | 1 | 3 | ¼ |
| 63 | ½ | 1 | 3 | ⅜ |
| 64 | ½ | 1 | 3 | ½ |
| 65 | ½ | 1 | 3 | ¾ |
| 66 | ½ | 1 | 3 | 1 |
| 67 | ½ | 1 | 4 | ⅛ |
| 68 | ½ | 1 | 4 | ¼ |
| 69 | ½ | 1 | 4 | ⅜ |
| 70 | ½ | 1 | 4 | ½ |
| 71 | ½ | 1 | 4 | ¾ |
| 72 | ½ | 1 | 4 | 1 |
| 73 | ¾ | ½ | 1 | ⅛ |
| 74 | ¾ | ½ | 1 | ¼ |
| 75 | ¾ | ½ | 1 | ⅜ |
| 76 | ¾ | ½ | 1 | ½ |
| 77 | ¾ | ½ | 1 | ¾ |
| 78 | ¾ | ½ | 1 | 1 |
| 79 | ¾ | ½ | 2 | ⅛ |
| 80 | ¾ | ½ | 2 | ¼ |
| 81 | ¾ | ½ | 2 | ⅜ |
| 82 | ¾ | ½ | 2 | ½ |
| 83 | ¾ | ½ | 2 | ¾ |
| 84 | ¾ | ½ | 2 | 1 |
| 85 | ¾ | ½ | 3 | ⅛ |
| 86 | ¾ | ½ | 3 | ¼ |
| 87 | ¾ | ½ | 3 | ⅜ |
| 88 | ¾ | ½ | 3 | ½ |
| 89 | ¾ | ½ | 3 | ¾ |
| 90 | ¾ | ½ | 3 | 1 |
| 91 | ¾ | ½ | 4 | ⅛ |
| 92 | ¾ | ½ | 4 | ¼ |
| 93 | ¾ | ½ | 4 | ⅜ |
| 94 | ¾ | ½ | 4 | ½ |
| 95 | ¾ | ½ | 4 | ¾ |
| 96 | ¾ | ½ | 4 | 1 |
| 97 | ¾ | ¾ | 1 | ⅛ |
| 98 | ¾ | ¾ | 1 | ¼ |
| 99 | ¾ | ¾ | 1 | ⅜ |
| 100 | ¾ | ¾ | 1 | ½ |
| 101 | ¾ | ¾ | 1 | ¾ |
| 102 | ¾ | ¾ | 1 | 1 |
| 103 | ¾ | ¾ | 2 | ⅛ |
| . | . | | . | . |
| . | . | | . | . |
| . | . | | . | . |
| 144 | ¾ | 1 | 4 | 1 |
| 145 | 1 | ½ | 1 | ⅛ |
| 146 | 1 | ½ | 1 | ¼ |
| 147 | 1 | ½ | 1 | ⅜ |
| 148 | 1 | ½ | 1 | ½ |
| 149 | 1 | ½ | 1 | ¾ |
| 150 | 1 | ½ | 1 | 1 |
| 151 | 1 | ½ | 2 | 1 |
| . | . | | . | . |
| . | . | | . | . |
| . | . | | . | . |
| 216 | 1 | | 4 | 1 |

In one example, when N_{TRP}=3, any table including at least one of parameter combinations in a sub-table of Table 35 can be used for the table of ‘paramCombination-r18’.

In Table 35, we omitted the rows we can clearly figure it out (based on earlier rows) for the sake of space limitation. Also, the table index numbers (from 1 to 648) in Table 35 should be interpreted as just indexes for corresponding parameter combinations. That is, the table index number can be any value based on the ordering of parameter combinations and the number of parameter combinations in a table.

In one example, any sub-table of Table 35 can be an example for the table of ‘paraCombination-r18’.

Although we write α₁, α₂, α₃, M, β in second, third, fourth, fifth columns of Table 35 as an example, they can be arranged in any order of columns, for example, M, α₁, α₂, α₃, β are written in second, third, fourth, and fifth columns.

TABLE 35

| paramCombination-r18 | α₁ | α₂ | α₃ | M | β |
|---|---|---|---|---|---|
| 1 | ½ | ½ | ½ | 1 | ⅛ |
| 2 | ½ | ½ | ½ | 1 | ¼ |
| 3 | ½ | ½ | ½ | 1 | ⅜ |
| 4 | ½ | ½ | ½ | 1 | ½ |
| 5 | ½ | ½ | ½ | 1 | ¾ |
| 6 | ½ | ½ | ½ | 1 | 1 |
| 7 | ½ | ½ | ½ | 2 | ⅛ |
| 8 | ½ | ½ | ½ | 2 | ¼ |
| 9 | ½ | ½ | ½ | 2 | ⅜ |
| 10 | ½ | ½ | ½ | 2 | ½ |
| 11 | ½ | ½ | ½ | 2 | ¾ |
| 12 | ½ | ½ | ½ | 2 | 1 |
| 13 | ½ | ½ | ½ | 3 | ⅛ |
| 14 | ½ | ½ | ½ | 3 | ¼ |
| 15 | ½ | ½ | ½ | 3 | ⅜ |
| 16 | ½ | ½ | ½ | 3 | ½ |
| 17 | ½ | ½ | ½ | 3 | ¾ |
| 18 | ½ | ½ | ½ | 3 | 1 |
| 19 | ½ | ½ | ½ | 4 | ⅛ |
| 20 | ½ | ½ | ½ | 4 | ¼ |
| 21 | ½ | ½ | ½ | 4 | ⅜ |
| 22 | ½ | ½ | ½ | 4 | ½ |
| 23 | ½ | ½ | ½ | 4 | ¾ |
| 24 | ½ | ½ | ½ | 4 | 1 |
| 25 | ½ | ½ | ¾ | 1 | ⅛ |
| 26 | ½ | ½ | ¾ | 1 | ¼ |
| 27 | ½ | ½ | ¾ | 1 | ⅜ |
| 28 | ½ | ½ | ¾ | 1 | ½ |
| 29 | ½ | ½ | ¾ | 1 | ¾ |
| 30 | ½ | ½ | ¾ | 1 | 1 |
| 31 | ½ | ½ | ¾ | 2 | ⅛ |
| 32 | ½ | ½ | ¾ | 2 | ¼ |
| 33 | ½ | ½ | ¾ | 2 | ⅜ |
| 34 | ½ | ½ | ¾ | 2 | ½ |
| 35 | ½ | ½ | ¾ | 2 | ¾ |
| 36 | ½ | ½ | ¾ | 2 | 1 |
| 37 | ½ | ½ | ¾ | 3 | ⅛ |
| 38 | ½ | ½ | ¾ | 3 | ¼ |
| 39 | ½ | ½ | ¾ | 3 | ⅜ |
| 40 | ½ | ½ | ¾ | 3 | ½ |
| 41 | ½ | ½ | ¾ | 3 | ¾ |
| 42 | ½ | ½ | ¾ | 3 | 1 |
| 43 | ½ | ½ | ¾ | 4 | ⅛ |
| 44 | ½ | ½ | ¾ | 4 | ¼ |
| 45 | ½ | ½ | ¾ | 4 | ⅜ |
| 46 | ½ | ½ | ¾ | 4 | ½ |
| 47 | ½ | ½ | ¾ | 4 | ¾ |
| 48 | ½ | ½ | ¾ | 4 | 1 |
| 49 | ½ | ½ | 1 | 1 | ⅛ |
| 50 | ½ | ½ | 1 | 1 | ¼ |
| 51 | ½ | ½ | 1 | 1 | ⅜ |
| 52 | ½ | ½ | 1 | 1 | ½ |
| 53 | ½ | ½ | 1 | 1 | ¾ |
| 54 | ½ | ½ | 1 | 1 | 1 |
| 55 | ½ | ½ | 1 | 2 | ⅛ |
| 56 | ½ | ½ | 1 | 2 | ¼ |
| 57 | ½ | ½ | 1 | 2 | ⅜ |
| 58 | ½ | ½ | 1 | 2 | ½ |
| 59 | ½ | ½ | 1 | 2 | ¾ |
| 60 | ½ | ½ | 1 | 2 | 1 |
| 61 | ½ | ½ | 1 | 3 | ⅛ |
| 62 | ½ | ½ | 1 | 3 | ¼ |
| 63 | ½ | ½ | 1 | 3 | ⅜ |
| 64 | ½ | ½ | 1 | 3 | ½ |
| 65 | ½ | ½ | 1 | 3 | ¾ |
| 66 | ½ | ½ | 1 | 3 | 1 |
| 67 | ½ | ½ | 1 | 4 | ⅛ |
| 68 | ½ | ½ | 1 | 4 | ¼ |
| 69 | ½ | ½ | 1 | 4 | ⅜ |
| 70 | ½ | ½ | 1 | 4 | ½ |
| 71 | ½ | ½ | 1 | 4 | ¾ |
| 72 | ½ | ½ | 1 | 4 | 1 |
| 73 | ½ | ¾ | ½ | 1 | ⅛ |
| 74 | ½ | ¾ | ½ | 1 | ¼ |
| 75 | ½ | ¾ | ½ | 1 | ⅜ |
| 76 | ½ | ¾ | ½ | 1 | ½ |
| 77 | ½ | ¾ | ½ | 1 | ¾ |
| 78 | ½ | ¾ | ½ | 1 | 1 |
| 79 | ½ | ¾ | ½ | 2 | ⅛ |
| . | . | | | . | . |
| . | . | | | . | . |
| . | . | | | . | . |
| 96 | ½ | ¾ | ½ | 4 | 1 |
| 97 | ½ | ¾ | ¾ | 1 | ⅛ |
| . | . | | | . | . |
| . | . | | | . | . |
| . | . | | | . | . |
| 120 | ½ | ¾ | ¾ | 4 | 1 |
| 121 | ½ | ¾ | 1 | 1 | ⅛ |
| . | . | | | . | . |
| . | . | | | . | . |
| . | . | | | . | . |
| 144 | ½ | ¾ | 1 | 4 | 1 |
| 145 | ½ | 1 | ½ | 1 | ⅛ |
| . | . | | | . | . |
| . | . | | | . | . |
| . | . | | | . | . |
| 168 | ½ | 1 | ½ | 4 | 1 |
| 169 | ½ | 1 | ¾ | 1 | ⅛ |
| . | . | | | . | . |
| . | . | | | . | . |
| . | . | | | . | . |
| 192 | ½ | 1 | ¾ | 4 | 1 |
| 193 | ½ | 1 | 1 | 1 | ⅛ |
| . | . | | | . | . |
| . | . | | | . | . |
| . | . | | | . | . |
| 216 | ½ | 1 | 1 | 4 | 1 |
| 217 | ¾ | ½ | ½ | 1 | ⅛ |
| . | . | | | . | . |
| . | . | | | . | . |
| . | . | | | . | . |
| 432 | ¾ | 1 | 1 | 4 | 1 |
| 433 | 1 | ½ | ½ | 1 | ⅛ |
| . | . | | | . | . |
| . | . | | | . | . |
| . | . | | | . | . |
| 648 | 1 | 1 | 1 | 4 | 1 |

In one example, when N_{TRP}=4, any table including at least one of parameter combinations in a sub-table of Table 36 can be used for the table of ‘paramCombination-r18’.

In Table 36, we omitted the rows we can clearly figure it out (based on earlier rows) for the sake of space limitation. Also, the table index numbers (from 1 to 1944) in Table 36 should be interpreted as just indexes for corresponding parameter combinations. That is, the table index number can be any value based on the ordering of parameter combinations and the number of parameter combinations in a table.

In one example, any sub-table of Table 36 can be an example for the table of ‘paraCombination-r18’.

Although we write α₁, α₂, α₃, α₄, M, β in second, third, fourth, fifth, and sixth columns of Table 36 as an example, they can be arranged in any order of columns, for example, M, α₁, α₂, α₃, α₄, β are written in second, third, fourth, fifth, and sixth columns.

TABLE 36

| paramCombination-r18 | α₁ | α₂ | α₃ | α₄ | M | β |
|---|---|---|---|---|---|---|
| 1 | ½ | ½ | ½ | ½ | 1 | ⅛ |
| 2 | ½ | ½ | ½ | ½ | 1 | ¼ |
| 3 | ½ | ½ | ½ | ½ | 1 | ⅜ |
| 4 | ½ | ½ | ½ | ½ | 1 | ½ |
| 5 | ½ | ½ | ½ | ½ | 1 | ¾ |
| 6 | ½ | ½ | ½ | ½ | 1 | 1 |
| 7 | ½ | ½ | ½ | ½ | 2 | ⅛ |
| 8 | ½ | ½ | ½ | ½ | 2 | ¼ |
| 9 | ½ | ½ | ½ | ½ | 2 | ⅜ |
| 10 | ½ | ½ | ½ | ½ | 2 | ½ |
| 11 | ½ | ½ | ½ | ½ | 2 | ¾ |
| 12 | ½ | ½ | ½ | ½ | 2 | 1 |
| 13 | ½ | ½ | ½ | ½ | 3 | ⅛ |
| 14 | ½ | ½ | ½ | ½ | 3 | ¼ |
| 15 | ½ | ½ | ½ | ½ | 3 | ⅜ |
| 16 | ½ | ½ | ½ | ½ | 3 | ½ |
| 17 | ½ | ½ | ½ | ½ | 3 | ¾ |
| 18 | ½ | ½ | ½ | ½ | 3 | 1 |
| 19 | ½ | ½ | ½ | ½ | 4 | ⅛ |
| 20 | ½ | ½ | ½ | ½ | 4 | ¼ |
| 21 | ½ | ½ | ½ | ½ | 4 | ⅜ |
| 22 | ½ | ½ | ½ | ½ | 4 | ½ |
| 23 | ½ | ½ | ½ | ½ | 4 | ¾ |
| 24 | ½ | ½ | ½ | ½ | 4 | 1 |
| 25 | ½ | ½ | ½ | ¾ | 1 | ⅛ |
| 26 | ½ | ½ | ½ | ¾ | 1 | ¼ |
| 27 | ½ | ½ | ½ | ¾ | 1 | ⅜ |
| 28 | ½ | ½ | ½ | ¾ | 1 | ½ |
| 29 | ½ | ½ | ½ | ¾ | 1 | ¾ |
| 30 | ½ | ½ | ½ | ¾ | 1 | 1 |
| 31 | ½ | ½ | ½ | ¾ | 2 | ⅛ |
| 32 | ½ | ½ | ½ | ¾ | 2 | ¼ |
| 33 | ½ | ½ | ½ | ¾ | 2 | ⅜ |
| 34 | ½ | ½ | ½ | ¾ | 2 | ½ |
| 35 | ½ | ½ | ½ | ¾ | 2 | ¾ |
| 36 | ½ | ½ | ½ | ¾ | 2 | 1 |
| 37 | ½ | ½ | ½ | ¾ | 3 | ⅛ |
| 38 | ½ | ½ | ½ | ¾ | 3 | ¼ |
| 39 | ½ | ½ | ½ | ¾ | 3 | ⅜ |
| 40 | ½ | ½ | ½ | ¾ | 3 | ½ |
| 41 | ½ | ½ | ½ | ¾ | 3 | ¾ |
| 42 | ½ | ½ | ½ | ¾ | 3 | 1 |
| 43 | ½ | ½ | ½ | ¾ | 4 | ⅛ |
| 44 | ½ | ½ | ½ | ¾ | 4 | ¼ |
| 45 | ½ | ½ | ½ | ¾ | 4 | ⅜ |
| 46 | ½ | ½ | ½ | ¾ | 4 | ½ |
| 47 | ½ | ½ | ½ | ¾ | 4 | ¾ |
| 48 | ½ | ½ | ½ | ¾ | 4 | 1 |
| 49 | ½ | ½ | ½ | 1 | 1 | ⅛ |
| 50 | ½ | ½ | ½ | 1 | 1 | ¼ |
| 51 | ½ | ½ | ½ | 1 | 1 | ⅜ |
| 52 | ½ | ½ | ½ | 1 | 1 | ½ |
| 53 | ½ | ½ | ½ | 1 | 1 | ¾ |
| 54 | ½ | ½ | ½ | 1 | 1 | 1 |
| 55 | ½ | ½ | ½ | 1 | 2 | ⅛ |
| 56 | ½ | ½ | ½ | 1 | 2 | ¼ |
| 57 | ½ | ½ | ½ | 1 | 2 | ⅜ |
| 58 | ½ | ½ | ½ | 1 | 2 | ½ |
| 59 | ½ | ½ | ½ | 1 | 2 | ¾ |
| 60 | ½ | ½ | ½ | 1 | 2 | 1 |
| 61 | ½ | ½ | ½ | 1 | 3 | ⅛ |
| 62 | ½ | ½ | ½ | 1 | 3 | ¼ |
| 63 | ½ | ½ | ½ | 1 | 3 | ⅜ |
| 64 | ½ | ½ | ½ | 1 | 3 | ½ |
| 65 | ½ | ½ | ½ | 1 | 3 | ¾ |
| 66 | ½ | ½ | ½ | 1 | 3 | 1 |
| 67 | ½ | ½ | ½ | 1 | 4 | ⅛ |
| 68 | ½ | ½ | ½ | 1 | 4 | ¼ |
| 69 | ½ | ½ | ½ | 1 | 4 | ⅜ |
| 70 | ½ | ½ | ½ | 1 | 4 | ½ |
| 71 | ½ | ½ | ½ | 1 | 4 | ¾ |
| 72 | ½ | ½ | ½ | 1 | 4 | 1 |
| 73 | ½ | ½ | ¾ | ½ | 1 | ⅛ |
| . | . | | | | . | . |
| . | . | | | | . | . |
| . | . | | | | . | . |
| 144 | ½ | ½ | ¾ | 1 | 4 | 1 |
| 145 | ½ | ½ | 1 | ½ | 1 | ⅛ |
| . | . | | | | . | . |
| . | . | | | | . | . |
| . | . | | | | . | . |
| 216 | ½ | ½ | 1 | 1 | 4 | 1 |
| 217 | ½ | ¾ | ½ | ½ | 1 | ⅛ |
| . | . | | | | . | . |
| . | . | | | | . | . |
| . | . | | | | . | . |
| 432 | ½ | ¾ | 1 | 1 | 4 | 1 |
| 433 | ½ | 1 | ½ | ½ | 1 | ⅛ |
| . | . | | | | . | . |
| . | . | | | | . | . |
| . | . | | | | . | . |
| 648 | ½ | 1 | 1 | 1 | 4 | 1 |
| 649 | ¾ | ½ | ½ | ½ | 1 | ⅛ |
| . | . | | | | . | . |
| . | . | | | | . | . |
| . | . | | | | . | . |
| 1296 | ¾ | 1 | 1 | 1 | 4 | 1 |
| 1297 | 1 | ½ | ½ | ½ | 1 | ⅛ |
| . | . | | | | . | . |
| . | . | | | | . | . |
| . | . | | | | . | . |
| 1944 | 1 | 1 | 1 | 1 | 4 | 1 |

In one embodiment, any table including at least one of parameter combinations in a sub-table of Table 33/Table 34/Table 35/Table 36 associated with {αₙ} such that αₙ₁≥αₙ₂ (non-increasing order) when n1<n2 can be used for the table of ‘paramCombination-r18’.

In one example, the ordering of the TRP can be configured by the NW 130, via e.g., RRC, MAC CE, or DCI.

In one embodiment, any table including at least one of parameter combinations in a sub-table of Table 33/Table 34/Table 35/Table 36 associated with {αₙ} such that αₙ₁≥αₙ₂ (non-increasing order) when n1>n2 can be used for the table of ‘paramCombination-r18’.

In one example, the ordering of the TRP can be configured by the NW 130, via e.g., RRC, MAC CE, or DCI.

In another embodiment, any table including at least one of parameter combinations in a sub-table of Table 33/Table 34/Table 35/Table 36 can be used for the table of ‘paramCombination-r18’, where the sub-table includes parameter combinations associated with M∈ [symbol] , where [symbol] is a subset of [symbol] . For example, if [symbol] ={1,2}, the sub-table includes the parameter combinations associated with M={1,2} in Table 33/Table 34/Table 35/Table 36.
In one example, [symbol] ={1,2} and the sub-table includes parameter combinations associated with M=1,2 in Table 33/Table 34/Table 35/Table 36.
In one example [symbol] ={1,2,4} and the sub-table includes parameter combinations associated with M=1,2,4 in Table 33/Table 34/Table 35/Table 36.
In one example, [symbol] ={1,2,3} and the sub-table includes parameter combinations associated with M=1,2,3 in Table 33/Table 34/Table 35/Table 36.
In one example, [symbol] ={1} and the sub-table includes parameter combinations associated with M=1,2 in Table 33/Table 34/Table 35/Table 36.

In another embodiment, any table including at least one of parameter combinations in a sub-table of Table 33/Table 34/Table 35/Table 36 can be used for the table of ‘paramCombination-r18’, where the sub-table includes parameter combinations associated with β∈ [symbol] , where [symbol] is a subset of [symbol] . For example, if [symbol] ={⅜,½,¾,1}, the sub-table includes the parameter combinations associated with β=⅜,½,¾,1 in Table 33/Table 34/Table 35/Table 36.
In one example [symbol] ={½,¾,1} and the sub-table includes parameter combinations associated with β=½,¾,1 in Table 33/Table 34/Table 35/Table 36.
In one example, [symbol] ={¼,½,¾,1} and the sub-table includes parameter combinations associated with β=¼,½,¾,1 in Table 33/Table 34/Table 35/Table 36.
In one example, [symbol] ={⅛,¼,½,¾,1} and the sub-table includes parameter combinations associated with β=⅛,¼,½,¾,1 in Table 33/Table 34/Table 35/Table 36.
In one example, [symbol] ={⅜,½,¾,1} and the sub-table includes parameter combinations associated with β=⅜,½,¾,1 in Table 33/Table 34/Table 35/Table 36.
In one example, [symbol] ={¼,⅜,½,¾,1} and the sub-table includes parameter combinations associated with β=¼,⅜,½,¾,1 in Table 33/Table 34/Table 35/Table 36.

In another embodiment, any table including at least one of parameter combinations in a sub-table of Table 33/Table 34/Table 35/Table 36 can be used for the table of ‘paramCombination-r18’, where the sub-table includes parameter combinations associated M∈ [symbol] and β∈ [symbol] , where M∈ [symbol] is defined in one or more embodiments described herein, and β∈ [symbol] is defined in one or more embodiments described herein.

In one example, the sub-table includes parameter combinations associated with:
M∈ [symbol] ={1,2} and β∈ [symbol] ={½,¾,1}.

In another embodiment, for any table described or any table (whole-table or a sub-table) that can be constructed by one or more embodiments described herein, the table can further include αₜₒₜ in addition to αₙ, M and β, and can be used for the table of ‘paramCombination-r18’.

In one example, Table 37 can be an example describing a table including αₜₒₜ in addition to αₙ, M and β, which is based on Table 36.

TABLE 37

| paramCombination-r18 | α₁ | α₂ | α₃ | α₄ | αₜₒₜ | M | β |
|---|---|---|---|---|---|---|---|
| 1 | ½ | ½ | ½ | ½ | ½ | 1 | ⅛ |
| 2 | ½ | ½ | ½ | ½ | ½ | 1 | ¼ |
| 3 | ½ | ½ | ½ | ½ | ½ | 1 | ⅜ |
| 4 | ½ | ½ | ½ | ½ | ½ | 1 | ½ |
| 5 | ½ | ½ | ½ | ½ | ½ | 1 | ¾ |
| 6 | ½ | ½ | ½ | ½ | ½ | 1 | 1 |
| 7 | ½ | ½ | ½ | ½ | ½ | 2 | ⅛ |
| 8 | ½ | ½ | ½ | ½ | ½ | 2 | ¼ |
| . | . | . | . | . | . | . | . |
| . | . | . | . | . | . | . | . |
| . | . | . | . | . | . | . | . |

In another embodiment, for any table described or any table (whole-table or a sub-table) that can be constructed by one or more embodiments described herein, the table can further include αₜₒₜ and N (or N_{TRP}) in addition to αₙ, M and β, and can be used for the table of ‘paramCombination-r18’.

In one example, Table 38 can be an example describing a table including αₜₒₜ and N (or N_{TRP}) in addition to αₙ, M and β, which is based on Table 36.

TABLE 38

| paramCombination-r18 | α₁ | α₂ | α₃ | α₄ | αₜₒₜ | N | M | β |
|---|---|---|---|---|---|---|---|---|
| 1 | ½ | ½ | ½ | ½ | ½ | 4 | 1 | ⅛ |
| 2 | ½ | ½ | ½ | ½ | ½ | 4 | 1 | ¼ |
| 3 | ½ | ½ | ½ | ½ | ½ | 4 | 1 | ⅜ |
| 4 | ½ | ½ | ½ | ½ | ½ | 4 | 1 | ½ |
| 5 | ½ | ½ | ½ | ½ | ½ | 4 | 1 | ¾ |
| 6 | ½ | ½ | ½ | ½ | ½ | 4 | 1 | 1 |
| 7 | ½ | ½ | ½ | ½ | ½ | 4 | 2 | ⅛ |
| 8 | ½ | ½ | ½ | ½ | ½ | 4 | 2 | ¼ |
| . | . | . | . | . | . | . | . | . |
| . | . | . | . | . | . | . | . | . |
| . | . | . | . | . | . | . | . | . |

In this example, αₜₒₜ in the table is computed by

$${α}_{tot} = {\sum }_{n = 1}^{N} \frac{{α}_{n}}{N} .$$

In another example, αₜₒₜ can be computed by

$${α}_{tot} = {\sum }_{n = 1}^{{N}_{TRP}} \frac{{α}_{n}}{{N}_{TRP}} .$$

In one example, Table 39 can be an example describing a table including αₜₒₜ and N (or N_{TRP}) in addition to αₙ, M and β, which is based on a combination of Table 33/Table 34/Table 35/Table 36.

TABLE 39

| paramCombination-r18 | α₁ | α₂ | α₃ | α₄ | αₜₒₜ | N | M | β |
|---|---|---|---|---|---|---|---|---|
| 1 | ½ | | | | ½ | 1 | 1 | ⅛ |
| . | . | . | . | . | . | . | . | . |
| . | . | . | . | . | . | . | . | . |
| . | . | . | . | . | . | . | . | . |
| a | ¾ | | | | ¾ | 1 | 1 | ⅛ |
| . | . | . | . | . | . | . | . | . |
| . | . | . | . | . | . | . | . | . |
| . | . | . | . | . | . | . | . | . |
| b | 1 | | | | 1 | 1 | 1 | ⅛ |
| . | . | . | . | . | . | . | . | . |
| . | . | . | . | . | . | . | . | . |
| . | . | . | . | . | . | . | . | . |
| c | ½ | ½ | | | ½ | 2 | 1 | ⅛ |
| . | . | . | . | . | . | . | . | . |
| . | . | . | . | . | . | . | . | . |
| . | . | . | . | . | . | . | . | . |
| d | ½ | ¾ | | | ⅝ | 2 | 1 | ⅛ |
| . | . | . | . | . | . | . | . | . |
| . | . | . | . | . | . | . | . | . |
| . | . | . | . | . | . | . | . | . |
| e | ½ | 1 | | | ¾ | 2 | 1 | ⅛ |
| . | . | . | . | . | . | . | . | . |
| . | . | . | . | . | . | . | . | . |
| . | . | . | . | . | . | . | . | . |
| f | ¾ | ½ | | | ⅝ | 2 | 1 | ⅛ |
| . | . | . | . | . | . | . | . | . |
| . | . | . | . | . | . | . | . | . |
| . | . | . | . | . | . | . | . | . |
| g | ¾ | ¾ | | | ¾ | 2 | 1 | ⅛ |
| . | . | . | . | . | . | . | . | . |
| . | . | . | . | . | . | . | . | . |
| . | . | . | . | . | . | . | . | . |
| . | . | . | . | . | . | . | . | . |
| . | . | . | . | . | . | . | . | . |
| . | . | . | . | . | . | . | . | . |
| h | ½ | ½ | ½ | | ½ | 3 | 1 | ⅛ |
| . | . | . | . | . | . | . | . | . |
| . | . | . | . | . | . | . | . | . |
| . | . | . | . | . | . | . | . | . |
| . | . | . | . | . | . | . | . | . |
| . | . | . | . | . | . | . | . | . |
| . | . | . | . | . | . | . | . | . |
| i | ½ | ½ | ½ | ½ | ½ | 4 | 1 | ⅛ |
| . | . | . | . | . | . | . | . | . |
| . | . | . | . | . | . | . | . | . |
| . | . | . | . | . | . | . | . | . |

In this example, αₜₒₜ in the table is computed by

$${α}_{tot} = {\sum }_{n = 1}^{N} \frac{{α}_{n}}{N} .$$

In another example, αₜₒₜ can be computed by

$${α}_{tot} = {\sum }_{n = 1}^{{N}_{TRP}} \frac{{α}_{n}}{{N}_{TRP}} .$$

In another example, blanks of the table can be replaced by 0 values, which is as follows for example:

TABLE 40

| paramCombination-r18 | α₁ | α₂ | α₃ | α₄ | αₜₒₜ | N | M | β |
|---|---|---|---|---|---|---|---|---|
| 1 | ½ | 0 | 0 | 0 | ½ | 1 | 1 | ⅛ |
| . | . | . | . | . | . | . | . | . |
| . | . | . | . | . | . | . | . | . |
| . | . | . | . | . | . | . | . | . |
| a | ¾ | 0 | 0 | 0 | ¾ | 1 | 1 | ⅛ |
| . | . | . | . | . | . | . | . | . |
| . | . | . | . | . | . | . | . | . |
| . | . | . | . | . | . | . | . | . |
| b | 1 | 0 | 0 | 0 | 1 | 1 | 1 | ⅛ |
| . | . | . | . | . | . | . | . | . |
| . | . | . | . | . | . | . | . | . |
| . | . | . | . | . | . | . | . | . |
| c | ½ | ½ | 0 | 0 | ½ | 2 | 1 | ⅛ |
| . | . | . | . | . | . | . | . | . |
| . | . | . | . | . | . | . | . | . |
| . | . | . | . | . | . | . | . | . |
| d | ½ | ¾ | 0 | 0 | ⅝ | 2 | 1 | ⅛ |
| . | . | . | . | . | . | . | . | . |
| . | . | . | . | . | . | . | . | . |
| . | . | . | . | . | . | . | . | . |
| e | ½ | 1 | 0 | 0 | ¾ | 2 | 1 | ⅛ |
| . | . | . | . | . | . | . | . | . |
| . | . | . | . | . | . | . | . | . |
| . | . | . | . | . | . | . | . | . |
| f | ¾ | ½ | 0 | 0 | ⅝ | 2 | 1 | ⅛ |
| . | . | . | . | . | . | . | . | . |
| . | . | . | . | . | . | . | . | . |
| . | . | . | . | . | . | . | . | . |
| g | ¾ | ¾ | 0 | 0 | ¾ | 2 | 1 | ⅛ |
| . | . | . | . | . | . | . | . | . |
| . | . | . | . | . | . | . | . | . |
| . | . | . | . | . | . | . | . | . |
| . | . | . | . | . | . | . | . | . |
| . | . | . | . | . | . | . | . | . |
| . | . | . | . | . | . | . | . | . |
| h | ½ | ½ | ½ | 0 | ½ | 3 | 1 | ⅛ |
| . | . | . | . | . | . | . | . | . |
| . | . | . | . | . | . | . | . | . |
| . | . | . | . | . | . | . | . | . |
| . | . | . | . | . | . | . | . | . |
| . | . | . | . | . | . | . | . | . |
| . | . | . | . | . | . | . | . | . |
| i | ½ | ½ | ½ | ½ | ½ | 4 | 1 | ⅛ |
| . | . | . | . | . | . | . | . | . |
| . | . | . | . | . | . | . | . | . |
| . | . | . | . | . | . | . | . | . |

In this example, αₜₒₜ in the table is computed by

$${α}_{tot} = {\sum }_{n = 1}^{N} \frac{{α}_{n}}{N} .$$

In another example, αₜₒₜ can be computed by

$${α}_{tot} = {\sum }_{n = 1}^{{N}_{TRP}} \frac{{α}_{n}}{{N}_{TRP}} .$$

In another embodiment, for any table described or any table (whole-table or a sub-table) that can be constructed by one or more embodiments described herein, the table can further include N (or N_{TRP}) in addition to αₙ, M and β, and can be used for the table of ‘paramCombination-r18’.

In one example, Table 11 can be an example describing a table including N (or N_{TRP}) in addition to α, M and β, which is based on Table 36.

TABLE 41

| paramCombination-r18 | α₁ | α₂ | α₃ | α₄ | N | M | β |
|---|---|---|---|---|---|---|---|
| 1 | ½ | ½ | ½ | ½ | 4 | 1 | ⅛ |
| 2 | ½ | ½ | ½ | ½ | 4 | 1 | ¼ |
| 3 | ½ | ½ | ½ | ½ | 4 | 1 | ⅜ |
| 4 | ½ | ½ | ½ | ½ | 4 | 1 | ½ |
| 5 | ½ | ½ | ½ | ½ | 4 | 1 | ¾ |
| 6 | ½ | ½ | ½ | ½ | 4 | 1 | 1 |
| 7 | ½ | ½ | ½ | ½ | 4 | 2 | ⅛ |
| 8 | ½ | ½ | ½ | ½ | 4 | 2 | ¼ |
| . | . | . | . | . | . | . | . |
| . | . | . | . | . | . | . | . |
| . | . | . | . | . | . | . | . |

In one example, Table 42 can be an example describing a table including Lₜₒₜ and N (or N_{TRP}) in addition to Lₙ, pᵥ and β, which is based on a combination of Table 33/Table 34/Table 35/Table 36.

TABLE 42

| paramCombination-r18 | α₁ | α₂ | α₃ | α₄ | N | M | β |
|---|---|---|---|---|---|---|---|
| 1 | ½ | | | | 1 | 1 | ⅛ |
| . | . | . | . | . | . | . | . |
| . | . | . | . | . | . | . | . |
| . | . | . | . | . | . | . | . |
| a | ¾ | | | | 1 | 1 | ⅛ |
| . | . | . | . | . | . | . | . |
| . | . | . | . | . | . | . | . |
| . | . | . | . | . | . | . | . |
| b | 1 | | | | 1 | 1 | ⅛ |
| . | . | . | . | . | . | . | . |
| . | . | . | . | . | . | . | . |
| . | . | . | . | . | . | . | . |
| c | ½ | ½ | | | 2 | 1 | ⅛ |
| . | . | . | . | . | . | . | . |
| . | . | . | . | . | . | . | . |
| . | . | . | . | . | . | . | . |
| d | ½ | ¾ | | | 2 | 1 | ⅛ |
| . | . | . | . | . | . | . | . |
| . | . | . | . | . | . | . | . |
| . | . | . | . | . | . | . | . |
| e | ½ | 1 | | | 2 | 1 | ⅛ |
| . | . | . | . | . | . | . | . |
| . | . | . | . | . | . | . | . |
| . | . | . | . | . | . | . | . |
| f | ¾ | ½ | | | 2 | 1 | ⅛ |
| . | . | . | . | . | . | . | . |
| . | . | . | . | . | . | . | . |
| . | . | . | . | . | . | . | . |
| g | ¾ | ¾ | | | 2 | 1 | ⅛ |
| . | . | . | . | . | . | . | . |
| . | . | . | . | . | . | . | . |
| . | . | . | . | . | . | . | . |
| . | . | . | . | . | . | . | . |
| . | . | . | . | . | . | . | . |
| . | . | . | . | . | . | . | . |
| h | ½ | ½ | ½ | | 3 | 1 | ⅛ |
| . | . | . | . | . | . | . | . |
| . | . | . | . | . | . | . | . |
| . | . | . | . | . | . | . | . |
| . | . | . | . | . | . | . | . |
| . | . | . | . | . | . | . | . |
| . | . | . | . | . | . | . | . |
| i | ½ | ½ | ½ | ½ | 4 | 1 | ⅛ |
| . | . | . | . | . | . | . | . |
| . | . | . | . | . | . | . | . |
| . | . | . | . | . | . | . | . |

In another example, blanks of the table can be replaced by 0 values, which is as follows, for example:

TABLE 43

| paramCombination-r18 | α₁ | α₂ | α₃ | α₄ | N | M | β |
|---|---|---|---|---|---|---|---|
| 1 | ½ | 0 | 0 | 0 | 1 | 1 | ⅛ |
| . | . | . | . | . | . | . | . |
| . | . | . | . | . | . | . | . |
| . | . | . | . | . | . | . | . |
| a | ¾ | 0 | 0 | 0 | 1 | 1 | ⅛ |
| . | . | . | . | . | . | . | . |
| . | . | . | . | . | . | . | . |
| . | . | . | . | . | . | . | . |
| b | 1 | 0 | 0 | 0 | 1 | 1 | ⅛ |
| . | . | . | . | . | . | . | . |
| . | . | . | . | . | . | . | . |
| . | . | . | . | . | . | . | . |
| c | ½ | ½ | 0 | 0 | 2 | 1 | ⅛ |
| . | . | . | . | . | . | . | . |
| . | . | . | . | . | . | . | . |
| . | . | . | . | . | . | . | . |
| d | ½ | ¾ | 0 | 0 | 2 | 1 | ⅛ |
| . | . | . | . | . | . | . | . |
| . | . | . | . | . | . | . | . |
| . | . | . | . | . | . | . | . |
| e | ½ | 1 | 0 | 0 | 2 | 1 | ⅛ |
| . | . | . | . | . | . | . | . |
| . | . | . | . | . | . | . | . |
| . | . | . | . | . | . | . | . |
| f | ¾ | ½ | 0 | 0 | 2 | 1 | ⅛ |
| . | . | . | . | . | . | . | . |
| . | . | . | . | . | . | . | . |
| . | . | . | . | . | . | . | . |
| g | ¾ | ¾ | 0 | 0 | 2 | 1 | ⅛ |
| . | . | . | . | . | . | . | . |
| . | . | . | . | . | . | . | . |
| . | . | . | . | . | . | . | . |
| . | . | . | . | . | . | . | . |
| . | . | . | . | . | . | . | . |
| . | . | . | . | . | . | . | . |
| h | ½ | ½ | ½ | 0 | 3 | 1 | ⅛ |
| . | . | . | . | . | . | . | . |
| . | . | . | . | . | . | . | . |
| . | . | . | . | . | . | . | . |
| . | . | . | . | . | . | . | . |
| . | . | . | . | . | . | . | . |
| . | . | . | . | . | . | . | . |
| i | ½ | ½ | ½ | ½ | 4 | 1 | ⅛ |
| . | . | . | . | . | . | . | . |
| . | . | . | . | . | . | . | . |
| . | . | . | . | . | . | . | . |

For any table described in the present disclosure or any table that can be constructed by any embodiment, the table having a different order of columns can also be interpreted as embodiments of the present disclosure.

In another embodiment, a subset of parameter combinations in a table designed based on one or more embodiments described herein for the table of ‘paramCombination-r18’ can be restricted not to configure based on one or more aspects such as a number of TRPs (N_{TRP}), a number of SBs K (numberOfPMI-SubbandsPerCQI-Subband), and a number of CSI-RS ports (2N₁N₂ or P_{CSI-RS}).

In one example, the parameter combination with αₙ=1 or/and ¾ for any n can be used/reported (by the UE 116) or configured (by the NW 130) under a condition.
In one example (C1), the condition corresponds to the case when number of CSI-RS ports (for a TRP)=32.
In one example (C2), the condition corresponds to the case when number of CSI-RS ports (for a TRP)≥t, where t is a threshold, which can be fixed, configured, or subject to UE capability.
In one example (C3), the condition corresponds to the case when number of CSI-RS ports (for a TRP)>t, where t is a threshold, which can be fixed, configured, or subject to UE capability.
In one example (C4), the condition corresponds to the case when N_{TRP}<3 (i.e., N_{TRP}=1,2).
In one example (C5), the condition corresponds to the case when N_{TRP}<s, where s is a threshold, which can be fixed, or configured, or subject to UE capability.
In one example (C6), the condition corresponds to the case when N_{TRP}≤s, where s is a threshold, which can be fixed, or configured, or subject to UE capability.
In one example (C7), the condition corresponds to the case when N_{TRP}>s, where s is a threshold, which can be fixed, or configured, or subject to UE capability.
In one example (C8), the condition corresponds to the case when N_{TRP}>s, where s is a threshold, which can be fixed, or configured, or subject to UE capability.
In one example (C9), the condition corresponds to the case when K<k, where k is a threshold, which can be fixed, or configured, or subject to UE capability.
In one example (C10), the condition corresponds to the case when K≤k, where k is a threshold, which can be fixed, or configured, or subject to UE capability.
In one example (C11), the condition corresponds to the case when K>k, where k is a threshold, which can be fixed, or configured, or subject to UE capability.
In one example (C12), the condition corresponds to the case when K≥k, where k is a threshold, which can be fixed, or configured, or subject to UE capability.
In one example (C13), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction).
In one example (C10), the condition corresponds to C1 or/and C2 or/and C3 or/and C4 or/and C5 or/and C6 or/and C7 or/and C8 or/and C9 or/and C10 or/and C11 or/and C12 and the value of R is 1 (e.g., configured via higher layer numberOfPMIsubbandPerCQIsubband).
In one example (C11), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction), and the value of R is 1 (e.g., configured via higher layer numberOfPMIsubbandPerCQIsubband).

In one example, the parameter combination with M=2 or/and 3 or or/and 4 for any n can be used/reported (by the UE 116) or configured (by the NW 130) under a condition.
In one example (C1), the condition corresponds to the case when number of CSI-RS ports (for a TRP)=32.
In one example (C2), the condition corresponds to the case when number of CSI-RS ports (for a TRP)≥t, where t is a threshold, which can be fixed, configured, or subject to UE capability.
In one example (C3), the condition corresponds to the case when number of CSI-RS ports (for a TRP)>t, where t is a threshold, which can be fixed, configured, or subject to UE capability.
In one example (C4), the condition corresponds to the case when N_{TRP}<3 (i.e., N_{TRP}=1,2).
In one example (C5), the condition corresponds to the case when N_{TRP}<s, where s is a threshold, which can be fixed, or configured, or subject to UE capability.
In one example (C6), the condition corresponds to the case when N_{TRP}≤s, where s is a threshold, which can be fixed, or configured, or subject to UE capability.
In one example (C7), the condition corresponds to the case when N_{TRP}>s, where s is a threshold, which can be fixed, or configured, or subject to UE capability.
In one example (C8), the condition corresponds to the case when N_{TRP}>s, where s is a threshold, which can be fixed, or configured, or subject to UE capability.
In one example (C9), the condition corresponds to the case when K<k, where k is a threshold, which can be fixed, or configured, or subject to UE capability.
In one example (C10), the condition corresponds to the case when K≤k, where k is a threshold, which can be fixed, or configured, or subject to UE capability.
In one example (C11), the condition corresponds to the case when K>k, where k is a threshold, which can be fixed, or configured, or subject to UE capability.
In one example (C12), the condition corresponds to the case when K≥k, where k is a threshold, which can be fixed, or configured, or subject to UE capability.
In one example (C13), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction).
In one example (C14), the condition corresponds to C1 or/and C2 or/and C3 or/and C4 or/and C5 or/and C6 or/and C7 or/and C8 or/and C9 or/and C10 or/and C11 or/and C12 and the value of R is 1 (e.g., configured via higher layer numberOfPMIsubbandPerCQIsubband).
In one example (C15), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction), and the value of R is 1 (e.g., configured via higher layer numberOfPMIsubbandPerCQIsubband).

In one example, the parameter combination with M=1 for any n can be used/reported (by the UE 116) or configured (by the NW 130) under a condition.
In one example (C1), the condition corresponds to the case when number of CSI-RS ports (for a TRP)=32.
In one example (C2), the condition corresponds to the case when number of CSI-RS ports (for a TRP)≥t, where t is a threshold, which can be fixed, configured, or subject to UE capability.
In one example (C3), the condition corresponds to the case when number of CSI-RS ports (for a TRP)>t, where t is a threshold, which can be fixed, configured, or subject to UE capability.
In one example (C4), the condition corresponds to the case when N_{TRP}<3 (i.e., N_{TRP}=1,2).
In one example (C5), the condition corresponds to the case when N_{TRP}<s, where s is a threshold, which can be fixed, or configured, or subject to UE capability.
In one example (C6), the condition corresponds to the case when N_{TRP}≤s, where s is a threshold, which can be fixed, or configured, or subject to UE capability.
In one example (C7), the condition corresponds to the case when N_{TRP}>s, where s is a threshold, which can be fixed, or configured, or subject to UE capability.
In one example (C8), the condition corresponds to the case when N_{TRP}>s, where s is a threshold, which can be fixed, or configured, or subject to UE capability.
In one example (C9), the condition corresponds to the case when K<k, where k is a threshold, which can be fixed, or configured, or subject to UE capability.
In one example (C10), the condition corresponds to the case when K≤k, where k is a threshold, which can be fixed, or configured, or subject to UE capability.
In one example (C11), the condition corresponds to the case when K>k, where k is a threshold, which can be fixed, or configured, or subject to UE capability.
In one example (C12), the condition corresponds to the case when K≥k, where k is a threshold, which can be fixed, or configured, or subject to UE capability.
In one example (C13), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction).
In one example (C14), the condition corresponds to C1 or/and C2 or/and C3 or/and C4 or/and C5 or/and C6 or/and C7 or/and C8 or/and C9 or/and C10 or/and C11 or/and C12 and the value of R is 1 (e.g., configured via higher layer numberOfPMIsubbandPerCQIsubband).
In one example (C15), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction), and the value of R is 1 (e.g., configured via higher layer numberOfPMIsubbandPerCQIsubband).

In one example, the parameter combination with β=½ or/and ¾ or/and 1 for any n can be used/reported (by the UE 116) or configured (by the NW 130) under a condition.
In one example (C1), the condition corresponds to the case when number of CSI-RS ports (for a TRP)=32.
In one example (C2), the condition corresponds to the case when number of CSI-RS ports (for a TRP)≥t, where t is a threshold, which can be fixed, configured, or subject to UE capability.
In one example (C3), the condition corresponds to the case when number of CSI-RS ports (for a TRP)>t, where t is a threshold, which can be fixed, configured, or subject to UE capability.
In one example (C4), the condition corresponds to the case when N_{TRP}<3 (i.e., N_{TRP}=1,2).
In one example (C5), the condition corresponds to the case when N_{TRP}<s, where s is a threshold, which can be fixed, or configured, or subject to UE capability.
In one example (C6), the condition corresponds to the case when N_{TRP}≤s, where s is a threshold, which can be fixed, or configured, or subject to UE capability.
In one example (C7), the condition corresponds to the case when N_{TRP}>s, where s is a threshold, which can be fixed, or configured, or subject to UE capability.
In one example (C8), the condition corresponds to the case when N_{TRP}>s, where s is a threshold, which can be fixed, or configured, or subject to UE capability.
In one example (C9), the condition corresponds to the case when K<k, where k is a threshold, which can be fixed, or configured, or subject to UE capability.
In one example (C10), the condition corresponds to the case when K≤k, where k is a threshold, which can be fixed, or configured, or subject to UE capability.
In one example (C11), the condition corresponds to the case when K>k, where k is a threshold, which can be fixed, or configured, or subject to UE capability.
In one example (C12), the condition corresponds to the case when K≥k, where k is a threshold, which can be fixed, or configured, or subject to UE capability.
In one example (C13), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction).
In one example (C14), the condition corresponds to C1 or/and C2 or/and C3 or/and C4 or/and C5 or/and C6 or/and C7 or/and C8 or/and C9 or/and C10 or/and C11 or/and C12 and the value of R is 1 (e.g., configured via higher layer numberOfPMIsubbandPerCQIsubband).
In one example (C15), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction), and the value of R is 1 (e.g., configured via higher layer numberOfPMIsubbandPerCQIsubband).

In one example, the parameter combination with αₙ=1 or/and ¾ or/and M=2 or/and 3 or/and 4 or/and 1 for any n can be used/reported (by the UE 116) or configured (by the NW 130) under a condition.
In one example (C1), the condition corresponds to the case when number of CSI-RS ports (for a TRP)=32.
In one example (C2), the condition corresponds to the case when number of CSI-RS ports (for a TRP)≥t, where t is a threshold, which can be fixed, configured, or subject to UE capability.
In one example (C3), the condition corresponds to the case when number of CSI-RS ports (for a TRP)>t, where t is a threshold, which can be fixed, configured, or subject to UE capability.
In one example (C4), the condition corresponds to the case when N_{TRP}<3 (i.e., N_{TRP}=1,2).
In one example (C5), the condition corresponds to the case when N_{TRP}<s, where s is a threshold, which can be fixed, or configured, or subject to UE capability.
In one example (C6), the condition corresponds to the case when N_{TRP}≤s, where s is a threshold, which can be fixed, or configured, or subject to UE capability.
In one example (C7), the condition corresponds to the case when N_{TRP}>s, where s is a threshold, which can be fixed, or configured, or subject to UE capability.
In one example (C8), the condition corresponds to the case when N_{TRP}>s, where s is a threshold, which can be fixed, or configured, or subject to UE capability.
In one example (C9), the condition corresponds to the case when K<k, where k is a threshold, which can be fixed, or configured, or subject to UE capability.
In one example (C10), the condition corresponds to the case when K≤k, where k is a threshold, which can be fixed, or configured, or subject to UE capability.
In one example (C11), the condition corresponds to the case when K>k, where k is a threshold, which can be fixed, or configured, or subject to UE capability.
In one example (C12), the condition corresponds to the case when K≥k, where k is a threshold, which can be fixed, or configured, or subject to UE capability.
In one example (C13), the condition corresponds to C1 or/and C2 or/and C3 or/and C4 or/and C5 or/and C6 or/and C7 or/and C8 or/and C9 or/and C10 or/and C11 or/and C12) and the max rank value (for RI reporting) is 2 (e.g., configured via RI-restriction.
In one example (C14), the condition corresponds to C1 or/and C2 or/and C3 or/and C4 or/and C5 or/and C6 or/and C7 or/and C8 or/and C9 or/and C10 or/and C11 or/and C12 and the value of R is 1 (e.g., configured via higher layer numberOfPMIsubbandPerCQIsubband).
In one example (C15), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction), and the value of R is 1 (e.g., configured via higher layer numberOfPMIsubbandPerCQIsubband).

In one example, the parameter combination with αₙ=1 or/and ¾ or/and β=½ or/and ¾ or/and 1 for any n can be used/reported (by the UE 116) or configured (by the NW 130) under a condition.
In one example (C1), the condition corresponds to the case when number of CSI-RS ports (for a TRP)=32.
In one example (C2), the condition corresponds to the case when number of CSI-RS ports (for a TRP)≥t, where t is a threshold, which can be fixed, configured, or subject to UE capability.
In one example (C3), the condition corresponds to the case when number of CSI-RS ports (for a TRP)>t, where t is a threshold, which can be fixed, configured, or subject to UE capability.
In one example (C4), the condition corresponds to the case when N_{TRP}<3 (i.e., N_{TRP}=1,2).
In one example (C5), the condition corresponds to the case when N_{TRP}<s, where s is a threshold, which can be fixed, or configured, or subject to UE capability.
In one example (C6), the condition corresponds to the case when N_{TRP}≤s, where s is a threshold, which can be fixed, or configured, or subject to UE capability.
In one example (C7), the condition corresponds to the case when N_{TRP}>s, where s is a threshold, which can be fixed, or configured, or subject to UE capability.
In one example (C8), the condition corresponds to the case when N_{TRP}>s, where s is a threshold, which can be fixed, or configured, or subject to UE capability.
In one example (C9), the condition corresponds to the case when K<k, where k is a threshold, which can be fixed, or configured, or subject to UE capability.
In one example (C10), the condition corresponds to the case when K≤k, where k is a threshold, which can be fixed, or configured, or subject to UE capability.
In one example (C11), the condition corresponds to the case when K>k, where k is a threshold, which can be fixed, or configured, or subject to UE capability.
In one example (C12), the condition corresponds to the case when K≥k, where k is a threshold, which can be fixed, or configured, or subject to UE capability.
In one example (C13), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction).
In one example (C14), the condition corresponds to C1 or/and C2 or/and C3 or/and C4 or/and C5 or/and C6 or/and C7 or/and C8 or/and C9 or/and C10 or/and C11 or/and C12 and the value of R is 1 (e.g., configured via higher layer numberOfPMIsubbandPerCQIsubband).
In one example (C15), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction), and the value of R is 1 (e.g., configured via higher layer numberOfPMIsubbandPerCQIsubband).

In one example, the parameter combination with M=2 or/and 3 or/and 4 or/and 1 or/and β=½ or/and ¾ or/and 1 for any n can be used/reported (by the UE 116) or configured (by the NW 130) under a condition.
In one example (C1), the condition corresponds to the case when number of CSI-RS ports (for a TRP)=32.
In one example (C2), the condition corresponds to the case when number of CSI-RS ports (for a TRP)≥t, where t is a threshold, which can be fixed, configured, or subject to UE capability.
In one example (C3), the condition corresponds to the case when number of CSI-RS ports (for a TRP)>t, where t is a threshold, which can be fixed, configured, or subject to UE capability.
In one example (C4), the condition corresponds to the case when N_{TRP}<3 (i.e., N_{TRP}=1,2).
In one example (C5), the condition corresponds to the case when N_{TRP}<s, where s is a threshold, which can be fixed, or configured, or subject to UE capability.
In one example (C6), the condition corresponds to the case when N_{TRP}≤s, where s is a threshold, which can be fixed, or configured, or subject to UE capability.
In one example (C7), the condition corresponds to the case when N_{TRP}>s, where s is a threshold, which can be fixed, or configured, or subject to UE capability.
In one example (C8), the condition corresponds to the case when N_{TRP}>s, where s is a threshold, which can be fixed, or configured, or subject to UE capability.
In one example (C9), the condition corresponds to the case when K<k, where k is a threshold, which can be fixed, or configured, or subject to UE capability.
In one example (C10), the condition corresponds to the case when K≤k, where k is a threshold, which can be fixed, or configured, or subject to UE capability.
In one example (C11), the condition corresponds to the case when K>k, where k is a threshold, which can be fixed, or configured, or subject to UE capability.
In one example (C12), the condition corresponds to the case when K≥k, where k is a threshold, which can be fixed, or configured, or subject to UE capability.
In one example (C13), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction).
In one example (C14), the condition corresponds to C1 or/and C2 or/and C3 or/and C4 or/and C5 or/and C6 or/and C7 or/and C8 or/and C9 or/and C10 or/and C11 or/and C12 and the value of R is 1 (e.g., configured via higher layer numberOfPMIsubbandPerCQIsubband).
In one example (C15), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction), and the value of R is 1 (e.g., configured via higher layer numberOfPMIsubbandPerCQIsubband).

In one example, the parameter combination with αₙ=1 or/and ¾ or/and M=2 or/and 3 or/and 4 or/and 1 or/and β=½ or/and ¾ or/and 1 for any n can be used/reported (by the UE 116) or configured (by the NW 130) under a condition.
In one example (C1), the condition corresponds to the case when number of CSI-RS ports (for a TRP)=32.
In one example (C2), the condition corresponds to the case when number of CSI-RS ports (for a TRP)≥t, where t is a threshold, which can be fixed, configured, or subject to UE capability.
In one example (C3), the condition corresponds to the case when number of CSI-RS ports (for a TRP)>t, where t is a threshold, which can be fixed, configured, or subject to UE capability.
In one example (C4), the condition corresponds to the case when N_{TRP}<3 (i.e., N_{TRP}=1,2).
In one example (C5), the condition corresponds to the case when N_{TRP}<s, where s is a threshold, which can be fixed, or configured, or subject to UE capability.
In one example (C6), the condition corresponds to the case when N_{TRP}≤s, where s is a threshold, which can be fixed, or configured, or subject to UE capability.
In one example (C7), the condition corresponds to the case when N_{TRP}>s, where s is a threshold, which can be fixed, or configured, or subject to UE capability.
In one example (C8), the condition corresponds to the case when N_{TRP}>s, where s is a threshold, which can be fixed, or configured, or subject to UE capability.
In one example (C9), the condition corresponds to the case when K<k, where k is a threshold, which can be fixed, or configured, or subject to UE capability.
In one example (C10), the condition corresponds to the case when K≤k, where k is a threshold, which can be fixed, or configured, or subject to UE capability.
In one example (C11), the condition corresponds to the case when K>k, where k is a threshold, which can be fixed, or configured, or subject to UE capability.
In one example (C12), the condition corresponds to the case when K>k, where k is a threshold, which can be fixed, or configured, or subject to UE capability.
In one example (C13), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction).
In one example (C14), the condition corresponds to C1 or/and C2 or/and C3 or/and C4 or/and C5 or/and C6 or/and C7 or/and C8 or/and C9 or/and C10 or/and C11 or/and C12 and the value of R is 1 (e.g., configured via higher layer numberOfPMIsubbandPerCQIsubband).
In one example (C15), the condition corresponds to C1 or/and C2 or/and C3 or/and C4 or/and C5 or/and C6 or/and C7 or/and C8 or/and C9 or/and C10 or/and C11 or/and C12 and the max rank value (for RI reporting) is 2 (e.g., configured via RI-restriction), and the value of R is 1 (e.g., configured via higher layer numberOfPMIsubbandPerCQIsubband).

For any table described in the present disclosure or any table that can be constructed by any embodiment, the table having a different order of columns can also be interpreted as an embodiment of the present disclosure. Additionally, the tables are intended to provide examples of values that may be included. In various embodiments, only some of and not all the values of the table may used or required.

FIG. 11 illustrates an example method 1100 performed by a UE in a wireless communication system according to embodiments of the present disclosure. The method 1100 of FIG. 11 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1100 is for illustration only and other embodiments can be used without departing from the scope of the present disclosure.

The method begins with the UE receiving information about a CSI report associated with N_{TRP} CSI-RS resources and N_{L} values of (L₁, . . . , L_{N}_{_{TRP}}), 1110. For example, in 1110, each of the N_{L} values of (L₁, . . . , L_{N}_{_{TRP}}) belongs to a table including N_{TRP}, (L₁, . . . , L_{N}_{_{TRP}}), and an associated index, and (L₁, . . . , L_{N}_{_{TRP}} is a tuple of numbers of spatial-domain (SD) basis vectors Lᵣ associated with CSI-RS resource r=1, . . . ,N_{TRP}.

In various embodiments, {L₁, . . . , L_{N}_{_{TRP}}} with Lᵣ=4 is allowed to be included in the information about the N_{L} combinations of values of Lᵣ {L₁, . . . , L_{N}_{_{TRP}}} when a number of CSI-RS ports (P_{CSI-RS}) for a CSI-RS resource r is greater than 4.

In various embodiments, when {L₁, . . . , L_{N}_{_{TRP}}} with Σᵣ₌₁^{N}^{_{TRP}} Lᵣ>Lₘₐₓ is not allowed to be included in the information about the N_{L} combinations of values of Lᵣ {L₁, . . . , L_{N}_{_{TRP}}}, where Lₘₐₓ is a value associated with a UE capability for a supported total number of SD basis vectors for the N_{TRP} CSI-RS resources.

The UE then determines the CSI report based on the information, 1120. In various embodiments, when N_{L}≥>1, the UE selects one of the N_{L} combinations of {L₁, . . . , L_{N}_{_{TRP}}} and determines the CSI report associated with the selected combination of {L₁, . . . , L_{N}_{_{TRP}}}. The UE may also include the selected combination of {L₁, . . . , L_{N}_{_{TRP}}} in the CSI report via an indicator of ┌log₂ N_{L}┐-bit in a CSI part 1 of the CSI report.

In various embodiments, when N_{L}=1, the UE determines the CSI report associated with a combination of {L₁, . . . , L_{N}_{_{TRP}}} and does not to include any indicator for selecting the combination of {L₁, . . . , L_{N}_{_{TRP}}} in the CSI report.

The UE then transmits the determined CSI report, 1130.

Any of the above variation embodiments can be utilized independently or in combination with at least one other variation embodiment. The above flowchart illustrates example methods that can be implemented in accordance with the principles of the present disclosure and various changes could be made to the methods illustrated in the flowchart herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive information about (i) a channel state information (CSI) report associated with N_{TRP} 1 CSI reference signal (CSI-RS) resources and (ii) N_{L}≥1 values of (L₁, . . . , L_{N}_{_{TRP}}), where:
each of the N_{L} values of (L₁, . . . , L_{N}_{_{TRP}}) belongs to a table including N_{TRP}, (L₁, . . . , L_{N}_{_{TRP}}), and an associated index, and
(L₁, . . . , L_{N}_{_{TRP}}) is a tuple of numbers of spatial-domain (SD) basis vectors Lᵣ associated with CSI-RS resource r=1, . . . , N_{TRP}; and
a processor operably coupled to the transceiver, the processor configured to determine the CSI report based on the information,
wherein the transceiver is further configured to transmit the determined CSI report.

2. The UE of claim 1, wherein, when N_{L}>1, the processor is further configured to:
select one of the N_{L} values of (L₁, . . . , L_{N}_{_{TRP}}), and
determine the CSI report associated with the selected value.

3. The UE of claim 2, wherein the processor is further configured to include the selected value in the CSI report via an indicator of ┌log₂ N_{L}┐-bit in a CSI part 1 of the CSI report.

4. The UE of claim 1, wherein, when N_{L}=1, the processor is further configured to:
determine the CSI report associated with a value of (L₁, . . . , L_{N}_{_{TRP}}), and
omit an indicator for selecting a value of (L₁, . . . , L_{N}_{_{TRP}}) in the CSI report.

5. The UE of claim 1, wherein the table includes one or more of the values of (L₁, . . . , L_{N}_{_{TRP}}) according to:

| N_{TRP} | L₁ | L₂ | L₃ | L₄ |
|---|---|---|---|---|
| 2 | 2 | 2 | | |
| | 2 | 4 | | |
| | 4 | 2 | | |
| | 4 | 4 | | |
| 3 | 2 | 2 | 2 | |
| | 2 | 2 | 4 | |
| | 2 | 4 | 2 | |
| | 2 | 4 | 4 | |
| | 4 | 2 | 2 | |
| | 4 | 2 | 4 | |
| | 4 | 4 | 2 | |
| | 4 | 4 | 4 | |
| 4 | 2 | 2 | 2 | 2 |
| | 2 | 2 | 2 | 4 |
| | 2 | 2 | 4 | 2 |
| | 2 | 2 | 4 | 4 |
| | 2 | 4 | 2 | 2 |
| | 2 | 4 | 2 | 4 |
| | 2 | 4 | 4 | 2 |
| | 2 | 4 | 4 | 4 |
| | 4 | 2 | 2 | 2 |
| | 4 | 2 | 2 | 4 |
| | 4 | 2 | 4 | 2 |
| | 4 | 2 | 4 | 4 |
| | 4 | 4 | 2 | 2 |
| | 4 | 4 | 2 | 4 |
| | 4 | 4 | 4 | 2 |
| | 4 | 4 | 4 | 4 |

6. The UE of claim 1, wherein the table includes one or more of the values of (L₁, . . . ,L_{N}_{_{TRP}}) according to:

| N_{TRP} | L₁ | L₂ | L₃ | L₄ |
|---|---|---|---|---|
| 1 | 2 | | | |
| | 4 | | | |
| | 6 | | | |
| 2 | 2 | 2 | | |
| | 2 | 4 | | |
| | 4 | 2 | | |
| | 4 | 4 | | |
| 3 | 2 | 2 | 2 | |
| | 2 | 2 | 4 | |
| | 2 | 4 | 2 | |
| | 4 | 2 | 2 | |
| | 4 | 4 | 4 | |
| 4 | 2 | 2 | 2 | 2 |
| | 2 | 2 | 2 | 4 |
| | 2 | 2 | 4 | 4 |
| | 4 | 4 | 4 | 4 |

7. The UE of claim 1, wherein (L₁, . . . , L_{N}_{_{TRP}}) having Lₙ=4 for some r∈{1, . . . , N_{TRP}} is allowed to be included in the information about the N_{L} values of (L₁, . . . , L_{N}_{_{TRP}}) when a number of CSI-RS ports (P_{CSI-RS}) for a CSI-RS resource r is greater than 4.

8. The UE of claim 1, wherein (L₁, . . . , L_{N}_{_{TRP}}) satisfying Σᵣ₌₁^{N}^{_{TRP}} Lᵣ>Lₘₐₓ is not allowed to be included in the information about the N_{L} values of (L₁, . . . , L_{N}_{_{TRP}}),
where Lₘₐₓ is a value associated with a UE capability for a supported total number of SD basis vectors for the N_{TRP} CSI-RS resources.

9. A base station (BS) comprising:
a transceiver configured to:
transmit information about (i) a channel state information (CSI) report associated with N_{TRP}≥1 CSI reference signal (CSI-RS) resources and (ii) N_{L}≥1 values of (L₁, . . . , L_{N}_{_{TRP}}), where:
each of the N_{L} values of (L₁, . . . , L_{N}_{_{TRP}}) belongs to a table including N_{TRP}, (L₁, . . . , L_{N}_{_{TRP}}), and an associated index, and
(L₁, . . . , L_{N}_{_{TRP}}) is a tuple of numbers of spatial-domain (SD) basis vectors Lᵣ associated with CSI-RS resource r=1, . . . , N_{TRP},
receive the CSI report that is based on the information.

10. The BS of claim 9, wherein, when N_{L}>1, the CSI report is associated with a selected one of the N_{L} values of (L₁, . . . , L_{N}_{_{TRP}}).

11. The BS of claim 10, wherein the selected value is included in the CSI report via an indicator of ┌log₂ N_{L}┐-bit in a CSI part 1 of the CSI report.

12. The BS of claim 9, wherein, when N_{L}=1:
the CSI report is associated with a value of (L₁, . . . , L_{N}_{_{TRP}}), and
the CSI report does not include any indicator for selecting a value of (L₁, . . . ,L_{N}_{_{TRP}}).

13. The BS of claim 9, wherein the table includes one or more of the values of (L₁, . . . , L_{N}_{_{TRP}}) according to:

| N_{TRP} | L₁ | L₂ | L₃ | L₄ |
|---|---|---|---|---|
| 2 | 2 | 2 | | |
| | 2 | 4 | | |
| | 4 | 2 | | |
| | 4 | 4 | | |
| 3 | 2 | 2 | 2 | |
| | 2 | 2 | 4 | |
| | 2 | 4 | 2 | |
| | 2 | 4 | 4 | |
| | 4 | 2 | 2 | |
| | 4 | 2 | 4 | |
| | 4 | 4 | 2 | |
| | 4 | 4 | 4 | |
| 4 | 2 | 2 | 2 | 2 |
| | 2 | 2 | 2 | 4 |
| | 2 | 2 | 4 | 2 |
| | 2 | 2 | 4 | 4 |
| | 2 | 4 | 2 | 2 |
| | 2 | 4 | 2 | 4 |
| | 2 | 4 | 4 | 2 |
| | 2 | 4 | 4 | 4 |
| | 4 | 2 | 2 | 2 |
| | 4 | 2 | 2 | 4 |
| | 4 | 2 | 4 | 2 |
| | 4 | 2 | 4 | 4 |
| | 4 | 4 | 2 | 2 |
| | 4 | 4 | 2 | 4 |
| | 4 | 4 | 4 | 2 |
| | 4 | 4 | 4 | 4 |

14. The BS of claim 9, wherein the table includes one or more of the values of (L₁, . . . , L_{N}_{_{TRP}}) according to:

| N_{TRP} | L₁ | L₂ | L₃ | L₄ |
|---|---|---|---|---|
| 1 | 2 | | | |
| | 4 | | | |
| | 6 | | | |
| 2 | 2 | 2 | | |
| | 2 | 4 | | |
| | 4 | 2 | | |
| | 4 | 4 | | |
| 3 | 2 | 2 | 2 | |
| | 2 | 2 | 4 | |
| | 2 | 4 | 2 | |
| | 4 | 2 | 2 | |
| | 4 | 4 | 4 | |
| 4 | 2 | 2 | 2 | 2 |
| | 2 | 2 | 2 | 4 |
| | 2 | 2 | 4 | 4 |
| | 4 | 4 | 4 | 4 |

15. The BS of claim 9, wherein (L₁, . . . , L_{N}_{_{TRP}}) having Lₙ=4 for some r∈{1, . . . , N_{TRP}} is allowed to be included in the information about the N_{L} values of (L₁, . . . , L_{N}_{_{TRP}}) when a number of CSI-RS ports (P_{CSI-RS}) for a CSI-RS resource r is greater than 4.

16. The BS of claim 9, wherein (L₁, . . . , L_{N}_{_{TRP}}) satisfying Σᵣ₌₁^{N}^{_{TRP}} Lᵣ>Lₘₐₓ is not allowed to be included in the information about the N_{L} values of (L₁, . . . , L_{N}_{_{TRP}}),
where Lₘₐₓ is a value associated with a UE capability for a supported total number of SD basis vectors for the N_{TRP} CSI-RS resources.

17. A method performed by a user equipment (UE), the method comprising:
receiving information about (i) a channel state information (CSI) report associated with N_{TRP} 1 CSI reference signal (CSI-RS) resources and (ii) N_{L}≥1 values of (L₁, . . . , L_{N}_{_{TRP}}), where:
each of the N_{L} values of (L₁, . . . , L_{N}_{_{TRP}}) is indicated based on a table including N_{TRP}, (L₁, . . . , L_{N}_{_{TRP}}), and an associated index, and
(L₁, . . . , L_{N}_{_{TRP}}) is a tuple of numbers of spatial-domain (SD) basis vectors Lᵣ associated with CSI-RS resource r=1, . . . , N_{TRP};
determining the CSI report based on the information; and
transmitting the determined CSI report.

18. The method of claim 17, further comprising:
when N_{L}>1, selecting one of the N_{L} values of (L₁, . . . , L_{N}_{_{TRP}}),
wherein determining the CSI report further comprises determining the CSI report associated with the selected value.

19. The method of claim 18, further comprising including the selected value in the CSI report via an indicator of ┌log₂ N_{L}┐-bit in a CSI part 1 of the CSI report.

20. The method of claim 17, wherein determining the CSI report further comprises, when N_{L}=1, determining the CSI report associated with a value of (L₁, . . . , L_{N}_{_{TRP}}) and omitting an indicator for selecting a value of (L₁, . . . , L_{N}_{_{TRP}}) in the CSI report.
